(19) United States
(12) Patent Application Publication
(10) Pub. No.: US 2025/0133574 A1
(43) Pub. Date: Apr. 24, 2025

(54) BEAM ACTIVATION, INDICATION AND APPLICATION

(71) Applicant: Samsung Electronics Co., Ltd., Suwon-si (KR)

(72) Inventors: Dalin Zhu, Allen, TX (US); Emad Nader Farag, Flanders, NJ (US); Eko Onggosanusi, Coppell, TX (US)

(21) Appl. No.: 18/912,479

(22) Filed: Oct. 10, 2024

Related U.S. Application Data
(60) Provisional application No. 63/545,292, filed on Oct. 23, 2023.
(60) Provisional application No. 63/545,298, filed on Oct. 23, 2023.
(60) Provisional application No. 63/545,498, filed on Oct. 24, 2023.
(60) Provisional application No. 63/545,881, filed on Oct. 26, 2023.
(60) Provisional application No. 63/547,065, filed on Nov. 2, 2023.
(60) Provisional application No. 63/681,582, filed on Aug. 9, 2024.

(51) Int. Cl. H04W 72/232; H04L 5/00

(52) U.S. Cl. CPC H04W 72/232; H04L 5/0091

(57) ABSTRACT

Methods and apparatus for beam activation, indication, and application. A method includes receiving, in a TCI state activation/deactivation MAC CE command, L activated TCI codepoints and receiving a DCI with a TCI field having S TCI codepoints. Each of the L activated TCI codepoints is mapped to a first or second TCI state. The method further includes identifying, the L activated TCI codepoints that are mapped to the S TCI codepoints, applying the first TCI state and the second TCI state for transmission and reception, receiving, in a first DCI and a second DCI, a first indication of the first TCI state and a second indication of the first TCI state, respectively, and identifying, based on a time of reception of the first and second DCIs, the first or second indication of the first TCI state to use to update the first TCI state after a beam application time.

### CROSS-REFERENCE TO RELATED AND CLAIM OF PRIORITY

The present application claims priority under 35 U.S.C. § 119(e) to: U.S. Provisional Patent Application No. 63/545,292 filed on Oct. 23, 2023; U.S. Provisional Patent Application No. 63/545,298 filed on Oct. 23, 2023; U.S. Provisional Patent Application No. 63/545,498 filed on Oct. 24, 2023; U.S. Provisional Patent Application No. 63/545,881 filed on Oct. 26, 2023; U.S. Provisional Patent Application No. 63/547,065 filed on Nov. 2, 2023; and U.S. Provisional Patent Application No. 63/681,582 filed on Aug. 9, 2024, which are hereby incorporated by reference in their entirety.

### TECHNICAL FIELD

The present disclosure relates generally to wireless communication systems and, more specifically, the present disclosure relates to methods and apparatus for beam activation, indication and application.

### BACKGROUND

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

### SUMMARY

The present disclosure relates to beam activation, indication and application.

In one embodiment, user equipment (UE) is provided. The UE includes a transceiver configured to receive, in a transmission configuration indication (TCI) state activation/deactivation medium access control control element (MAC CE) command, L activated TCI codepoints and receive a downlink control information (DCI) with a TCI field having S TCI codepoints, where S≥1 and L≥1. Each of the L activated TCI codepoints is mapped to a first or second TCI state. The UE further includes a processor operably coupled to the transceiver. The processor is configured to identify, the L activated TCI codepoints that are mapped to the S TCI codepoints and apply the first TCI state and the second TCI state for transmission and reception. The transceiver is further configured to receive, in a first DCI and a second DCI, a first indication of the first TCI state and a second indication of the first TCI state, respectively. The processor is further configured to identify, based on a time of reception of the first and second DCIs, the first or second indication of the first TCI state to use to update the first TCI state after a beam application time.

In another embodiment, a base station (BS) is provided. The BS includes a processor and a transceiver operably coupled to the processor. The transceiver is configured to transmit, in a TCI state activation/deactivation MAC CE command, L activated TCI codepoints; transmit a DCI with a TCI field having S TCI codepoints, where L≥1 and S≥1; and transmit, in a first DCI and a second DCI, a first indication of the first TCI state and a second indication of the first TCI state, respectively. The L activated TCI codepoints are mapped to the S TCI codepoints. Each of the L activated TCI codepoints is mapped to a first or second TCI state used for transmission and reception. Based on a time of reception of the first and second DCIs, the first or second indication of the first TCI state indicates to update the first TCI state after a beam application time.

In another embodiment, a method performed by a UE is provided. The method includes receiving, in a TCI state activation/deactivation MAC CE command, L activated TCI codepoints and receiving a DCI with a TCI field having S TCI codepoints, where S≥1 and L≥1. Each of the L activated TCI codepoints is mapped to a first or second TCI state. The method further includes identifying, the L activated TCI codepoints that are mapped to the S TCI codepoints and applying the first TCI state and the second TCI state for transmission and reception. The method further includes receiving, in a first DCI and a second DCI, a first indication of the first TCI state and a second indication of the first TCI state, respectively, and identifying, based on a time of reception of the first and second DCIs, the first or second indication of the first TCI state to use to update the first TCI state after a beam application time.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system, or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of the present disclosure and its advantages, reference is now made to the following description taken in conjunction with the accompanying drawings, in which like reference numerals represent like parts:

FIG. 1 illustrates an example wireless network according to embodiments of the present disclosure;

FIG. 2 illustrates an example gNodeB (gNB) according to embodiments of the present disclosure;

FIG. 3 illustrates an example user equipment (UE) according to embodiments of the present disclosure;

FIGS. 4A and 4B illustrate an example of a wireless transmit and receive paths according to embodiments of the present disclosure;

FIG. 5A illustrates an example of a wireless system according to embodiments of the present disclosure;

FIG. 5B illustrates an example of a multi-beam operation according to embodiments of the present disclosure;

FIG. 6 illustrates an example of a transmitter structure for beamforming according to embodiments of the present disclosure;

FIG. 7 illustrates a flowchart of an example UE procedure for applying transmission configuration indication (TCI) state(s) according to embodiments of the present disclosure; and

FIG. 8 illustrates an example medium access control (MAC) control element (CE) command for TCI state(s) activation according to embodiments of the present disclosure.

### DETAILED DESCRIPTION

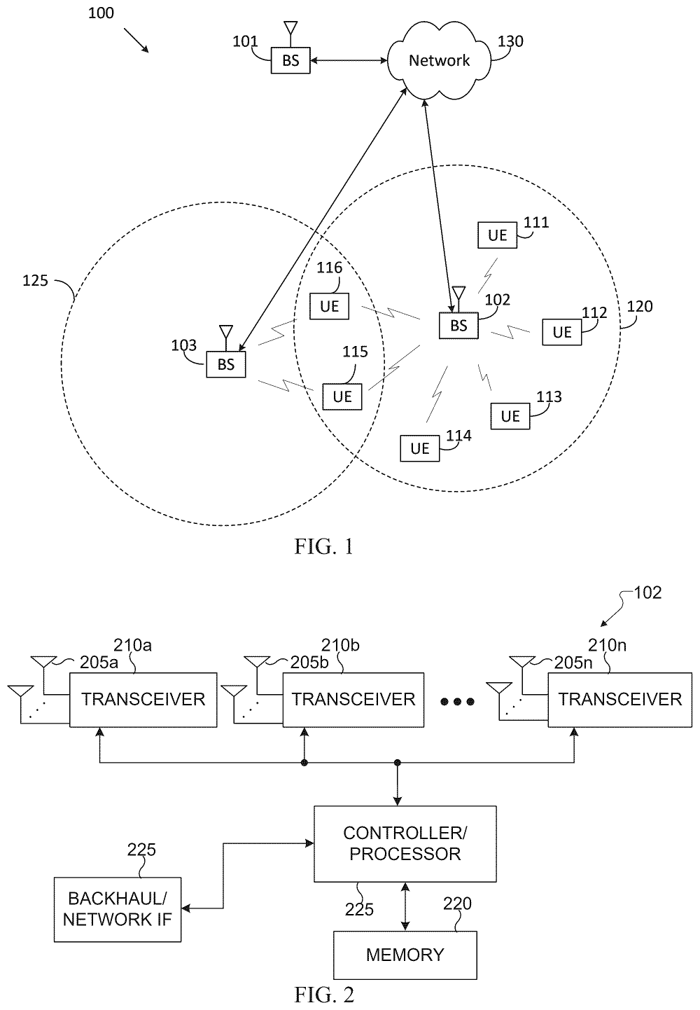

FIGS. 1-8, discussed below, and the various, non-limiting embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

To meet the demand for wireless data traffic having increased since deployment of 4G communication systems, and to enable various vertical applications, 5G/NR communication systems have been developed and are currently being deployed. The 5G/NR communication system is implemented in higher frequency (mmWave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (CoMP), reception-end interference cancelation and the like.

The discussion of 5G systems and frequency bands associated therewith is for reference as certain embodiments of the present disclosure may be implemented in 5G systems. However, the present disclosure is not limited to 5G systems, or the frequency bands associated therewith, and embodiments of the present disclosure may be utilized in connection with any frequency band. For example, aspects of the present disclosure may also be applied to deployment of 5G communication systems, 6G, or even later releases which may use terahertz (THz) bands.

The following documents and standards descriptions are hereby incorporated by reference into the present disclosure as if fully set forth herein: [1]3GPP TS 38.211 v16.1.0, “NR; Physical channels and modulation;” [2]3GPP TS 38.212 v16.1.0, “NR; Multiplexing and Channel coding;” [3]3GPP TS 38.213 v16.1.0, “NR; Physical Layer Procedures for Control;” [4]3GPP TS 38.214 v16.1.0, “NR; Physical Layer Procedures for Data;” [5]3GPP TS 38.321 v16.1.0, “NR; Medium Access Control (MAC) protocol specification;” and [6]3GPP TS 38.331 v16.1.0, “NR; Radio Resource Control (RRC) Protocol Specification.”

FIGS. 1-3 below describe various embodiments implemented in wireless communications systems and with the use of orthogonal frequency division multiplexing (OFDM) or orthogonal frequency division multiple access (OFDMA) communication techniques. The descriptions of FIGS. 1-3 are not meant to imply physical or architectural limitations to how different embodiments may be implemented. Different embodiments of the present disclosure may be implemented in any suitably arranged communications system.

FIG. 1 illustrates an example wireless network 100 according to embodiments of the present disclosure. The embodiment of the wireless network 100 shown in FIG. 1 is for illustration only. Other embodiments of the wireless network 100 could be used without departing from the scope of this disclosure.

As shown in FIG. 1, the wireless network 100 includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

The dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof for identifying and/or performing beam activation, indication, and application. In certain embodiments, one or more of the BSs 101-103 include circuitry, programing, or a combination thereof to support beam activation, indication, and application.

Although FIG. 1 illustrates one example of a wireless network, various changes may be made to FIG. 1. For example, the wireless network 100 could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

FIG. 2 illustrates an example gNB 102 according to embodiments of the present disclosure. The embodiment of the gNB 102 illustrated in FIG. 2 is for illustration only, and the gNBs 101 and 103 of FIG. 1 could have the same or similar configuration. However, gNBs come in a wide variety of configurations, and FIG. 2 does not limit the scope of this disclosure to any particular implementation of a gNB.

As shown in FIG. 2, the gNB 102 includes multiple antennas 205a-205n, multiple transceivers 210a-210n, a controller/processor 225, a memory 230, and a backhaul or network interface 235.

The transceivers 210a-210n receive, from the antennas 205a-205n, incoming radio frequency (RF) signals, such as signals transmitted by UEs in the wireless network 100. The transceivers 210a-210n down-convert the incoming RF signals to generate IF or baseband signals. The IF or baseband signals are processed by receive (RX) processing circuitry in the transceivers 210a-210n and/or controller/processor 225, which generates processed baseband signals by filtering, decoding, and/or digitizing the baseband or IF signals. The controller/processor 225 may further process the baseband signals.

Transmit (TX) processing circuitry in the transceivers 210a-210n and/or controller/processor 225 receives analog or digital data (such as voice data, web data, e-mail, or interactive video game data) from the controller/processor 225. The TX processing circuitry encodes, multiplexes, and/or digitizes the outgoing baseband data to generate processed baseband or IF signals. The transceivers 210a-210n up-converts the baseband or IF signals to RF signals that are transmitted via the antennas 205a-205n.

The controller/processor 225 can include one or more processors or other processing devices that control the overall operation of the gNB 102. For example, the controller/processor 225 could control the reception of uplink (UL) channel signals and the transmission of downlink (DL) channel signals by the transceivers 210a-210n in accordance with well-known principles. The controller/processor 225 could support additional functions as well, such as more advanced wireless communication functions. For instance, the controller/processor 225 could support beam forming or directional routing operations in which outgoing/incoming signals from/to multiple antennas 205a-205n are weighted differently to effectively steer the outgoing signals in a desired direction. As another example, the controller/processor 225 could support methods for supporting beam activation, indication, and application. Any of a wide variety of other functions could be supported in the gNB 102 by the controller/processor 225.

The controller/processor 225 is also capable of executing programs and other processes resident in the memory 230, such as supporting beam activation, indication, and application. The controller/processor 225 can move data into or out of the memory 230 as required by an executing process.

The controller/processor 225 is also coupled to the backhaul or network interface 235. The backhaul or network interface 235 allows the gNB 102 to communicate with other devices or systems over a backhaul connection or over a network. The interface 235 could support communications over any suitable wired or wireless connection(s). For example, when the gNB 102 is implemented as part of a cellular communication system (such as one supporting 5G/NR, LTE, or LTE-A), the interface 235 could allow the gNB 102 to communicate with other gNBs over a wired or wireless backhaul connection. When the gNB 102 is implemented as an access point, the interface 235 could allow the gNB 102 to communicate over a wired or wireless local area network or over a wired or wireless connection to a larger network (such as the Internet).

The interface 235 includes any suitable structure supporting communications over a wired or wireless connection, such as an Ethernet or transceiver.

The memory 230 is coupled to the controller/processor 225. Part of the memory 230 could include a RAM, and another part of the memory 230 could include a Flash memory or other ROM.

Although FIG. 2 illustrates one example of gNB 102, various changes may be made to FIG. 2. For example, the gNB 102 could include any number of each component shown in FIG. 2. Also, various components in FIG. 2 could be combined, further subdivided, or omitted and additional components could be added according to particular needs.

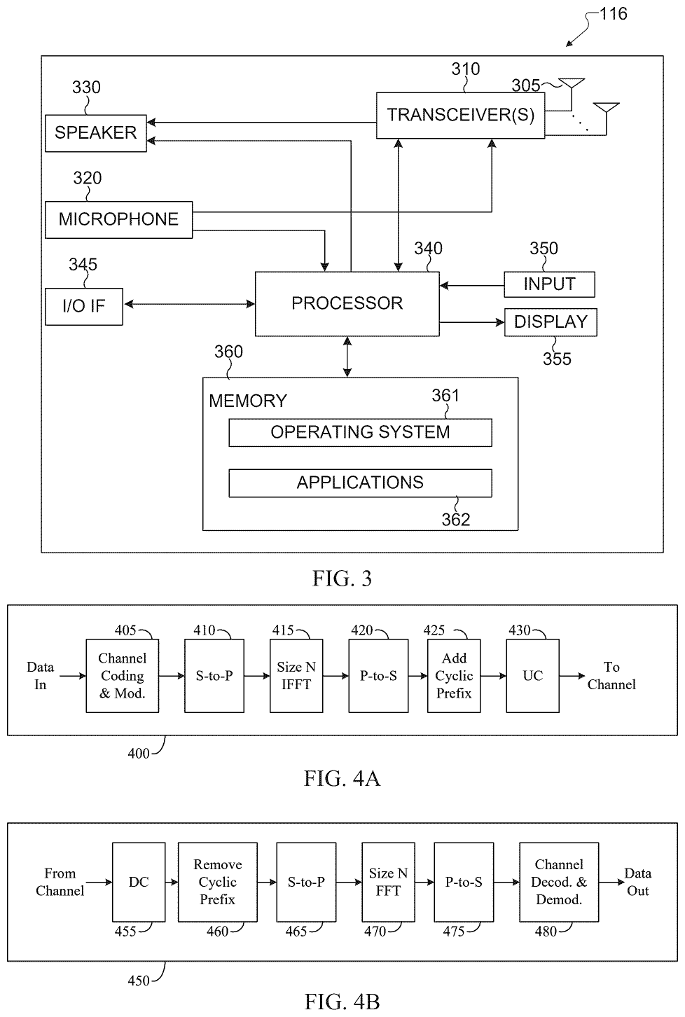

FIG. 3 illustrates an example UE 116 according to embodiments of the present disclosure. The embodiment of the UE 116 illustrated in FIG. 3 is for illustration only, and the UEs 111-115 of FIG. 1 could have the same or similar configuration. However, UEs come in a wide variety of configurations, and FIG. 3 does not limit the scope of this disclosure to any particular implementation of a UE.

As shown in FIG. 3, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna(s) 305, an incoming RF signal transmitted by a gNB of the wireless network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360. For example, the processor 340 may execute processes for identifying and/or performing beam activation, indication, and application as described in embodiments of the present disclosure. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes, for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3 illustrates one example of UE 116, various changes may be made to FIG. 3. For example, various components in FIG. 3 could be combined, further subdivided, or omitted and additional components could be added according to particular needs. As a particular example, the processor 340 could be divided into multiple processors, such as one or more central processing units (CPUs) and one or more graphics processing units (GPUs). In another example, the transceiver(s) 310 may include any number of transceivers and signal processing chains and may be connected to any number of antennas. Also, while FIG. 3 illustrates the UE 116 configured as a mobile telephone or smartphone, UEs could be configured to operate as other types of mobile or stationary devices.

FIG. 4A and FIG. 4B illustrate an example of wireless transmit and receive paths 400 and 450, respectively, according to embodiments of the present disclosure. For example, a transmit path 400 may be described as being implemented in a gNB (such as gNB 102), while a receive path 450 may be described as being implemented in a UE (such as UE 116). However, it will be understood that the receive path 450 can be implemented in a gNB and that the transmit path 400 can be implemented in a UE. In some embodiments, the receive path 450 is configured to support beam activation, indication, and application as described in embodiments of the present disclosure.

As illustrated in FIG. 4A, the transmit path 400 includes a channel coding and modulation block 205, a serial-to-parallel (S-to-P) block 410, a size N Inverse Fast Fourier Transform (IFFT) block 415, a parallel-to-serial (P-to-S) block 420, an add cyclic prefix block 425, and an up-converter (UC) 430. The receive path 250 includes a down-converter (DC) 455, a remove cyclic prefix block 460, a S-to-P block 465, a size N Fast Fourier Transform (FFT) block 470, a parallel-to-serial (P-to-S) block 475, and a channel decoding and demodulation block 480.

In the transmit path 400, the channel coding and modulation block 405 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 410 converts (such as de-multiplexes) the serial modulated symbols to parallel data in order to generate N parallel symbol streams, where N is the IFFT/FFT size used in the gNB 102 and the UE 116. The size N IFFT block 415 performs an IFFT operation on the N parallel symbol streams to generate time-domain output signals. The parallel-to-serial block 420 converts (such as multiplexes) the parallel time-domain output symbols from the size N IFFT block 415 in order to generate a serial time-domain signal. The add cyclic prefix block 425 inserts a cyclic prefix to the time-domain signal. The up-converter 430 modulates (such as up-converts) the output of the add cyclic prefix block 425 to a RF frequency for transmission via a wireless channel. The signal may also be filtered at a baseband before conversion to the RF frequency.

As illustrated in FIG. 4B, the down-converter 455 down-converts the received signal to a baseband frequency, and the remove cyclic prefix block 460 removes the cyclic prefix to generate a serial time-domain baseband signal. The serial-to-parallel block 465 converts the time-domain baseband signal to parallel time-domain signals. The size N FFT block 470 performs an FFT algorithm to generate N parallel frequency-domain signals. The (P-to-S) block 475 converts the parallel frequency-domain signals to a sequence of modulated data symbols. The channel decoding and demodulation block 480 demodulates and decodes the modulated symbols to recover the original input data stream.

Each of the gNBs 101-103 may implement a transmit path 400 that is analogous to transmitting in the downlink to UEs 111-116 and may implement a receive path 450 that is analogous to receiving in the uplink from UEs 111-116. Similarly, each of UEs 111-116 may implement a transmit path 400 for transmitting in the uplink to gNBs 101-103 and may implement a receive path 450 for receiving in the downlink from gNBs 101-103.

Each of the components in FIGS. 4A and 4B can be implemented using only hardware or using a combination of hardware and software/firmware. As a particular example, at least some of the components in FIGS. 4A and 4B may be implemented in software, while other components may be implemented by configurable hardware or a mixture of software and configurable hardware. For instance, the FFT block 470 and the IFFT block 415 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 4A and 4B illustrate examples of wireless transmit and receive paths 400 and 450, respectively, various changes may be made to FIGS. 4A and 4B. For example, various components in FIGS. 4A and 4B can be combined, further subdivided, or omitted and additional components can be added according to particular needs. Also, FIGS. 4A and 4B are meant to illustrate examples of the types of transmit and receive paths that can be used in a wireless network. Any other suitable architectures can be used to support wireless communications in a wireless network.

In embodiments of the present disclosure, a beam is determined by either a transmission configuration indicator (TCI) state that establishes a quasi-colocation (QCL) relationship between a source reference signal (RS) (e.g., single sideband (SSB) and/or Channel State Information Reference Signal (CSI-RS)) and a target RS or a spatial relation information that establishes an association to a source RS, such as SSB or CSI-RS or sounding reference signal (SRS). In either case, the ID of the source reference signal identifies the beam. The TCI state and/or the spatial relation reference RS can determine a spatial RX filter for reception of downlink channels at the UE 116, or a spatial TX filter for transmission of uplink channels from the UE 116.

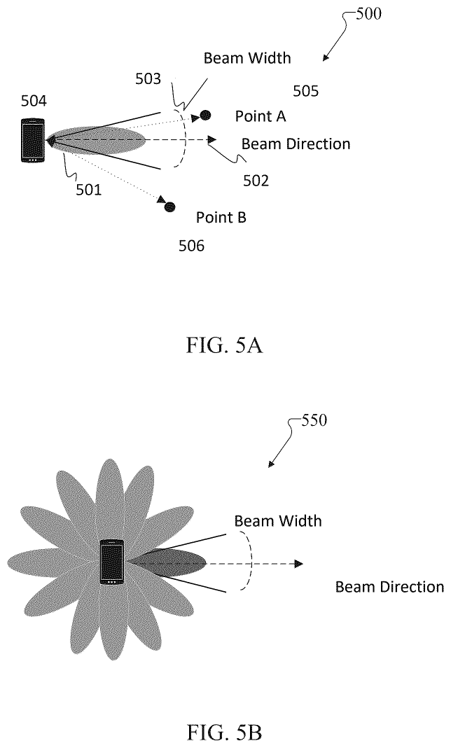

As illustrated in FIG. 5A, in a wireless system 500, a beam 501 for a device 504 can be characterized by abeam direction 502 and abeam width 503. For example, the device 504 (or UE 116) transmits RF energy in a beam direction and within a beam width. The device 504 receives RF energy in a beam direction and within a beam width. As illustrated in FIG. 5A, a device at point A 505 can receive from and transmit to device 504 as Point A is within a beam width and direction of a beam from device 504. As illustrated in FIG. 5A, a device at point B 506 cannot receive from and transmit to device 504 as Point B 506 is outside a beam width and direction of a beam from device 504. While FIG. 5A, for illustrative purposes, shows a beam in 2-dimensions (2D), it should be apparent to those skilled in the art, that a beam can be in 3-dimensions (3D), where the beam direction and beam width are defined in space.

FIG. 5B illustrates an example of a multi-beam operation 550 according to embodiments of the present disclosure. For example, the multi-beam operation 550 can be utilized by gNB 102 of FIG. 2. This example is for illustration only and other embodiments can be used without departing from the scope of the present disclosure.

In a wireless system, a device can transmit and/or receive on multiple beams. This is known as “multi-beam operation”. While FIG. 5B, for illustrative purposes, a beam is in 2D, it should be apparent to those skilled in the art, that a beam can be 3D, where a beam can be transmitted to or received from any direction in space.

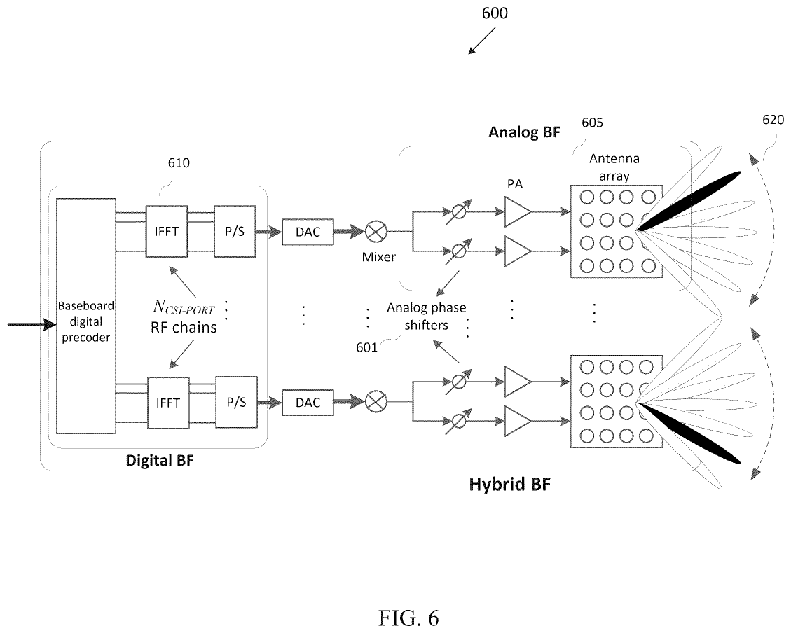

FIG. 6 illustrates an example of a transmitter structure 600 for beamforming according to embodiments of the present disclosure. In certain embodiments, one or more of gNB 102 or UE 116 includes the transmitter structure 600. For example, one or more of antenna 205 and its associated systems or antenna 305 and its associated systems can be included in transmitter structure 600. This example is for illustration only and other embodiments can be used without departing from the scope of the present disclosure.

Accordingly, embodiments of the present disclosure recognize that Rel-14 LTE and Rel-15 NR support up to 32 CSI-RS antenna ports which enable an eNB or a gNB to be equipped with a large number of antenna elements (such as 64 or 128). A plurality of antenna elements can then be mapped onto one CSI-RS port. For mmWave bands, although a number of antenna elements can be larger for a given form factor, a number of CSI-RS ports, that can correspond to the number of digitally precoded ports, can be limited due to hardware constraints (such as the feasibility to install a large number of analog-to-digital converters (ADCs)/digital-to-analog converters (DACs) at mmWave frequencies) as illustrated in FIG. 6. Then, one CSI-RS port can be mapped onto a large number of antenna elements that can be controlled by a bank of analog phase shifters 601. One CSI-RS port can then correspond to one sub-array which produces a narrow analog beam through analog beamforming 605. This analog beam can be configured to sweep across a wider range of angles 620 by varying the phase shifter bank across symbols or slots/subframes. The number of sub-arrays (equal to the number of RF chains) is the same as the number of CSI-RS ports N_{CSI-PORT}. A digital beamforming unit 610 performs a linear combination across N_{CSI-PORT} analog beams to further increase a precoding gain. While analog beams are wideband (hence not frequency-selective), digital precoding can be varied across frequency sub-bands or resource blocks. Receiver operation can be conceived analogously.

Since the transmitter structure 600 of FIG. 6 utilizes multiple analog beams for transmission and reception (wherein one or a small number of analog beams are selected out of a large number, for instance, after a training duration that is occasionally or periodically performed), the term “multi-beam operation” is used to refer to the overall system aspect. This includes, for the purpose of illustration, indicating the assigned DL or UL TX beam (also termed “beam indication”), measuring at least one reference signal for calculating and performing beam reporting (also termed “beam measurement” and “beam reporting”, respectively), and receiving a DL or UL transmission via a selection of a corresponding RX beam. The system of FIG. 6 is also applicable to higher frequency bands such as ≥52.6 GHz (also termed frequency range 4 or FR4). In this case, the system can employ only analog beams. Due to the O2 absorption loss around 60 GHz frequency (˜10 dB additional loss per 100 m distance), a larger number and narrower analog beams (hence a larger number of radiators in the array) are needed to compensate for the additional path loss.

In this disclosure, a beam is determined by either of;
A TCI state, that establishes a quasi-colocation (QCL) relationship between a source reference signal (e.g. SSB and/or CSI-RS) and a target reference signal
A spatial relation information that establishes an association to a source reference signal, such as SSB or CSI-RS or SRS.

In either case, the ID of the source reference signal identifies the beam.

The TCI state and/or the spatial relation reference RS can determine a spatial Rx filter for reception of downlink channels at the UE, or a spatial TX filter for transmission of uplink channels from the UE.

The text and figures are provided solely as examples to aid the reader in understanding the present disclosure. They are not intended and are not to be construed as limiting the scope of the present disclosure in any manner. Although certain embodiments and examples have been provided, it will be apparent to those skilled in the art based on the disclosures herein that changes in the embodiments and examples shown may be made without departing from the scope of the present disclosure. The transmitter structure 600 for beamforming is for illustration only and other embodiments can be used without departing from the scope of the present disclosure.

The flowcharts herein illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

In a multi-TRP system, a UE could be indicated by the network one or more joint/DL/UL TCI states for at least UE-dedicated reception(s)/transmission(s) of DL/UL channels or signals, and a TCI codepoint activated by a TCI state(s)/beam(s) activation MAC CE for multi-TRP operation can be mapped to one or more joint/DL/UL TCI states. However, under certain conditions, it is not desirable to map each of the TCI codepoints activated by the MAC CE for the multi-TRP operation to a single TCI state. Furthermore, embodiments of the present disclosure recognize that as different (number of) TCI states could be applied for different channels or signals, conditions of applying which of the indicated TCI states to which of the channels/signals need to be specified.

This disclosure evaluates various design aspects related to TCI codepoint(s) activation for a multi-TRP system. Specifically, this disclosure specifies various conditions to map one or more joint/DL/UL TCI states to a TCI codepoint activated by the TCI state(s) activation MAC CE for the multi-TRP operation. Furthermore, this disclosure also provides solutions for TCI state(s) selection for different channels especially when different number of TCI states can be applied for the different channels.

As specified in Rel-17, a unified TCI framework could indicate/include N≥1 DL TCI states and/or M≥1 UL TCI states, wherein the indicated TCI state could be at least one of:
A DL TCI state and/or its corresponding/associated TCI state ID
An UL TCI state and/or its corresponding/associated TCI state ID
A joint DL and UL TCI state and/or its corresponding/associated TCI state ID
Separate DL TCI state and UL TCI state and/or their corresponding/associated TCI state ID(s)

There could be various design options/channels to indicate to the UE a beam (i.e., a TCI state) for the transmission/reception of a physical downlink control channel (PDCCH) or a physical downlink shared channel (PDSCH). As described in the 3GPP Rel-17,
In one example, a MAC CE could be used to indicate to the UE a beam (i.e., a TCI state and/or a TCI state ID) for the transmission/reception of a PDCCH or a PDSCH.
In another example, a downlink control information (DCI) could be used to indicate to the UE a beam (i.e., a TCI state and/or a TCI state ID) for the transmission/reception of a PDCCH or a PDSCH
   For example, a DL related DCI (e.g., DCI format 1_0, DCI format 1_1 or DCI format 1_2) could be used to indicate to the UE a beam (i.e., a TCI state and/or a TCI state ID) for the transmission/reception of a PDCCH or a PDSCH, wherein the DL related DCI may or may not include a DL assignment.
   For another example, an UL related DCI (e.g., DCI format 0_0, DCI format 0_1, DCI format 0_2) could be used to indicate to the UE a beam (i.e., a TCI state and/or a TCI state ID) for the transmission/reception of a PDCCH or a PDSCH, wherein the UL related DCI may or may not include an UL scheduling grant.
   Yet for another example, a custom/purpose designed DCI format could be used to indicate to the UE a beam (i.e., a TCI state and/or a TCI state ID) for the transmission/reception of a PDCCH or a PDSCH.

Rel-17 introduced the unified TCI framework, where a unified or master or main TCI state is signaled to the UE. The unified or master or main TCI state can be one of:
In case of joint TCI state indication, wherein a same beam is used for DL and UL channels, a joint TCI state that can be used at least for UE-dedicated DL channels and UE-dedicated UL channels.
In case of separate TCI state indication, wherein different beams are used for DL and UL channels, a DL TCI state can be used at least for UE-dedicated DL channels.
In case of separate TCI state indication, wherein different beams are used for DL and UL channels, a UL TCI state can be used at least for UE-dedicated UL channels.
   The unified (master or main) TCI state is TCI state of UE-dedicated reception on PDSCH/PDCCH or dynamic-grant/configured-grant based physical uplink shared channel (PUSCH) and dedicated physical uplink control channel (PUCCH) resources.

In a (single-DCI based) multi-TRP system, a UE could be indicated/provided/configured by the network, e.g., via a beam indication MAC CE or a DCI (e.g., via one or more TCI codepoints of one or more TCI fields in the corresponding DCI 1_1/1_2 with or without DL assignment), a set of one or more (e.g., N≥1) TCI states/pairs of TCI states, wherein a TCI state could be a joint DL and UL TCI state or a separate DL TCI state provided by TCI-State/DLorJointTCI-State, or a separate UL TCI state provided by TCI-State/UL-TCIState, and a pair of TCI states could include/contain a separate DL TCI state provided by TCI-State/DLorJointTCI-State or a separate UL TCI State provided by TCI-State/UL-TCIState, under the unified TCI framework.

For PDCCH reception or PDCCH candidate monitoring in a (single-DCI based) multi-TRP system, a UE could be configured/provided/indicated by the network via higher layer RRC signaling/parameter and/or MAC CE command and/or dynamic DCI based L1 signaling—e.g., in higher layer RRC signaling/parameter ControlResourceSet that configures a CORESET—a first indicator to indicate which one or more of the set of TCI states/pairs of TCI states indicated, e.g., by a TCI codepoint, in a beam indication DCI or MAC CE as specified herein in the present disclosure, to use/apply for receiving/monitoring the PDCCH(s)/PDCCH candidate(s) in the corresponding CORESET. For instance, for N=2 (i.e., a set of two TCI states/pairs of TCI states are indicated), the first indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for receiving/monitoring the PDCCH(s)/PDCCH candidate(s) in the corresponding CORESET, ‘01’ indicating that the second TCI state(s) among the set of TCI states/pairs of TCI states indicated, e.g., by a TCI codepoint, in a beam indication DCI or MAC CE as specified herein in the present disclosure, could be used/applied for receiving/monitoring the PDCCH(s)/PDCCH candidate(s) in the corresponding CORESET, ‘10’ indicating that the first and second TCI states among the set of TCI states/pairs of TCI states indicated, e.g., by a TCI codepoint, in a beam indication DCI or MAC CE as specified herein in the present disclosure, could be respectively used/applied for receiving/monitoring the PDCCH(s)/PDCCH candidate(s)—e.g., first and second PDCCH candidates—in the corresponding CORESET(s), and ‘11’ indicating that the second and first TCI states among the set of TCI states/pairs of TCI states indicated, e.g., by a TCI codepoint, in a beam indication DCI or MAC CE as specified herein in the present disclosure, or none of the indicated TCI states, could be (respectively) used/applied for receiving/monitoring the PDCCH(s)/PDCCH candidate(s)—e.g., first and second PDCCH candidates—in the corresponding CORESET(s), wherein the first and second PDCCH candidates could be received in search space sets that are higher layer linked via SearchSpaceLinking and/or the first and second PDCCH candidates carry the same/identical DCI payload. Furthermore, throughout the present disclosure, the first TCI state(s) or the second TCI state(s)—specified herein in the present disclosure—could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states. Throughout the present disclosure, the first indicator could also be referred to as or could correspond to a higher layer parameter applyIndicatedTCIState configured/provided in PDCCH-Config/ControlResourceSet, which could be set to ‘none’, ‘first’, ‘second’ or ‘both’ respectively indicating/providing that none of the indicated TCI states, the first indicated TCI state(s), the second indicated TCI state(s) or both the first and second indicated TCI states could be used for PDCCH reception(s).

For PDSCH reception in a (single-DCI based) multi-TRP system, a UE could be configured/provided/indicated by the network via higher layer RRC signaling/parameter and/or MAC CE command and/or dynamic DCI based L1 signaling—e.g., in a DL DCI (e.g., DCI format 1_0/1_1/1_2) that schedules the PDSCH—a second indicator to indicate which one or more of the set of TCI states/pairs of TCI states indicated, e.g., by a TCI codepoint, in a beam indication DCI or MAC CE as specified herein in the present disclosure, to use/apply for receiving the PDSCH(s). For instance, for N=2 (i.e., a set of two TCI states/pairs of TCI states are indicated), the second indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for receiving the corresponding PDSCH(s)—e.g., scheduled by the DL DCI/PDCCH, ‘01’ indicating that the second TCI state(s) among the set of TCI states/pairs of TCI states indicated, e.g., by a TCI codepoint, in a beam indication DCI or MAC CE as specified herein in the present disclosure, could be used/applied for receiving the corresponding PDSCH(s)—e.g., scheduled by the DL DCI/PDCCH, ‘10’ indicating that the first and second TCI states among the set of TCI states/pairs of TCI states indicated, e.g., by a TCI codepoint, in a beam indication DCI or MAC CE as specified herein in the present disclosure, could be respectively used/applied for receiving the corresponding PDSCH(s)—e.g., first and second PDSCHs—e.g., scheduled by the DL DCI/PDCCH, and ‘11’ indicating that the second and first TCI states among the set of TCI states/pairs of TCI states indicated, e.g., by a TCI codepoint, in a beam indication DCI or MAC CE as specified herein in the present disclosure, could be respectively used/applied for receiving the corresponding PDSCH(s)—e.g., first and second PDSCHs—e.g., scheduled by the DL DCI/PDCCH, wherein the first and second PDSCHs could correspond to two PDSCH transmission occasions or repetition in space, time and/or frequency. Furthermore, throughout the present disclosure, the first TCI state(s) or the second TCI state(s)—specified herein in the present disclosure—could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states. Throughout the present disclosure, the second indicator could also be referred to as or could correspond to a DCI indicator ‘TCI selection’ field in DCI format 1_1/1_2 (present when a higher layer parameter tciSelectionPresentlnDCI is set to ‘enabled’), which could be set to ‘none’, ‘first’, ‘second’ or ‘both’ respectively indicating/providing that none of the indicated TCI states, the first indicated TCI state(s), the second indicated TCI state(s) or both the first and second indicated TCI states could be used for PDSCH reception(s).

For PUCCH transmission in a (single-DCI based) multi-TRP system, a UE could be configured/provided/indicated by the network (e.g., the network 130) via higher layer RRC signaling/parameter and/or MAC CE command and/or dynamic DCI based L1 signaling—e.g., in higher layer RRC signaling/parameter PUCCH-Config that configures PUCCH(s)/PUCCH resource(s)—a third indicator to indicate which one or more of the set of TCI states/pairs of TCI states indicated, e.g., by a TCI codepoint, in a beam indication DCI or MAC CE as specified herein in the present disclosure, to use/apply for transmitting the PUCCH(s)/PUCCH resource(s). For instance, for N=2 (i.e., a set of two TCI states/pairs of TCI states are indicated), the third indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for transmitting the PUCCH(s)/PUCCH resource(s), ‘01’ indicating that the second TCI state(s) among the set of TCI states/pairs of TCI states indicated, e.g., by a TCI codepoint, in a beam indication DCI or MAC CE as specified herein in the present disclosure, could be used/applied for transmitting the PUCCH(s)/PUCCH resource(s), ‘10’ indicating that the first and second TCI states among the set of TCI states/pairs of TCI states indicated, e.g., by a TCI codepoint, in a beam indication DCI or MAC CE as specified herein in the present disclosure, could be respectively used/applied for transmitting the PUCCH(s)/PUCCH resource(s)—e.g., first PUCCH/PUCCH resource and second PUCCH/PUCCH resource, and ‘11’ indicating that the second and first TCI states among the set of TCI states/pairs of TCI states indicated, e.g., by a TCI codepoint, in a beam indication DCI or MAC CE as specified herein in the present disclosure, or none of the indicated TCI states, could be (respectively) used/applied for transmitting the PUCCH(s)/PUCCH resource(s)—e.g., first PUCCH/PUCCH resource and second PUCCH/PUCCH resource, wherein the first and second PUCCHs/PUCCH resources could correspond to two PUCCH transmission occasions or repetitions in space, time and/or frequency. Furthermore, throughout the present disclosure, the first TCI state(s) or the second TCI state(s)—specified herein in the present disclosure—could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states. Throughout the present disclosure, the third indicator could also be referred to as or could correspond to a higher layer parameter applyIndicatedTCIState configured/provided in higher layer parameter(s) that configures/provides a PUCCH resource/resource group, which could be set to ‘none’, ‘first’, ‘second’ or ‘both’ respectively indicating/providing that none of the indicated TCI states, the first indicated TCI state(s), the second indicated TCI state(s) or both the first and second indicated TCI states could be used for PUCCH transmission(s).

For PUSCH transmission in a (single-DCI based) multi-TRP system, a UE could be configured/provided/indicated by the network via higher layer RRC signaling/parameter and/or MAC CE command and/or dynamic DCI based L1 signaling—e.g., in an UL DCI (e.g., DCI format 0_0/0_1/0_2) that schedules the PUSCH—a fourth indicator to indicate which one or more of the set of TCI states/pairs of TCI states indicated, e.g., by a TCI codepoint, in a beam indication DCI or MAC CE as specified herein in the present disclosure, to use/apply for transmitting the PUSCH(s). For instance, for N=2 (i.e., a set of two TCI states/pairs of TCI states are indicated), the fourth indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for transmitting the corresponding PUSCH(s)—e.g., scheduled by the UL DCI/PDCCH, ‘01’ indicating that the second TCI state(s) among the set of TCI states/pairs of TCI states indicated, e.g., by a TCI codepoint, in a beam indication DCI or MAC CE as specified herein in the present disclosure, could be used/applied for transmitting the corresponding PUSCH(s)—e.g., scheduled by the UL DCI/PDCCH, ‘10’ indicating that the first and second TCI states among the set of TCI states/pairs of TCI states indicated, e.g., by a TCI codepoint, in a beam indication DCI or MAC CE as specified herein in the present disclosure, could be respectively used/applied for transmitting the corresponding PUSCH(s)—e.g., first and second PUSCHs—e.g., scheduled by the UL DCI/PDCCH, and ‘11’ indicating that the second and first TCI states among the set of TCI states/pairs of TCI states indicated, e.g., by a TCI codepoint, in a beam indication DCI or MAC CE as specified herein in the present disclosure, could be respectively used/applied for transmitting the corresponding PUSCH(s)—e.g., first and second PUSCHs—e.g., scheduled by the UL DCI/PDCCH, wherein the first and second PUSCHs could correspond to two PUSCH transmission occasions or repetition in space, time and/or frequency. Furthermore, throughout the present disclosure, the first TCI state(s) or the second TCI state(s)—specified herein in the present disclosure—could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states. Throughout the present disclosure, the fourth indicator could also be referred to as or could correspond to a DCI indicator ‘SRS resource set’ field in DCI format 0_1/0_2, which could be set to ‘none’, ‘first’, ‘second’ or ‘both’ respectively indicating/providing that none of the indicated TCI states, the first indicated TCI state(s), the second indicated TCI state(s) or both the first and second indicated TCI states could be used for PUSCH transmission(s).

In a (multi-DCI based) multi-TRP system, a UE could be indicated/provided/configured by the network, e.g., in PDCCH-Config, two values (i.e., 0 and 1) of CORESET pool index (denoted by CORESETPoolIndex), wherein each CORESET could be configured with a value of CORESETPoolIndex. Furthermore, a UE could be indicated/provided/configured by the network, e.g., via a beam indication MAC CE or a DCI (e.g., via one or more TCI codepoints of one or more TCI fields in the corresponding DCI format 1_1/1_2 with or without DL assignment) associated to a CORESET pool index value (e.g., 0 or 1), one or more TCI states/pairs of TCI states for the same (or different) CORESET pool index value, wherein a TCI state could be a joint DL and UL TCI state or a separate DL TCI state provided by TCI-State/DLorJointTCI-State or a separate UL TCI state provided by TCI-State/UL-TCIState indicated for channels/signals such as PDCCH, PDSCH, PUCCH and PUSCH associated to the same (or different) CORESET pool index value, and a pair of TCI states could include/contain a separate DL TCI state provided by TCI-State/DLorJointTCI-State or a separate UL TCI State provided by TCI-State/UL-TCIState indicated for channels/signals such as PDCCH, PDSCH, PUCCH and PUSCH associated to the same (or different) CORESET pool index value, under the unified TCI framework.

As specified herein in the present disclosure, a UE could receive from the network a first (unified) TCI state(s) activation MAC CE command, used to map up to 8 TCI states and/or pairs of TCI states, with each pair comprising of one TCI state for DL channels/signals and/or one TCI state for UL channels/signals, to the codepoints of the DCI field ‘Transmission Configuration Indication’ for one or for a set of component carriers (CCs)/DL bandwidth parts (BWPs), and/or a second (unified) TCI state(s) activation MAC CE command, used to map up to 8 sets of TCI states, wherein each set could be comprised of up to two (e.g., none, one or two) TCI states for DL and UL signals/channels, and/or up to two (e.g., none, one or two) TCI state(s) for DL channels/signals and/or up to two (e.g., none, one or two) TCI state(s) for UL channels/signals to the codepoints of the DCI field “Transmission Configuration Indication” for one or for a set of CCs/DL BWPs, and if applicable, for one or for a set of CCs/UL BWPs. When a set of TCI state IDs are activated for a set of CCs/DL BWPs and if applicable, for a set of CCs/UL BWPs, where the applicable list of CCs is determined by the indicated CC in the activation command, the same set of TCI state IDs are applied for DL and/or UL BWPs in the indicated CCs. If the first/second MAC CE activation command maps TCI-State(s) and/or TCI-UL-State(s) to only one TCI codepoint, the UE shall apply the indicated TCI-State(s) and/or TCI-UL-State(s) to one or to a set of CCs/DL BWPs, and if applicable, to one or to a set of CCs/UL BWPs once the indicated mapping for the one single TCI codepoint is applied. That is, e.g., when/if the UE is provided/configured with dl-OrJointTCI-StateList and/or ul-TCI-StateList and/or is having one or two indicated TCI states and/or is having first and/or second indicated TCI states, an activated TCI codepoint in the second MAC CE activation command could be composed/comprised of one of:
Case 1: a first TCI state for DL channel(s)/signal(s)
Case 2: a first TCI state for DL channel(s)/signal(s) and a second TCI state for DL channel(s)/signal(s)
Case 3: a first TCI state for DL channel(s)/signal(s) and a second TCI state for UL channel(s)/signal(s)
Case 4: a first TCI state for DL channel(s)/signal(s) and a pair of a second TCI state for DL channel(s)/signal(s) and a second TCI state for UL channel(s)/signal(s)
Case 5: a first TCI state for UL channel(s)/signal(s)
Case 6: a first TCI state for UL channel(s)/signal(s) and a second TCI state for DL channel(s)/signal(s)
Case 7: a first TCI state for UL channel(s)/signal(s) and a second TCI state for UL channel(s)/signal(s)
Case 8: a first TCI state for UL channel(s)/signal(s) and a pair of a second TCI state for DL channel(s)/signal(s) and a second TCI state for UL channel(s)/signal(s)
Case 9: a pair of a first TCI state for DL channel(s)/signal(s) and a first TCI state for UL channel(s)/signal(s)
Case 10: a pair of a first TCI state for DL channel(s)/signal(s) and a first TCI state for UL channel(s)/signal(s) and a second TCI state for DL channel(s)/signal(s)
Case 11: a pair of a first TCI state for DL channel(s)/signal(s) and a first TCI state for UL channel(s)/signal(s) and a second TCI state for UL channel(s)/signal(s)
Case 12: a pair of a first TCI state for DL channel(s)/signal(s) and a first TCI state for UL channel(s)/signal(s) and a pair of a second TCI state for DL channel(s)/signal(s) and a second TCI state for UL channel(s)/signal(s)
Case 13: a second TCI state for DL channel(s)/signal(s)
Case 14: a second TCI state for UL channel(s)/signal(s)
Case 15: a pair of a second TCI state for DL channel(s)/signal(s) and a second TCI state for UL channel(s)/signal(s)
Case 16: a first TCI state for DL channel(s)/signal(s) and UL channel(s)/signal(s)
Case 17: a second TCI state for DL channel(s)/signal(s) and UL channel(s)/signal(s)
Case 18: a pair of a first TCI state for DL channel(s)/signal(s) and UL channel(s)/signal(s) and a second TCI state for DL channel(s)/signal(s) and UL channel(s)/signal(s)

Furthermore, when/if the UE (e.g., the UE 116) is configured by higher layer parameter PDCCH-Config that contains two values of coresetPoolIndex (e.g., 0 and 1) in ControlResourceSet, the first/second (unified) TCI state(s) activation command as specified herein in the present disclosure could also incorporate/provide/indicate/include/contain a value of coresetPoolIndex (e.g., 0 or 1). For this case, the TCI state(s)/TCI codepoint(s) activated by/in the first/second (unified) TCI state(s) activation command could be specific to the same coresetPoolIndex value (i.e., 0 or 1) provided/indicated therein.

In one example, when/if the UE is not provided/configured with two values of coresetPoolIndex (e.g., 0 and 1) in PDCCH-Config and/or ControlResourceSet, and/or when/if the UE is provided/configured by higher layer parameter PDCCH-Config that contains a single value of coresetPoolIndex (e.g., 0) in ControlResourceSet, the UE may or may not expect, or may or may not be expected to receive a third (unified) TCI state(s) activation MAC CE command, wherein the TCI codepoint(s) activated by/in the third (unified) TCI state(s) activation MAC CE command could be comprised of or mapped to or could correspond to one of:
Case 19: first TCI state(s) for DL channels/signals, and/or first TCI state(s) for UL channels/signals, and/or pair(s) of TCI states with each pair comprising of a first TCI state for DL channels/signals and a first TCI state for UL channels/signals
Case 20: second TCI state(s) for DL channels/signals, and/or second TCI state(s) for UL channels/signals, and/or pair(s) of TCI states with each pair comprising of a second TCI state for DL channels/signals and a second TCI state for UL channels/signals
Case 21: first TCI state(s) for both DL and UL channels/signals
Case 22: second TCI state(s) for both DL and UL channels/signals

That is, the TCI codepoint(s) activated by/in a third (unified) TCI state(s) activation command could be comprised of or mapped to either first joint/DL/UL TCI state(s)/pair(s) of first DL and UL TCI states or second joint/DL/UL TCI state(s)/pair(s) of second DL and UL TCI states.

In another example, when/if the UE is not provided/configured with two values of coresetPoolIndex (e.g., 0 and 1) in PDCCH-Config and/or ControlResourceSet, and/or when/if the UE is provided/configured by higher layer parameter PDCCH-Config that contains a single value of coresetPoolIndex (e.g., 0) in ControlResourceSet, the UE may or may not expect, or may or may not be expected to receive a fourth (unified) TCI state(s) activation MAC CE command as specified herein in the present disclosure with (1) at least one TCI codepoint activated therein composing/comprising of a first TCI state for DL and/or UL channel(s)/signal(s) or a pair of a first TCI state for DL channel(s)/signal(s) and a first TCI state for UL channel(s)/signal(s), and a second TCI state for DL and/or UL channel(s)/signal(s) or a pair of a second TCI state for DL channel(s)/signal(s) and a second TCI state for UL channel(s)/signal(s), and/or (2) at least one TCI codepoint activated therein composing/comprising of at least first TCI state(s) as specified herein in the present disclosure and another TCI codepoint activated therein composing/comprising of at least second TCI state(s) as specified herein in the present disclosure. That is, for this case/design example, the UE may or may not expect, or may or may not be expected to receive a fourth (unified) TCI state(s) activation MAC CE command as specified herein in the present disclosure with (1) at least one TCI codepoint activated therein composing/comprising of one of:
Case 2: a first TCI state for DL channel(s)/signal(s) and a second TCI state for DL channel(s)/signal(s)
Case 3: a first TCI state for DL channel(s)/signal(s) and a second TCI state for UL channel(s)/signal(s)
Case 4: a first TCI state for DL channel(s)/signal(s) and a pair of a second TCI state for DL channel(s)/signal(s) and a second TCI state for UL channel(s)/signal(s)
Case 6: a first TCI state for UL channel(s)/signal(s) and a second TCI state for DL channel(s)/signal(s)
Case 7: a first TCI state for UL channel(s)/signal(s) and a second TCI state for UL channel(s)/signal(s)
Case 8: a first TCI state for UL channel(s)/signal(s) and a pair of a second TCI state for DL channel(s)/signal(s) and a second TCI state for UL channel(s)/signal(s)
Case 10: a pair of a first TCI state for DL channel(s)/signal(s) and a first TCI state for UL channel(s)/signal(s) and a second TCI state for DL channel(s)/signal(s)
Case 11: a pair of a first TCI state for DL channel(s)/signal(s) and a first TCI state for UL channel(s)/signal(s) and a second TCI state for UL channel(s)/signal(s)
Case 12: a pair of a first TCI state for DL channel(s)/signal(s) and a first TCI state for UL channel(s)/signal(s) and a pair of a second TCI state for DL channel(s)/signal(s) and a second TCI state for UL channel(s)/signal(s)
Case 18: a pair of a first TCI state for DL channel(s)/signal(s) and UL channel(s)/signal(s) and a second TCI state for DL channel(s)/signal(s) and UL channel(s)/signal(s), and/or (2) at least one TCI codepoint activated therein composing/comprising of one of:
Case 1: a first TCI state for DL channel(s)/signal(s)
Case 2: a first TCI state for DL channel(s)/signal(s) and a second TCI state for DL channel(s)/signal(s)
Case 3: a first TCI state for DL channel(s)/signal(s) and a second TCI state for UL channel(s)/signal(s)
Case 4: a first TCI state for DL channel(s)/signal(s) and a pair of a second TCI state for DL channel(s)/signal(s) and a second TCI state for UL channel(s)/signal(s)
Case 5: a first TCI state for UL channel(s)/signal(s)
Case 6: a first TCI state for UL channel(s)/signal(s) and a second TCI state for DL channel(s)/signal(s)
Case 7: a first TCI state for UL channel(s)/signal(s) and a second TCI state for UL channel(s)/signal(s)
Case 8: a first TCI state for UL channel(s)/signal(s) and a pair of a second TCI state for DL channel(s)/signal(s) and a second TCI state for UL channel(s)/signal(s)
Case 9: a pair of a first TCI state for DL channel(s)/signal(s) and a first TCI state for UL channel(s)/signal(s)
Case 10: a pair of a first TCI state for DL channel(s)/signal(s) and a first TCI state for UL channel(s)/signal(s) and a second TCI state for DL channel(s)/signal(s)
Case 11: a pair of a first TCI state for DL channel(s)/signal(s) and a first TCI state for UL channel(s)/signal(s) and a second TCI state for UL channel(s)/signal(s)
Case 12: a pair of a first TCI state for DL channel(s)/signal(s) and a first TCI state for UL channel(s)/signal(s) and a pair of a second TCI state for DL channel(s)/signal(s) and a second TCI state for UL channel(s)/signal(s)
Case 16: a first TCI state for DL channel(s)/signal(s) and UL channel(s)/signal(s)
Case 18: a pair of a first TCI state for DL channel(s)/signal(s) and UL channel(s)/signal(s) and a second TCI state for DL channel(s)/signal(s) and UL channel(s)/signal(s), and another TCI codepoint activated therein composing/comprising of one of:
Case 2: a first TCI state for DL channel(s)/signal(s) and a second TCI state for DL channel(s)/signal(s)
Case 3: a first TCI state for DL channel(s)/signal(s) and a second TCI state for UL channel(s)/signal(s)
Case 4: a first TCI state for DL channel(s)/signal(s) and a pair of a second TCI state for DL channel(s)/signal(s) and a second TCI state for UL channel(s)/signal(s)
Case 6: a first TCI state for UL channel(s)/signal(s) and a second TCI state for DL channel(s)/signal(s)
Case 7: a first TCI state for UL channel(s)/signal(s) and a second TCI state for UL channel(s)/signal(s)
Case 8: a first TCI state for UL channel(s)/signal(s) and a pair of a second TCI state for DL channel(s)/signal(s) and a second TCI state for UL channel(s)/signal(s)
Case 10: a pair of a first TCI state for DL channel(s)/signal(s) and a first TCI state for UL channel(s)/signal(s) and a second TCI state for DL channel(s)/signal(s)
Case 11: a pair of a first TCI state for DL channel(s)/signal(s) and a first TCI state for UL channel(s)/signal(s) and a second TCI state for UL channel(s)/signal(s)
Case 12: a pair of a first TCI state for DL channel(s)/signal(s) and a first TCI state for UL channel(s)/signal(s) and a pair of a second TCI state for DL channel(s)/signal(s) and a second TCI state for UL channel(s)/signal(s)
Case 13: a second TCI state for DL channel(s)/signal(s)
Case 14: a second TCI state for UL channel(s)/signal(s)
Case 15: a pair of a second TCI state for DL channel(s)/signal(s) and a second TCI state for UL channel(s)/signal(s)
Case 17: a second TCI state for DL channel(s)/signal(s) and UL channel(s)/signal(s)
Case 18: a pair of a first TCI state for DL channel(s)/signal(s) and UL channel(s)/signal(s) and a second TCI state for DL channel(s)/signal(s) and UL channel(s)/signal(s)

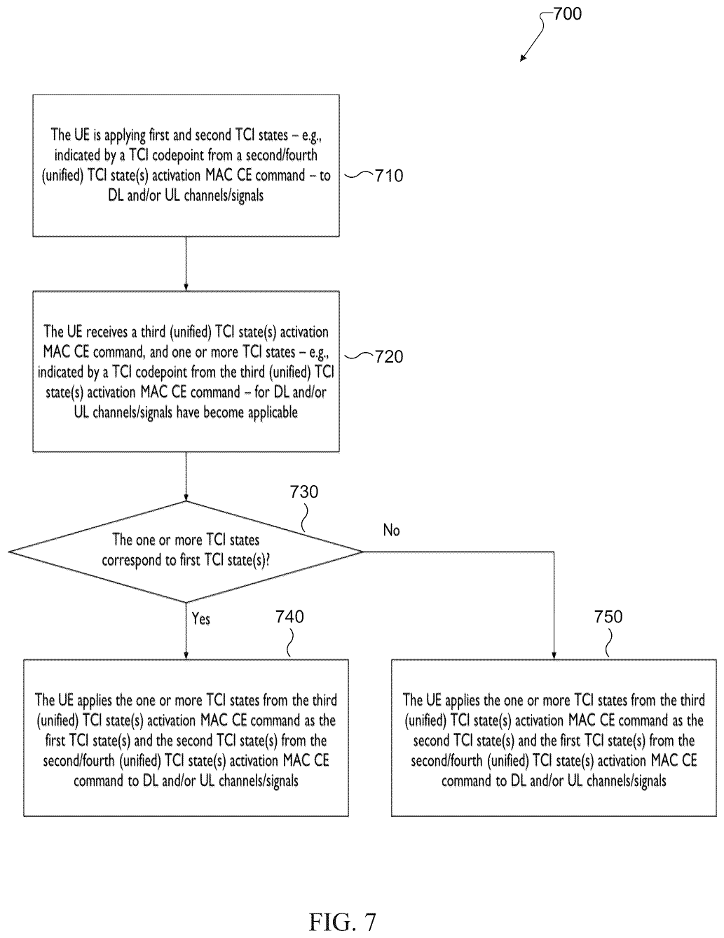

FIG. 7 illustrates a flowchart of an example UE procedure 700 for applying TCI state(s) according to embodiments of the present disclosure. For example, procedure 700 for applying TCI state(s) can be followed by any of the UEs 111-116 of FIG. 1, such as the UE 116 of FIG. 3. This example is for illustration only and can be used without departing from the scope of the present disclosure.

The procedure begins in 710, the UE is applying first and second TCI states—e.g., indicated by a TCI codepoint from a second/fourth (unified) TCI state(s) activation MAC CE command—to DL and/or UL channels/signals. In 720, the UE receives a third (unified) TCI state(s) activation MAC CE command, and one or more TCI states—e.g., indicated by a TCI codepoint from the third (unified) TCI state(s) activation MAC CE command—for DL and/or UL channels/signals have become applicable. In 730, the UE determines whether the one or more TCI states correspond to first TCI state(s). If the UE determines that the one or more TCI states correspond to first TCI state(s), in 740, the UE applies the one or more TCI states from the third (unified) TCI state(s) activation MAC CE command as the first TCI state(s) and the second TCI state(s) from the second/fourth (unified) TCI state(s) activation MAC CE command to DL and/or UL channels/signals. If the UE determines that the one or more TCI states do not correspond to first TCI state(s), in 750, the UE applies the one or more TCI states from the third (unified) TCI state(s) activation MAC CE command as the second TCI state(s) and the first TCI state(s) from the second/fourth (unified) TCI state(s) activation MAC CE command to DL and/or UL channels/signals.

In one embodiment, when/if a UE is provided/configured with dl-OrJointTCI-StateList and/or ul-TCI-StateList, and/or when/if the UE is having one or two indicated TCI state(s) and/or pair(s) of TCI states, and/or when/if the UE is having first and/or second indicated TCI states, and/or when/if the UE receives from the network a first (unified) TCI state(s) activation MAC CE command as specified herein in the present disclosure, and/or when/if the TCI state(s)/TCI codepoint(s) activated by/in the first (unified) TCI state(s) activation MAC CE command has become applicable, and/or when/if the UE is applying one or more TCI states activated by/in the first (unified) TCI state(s) activation MAC CE command for DL and/or UL channels/signals (e.g., (i) the one or more TCI states could correspond to or could be mapped to the single TCI codepoint activated by/in the first (unified) TCI state(s) activation MAC CE command, and/or (ii) the one or more TCI states could be indicated/provided by a TCI codepoint of a TCI field in a beam indication DCI—e.g., DCI format 1_1/1_2 with or without DL assignment, and the TCI codepoint is activated by/in the first (unified) TCI state(s) activation MAC CE command):
In one example, the UE may not expect or may not be expected to receive from the network any second (unified) TCI state(s) activation MAC CE command(s) as specified herein in the present disclosure.
In another example, the UE could expect or could be expected to receive from the network a second (unified) TCI state(s) activation MAC CE command as specified herein in the present disclosure. In this case/design example, when/if the TCI state(s)/TCI codepoint(s) activated by/in the second (unified) TCI state(s) activation MAC CE command has become applicable, and/or when/if one or more TCI states activated by/in the second (unified) TCI state(s) activation MAC CE command as specified herein in the present disclosure have become applicable (e.g., (i) the one or more TCI states could correspond to or could be mapped to the single TCI codepoint activated by/in the second (unified) TCI state(s) activation MAC CE command, and/or (ii) the one or more TCI states could be indicated/provided by a TCI codepoint of a TCI field in a beam indication DCI—e.g., DCI format 1_1/1_2 with or without DL assignment, and the TCI codepoint is activated by/in the second (unified) TCI state(s) activation MAC CE command),
   For example, when/if the one or more TCI states activated by/in the second (unified) TCI state(s) activation MAC CE command as specified herein in the present disclosure correspond to first TCI state(s),
      In one example, the UE could only apply the one or more TCI states activated by/in the second (unified) TCI state(s) activation MAC CE command as specified herein in the present disclosure—as the first TCI state(s)—for DL and/or UL channels/signals. For this case/design example, the UE may not expect or may not be expected to receive from or be provided/indicated/configured by the network the first indicator as specified herein in the present disclosure for PDCCH reception(s), and/or the second indicator as specified herein in the present disclosure for PDSCH reception(s), and/or the third indicator as specified herein in the present disclosure for PUCCH transmission(s), and/or the fourth indicator as specified herein in the present disclosure for PUSCH transmission(s)—e.g., when/if the UE is not provided/configured/indicated by the network, the first and/or second and/or third and/or fourth indicator(s) as specified herein in the present disclosure, in/via their respective RRC/DCI signaling(s). Or, when/if the UE receives from or is provided/indicated/configured by the network (e.g., the network 130) the first indicator as specified herein in the present disclosure for PDCCH reception(s), and/or the second indicator as specified herein in the present disclosure for PDSCH reception(s), and/or the third indicator as specified herein in the present disclosure for PUCCH transmission(s), and/or the fourth indicator as specified herein in the present disclosure for PUSCH transmission(s), (1) the UE could ignore/omit/not follow the value(s) of the first and/or second and/or third and/or fourth indicator(s) as specified herein in the present disclosure for the respective/corresponding channel(s)/signal(s), (2) the UE could expect or could be expected that the first and/or second and/or third and/or fourth indicator(s) as specified herein in the present disclosure indicates that none of the indicated TCI state(s) and/or the first TCI state(s) could be used/applied for receiving and/or transmitting the respective/corresponding channel(s)/signal(s), and/or (3) the UE may not expect or may not be expected that the first and/or second and/or third and/or fourth indicator(s) as specified herein in the present disclosure indicates that none of the indicated TCI state(s) and/or the second TCI state(s) and/or both the first and second TCI states could be used/applied for receiving and/or transmitting the respective/corresponding channel(s)/signal(s).
      In another example, the UE could apply at least the one or more TCI states activated by/in the second (unified) TCI state(s) activation MAC CE command as specified herein in the present disclosure for DL and/or UL channels/signals. For this case/design example, e.g., when/if the UE is provided/configured/indicated by the network, the first and/or second and/or third and/or fourth indicator(s) as specified herein in the present disclosure, in/via their respective RRC/DCI signaling(s), the UE could apply the one or more TCI states activated by/in the second (unified) TCI state(s) activation MAC CE command as specified herein in the present disclosure as the first TCI state(s) and/or the one or more TCI states activated by/in the first (unified) TCI state(s) activation MAC CE command as specified herein in the present disclosure as the second TCI state(s) for DL and/or UL channels/signals.
   For another example, when/if the one or more TCI states activated by/in the second (unified) TCI state(s) activation MAC CE command as specified herein in the present disclosure correspond to second TCI state(s),
      In one example, the UE could only apply the one or more TCI states activated by/in the second (unified) TCI state(s) activation MAC CE command as specified herein in the present disclosure—as the second TCI state(s)—for DL and/or UL channels/signals. For this case/design example, the UE may not expect or may not be expected to receive from or be provided/indicated/configured by the network the first indicator as specified herein in the present disclosure for PDCCH reception(s), and/or the second indicator as specified herein in the present disclosure for PDSCH reception(s), and/or the third indicator as specified herein in the present disclosure for PUCCH transmission(s), and/or the fourth indicator as specified herein in the present disclosure for PUSCH transmission(s)—e.g., when/if the UE is not provided/configured/indicated by the network, the first and/or second and/or third and/or fourth indicator(s) as specified herein in the present disclosure, in/via their respective RRC/DCI signaling(s). Or, when/if the UE receives from or is provided/indicated/configured by the network the first indicator as specified herein in the present disclosure for PDCCH reception(s), and/or the second indicator as specified herein in the present disclosure for PDSCH reception(s), and/or the third indicator as specified herein in the present disclosure for PUCCH transmission(s), and/or the fourth indicator as specified herein in the present disclosure for PUSCH transmission(s), (1) the UE could ignore/omit/not follow the value(s) of the first and/or second and/or third and/or fourth indicator(s) as specified herein in the present disclosure for the respective/corresponding channel(s)/signal(s), (2) the UE could expect or could be expected that the first and/or second and/or third and/or fourth indicator(s) as specified herein in the present disclosure indicates that none of the indicated TCI state(s) and/or the second TCI state(s) could be used/applied for receiving and/or transmitting the respective/corresponding channel(s)/signal(s), and/or (3) the UE may not expect or may not be expected that the first and/or second and/or third and/or fourth indicator(s) as specified herein in the present disclosure indicates that none of the indicated TCI state(s) and/or the first TCI state(s) and/or both the first and second TCI states could be used/applied for receiving and/or transmitting the respective/corresponding channel(s)/signal(s).
      In another example, the UE could apply at least the one or more TCI states activated by/in the second (unified) TCI state(s) activation MAC CE command as specified herein in the present disclosure for DL and/or UL channels/signals. For this case/design example, e.g., when/if the UE is provided/configured/indicated by the network, the first and/or second and/or third and/or fourth indicator(s) as specified herein in the present disclosure, in/via their respective RRC/DCI signaling(s), the UE could apply the one or more TCI states activated by/in the second (unified) TCI state(s) activation MAC CE command as specified herein in the present disclosure as the second TCI state(s) and/or the one or more TCI states activated by/in the first (unified) TCI state(s) activation MAC CE command as specified herein in the present disclosure as the first TCI state(s) for DL and/or UL channels/signals.
   For another example, when/if the one or more TCI states activated by/in the second (unified) TCI state(s) activation MAC CE command as specified herein in the present disclosure correspond to both first and second TCI states,
      In one example, the UE could only apply one or more of the one or more TCI states activated by/in the second (unified) TCI state(s) activation MAC CE command that correspond(s) to the first TCI state(s) as specified herein in the present disclosure for DL and/or UL channels/signals, according to/based on/following those discussed/specified herein in the present disclosure—e.g., those specified in one or more examples described herein.
      In another example, the UE could only apply one or more of the one or more TCI states activated by/in the second (unified) TCI state(s) activation MAC CE command that correspond(s) to the second TCI state(s) as specified herein in the present disclosure for DL and/or UL channels/signals, according to/based on/following those discussed/specified herein in the present disclosure—e.g., according to one or more examples described herein.
      In another example, the UE could apply one or more of the one or more TCI states activated by/in the second (unified) TCI state(s) activation MAC CE command that correspond(s) to the first TCI state(s) as specified herein in the present disclosure as the first TCI state(s) and/or the one or more TCI states activated by/in the first (unified) TCI state(s) activation MAC CE command as the second TCI state(s) as specified herein in the present disclosure for DL and/or UL channels/signals, according to/based on/following those discussed/specified herein in the present disclosure—e.g., according to one or more examples described herein.
      In another example, the UE could apply one or more of the one or more TCI states activated by/in the second (unified) TCI state(s) activation MAC CE command that correspond(s) to the second TCI state(s) as specified herein in the present disclosure as the second TCI state(s) and/or the one or more TCI states activated by/in the first (unified) TCI state(s) activation MAC CE command as the first TCI state(s) as specified herein in the present disclosure for DL and/or UL channels/signals, according to/based on/following those discussed/specified herein in the present disclosure—e.g., according to one or more examples described herein.
      In another example, the UE could apply one or more of the one or more TCI states activated by/in the second (unified) TCI state(s) activation MAC CE command that correspond(s) to the first TCI state(s) as specified herein in the present disclosure as the first TCI state(s) and/or one or more of the one or more TCI states activated by/in the second (unified) TCI state(s) activation MAC CE command that correspond(s) to the second TCI state(s) as specified herein in the present disclosure as the second TCI state(s) for DL and/or UL channels/signals, according to/based on/following those discussed/specified herein in the present disclosure—e.g., according to one or more examples described herein.

The UE could follow one or more of the described/specified design examples herein to determine which of the indicated TCI state(s) to use/apply according to/based on: (1) fixed rule(s)/value(s) in the system specification(s), (2) network's configuration(s)/indication(s), e.g., via higher layer RRC signaling(s)/parameter(s) and/or MAC CE command(s) and/or dynamic DCI based L1 signaling(s) and/or dynamic DCI based L1 signaling(s), and/or (3) UE's autonomous determination/selection, which could be further sent to the network, e.g., via/in part of a/the CSI/beam report and/or UE's capability signaling(s).
In another example, the UE could expect or could be expected to receive from the network a second (unified) TCI state(s) activation MAC CE command as specified herein in the present disclosure. In this case/design example, when/if the TCI state(s)/TCI codepoint(s) activated by/in the second (unified) TCI state(s) activation MAC CE command has become applicable, and/or when/if one or more TCI states activated by/in the second (unified) TCI state(s) activation MAC CE command as specified herein in the present disclosure have become applicable (e.g., (i) the one or more TCI states could correspond to or could be mapped to the single TCI codepoint activated by/in the second (unified) TCI state(s) activation MAC CE command, and/or (ii) the one or more TCI states could be indicated/provided by a TCI codepoint of a TCI field in a beam indication DCI—e.g., DCI format 1_1/1_2 with or without DL assignment, and the TCI codepoint is activated by/in the second (unified) TCI state(s) activation MAC CE command), the UE could expect or could be expected that the one or more TCI states activated by/in the second (unified) TCI state(s) activation MAC CE command correspond to both first and second TCI states, wherein (i) the one or more TCI states could correspond to or could be mapped to the single TCI codepoint that is comprised of both first and second TCI states activated by/in the second (unified) TCI state(s) activation MAC CE command, and/or (ii) the one or more TCI states could be indicated/provided by a TCI codepoint that is comprised of both first and second TCI states of a TCI field in a beam indication DCI—e.g., DCI format 1_1/1_2 with or without DL assignment, and the TCI codepoint is activated by/in the second (unified) TCI state(s) activation MAC CE command (i.e., the UE could only expect or could only be expected that a TCI codepoint that is activated by/in the second (unified) TCI state(s) activation MAC CE command and comprised of both first and second TCI states is indicated/provided by the TCI field in the beam indication DCI). Or equivalently, the UE may not expect or may not be expected the one or more TCI states activated by/in the second (unified) TCI state(s) activation MAC CE command to be comprised of a single TCI state/pair of TCI states—i.e., either first or second TCI state(s) as specified herein in the present disclosure. For this case/design example,
   In one example, the UE could only apply one or more of the one or more TCI states activated by/in the second (unified) TCI state(s) activation MAC CE command that correspond(s) to the first TCI state(s) as specified herein in the present disclosure for DL and/or UL channels/signals, according to/based on/following those discussed/specified herein in the present disclosure—e.g., according to one or more examples described herein.
   In another example, the UE (e.g., the UE 116) could only apply one or more of the one or more TCI states activated by/in the second (unified) TCI state(s) activation MAC CE command that correspond(s) to the second TCI state(s) as specified herein in the present disclosure for DL and/or UL channels/signals, according to/based on/following those discussed/specified herein in the present disclosure—e.g., according to one or more examples described herein.
   In another example, the UE could apply one or more of the one or more TCI states activated by/in the second (unified) TCI state(s) activation MAC CE command that correspond(s) to the first TCI state(s) as specified herein in the present disclosure as the first TCI state(s) and/or the one or more TCI states activated by/in the first (unified) TCI state(s) activation MAC CE command as the second TCI state(s) as specified herein in the present disclosure for DL and/or UL channels/signals, according to/based on/following those discussed/specified herein in the present disclosure—e.g., according to one or more examples described herein.
   In another example, the UE could apply one or more of the one or more TCI states activated by/in the second (unified) TCI state(s) activation MAC CE command that correspond(s) to the second TCI state(s) as specified herein in the present disclosure as the second TCI state(s) and/or the one or more TCI states activated by/in the first (unified) TCI state(s) activation MAC CE command as the first TCI state(s) as specified herein in the present disclosure for DL and/or UL channels/signals, according to/based on/following those discussed/specified herein in the present disclosure—e.g., according to one or more examples described herein.
   In another example, the UE could apply one or more of the one or more TCI states activated by/in the second (unified) TCI state(s) activation MAC CE command that correspond(s) to the first TCI state(s) as specified herein in the present disclosure as the first TCI state(s) and one or more of the one or more TCI states activated by/in the second (unified) TCI state(s) activation MAC CE command that correspond(s) to the second TCI state(s) as specified herein in the present disclosure as the second TCI state(s) for DL and/or UL channels/signals, according to/based on/following those discussed/specified herein in the present disclosure—e.g., according to one or more examples described herein.
In another example, the UE may not expect or may not be expected to receive from the network any third (unified) TCI state(s) activation MAC CE command(s) as specified herein in the present disclosure.
In another example, the UE could expect or could be expected to receive from the network a third (unified) TCI state(s) activation MAC CE command as specified herein in the present disclosure. In this case/design example, when/if the TCI state(s)/TCI codepoint(s) activated by/in the third (unified) TCI state(s) activation MAC CE command has become applicable, and/or when/if one or more TCI states activated by/in the third (unified) TCI state(s) activation MAC CE command as specified herein in the present disclosure have become applicable (e.g., (i) the one or more TCI states could correspond to or could be mapped to the single TCI codepoint activated by/in the third (unified) TCI state(s) activation MAC CE command, and/or (ii) the one or more TCI states could be indicated/provided by a TCI codepoint of a TCI field in a beam indication DCI—e.g., DCI format 1_1/1_2 with or without DL assignment, and the TCI codepoint is activated by/in the third (unified) TCI state(s) activation MAC CE command),
   For example, regardless of whether the one or more TCI states activated by/in the third (unified) TCI state(s) activation MAC CE command corresponds to first or second TCI state(s), and/or, e.g., when/if the UE is not provided/configured/indicated by the network, the first and/or second and/or third and/or fourth indicator(s) as specified herein in the present disclosure, in/via their respective RRC/DCI signaling(s), the UE could only apply the one or more TCI states activated by/in the third (unified) TCI state(s) activation MAC CE command as specified herein in the present disclosure for DL and/or UL channels/signals. That is, for this case/design example, the UE may not expect or may not be expected to receive from or be provided/indicated/configured by the network the first indicator as specified herein in the present disclosure for PDCCH reception(s), and/or the second indicator as specified herein in the present disclosure for PDSCH reception(s), and/or the third indicator as specified herein in the present disclosure for PUCCH transmission(s), and/or the fourth indicator as specified herein in the present disclosure for PUSCH transmission(s).
   For another example, when/if the one or more TCI states activated by/in the third (unified) TCI state(s) activation MAC CE command as specified herein in the present disclosure correspond to first TCI state(s),
      In one example, the UE could only apply the one or more TCI states activated by/in the third (unified) TCI state(s) activation MAC CE command as specified herein in the present disclosure—as the first TCI state(s)—for DL and/or UL channels/signals. For this case/design example, the UE may not expect or may not be expected to receive from or be provided/indicated/configured by the network the first indicator as specified herein in the present disclosure for PDCCH reception(s), and/or the second indicator as specified herein in the present disclosure for PDSCH reception(s), and/or the third indicator as specified herein in the present disclosure for PUCCH transmission(s), and/or the fourth indicator as specified herein in the present disclosure for PUSCH transmission(s)—e.g., when/if the UE is not provided/configured/indicated by the network, the first and/or second and/or third and/or fourth indicator(s) as specified herein in the present disclosure, in/via their respective RRC/DCI signaling(s). Or, when/if the UE receives from or is provided/indicated/configured by the network the first indicator as specified herein in the present disclosure for PDCCH reception(s), and/or the second indicator as specified herein in the present disclosure for PDSCH reception(s), and/or the third indicator as specified herein in the present disclosure for PUCCH transmission(s), and/or the fourth indicator as specified herein in the present disclosure for PUSCH transmission(s), (1) the UE could ignore/omit/not follow the value(s) of the first and/or second and/or third and/or fourth indicator(s) as specified herein in the present disclosure for the respective/corresponding channel(s)/signal(s), (2) the UE could expect or could be expected that the first and/or second and/or third and/or fourth indicator(s) as specified herein in the present disclosure indicates that none of the indicated TCI state(s) and/or the first TCI state(s) could be used/applied for receiving and/or transmitting the respective/corresponding channel(s)/signal(s), and/or (3) the UE may not expect or may not be expected that the first and/or second and/or third and/or fourth indicator(s) as specified herein in the present disclosure indicates that none of the indicated TCI state(s) and/or the second TCI state(s) and/or both the first and second TCI states could be used/applied for receiving and/or transmitting the respective/corresponding channel(s)/signal(s).
      In another example, the UE could apply at least the one or more TCI states activated by/in the third (unified) TCI state(s) activation MAC CE command as specified herein in the present disclosure for DL and/or UL channels/signals. For this case/design example, e.g., when/if the UE is provided/configured/indicated by the network, the first and/or second and/or third and/or fourth indicator(s) as specified herein in the present disclosure, in/via their respective RRC/DCI signaling(s), the UE could apply the one or more TCI states activated by/in the third (unified) TCI state(s) activation MAC CE command as specified herein in the present disclosure as the first TCI state(s) and/or the one or more TCI states activated by/in the first (unified) TCI state(s) activation MAC CE command as specified herein in the present disclosure as the second TCI state(s) for DL and/or UL channels/signals.
   For another example, when/if the one or more TCI states activated by/in the third (unified) TCI state(s) activation MAC CE command as specified herein in the present disclosure correspond to second TCI state(s),
      In one example, the UE could only apply the one or more TCI states activated by/in the third (unified) TCI state(s) activation MAC CE command as specified herein in the present disclosure—as the second TCI state(s)—for DL and/or UL channels/signals. For this case/design example, the UE may not expect or may not be expected to receive from or be provided/indicated/configured by the network the first indicator as specified herein in the present disclosure for PDCCH reception(s), and/or the second indicator as specified herein in the present disclosure for PDSCH reception(s), and/or the third indicator as specified herein in the present disclosure for PUCCH transmission(s), and/or the fourth indicator as specified herein in the present disclosure for PUSCH transmission(s)—e.g., when/if the UE is not provided/configured/indicated by the network, the first and/or second and/or third and/or fourth indicator(s) as specified herein in the present disclosure, in/via their respective RRC/DCI signaling(s). Or, when/if the UE receives from or is provided/indicated/configured by the network the first indicator as specified herein in the present disclosure for PDCCH reception(s), and/or the second indicator as specified herein in the present disclosure for PDSCH reception(s), and/or the third indicator as specified herein in the present disclosure for PUCCH transmission(s), and/or the fourth indicator as specified herein in the present disclosure for PUSCH transmission(s), (1) the UE could ignore/omit/not follow the value(s) of the first and/or second and/or third and/or fourth indicator(s) as specified herein in the present disclosure for the respective/corresponding channel(s)/signal(s), (2) the UE could expect or could be expected that the first and/or second and/or third and/or fourth indicator(s) as specified herein in the present disclosure indicates that none of the indicated TCI state(s) and/or the second TCI state(s) could be used/applied for receiving and/or transmitting the respective/corresponding channel(s)/signal(s), and/or (3) the UE may not expect or may not be expected that the first and/or second and/or third and/or fourth indicator(s) as specified herein in the present disclosure indicates that none of the indicated TCI state(s) and/or the first TCI state(s) and/or both the first and second TCI states could be used/applied for receiving and/or transmitting the respective/corresponding channel(s)/signal(s).
      In another example, the UE could apply at least the one or more TCI states activated by/in the third (unified) TCI state(s) activation MAC CE command as specified herein in the present disclosure for DL and/or UL channels/signals. For this case/design example, e.g., when/if the UE is provided/configured/indicated by the network, the first and/or second and/or third and/or fourth indicator(s) as specified herein in the present disclosure, in/via their respective RRC/DCI signaling(s), the UE could apply the one or more TCI states activated by/in the third (unified) TCI state(s) activation MAC CE command as specified herein in the present disclosure as the second TCI state(s) and/or the one or more TCI states activated by/in the first (unified) TCI state(s) activation MAC CE command as specified herein in the present disclosure as the first TCI state(s) for DL and/or UL channels/signals.
In another example, the UE may not expect or may not be expected to receive from the network any fourth (unified) TCI state(s) activation MAC CE command(s) as specified herein in the present disclosure.
In another example, the UE could expect or could be expected to receive from the network a fourth (unified) TCI state(s) activation MAC CE command as specified herein in the present disclosure. In this case/design example, when/if the TCI state(s)/TCI codepoint(s) activated by/in the fourth (unified) TCI state(s) activation MAC CE command has become applicable, and/or when/if one or more TCI states activated by/in the fourth (unified) TCI state(s) activation MAC CE command as specified herein in the present disclosure have become applicable (e.g., (i) the one or more TCI states could correspond to or could be mapped to the single TCI codepoint activated by/in the fourth (unified) TCI state(s) activation MAC CE command, and/or (ii) the one or more TCI states could be indicated/provided by a TCI codepoint of a TCI field in a beam indication DCI—e.g., DCI format 1_1/1_2 with or without DL assignment, and the TCI codepoint is activated by/in the fourth (unified) TCI state(s) activation MAC CE command),
   For example, when/if the one or more TCI states activated by/in the fourth (unified) TCI state(s) activation MAC CE command as specified herein in the present disclosure correspond to first TCI state(s),
      In one example, the UE could only apply the one or more TCI states activated by/in the fourth (unified) TCI state(s) activation MAC CE command as specified herein in the present disclosure—as the first TCI state(s)—for DL and/or UL channels/signals. For this case/design example, the UE may not expect or may not be expected to receive from or be provided/indicated/configured by the network the first indicator as specified herein in the present disclosure for PDCCH reception(s), and/or the second indicator as specified herein in the present disclosure for PDSCH reception(s), and/or the third indicator as specified herein in the present disclosure for PUCCH transmission(s), and/or the fourth indicator as specified herein in the present disclosure for PUSCH transmission(s)—e.g., when/if the UE is not provided/configured/indicated by the network, the first and/or second and/or third and/or fourth indicator(s) as specified herein in the present disclosure, in/via their respective RRC/DCI signaling(s). Or, when/if the UE receives from or is provided/indicated/configured by the network the first indicator as specified herein in the present disclosure for PDCCH reception(s), and/or the second indicator as specified herein in the present disclosure for PDSCH reception(s), and/or the third indicator as specified herein in the present disclosure for PUCCH transmission(s), and/or the fourth indicator as specified herein in the present disclosure for PUSCH transmission(s), (1) the UE could ignore/omit/not follow the value(s) of the first and/or second and/or third and/or fourth indicator(s) as specified herein in the present disclosure for the respective/corresponding channel(s)/signal(s), (2) the UE could expect or could be expected that the first and/or second and/or third and/or fourth indicator(s) as specified herein in the present disclosure indicates that none of the indicated TCI state(s) and/or the first TCI state(s) could be used/applied for receiving and/or transmitting the respective/corresponding channel(s)/signal(s), and/or (3) the UE may not expect or may not be expected that the first and/or second and/or third and/or fourth indicator(s) as specified herein in the present disclosure indicates that none of the indicated TCI state(s) and/or the second TCI state(s) and/or both the first and second TCI states could be used/applied for receiving and/or transmitting the respective/corresponding channel(s)/signal(s).
      In another example, the UE could apply at least the one or more TCI states activated by/in the fourth (unified) TCI state(s) activation MAC CE command as specified herein in the present disclosure for DL and/or UL channels/signals. For this case/design example, e.g., when/if the UE is provided/configured/indicated by the network, the first and/or second and/or third and/or fourth indicator(s) as specified herein in the present disclosure, in/via their respective RRC/DCI signaling(s), the UE could apply the one or more TCI states activated by/in the fourth (unified) TCI state(s) activation MAC CE command as specified herein in the present disclosure as the first TCI state(s) and/or the one or more TCI states activated by/in the first (unified) TCI state(s) activation MAC CE command as specified herein in the present disclosure as the second TCI state(s) for DL and/or UL channels/signals.
   For another example, when/if the one or more TCI states activated by/in the fourth (unified) TCI state(s) activation MAC CE command as specified herein in the present disclosure correspond to second TCI state(s),
      In one example, the UE could only apply the one or more TCI states activated by/in the fourth (unified) TCI state(s) activation MAC CE command as specified herein in the present disclosure—as the second TCI state(s)—for DL and/or UL channels/signals. For this case/design example, the UE may not expect or may not be expected to receive from or be provided/indicated/configured by the network (e.g., the network 130) the first indicator as specified herein in the present disclosure for PDCCH reception(s), and/or the second indicator as specified herein in the present disclosure for PDSCH reception(s), and/or the third indicator as specified herein in the present disclosure for PUCCH transmission(s), and/or the fourth indicator as specified herein in the present disclosure for PUSCH transmission(s)—e.g., when/if the UE is not provided/configured/indicated by the network, the first and/or second and/or third and/or fourth indicator(s) as specified herein in the present disclosure, in/via their respective RRC/DCI signaling(s). Or, when/if the UE receives from or is provided/indicated/configured by the network the first indicator as specified herein in the present disclosure for PDCCH reception(s), and/or the second indicator as specified herein in the present disclosure for PDSCH reception(s), and/or the third indicator as specified herein in the present disclosure for PUCCH transmission(s), and/or the fourth indicator as specified herein in the present disclosure for PUSCH transmission(s), (1) the UE could ignore/omit/not follow the value(s) of the first and/or second and/or third and/or fourth indicator(s) as specified herein in the present disclosure for the respective/corresponding channel(s)/signal(s), (2) the UE could expect or could be expected that the first and/or second and/or third and/or fourth indicator(s) as specified herein in the present disclosure indicates that none of the indicated TCI state(s) and/or the second TCI state(s) could be used/applied for receiving and/or transmitting the respective/corresponding channel(s)/signal(s), and/or (3) the UE may not expect or may not be expected that the first and/or second and/or third and/or fourth indicator(s) as specified herein in the present disclosure indicates that none of the indicated TCI state(s) and/or the first TCI state(s) and/or both the first and second TCI states could be used/applied for receiving and/or transmitting the respective/corresponding channel(s)/signal(s).
      In another example, the UE could apply at least the one or more TCI states activated by/in the fourth (unified) TCI state(s) activation MAC CE command as specified herein in the present disclosure for DL and/or UL channels/signals. For this case/design example, e.g., when/if the UE is provided/configured/indicated by the network, the first and/or second and/or third and/or fourth indicator(s) as specified herein in the present disclosure, in/via their respective RRC/DCI signaling(s), the UE could apply the one or more TCI states activated by/in the fourth (unified) TCI state(s) activation MAC CE command as specified herein in the present disclosure as the second TCI state(s) and/or the one or more TCI states activated by/in the first (unified) TCI state(s) activation MAC CE command as specified herein in the present disclosure as the first TCI state(s) for DL and/or UL channels/signals.
   For another example, when/if the one or more TCI states activated by/in the fourth (unified) TCI state(s) activation MAC CE command as specified herein in the present disclosure correspond to both first and second TCI states,
      In one example, the UE could only apply one or more of the one or more TCI states activated by/in the fourth (unified) TCI state(s) activation MAC CE command that correspond(s) to the first TCI state(s) as specified herein in the present disclosure for DL and/or UL channels/signals, according to/based on/following those discussed/specified herein in the present disclosure—e.g., according to one or more examples described herein.
      In another example, the UE could only apply one or more of the one or more TCI states activated by/in the fourth (unified) TCI state(s) activation MAC CE command that correspond(s) to the second TCI state(s) as specified herein in the present disclosure for DL and/or UL channels/signals, according to/based on/following those discussed/specified herein in the present disclosure—e.g., according to one or more examples described herein. In another example, the UE could apply one or more of the one or more TCI states activated by/in the fourth (unified) TCI state(s) activation MAC CE command that correspond(s) to the first TCI state(s) as specified herein in the present disclosure as the first TCI state(s) and/or the one or more TCI states activated by/in the first (unified) TCI state(s) activation MAC CE command as the second TCI state(s) as specified herein in the present disclosure for DL and/or UL channels/signals, according to/based on/following those discussed/specified herein in the present disclosure—e.g., according to one or more examples described herein.
      In another example, the UE could apply one or more of the one or more TCI states activated by/in the fourth (unified) TCI state(s) activation MAC CE command that correspond(s) to the second TCI state(s) as specified herein in the present disclosure as the second TCI state(s) and/or the one or more TCI states activated by/in the first (unified) TCI state(s) activation MAC CE command as the first TCI state(s) as specified herein in the present disclosure for DL and/or UL channels/signals, according to/based on/following those discussed/specified herein in the present disclosure—e.g., according to one or more examples described herein.
      In another example, the UE could apply one or more of the one or more TCI states activated by/in the fourth (unified) TCI state(s) activation MAC CE command that correspond(s) to the first TCI state(s) as specified herein in the present disclosure as the first TCI state(s) and/or one or more of the one or more TCI states activated by/in the fourth (unified) TCI state(s) activation MAC CE command that correspond(s) to the second TCI state(s) as specified herein in the present disclosure as the second TCI state(s) for DL and/or UL channels/signals, according to/based on/following those discussed/specified herein in the present disclosure—e.g., according to one or more examples described herein.

The UE could follow one or more of the described/specified design examples herein to determine which of the indicated TCI state(s) to use/apply according to/based on: (1) fixed rule(s)/value(s) in the system specification(s), (2) network's configuration(s)/indication(s), e.g., via higher layer RRC signaling(s)/parameter(s) and/or MAC CE command(s) and/or dynamic DCI based L1 signaling(s) and/or dynamic DCI based L1 signaling(s), and/or (3) UE's autonomous determination/selection, which could be further sent to the network, e.g., via/in part of a/the CSI/beam report and/or UE's capability signaling(s).
In another example, the UE could expect or could be expected to receive from the network a fourth (unified) TCI state(s) activation MAC CE command as specified herein in the present disclosure. In this case/design example, when/if the TCI state(s)/TCI codepoint(s) activated by/in the fourth (unified) TCI state(s) activation MAC CE command has become applicable, and/or when/if one or more TCI states activated by/in the fourth (unified) TCI state(s) activation MAC CE command as specified herein in the present disclosure have become applicable (e.g., (i) the one or more TCI states could correspond to or could be mapped to the single TCI codepoint activated by/in the fourth (unified) TCI state(s) activation MAC CE command, and/or (ii) the one or more TCI states could be indicated/provided by a TCI codepoint of a TCI field in a beam indication DCI—e.g., DCI format 1_1/1_2 with or without DL assignment, and the TCI codepoint is activated by/in the fourth (unified) TCI state(s) activation MAC CE command), the UE could expect or could be expected that the one or more TCI states activated by/in the fourth (unified) TCI state(s) activation MAC CE command correspond to both first and second TCI states, wherein (i) the one or more TCI states could correspond to or could be mapped to the single TCI codepoint that is comprised of both first and second TCI states activated by/in the fourth (unified) TCI state(s) activation MAC CE command, and/or (ii) the one or more TCI states could be indicated/provided by a TCI codepoint that is comprised of both first and second TCI states of a TCI field in a beam indication DCI—e.g., DCI format 1_1/1_2 with or without DL assignment, and the TCI codepoint is activated by/in the fourth (unified) TCI state(s) activation MAC CE command (i.e., the UE could only expect or could only be expected that a TCI codepoint that is activated by/in the fourth (unified) TCI state(s) activation MAC CE command and comprised of both first and second TCI states is indicated/provided by the TCI field in the beam indication DCI). Or equivalently, the UE may not expect or may not be expected the one or more TCI states activated by/in the fourth (unified) TCI state(s) activation MAC CE command to be comprised of a single TCI state/pair of TCI states—i.e., either first or second TCI state(s) as specified herein in the present disclosure. For this case/design example,
   In one example, the UE could only apply one or more of the one or more TCI states activated by/in the fourth (unified) TCI state(s) activation MAC CE command that correspond(s) to the first TCI state(s) as specified herein in the present disclosure for DL and/or UL channels/signals, according to/based on/following those discussed/specified herein in the present disclosure—e.g., according to one or more examples described herein.
   In another example, the UE could only apply one or more of the one or more TCI states activated by/in the fourth (unified) TCI state(s) activation MAC CE command that correspond(s) to the second TCI state(s) as specified herein in the present disclosure for DL and/or UL channels/signals, according to/based on/following those discussed/specified herein in the present disclosure—e.g., according to one or more examples described herein.
   In another example, the UE (e.g., the UE 116) could apply one or more of the one or more TCI states activated by/in the fourth (unified) TCI state(s) activation MAC CE command that correspond(s) to the first TCI state(s) as specified herein in the present disclosure as the first TCI state(s) and/or the one or more TCI states activated by/in the first (unified) TCI state(s) activation MAC CE command as the second TCI state(s) as specified herein in the present disclosure for DL and/or UL channels/signals, according to/based on/following those discussed/specified herein in the present disclosure—e.g., according to one or more examples described herein.
   In another example, the UE could apply one or more of the one or more TCI states activated by/in the fourth (unified) TCI state(s) activation MAC CE command that correspond(s) to the second TCI state(s) as specified herein in the present disclosure as the second TCI state(s) and/or the one or more TCI states activated by/in the first (unified) TCI state(s) activation MAC CE command as the first TCI state(s) as specified herein in the present disclosure for DL and/or UL channels/signals, according to/based on/following those discussed/specified herein in the present disclosure—e.g., according to one or more examples described herein.
   In another example, the UE could apply one or more of the one or more TCI states activated by/in the fourth (unified) TCI state(s) activation MAC CE command that correspond(s) to the first TCI state(s) as specified herein in the present disclosure as the first TCI state(s) and one or more of the one or more TCI states activated by/in the fourth (unified) TCI state(s) activation MAC CE command that correspond(s) to the second TCI state(s) as specified herein in the present disclosure as the second TCI state(s) for DL and/or UL channels/signals, according to/based on/following those discussed/specified herein in the present disclosure—e.g., according to one or more examples described herein.

In one embodiment, when/if a UE is provided/configured with dl-OrJointTCI-StateList and/or ul-TCI-StateList, and/or when/if the UE is having one or two indicated TCI state(s) and/or pair(s) of TCI states, and/or when/if the UE is having first and/or second indicated TCI states, and/or when/if the UE receives from the network a third (unified) TCI state(s) activation MAC CE command as specified herein in the present disclosure, and/or when/if the TCI state(s)/TCI codepoint(s) activated by/in the third (unified) TCI state(s) activation MAC CE command has become applicable, and/or when/if the UE is applying one or more TCI states activated by/in the third (unified) TCI state(s) activation MAC CE command for DL and/or UL channels/signals (e.g., (i) the one or more TCI states could correspond to or could be mapped to the single TCI codepoint activated by/in the third (unified) TCI state(s) activation MAC CE command, and/or (ii) the one or more TCI states could be indicated/provided by a TCI codepoint of a TCI field in a beam indication DCI—e.g., DCI format 1_1/1_2 with or without DL assignment, and the TCI codepoint is activated by/in the third (unified) TCI state(s) activation MAC CE command), and the one or more TCI states could correspond to first TCI state(s) or second TCI state(s) according to those specified herein in the present disclosure.
In one example, the UE may not expect or may not be expected to receive from the network any second/fourth (unified) TCI state(s) activation MAC CE command(s) as specified herein in the present disclosure.
In another example, the UE could expect or could be expected to receive from the network a second/fourth (unified) TCI state(s) activation MAC CE command as specified herein in the present disclosure. In this case/design example, when/if the TCI state(s)/TCI codepoint(s) activated by/in the second/fourth (unified) TCI state(s) activation MAC CE command has become applicable, and/or when/if one or more TCI states activated by/in the second/fourth (unified) TCI state(s) activation MAC CE command as specified herein in the present disclosure have become applicable (e.g., (i) the one or more TCI states could correspond to or could be mapped to the single TCI codepoint activated by/in the second/fourth (unified) TCI state(s) activation MAC CE command, and/or (ii) the one or more TCI states could be indicated/provided by a TCI codepoint of a TCI field in a beam indication DCI—e.g., DCI format 1_1/1_2 with or without DL assignment, and the TCI codepoint is activated by/in the second/fourth (unified) TCI state(s) activation MAC CE command),
   For example, when/if the one or more TCI states activated by/in the second/fourth (unified) TCI state(s) activation MAC CE command as specified herein in the present disclosure correspond to first TCI state(s),
      In one example, the UE could only apply the one or more TCI states activated by/in the second/fourth (unified) TCI state(s) activation MAC CE command as specified herein in the present disclosure—as the first TCI state(s)—for DL and/or UL channels/signals. For this case/design example, the UE may not expect or may not be expected to receive from or be provided/indicated/configured by the network the first indicator as specified herein in the present disclosure for PDCCH reception(s), and/or the second indicator as specified herein in the present disclosure for PDSCH reception(s), and/or the third indicator as specified herein in the present disclosure for PUCCH transmission(s), and/or the fourth indicator as specified herein in the present disclosure for PUSCH transmission(s)—e.g., when/if the UE is not provided/configured/indicated by the network, the first and/or second and/or third and/or fourth indicator(s) as specified herein in the present disclosure, in/via their respective RRC/DCI signaling(s). Or, when/if the UE receives from or is provided/indicated/configured by the network the first indicator as specified herein in the present disclosure for PDCCH reception(s), and/or the second indicator as specified herein in the present disclosure for PDSCH reception(s), and/or the third indicator as specified herein in the present disclosure for PUCCH transmission(s), and/or the fourth indicator as specified herein in the present disclosure for PUSCH transmission(s), (1) the UE could ignore/omit/not follow the value(s) of the first and/or second and/or third and/or fourth indicator(s) as specified herein in the present disclosure for the respective/corresponding channel(s)/signal(s), (2) the UE could expect or could be expected that the first and/or second and/or third and/or fourth indicator(s) as specified herein in the present disclosure indicates that none of the indicated TCI state(s) and/or the first TCI state(s) could be used/applied for receiving and/or transmitting the respective/corresponding channel(s)/signal(s), and/or (3) the UE may not expect or may not be expected that the first and/or second and/or third and/or fourth indicator(s) as specified herein in the present disclosure indicates that none of the indicated TCI state(s) and/or the second TCI state(s) and/or both the first and second TCI states could be used/applied for receiving and/or transmitting the respective/corresponding channel(s)/signal(s).
      In another example, the UE could apply at least the one or more TCI states activated by/in the second/fourth (unified) TCI state(s) activation MAC CE command as specified herein in the present disclosure for DL and/or UL channels/signals. For this case/design example, e.g., when/if the UE is provided/configured/indicated by the network, the first and/or second and/or third and/or fourth indicator(s) as specified herein in the present disclosure, in/via their respective RRC/DCI signaling(s), the UE could apply the one or more TCI states activated by/in the second/fourth (unified) TCI state(s) activation MAC CE command as specified herein in the present disclosure as the first TCI state(s) and/or the one or more TCI states (corresponding to either first or second TCI state(s) as specified herein) activated by/in the third (unified) TCI state(s) activation MAC CE command as specified herein in the present disclosure as the second TCI state(s) for DL and/or UL channels/signals.
   For another example, when/if the one or more TCI states activated by/in the second/fourth (unified) TCI state(s) activation MAC CE command as specified herein in the present disclosure correspond to second TCI state(s),
      In one example, the UE could only apply the one or more TCI states activated by/in the second/fourth (unified) TCI state(s) activation MAC CE command as specified herein in the present disclosure—as the second TCI state(s)—for DL and/or UL channels/signals. For this case/design example, the UE may not expect or may not be expected to receive from or be provided/indicated/configured by the network the first indicator as specified herein in the present disclosure for PDCCH reception(s), and/or the second indicator as specified herein in the present disclosure for PDSCH reception(s), and/or the third indicator as specified herein in the present disclosure for PUCCH transmission(s), and/or the fourth indicator as specified herein in the present disclosure for PUSCH transmission(s)—e.g., when/if the UE is not provided/configured/indicated by the network, the first and/or second and/or third and/or fourth indicator(s) as specified herein in the present disclosure, in/via their respective RRC/DCI signaling(s). Or, when/if the UE receives from or is provided/indicated/configured by the network the first indicator as specified herein in the present disclosure for PDCCH reception(s), and/or the second indicator as specified herein in the present disclosure for PDSCH reception(s), and/or the third indicator as specified herein in the present disclosure for PUCCH transmission(s), and/or the fourth indicator as specified herein in the present disclosure for PUSCH transmission(s), (1) the UE could ignore/omit/not follow the value(s) of the first and/or second and/or third and/or fourth indicator(s) as specified herein in the present disclosure for the respective/corresponding channel(s)/signal(s), (2) the UE could expect or could be expected that the first and/or second and/or third and/or fourth indicator(s) as specified herein in the present disclosure indicates that none of the indicated TCI state(s) and/or the second TCI state(s) could be used/applied for receiving and/or transmitting the respective/corresponding channel(s)/signal(s), and/or (3) the UE may not expect or may not be expected that the first and/or second and/or third and/or fourth indicator(s) as specified herein in the present disclosure indicates that none of the indicated TCI state(s) and/or the first TCI state(s) and/or both the first and second TCI states could be used/applied for receiving and/or transmitting the respective/corresponding channel(s)/signal(s).
      In another example, the UE could apply at least the one or more TCI states activated by/in the second/fourth (unified) TCI state(s) activation MAC CE command as specified herein in the present disclosure for DL and/or UL channels/signals. For this case/design example, e.g., when/if the UE is provided/configured/indicated by the network, the first and/or second and/or third and/or fourth indicator(s) as specified herein in the present disclosure, in/via their respective RRC/DCI signaling(s), the UE could apply the one or more TCI states activated by/in the second/fourth (unified) TCI state(s) activation MAC CE command as specified herein in the present disclosure as the second TCI state(s) and/or the one or more TCI states (corresponding to either first or second TCI state(s) as specified herein in the present disclosure) activated by/in the third (unified) TCI state(s) activation MAC CE command as specified herein in the present disclosure as the first TCI state(s) for DL and/or UL channels/signals.
   For another example, when/if the one or more TCI states activated by/in the second/fourth (unified) TCI state(s) activation MAC CE command as specified herein in the present disclosure correspond to both first and second TCI states,
      In one example, the UE could only apply one or more of the one or more TCI states activated by/in the second/fourth (unified) TCI state(s) activation MAC CE command that correspond(s) to the first TCI state(s) as specified herein in the present disclosure for DL and/or UL channels/signals, according to/based on/following those discussed/specified herein in the present disclosure—e.g., according to one or more examples described herein.
      In another example, the UE could only apply one or more of the one or more TCI states activated by/in the second/fourth (unified) TCI state(s) activation MAC CE command that correspond(s) to the second TCI state(s) as specified herein in the present disclosure for DL and/or UL channels/signals, according to/based on/following those discussed/specified herein in the present disclosure—e.g., according to one or more examples described herein.
      In another example, the UE could apply one or more of the one or more TCI states activated by/in the second/fourth (unified) TCI state(s) activation MAC CE command that correspond(s) to the first TCI state(s) as specified herein in the present disclosure as the first TCI state(s) and/or the one or more TCI states (corresponding to either first or second TCI state(s) as specified herein) activated by/in the third (unified) TCI state(s) activation MAC CE command as the second TCI state(s) as specified herein in the present disclosure for DL and/or UL channels/signals, according to/based on/following those discussed/specified herein in the present disclosure—e.g., according to one or more examples described herein.
      In another example, the UE could apply one or more of the one or more TCI states activated by/in the second/fourth (unified) TCI state(s) activation MAC CE command that correspond(s) to the second TCI state(s) as specified herein in the present disclosure as the second TCI state(s) and/or the one or more TCI states (corresponding to either first or second TCI state(s) as specified herein) activated by/in the third (unified) TCI state(s) activation MAC CE command as the first TCI state(s) as specified herein in the present disclosure for DL and/or UL channels/signals, according to/based on/following those discussed/specified herein in the present disclosure—e.g., according to one or more examples described herein.
      In another example, the UE could apply one or more of the one or more TCI states activated by/in the second/fourth (unified) TCI state(s) activation MAC CE command that correspond(s) to the first TCI state(s) as specified herein in the present disclosure as the first TCI state(s) and/or one or more of the one or more TCI states activated by/in the second/fourth (unified) TCI state(s) activation MAC CE command that correspond(s) to the second TCI state(s) as specified herein in the present disclosure as the second TCI state(s) for DL and/or UL channels/signals, according to/based on/following those discussed/specified herein in the present disclosure—e.g., according to one or more examples described herein.

The UE could follow one or more of the described/specified design examples herein to determine which of the indicated TCI state(s) to use/apply according to/based on: (1) fixed rule(s)/value(s) in the system specification(s), (2) network's configuration(s)/indication(s), e.g., via higher layer RRC signaling(s)/parameter(s) and/or MAC CE command(s) and/or dynamic DCI based L1 signaling(s) and/or dynamic DCI based L1 signaling(s), and/or (3) UE's autonomous determination/selection, which could be further sent to the network, e.g., via/in part of a/the CSI/beam report and/or UE's capability signaling(s).
In another example, the UE could expect or could be expected to receive from the network a second/fourth (unified) TCI state(s) activation MAC CE command as specified herein in the present disclosure. In this case/design example, when/if the TCI state(s)/TCI codepoint(s) activated by/in the second/fourth (unified) TCI state(s) activation MAC CE command has become applicable, and/or when/if one or more TCI states activated by/in the second/fourth (unified) TCI state(s) activation MAC CE command as specified herein in the present disclosure have become applicable (e.g., (i) the one or more TCI states could correspond to or could be mapped to the single TCI codepoint activated by/in the second/fourth (unified) TCI state(s) activation MAC CE command, and/or (ii) the one or more TCI states could be indicated/provided by a TCI codepoint of a TCI field in a beam indication DCI—e.g., DCI format 1_1/1_2 with or without DL assignment, and the TCI codepoint is activated by/in the second/fourth (unified) TCI state(s) activation MAC CE command), the UE could expect or could be expected that the one or more TCI states activated by/in the second/fourth (unified) TCI state(s) activation MAC CE command correspond to both first and second TCI states, wherein (i) the one or more TCI states could correspond to or could be mapped to the single TCI codepoint that is comprised of both first and second TCI states activated by/in the second/fourth (unified) TCI state(s) activation MAC CE command, and/or (ii) the one or more TCI states could be indicated/provided by a TCI codepoint that is comprised of both first and second TCI states of a TCI field in a beam indication DCI—e.g., DCI format 1_1/1_2 with or without DL assignment, and the TCI codepoint is activated by/in the second/fourth (unified) TCI state(s) activation MAC CE command (i.e., the UE could only expect or could only be expected that a TCI codepoint that is activated by/in the second/fourth (unified) TCI state(s) activation MAC CE command and comprised of both first and second TCI states is indicated/provided by the TCI field in the beam indication DCI). Or equivalently, the UE may not expect or may not be expected the one or more TCI states activated by/in the second/fourth (unified) TCI state(s) activation MAC CE command to be comprised of a single TCI state/pair of TCI states—i.e., either first or second TCI state(s) as specified herein in the present disclosure. For this case/design example,
   In one example, the UE could only apply one or more of the one or more TCI states activated by/in the second/fourth (unified) TCI state(s) activation MAC CE command that correspond(s) to the first TCI state(s) as specified herein in the present disclosure for DL and/or UL channels/signals, according to/based on/following those discussed/specified herein in the present disclosure—e.g., according to one or more examples described herein.
   In another example, the UE could only apply one or more of the one or more TCI states activated by/in the second (unified) TCI state(s) activation MAC CE command that correspond(s) to the second TCI state(s) as specified herein in the present disclosure for DL and/or UL channels/signals, according to/based on/following those discussed/specified herein in the present disclosure—e.g., according to one or more examples described herein.
   In another example, the UE could apply one or more of the one or more TCI states activated by/in the second/fourth (unified) TCI state(s) activation MAC CE command that correspond(s) to the first TCI state(s) as specified herein in the present disclosure as the first TCI state(s) and/or the one or more TCI states (corresponding to either first or second TCI state(s) as specified herein) activated by/in the third (unified) TCI state(s) activation MAC CE command as the second TCI state(s) as specified herein in the present disclosure for DL and/or UL channels/signals, according to/based on/following those discussed/specified herein in the present disclosure—e.g., according to one or more examples described herein.
   In another example, the UE could apply one or more of the one or more TCI states activated by/in the second/fourth (unified) TCI state(s) activation MAC CE command that correspond(s) to the second TCI state(s) as specified herein in the present disclosure as the second TCI state(s) and/or the one or more TCI states (corresponding to either first or second TCI state(s) as specified herein) activated by/in the third (unified) TCI state(s) activation MAC CE command as the first TCI state(s) as specified herein in the present disclosure for DL and/or UL channels/signals, according to/based on/following those discussed/specified herein in the present disclosure—e.g., according to one or more examples described herein.
   In another example, the UE could apply one or more of the one or more TCI states activated by/in the second/fourth (unified) TCI state(s) activation MAC CE command that correspond(s) to the first TCI state(s) as specified herein in the present disclosure as the first TCI state(s) and one or more of the one or more TCI states activated by/in the second/fourth (unified) TCI state(s) activation MAC CE command that correspond(s) to the second TCI state(s) as specified herein in the present disclosure as the second TCI state(s) for DL and/or UL channels/signals, according to/based on/following those discussed/specified herein in the present disclosure—e.g., according to one or more examples described herein.
In another example, the UE may not expect or may not be expected to receive from the network (e.g., the network 130) any third (unified) TCI state(s) activation MAC CE command(s) as specified herein in the present disclosure.
In another example, the UE could expect or could be expected to receive from the network another third (unified) TCI state(s) activation MAC CE command as specified herein in the present disclosure. In this case/design example, when/if the TCI state(s)/TCI codepoint(s) activated by/in the another third (unified) TCI state(s) activation MAC CE command has become applicable, and/or when/if one or more TCI states activated by/in the another third (unified) TCI state(s) activation MAC CE command as specified herein in the present disclosure have become applicable (e.g., (i) the one or more TCI states could correspond to or could be mapped to the single TCI codepoint activated by/in the another third (unified) TCI state(s) activation MAC CE command, and/or (ii) the one or more TCI states could be indicated/provided by a TCI codepoint of a TCI field in a beam indication DCI—e.g., DCI format 1_1/1_2 with or without DL assignment, and the TCI codepoint is activated by/in the another third (unified) TCI state(s) activation MAC CE command),
   For example, regardless of whether the one or more TCI states activated by/in the another third (unified) TCI state(s) activation MAC CE command corresponds to first or second TCI state(s), and/or, e.g., when/if the UE is not provided/configured/indicated by the network, the first and/or second and/or third and/or fourth indicator(s) as specified herein in the present disclosure, in/via their respective RRC/DCI signaling(s), the UE could only apply the one or more TCI states activated by/in the another third (unified) TCI state(s) activation MAC CE command as specified herein in the present disclosure for DL and/or UL channels/signals. That is, for this case/design example, the UE may not expect or may not be expected to receive from or be provided/indicated/configured by the network the first indicator as specified herein in the present disclosure for PDCCH reception(s), and/or the second indicator as specified herein in the present disclosure for PDSCH reception(s), and/or the third indicator as specified herein in the present disclosure for PUCCH transmission(s), and/or the fourth indicator as specified herein in the present disclosure for PUSCH transmission(s).
   For another example, when/if the one or more TCI states activated by/in the other third (unified) TCI state(s) activation MAC CE command as specified herein in the present disclosure correspond to first TCI state(s),
      In one example, the UE could only apply the one or more TCI states activated by/in another third (unified) TCI state(s) activation MAC CE command as specified herein in the present disclosure—as the first TCI state(s)—for DL and/or UL channels/signals. For this case/design example, the UE may not expect or may not be expected to receive from or be provided/indicated/configured by the network the first indicator as specified herein in the present disclosure for PDCCH reception(s), and/or the second indicator as specified herein in the present disclosure for PDSCH reception(s), and/or the third indicator as specified herein in the present disclosure for PUCCH transmission(s), and/or the fourth indicator as specified herein in the present disclosure for PUSCH transmission(s)—e.g., when/if the UE is not provided/configured/indicated by the network, the first and/or second and/or third and/or fourth indicator(s) as specified herein in the present disclosure, in/via their respective RRC/DCI signaling(s). Or, when/if the UE receives from or is provided/indicated/configured by the network the first indicator as specified herein in the present disclosure for PDCCH reception(s), and/or the second indicator as specified herein in the present disclosure for PDSCH reception(s), and/or the third indicator as specified herein in the present disclosure for PUCCH transmission(s), and/or the fourth indicator as specified herein in the present disclosure for PUSCH transmission(s), (1) the UE could ignore/omit/not follow the value(s) of the first and/or second and/or third and/or fourth indicator(s) as specified herein in the present disclosure for the respective/corresponding channel(s)/signal(s), (2) the UE could expect or could be expected that the first and/or second and/or third and/or fourth indicator(s) as specified herein in the present disclosure indicates that none of the indicated TCI state(s) and/or the first TCI state(s) could be used/applied for receiving and/or transmitting the respective/corresponding channel(s)/signal(s), and/or (3) the UE may not expect or may not be expected that the first and/or second and/or third and/or fourth indicator(s) as specified herein in the present disclosure indicates that none of the indicated TCI state(s) and/or the second TCI state(s) and/or both the first and second TCI states could be used/applied for receiving and/or transmitting the respective/corresponding channel(s)/signal(s).
      In another example, the UE (e.g., the UE 116) could apply at least the one or more TCI states activated by/in another third (unified) TCI state(s) activation MAC CE command as specified herein in the present disclosure for DL and/or UL channels/signals. For this case/design example, e.g., when/if the UE is provided/configured/indicated by the network, the first and/or second and/or third and/or fourth indicator(s) as specified herein in the present disclosure, in/via their respective RRC/DCI signaling(s), the UE could apply the one or more TCI states activated by/in the another third (unified) TCI state(s) activation MAC CE command as specified herein in the present disclosure as the first TCI state(s) and/or the one or more TCI states (corresponding to either first or second TCI state(s) as specified herein) activated by/in the (previous/prior) third (unified) TCI state(s) activation MAC CE command as specified herein in the present disclosure as the second TCI state(s) for DL and/or UL channels/signals.
   For another example, when/if the one or more TCI states activated by/in another third (unified) TCI state(s) activation MAC CE command as specified herein in the present disclosure correspond to second TCI state(s),
      In one example, the UE could only apply the one or more TCI states activated by/in another third (unified) TCI state(s) activation MAC CE command as specified herein in the present disclosure—as the second TCI state(s)—for DL and/or UL channels/signals. For this case/design example, the UE may not expect or may not be expected to receive from or be provided/indicated/configured by the network the first indicator as specified herein in the present disclosure for PDCCH reception(s), and/or the second indicator as specified herein in the present disclosure for PDSCH reception(s), and/or the third indicator as specified herein in the present disclosure for PUCCH transmission(s), and/or the fourth indicator as specified herein in the present disclosure for PUSCH transmission(s)—e.g., when/if the UE is not provided/configured/indicated by the network, the first and/or second and/or third and/or fourth indicator(s) as specified herein in the present disclosure, in/via their respective RRC/DCI signaling(s). Or, when/if the UE receives from or is provided/indicated/configured by the network the first indicator as specified herein in the present disclosure for PDCCH reception(s), and/or the second indicator as specified herein in the present disclosure for PDSCH reception(s), and/or the third indicator as specified herein in the present disclosure for PUCCH transmission(s), and/or the fourth indicator as specified herein in the present disclosure for PUSCH transmission(s), (1) the UE could ignore/omit/not follow the value(s) of the first and/or second and/or third and/or fourth indicator(s) as specified herein in the present disclosure for the respective/corresponding channel(s)/signal(s), (2) the UE could expect or could be expected that the first and/or second and/or third and/or fourth indicator(s) as specified herein in the present disclosure indicates that none of the indicated TCI state(s) and/or the second TCI state(s) could be used/applied for receiving and/or transmitting the respective/corresponding channel(s)/signal(s), and/or (3) the UE may not expect or may not be expected that the first and/or second and/or third and/or fourth indicator(s) as specified herein in the present disclosure indicates that none of the indicated TCI state(s) and/or the first TCI state(s) and/or both the first and second TCI states could be used/applied for receiving and/or transmitting the respective/corresponding channel(s)/signal(s).
      In another example, the UE could apply at least the one or more TCI states activated by/in another third (unified) TCI state(s) activation MAC CE command as specified herein in the present disclosure for DL and/or UL channels/signals. For this case/design example, e.g., when/if the UE is provided/configured/indicated by the network, the first and/or second and/or third and/or fourth indicator(s) as specified herein in the present disclosure, in/via their respective RRC/DCI signaling(s), the UE could apply the one or more TCI states activated by/in the another third (unified) TCI state(s) activation MAC CE command as specified herein in the present disclosure as the second TCI state(s) and/or the one or more TCI states (corresponding to either first or second TCI state(s) as specified herein) activated by/in the (previous/prior) third (unified) TCI state(s) activation MAC CE command as specified herein in the present disclosure as the first TCI state(s) for DL and/or UL channels/signals.

In one embodiment, when/if a UE is provided/configured with dl-OrJointTCI-StateList and/or ul-TCI-StateList, and/or when/if the UE is having one or two indicated TCI state(s) and/or pair(s) of TCI states, and/or when/if the UE is having first and/or second indicated TCI states, and/or when/if the UE receives from the network a second/fourth (unified) TCI state(s) activation MAC CE command as specified herein in the present disclosure, and/or when/if the TCI state(s)/TCI codepoint(s) activated by/in the second/fourth (unified) TCI state(s) activation MAC CE command has become applicable, and/or when/if the UE is applying one or more TCI states activated by/in the second/fourth (unified) TCI state(s) activation MAC CE command for DL and/or UL channels/signals (e.g., (i) the one or more TCI states could correspond to or could be mapped to the single TCI codepoint activated by/in the second/fourth (unified) TCI state(s) activation MAC CE command, and/or (ii) the one or more TCI states could be indicated/provided by a TCI codepoint of a TCI field in a beam indication DCI—e.g., DCI format 1_1/1_2 with or without DL assignment, and the TCI codepoint is activated by/in the second/fourth (unified) TCI state(s) activation MAC CE command), wherein the one or more TCI states activated by/in the second/fourth (unified) TCI state(s) activation MAC CE command could also be referred to as first TCI state(s) and/or second TCI state(s) activated by/in the second/fourth (unified) TCI state(s) activation MAC CE command (e.g., (i) the first and/or second TCI state(s) as specified herein could correspond to or could be mapped to the single TCI codepoint activated by/in the second/fourth (unified) TCI state(s) activation MAC CE command, and/or (ii) the first and/or second TCI state(s) as specified herein could be indicated/provided by a TCI codepoint of a TCI field in a beam indication DCI—e.g., DCI format 1_1/1_2 with or without DL assignment, and the TCI codepoint is activated by/in the second/fourth (unified) TCI state(s) activation MAC CE command),
In one example, the UE may not expect or may not be expected to receive from the network any first (unified) TCI state(s) activation MAC CE command(s) as specified herein in the present disclosure.
In another example, the UE could expect or could be expected to receive from the network a first (unified) TCI state(s) activation MAC CE command as specified herein in the present disclosure. In this case/design example, when/if the TCI state(s)/TCI codepoint(s) activated by/in the first (unified) TCI state(s) activation MAC CE command has become applicable, and/or when/if one or more TCI states activated by/in the first (unified) TCI state(s) activation MAC CE command as specified herein in the present disclosure have become applicable (e.g., (i) the one or more TCI states could correspond to or could be mapped to the single TCI codepoint activated by/in the first (unified) TCI state(s) activation MAC CE command, and/or (ii) the one or more TCI states could be indicated/provided by a TCI codepoint of a TCI field in a beam indication DCI—e.g., DCI format 1_1/1_2 with or without DL assignment, and the TCI codepoint is activated by/in the first (unified) TCI state(s) activation MAC CE command), the UE could only apply the one or more TCI states activated by/in the first (unified) TCI state(s) activation MAC CE command as specified herein in the present disclosure for DL and/or UL channels/signals.
In another example, the UE may not expect or may not be expected to receive from the network any third (unified) TCI state(s) activation MAC CE command(s) as specified herein in the present disclosure.
In another example, the UE could expect or could be expected to receive from the network a third (unified) TCI state(s) activation MAC CE command as specified herein in the present disclosure. In this case/design example, when/if the TCI state(s)/TCI codepoint(s) activated by/in the third (unified) TCI state(s) activation MAC CE command has become applicable, and/or when/if one or more TCI states activated by/in the third (unified) TCI state(s) activation MAC CE command as specified herein in the present disclosure have become applicable (e.g., (i) the one or more TCI states could correspond to or could be mapped to the single TCI codepoint activated by/in the third (unified) TCI state(s) activation MAC CE command, and/or (ii) the one or more TCI states could be indicated/provided by a TCI codepoint of a TCI field in a beam indication DCI—e.g., DCI format 1_1/1_2 with or without DL assignment, and the TCI codepoint is activated by/in the third (unified) TCI state(s) activation MAC CE command),
   For example, e.g., when/if the UE is not provided/configured/indicated by the network, the first and/or second and/or third and/or fourth indicator(s) as specified herein in the present disclosure, in/via their respective RRC/DCI signaling(s), that is, when/if the UE may not expect or may not be expected to receive from or be provided/indicated/configured by the network the first indicator as specified herein in the present disclosure for PDCCH reception(s), and/or the second indicator as specified herein in the present disclosure for PDSCH reception(s), and/or the third indicator as specified herein in the present disclosure for PUCCH transmission(s), and/or the fourth indicator as specified herein in the present disclosure for PUSCH transmission(s),
      In one example, the UE could only apply the one or more TCI states activated by/in the third (unified) TCI state(s) activation MAC CE command as specified herein in the present disclosure for DL and/or UL channels/signals (i.e., regardless of whether the one or more TCI states activated by/in the third (unified) TCI state(s) activation MAC CE command corresponds to first or second TCI state(s)).
      In another example, when/if the one or more TCI states activated by/in the third (unified) TCI state(s) activation MAC CE command as specified herein in the present disclosure correspond to first TCI state(s), the UE could only apply the one or more TCI states activated by/in the third (unified) TCI state(s) activation MAC CE command as specified herein in the present disclosure—as the first TCI state(s)—for DL and/or UL channels/signals.
      In another example, when/if the one or more TCI states activated by/in the third (unified) TCI state(s) activation MAC CE command as specified herein in the present disclosure correspond to second TCI state(s), the UE could only apply the one or more TCI states activated by/in the third (unified) TCI state(s) activation MAC CE command as specified herein in the present disclosure—as the second TCI state(s)—for DL and/or UL channels/signals.
   For another example, e.g., when/if the UE is provided/configured/indicated by the network, the first and/or second and/or third and/or fourth indicator(s) as specified herein in the present disclosure, in/via their respective RRC/DCI signaling(s)—e.g., when/if the second indicator (or equivalently, the TCI selection field indicator) is RRC configured to be present (e.g., by setting tciSelectionPresentInDCI to ‘enabled’) in the corresponding DCI format(s) 1_1/1_2, that is, when/if the UE could expect or could be expected to receive from or be provided/indicated/configured by the network the first indicator as specified herein in the present disclosure for PDCCH reception(s), and/or the second indicator as specified herein in the present disclosure for PDSCH reception(s), and/or the third indicator as specified herein in the present disclosure for PUCCH transmission(s), and/or the fourth indicator as specified herein in the present disclosure for PUSCH transmission(s), and/or when/if the first and/or second and/or third and/or fourth indicator(s) as specified herein in the present disclosure is set to ‘first’, ‘second’, ‘both’ or ‘none’ in/via their respective RRC/DCI signaling(s), the UE could apply at least the one or more TCI states activated by/in the third (unified) TCI state(s) activation MAC CE command as specified herein in the present disclosure for DL and/or UL channels/signals.
      In one example, when/if the one or more TCI states activated by/in the third (unified) TCI state(s) activation MAC CE command as specified herein in the present disclosure correspond to first TCI state(s), the UE could only apply the one or more TCI states activated by/in the third (unified) TCI state(s) activation MAC CE command as specified herein in the present disclosure—as the first TCI state(s)—for DL and/or UL channels/signals.
      In another example, when/if the one or more TCI states activated by/in the third (unified) TCI state(s) activation MAC CE command as specified herein in the present disclosure correspond to second TCI state(s), the UE could only apply the one or more TCI states activated by/in the third (unified) TCI state(s) activation MAC CE command as specified herein in the present disclosure—as the second TCI state(s)—for DL and/or UL channels/signals.
      In another example, when/if the one or more TCI states activated by/in the third (unified) TCI state(s) activation MAC CE command as specified herein in the present disclosure correspond to first TCI state(s), the UE could apply the one or more TCI states activated by/in the third (unified) TCI state(s) activation MAC CE command as specified herein in the present disclosure as the first TCI states and/or one or more of the one or more TCI states activated by/in the second/fourth (unified) TCI state(s) activation MAC CE command that correspond(s) to the second TCI state(s) as specified herein in the present disclosure as the second TCI state(s) for DL and/or UL channels/signals.
      In another example, when/if the one or more TCI states activated by/in the third (unified) TCI state(s) activation MAC CE command as specified herein in the present disclosure correspond to second TCI state(s), the UE could apply the one or more TCI states activated by/in the third (unified) TCI state(s) activation MAC CE command as specified herein in the present disclosure as the second TCI states and/or one or more of the one or more TCI states activated by/in the second/fourth (unified) TCI state(s) activation MAC CE command that correspond(s) to the first TCI state(s) as specified herein in the present disclosure as the first TCI state(s) for DL and/or UL channels/signals.

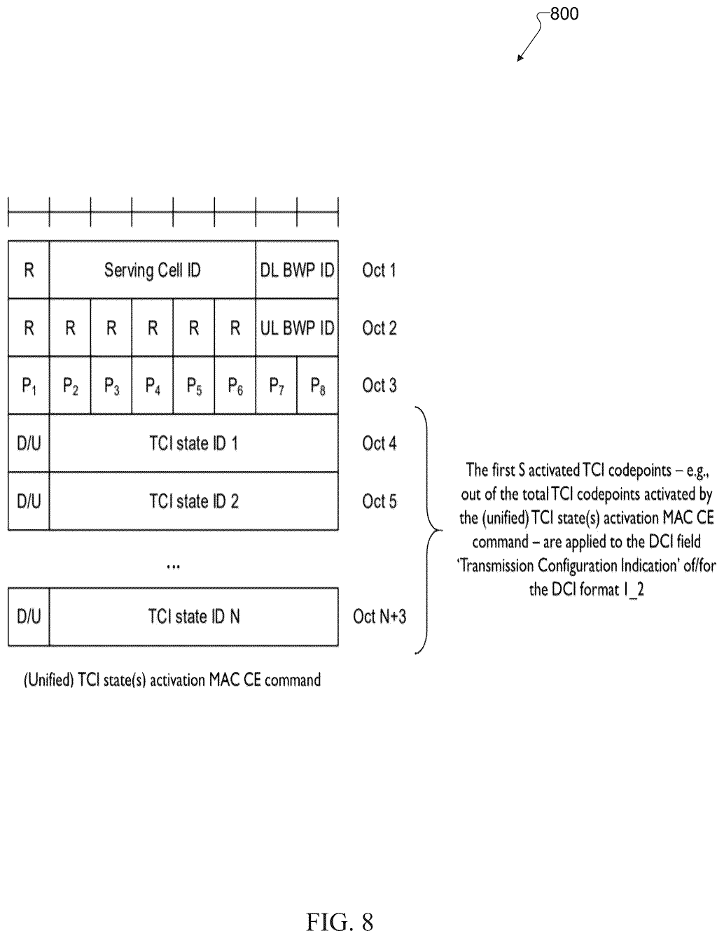

FIG. 8 illustrates an example MAC CE command 800 for TCI state(s) activation according to embodiments of the present disclosure. For example, the UE 111 of FIG. 1 may respond to MAC CE command 800 for TCI state(s) activation. This example is for illustration only and can be used without departing from the scope of the present disclosure.

In one embodiment, with reference to FIG. 8, when/if a UE is provided/configured with dl-OrJointTCI-StateList and/or ul-TCI-StateList, and/or when/if the UE receives a (unified) TCI state(s) activation MAC CE command—e.g., a first (unified) TCI state(s) activation MAC CE command or a second (unified) TCI state(s) activation MAC CE command or a third (unified) TCI state(s) activation MAC CE command or a fourth (unified) TCI state(s) activation MAC CE command as specified herein in the present disclosure, and/or when/if the DCI field ‘Transmission Configuration Indication’ is present in DCI format 1_2, and/or when/if the number of codepoints S in the DCI field ‘Transmission Configuration Indication’ of the DCI format 1_2 is smaller than the number of TCI codepoints that are activated by the (unified) TCI state(s) activation MAC CE command—e.g., a first (unified) TCI state(s) activation MAC CE command or a second (unified) TCI state(s) activation MAC CE command or a third (unified) TCI state(s) activation MAC CE command or a fourth (unified) TCI state(s) activation MAC CE command as specified herein in the present disclosure, only the first S activated TCI codepoints—e.g., out of the total TCI codepoints activated by the (unified) TCI state(s) activation MAC CE command as specified herein—are applied to the DCI field ‘Transmission Configuration Indication’ of/for the DCI format 1_2. When a UE is provided in PDCCH-Config two values of coresetPoolIndex (e.g., 0 and 1) in CORESET(s)/ControlResourceSet, the DCI format 1_2 as specified herein in the present disclosure and the (unified) TCI state(s) activation MAC CE command as specified herein in the present disclosure (and therefore, the first S activated TCI codepoints among the TCI codepoints activated therein) could be specific to a/the same value of coresetPoolIndex (i.e., 0 or 1). That is, when/if a UE receives a (unified) TCI state(s) activation MAC CE command—e.g., a first (unified) TCI state(s) activation MAC CE command or a second (unified) TCI state(s) activation MAC CE command or a third (unified) TCI state(s) activation MAC CE command or a fourth (unified) TCI state(s) activation MAC CE command as specified herein in the present disclosure—that is specific to a value of coresetPoolIndex, e.g., 0 (or 1)—e.g., the value of coresetPoolIndex is provided/indicated in the MAC CE command, and/or when/if the DCI field ‘Transmission Configuration Indication’ is present in DCI format 1_2 specific to the same value of coresetPoolIndex, i.e., 0 (or 1), and/or when/if the number of codepoints S in the DCI field ‘Transmission Configuration Indication’ of the DCI format 1_2 specific to the same value of coresetPoolIndex, i.e., 0 (or 1), is smaller than the number of TCI codepoints that are activated by the (unified) TCI state(s) activation MAC CE command—e.g., a first (unified) TCI state(s) activation MAC CE command or a second (unified) TCI state(s) activation MAC CE command or a third (unified) TCI state(s) activation MAC CE command or a fourth (unified) TCI state(s) activation MAC CE command as specified herein in the present disclosure—specific to the same value of coresetPoolIndex, i.e., 0 (or 1), only the first S activated TCI codepoints—e.g., out of the total TCI codepoints activated by the (unified) TCI state(s) activation MAC CE command as specified herein specific to the same value of coresetPoolIndex, i.e., 0 (or 1)—are applied to the DCI field ‘Transmission Configuration Indication’ of/for the DCI format 1_2 specific to the same value of coresetPoolIndex, i.e., 0 (or 1), wherein the DCI format 1_2 is specific to a value of coresetPoolIndex when/if the PDCCH candidate(s) that carries the DCI format 1_2 is received in CORESET(s) associated/configured/specific to/with the same value of coresetPoolIndex. Applying the first S activated TCI codepoints—e.g., out of the total TCI codepoints activated by the (unified) TCI state(s) activation MAC CE command—to/for the DCI format 12 is provided.
In one example, the UE could expect that each of the (first) S activated TCI codepoints applied for the DCI format 1_2 could be comprised of one TCI state for both DL and UL channels/signals, one TCI state for DL channels/signals, one TCI state for UL channels/signals, or a pair of TCI states comprising of one TCI state for DL channels/signals and one TCI state for UL channels/signals—i.e., the same TCI codepoint definition as that for the first (unified) TCI state(s) activation MAC CE command as specified herein in the present disclosure.
In another example, the UE could expect that each of the (first) S activated TCI codepoints applied for the DCI format 1_2 could be comprised of a set of TCI states with the set comprising of up to two (e.g., none, one or two) TCI states for DL and UL channels/signals and/or up to two (e.g., none, one or two) TCI state(s) for DL channels/signals and/or up to two (e.g., none, one or two) TCI state(s) for UL channels/signals—i.e., the same TCI codepoint definition as that for the second (unified) TCI state(s) activation MAC CE command as specified herein in the present disclosure.
In another example, the UE could expect that the (first) S activated TCI codepoints applied for the DCI format 1_2 could correspond to one of:
   Case 19: first TCI state(s) for DL channels/signals, and/or first TCI state(s) for UL channels/signals, and/or pair(s) of TCI states with each pair comprising of a first TCI state for DL channels/signals and a first TCI state for UL channels/signals
   Case 20: second TCI state(s) for DL channels/signals, and/or second TCI state(s) for UL channels/signals, and/or pair(s) of TCI states with each pair comprising of a second TCI state for DL channels/signals and a second TCI state for UL channels/signals
   Case 21: first TCI state(s) for both DL and UL channels/signals
   Case 22: second TCI state(s) for both DL and UL channels/signals

That is, the same TCI codepoint definition as that for the third (unified) TCI state(s) activation MAC CE command as specified herein in the present disclosure is retained in this case/design example—the (first) S activated TCI codepoint(s) applied for the DCI format 1_2 could be comprised of or mapped to either first joint/DL/UL TCI state(s)/pair(s) of first DL and UL TCI states or second joint/DL/UL TCI state(s)/pair(s) of second DL and UL TCI states.
In another example, the UE may not expect that the (first) S activated TCI codepoints applied for the DCI format 1_2 could correspond to one of:
   Case 19: first TCI state(s) for DL channels/signals, and/or first TCI state(s) for UL channels/signals, and/or pair(s) of TCI states with each pair comprising of a first TCI state for DL channels/signals and a first TCI state for UL channels/signals
   Case 20: second TCI state(s) for DL channels/signals, and/or second TCI state(s) for UL channels/signals, and/or pair(s) of TCI states with each pair comprising of a second TCI state for DL channels/signals and a second TCI state for UL channels/signals
   Case 21: first TCI state(s) for both DL and UL channels/signals
   Case 22: second TCI state(s) for both DL and UL channels/signals
In another example, the UE could expect that the (first) S activated TCI codepoints applied for the DCI format 1_2 could comprise/include/contain at least one activated TCI codepoint that is composed/comprised of a first TCI state for DL and/or UL channel(s)/signal(s) or a pair of a first TCI state for DL channel(s)/signal(s) and a first TCI state for UL channel(s)/signal(s), and a second TCI state for DL and/or UL channel(s)/signal(s) or a pair of a second TCI state for DL channel(s)/signal(s) and a second TCI state for UL channel(s)/signal(s); i.e., for this case/design example, at least one activated TCI codepoint out of the (first) S activated TCI codepoints applied for the DCI format 1_2 could be composed/comprised of one of:
   Case 2: a first TCI state for DL channel(s)/signal(s) and a second TCI state for DL channel(s)/signal(s)
   Case 3: a first TCI state for DL channel(s)/signal(s) and a second TCI state for UL channel(s)/signal(s)
   Case 4: a first TCI state for DL channel(s)/signal(s) and a pair of a second TCI state for DL channel(s)/signal(s) and a second TCI state for UL channel(s)/signal(s)
   Case 6: a first TCI state for UL channel(s)/signal(s) and a second TCI state for DL channel(s)/signal(s)
   Case 7: a first TCI state for UL channel(s)/signal(s) and a second TCI state for UL channel(s)/signal(s)
   Case 8: a first TCI state for UL channel(s)/signal(s) and a pair of a second TCI state for DL channel(s)/signal(s) and a second TCI state for UL channel(s)/signal(s)
   Case 10: a pair of a first TCI state for DL channel(s)/signal(s) and a first TCI state for UL channel(s)/signal(s) and a second TCI state for DL channel(s)/signal(s)
   Case 11: a pair of a first TCI state for DL channel(s)/signal(s) and a first TCI state for UL channel(s)/signal(s) and a second TCI state for UL channel(s)/signal(s)
   Case 12: a pair of a first TCI state for DL channel(s)/signal(s) and a first TCI state for UL channel(s)/signal(s) and a pair of a second TCI state for DL channel(s)/signal(s) and a second TCI state for UL channel(s)/signal(s)
   Case 18: a pair of a first TCI state for DL channel(s)/signal(s) and UL channel(s)/signal(s) and a second TCI state for DL channel(s)/signal(s) and UL channel(s)/signal(s)

That is, the same TCI codepoint definition as that for the fourth (unified) TCI state(s) activation MAC CE command as specified herein in the present disclosure is retained in this case/design example.
In another example, the UE could expect that the (first) S activated TCI codepoints applied for the DCI format 1_2 may not comprise/include/contain any activated TCI codepoint(s) that is composed/comprised of a first TCI state for DL and/or UL channel(s)/signal(s) or a pair of a first TCI state for DL channel(s)/signal(s) and a first TCI state for UL channel(s)/signal(s), and a second TCI state for DL and/or UL channel(s)/signal(s) or a pair of a second TCI state for DL channel(s)/signal(s) and a second TCI state for UL channel(s)/signal(s); i.e., for this case/design example, none of the (first) S activated TCI codepoints applied for the DCI format 1_2 could be composed/comprised of any of:
   Case 2: a first TCI state for DL channel(s)/signal(s) and a second TCI state for DL channel(s)/signal(s)
   Case 3: a first TCI state for DL channel(s)/signal(s) and a second TCI state for UL channel(s)/signal(s)
   Case 4: a first TCI state for DL channel(s)/signal(s) and a pair of a second TCI state for DL channel(s)/signal(s) and a second TCI state for UL channel(s)/signal(s)
   Case 6: a first TCI state for UL channel(s)/signal(s) and a second TCI state for DL channel(s)/signal(s)
   Case 7: a first TCI state for UL channel(s)/signal(s) and a second TCI state for UL channel(s)/signal(s)
   Case 8: a first TCI state for UL channel(s)/signal(s) and a pair of a second TCI state for DL channel(s)/signal(s) and a second TCI state for UL channel(s)/signal(s)
   Case 10: a pair of a first TCI state for DL channel(s)/signal(s) and a first TCI state for UL channel(s)/signal(s) and a second TCI state for DL channel(s)/signal(s)
   Case 11: a pair of a first TCI state for DL channel(s)/signal(s) and a first TCI state for UL channel(s)/signal(s) and a second TCI state for UL channel(s)/signal(s)
   Case 12: a pair of a first TCI state for DL channel(s)/signal(s) and a first TCI state for UL channel(s)/signal(s) and a pair of a second TCI state for DL channel(s)/signal(s) and a second TCI state for UL channel(s)/signal(s)
   Case 18: a pair of a first TCI state for DL channel(s)/signal(s) and UL channel(s)/signal(s) and a second TCI state for DL channel(s)/signal(s) and UL channel(s)/signal(s)
In another example, the UE (e.g., the UE 116) could expect that the (first) S activated TCI codepoints applied for the DCI format 1_2 could comprise/include/contain at least one TCI codepoint that is composed/comprised of at least first TCI state(s) as specified herein in the present disclosure and another TCI codepoint that is composed/comprised of at least second TCI state(s) as specified herein in the present disclosure; i.e., for this case/design example, at least one activated TCI codepoint out of the (first) S activated TCI codepoints applied for the DCI format 1_2 could be composed/comprised of one of:
   Case 1: a first TCI state for DL channel(s)/signal(s)
   Case 2: a first TCI state for DL channel(s)/signal(s) and a second TCI state for DL channel(s)/signal(s)
   Case 3: a first TCI state for DL channel(s)/signal(s) and a second TCI state for UL channel(s)/signal(s)
   Case 4: a first TCI state for DL channel(s)/signal(s) and a pair of a second TCI state for DL channel(s)/signal(s) and a second TCI state for UL channel(s)/signal(s)
   Case 5: a first TCI state for UL channel(s)/signal(s)
   Case 6: a first TCI state for UL channel(s)/signal(s) and a second TCI state for DL channel(s)/signal(s)
   Case 7: a first TCI state for UL channel(s)/signal(s) and a second TCI state for UL channel(s)/signal(s)
   Case 8: a first TCI state for UL channel(s)/signal(s) and a pair of a second TCI state for DL channel(s)/signal(s) and a second TCI state for UL channel(s)/signal(s)
   Case 9: a pair of a first TCI state for DL channel(s)/signal(s) and a first TCI state for UL channel(s)/signal(s)
   Case 10: a pair of a first TCI state for DL channel(s)/signal(s) and a first TCI state for UL channel(s)/signal(s) and a second TCI state for DL channel(s)/signal(s)
   Case 11: a pair of a first TCI state for DL channel(s)/signal(s) and a first TCI state for UL channel(s)/signal(s) and a second TCI state for UL channel(s)/signal(s)
   Case 12: a pair of a first TCI state for DL channel(s)/signal(s) and a first TCI state for UL channel(s)/signal(s) and a pair of a second TCI state for DL channel(s)/signal(s) and a second TCI state for UL channel(s)/signal(s)
   Case 16: a first TCI state for DL channel(s)/signal(s) and UL channel(s)/signal(s)
   Case 18: a pair of a first TCI state for DL channel(s)/signal(s) and UL channel(s)/signal(s) and a second TCI state for DL channel(s)/signal(s) and UL channel(s)/signal(s)

Another TCI codepoint out of the (first) S activated TCI codepoints applied for the DCI format 1_2 could be composed/comprised of one of:
Case 2: a first TCI state for DL channel(s)/signal(s) and a second TCI state for DL channel(s)/signal(s)
Case 3: a first TCI state for DL channel(s)/signal(s) and a second TCI state for UL channel(s)/signal(s)
Case 4: a first TCI state for DL channel(s)/signal(s) and a pair of a second TCI state for DL channel(s)/signal(s) and a second TCI state for UL channel(s)/signal(s)
Case 6: a first TCI state for UL channel(s)/signal(s) and a second TCI state for DL channel(s)/signal(s)
Case 7: a first TCI state for UL channel(s)/signal(s) and a second TCI state for UL channel(s)/signal(s)
Case 8: a first TCI state for UL channel(s)/signal(s) and a pair of a second TCI state for DL channel(s)/signal(s) and a second TCI state for UL channel(s)/signal(s)
Case 10: a pair of a first TCI state for DL channel(s)/signal(s) and a first TCI state for UL channel(s)/signal(s) and a second TCI state for DL channel(s)/signal(s)
Case 11: a pair of a first TCI state for DL channel(s)/signal(s) and a first TCI state for UL channel(s)/signal(s) and a second TCI state for UL channel(s)/signal(s)
Case 12: a pair of a first TCI state for DL channel(s)/signal(s) and a first TCI state for UL channel(s)/signal(s) and a pair of a second TCI state for DL channel(s)/signal(s) and a second TCI state for UL channel(s)/signal(s)
Case 13: a second TCI state for DL channel(s)/signal(s)
Case 14: a second TCI state for UL channel(s)/signal(s)
Case 15: a pair of a second TCI state for DL channel(s)/signal(s) and a second TCI state for UL channel(s)/signal(s)
Case 17: a second TCI state for DL channel(s)/signal(s) and UL channel(s)/signal(s)
Case 18: a pair of a first TCI state for DL channel(s)/signal(s) and UL channel(s)/signal(s) and a second TCI state for DL channel(s)/signal(s) and UL channel(s)/signal(s)

That is, the same TCI codepoint definition as that for the fourth (unified) TCI state(s) activation MAC CE command as specified herein in the present disclosure is retained in this case/design example.
In another example, when/if the (first) S activated TCI codepoints applied for the DCI format 1_2 comprise/include/contain at least one TCI codepoint that is composed/comprised of at least first TCI state(s) as specified herein in the present disclosure, the UE could expect that the (first) S activated TCI codepoints applied for the DCI format 1_2 may not comprise/include/contain any TCI codepoint that is composed/comprised of second TCI state(s) as specified herein in the present disclosure.
In another example, when/if the (first) S activated TCI codepoints applied for the DCI format 1_2 comprise/include/contain at least one TCI codepoint that is composed/comprised of at least second TCI state(s) as specified herein in the present disclosure, the UE could expect that the (first) S activated TCI codepoints applied for the DCI format 1_2 may not comprise/include/contain any TCI codepoint that is composed/comprised of first TCI state(s) as specified herein in the present disclosure.

In one embodiment, when/if a UE is provided/configured with dl-OrJointTCI-StateList and/or ul-TCI-StateList, and/or when/if the UE receives a (unified) TCI state(s) activation MAC CE command—e.g., a first (unified) TCI state(s) activation MAC CE command or a second (unified) TCI state(s) activation MAC CE command or a third (unified) TCI state(s) activation MAC CE command or a fourth (unified) TCI state(s) activation MAC CE command as specified herein in the present disclosure, and/or when/if the DCI field ‘Transmission Configuration Indication’ is present in DCI format 1_2, and/or when/if the number of codepoints S in the DCI field ‘Transmission Configuration Indication’ of the DCI format 1_2 is smaller than the number of TCI codepoints that are activated by the (unified) TCI state(s) activation MAC CE command—e.g., a first (unified) TCI state(s) activation MAC CE command or a second (unified) TCI state(s) activation MAC CE command or a third (unified) TCI state(s) activation MAC CE command or a fourth (unified) TCI state(s) activation MAC CE command as specified herein in the present disclosure, one of:
Only the first S activated TCI codepoints that are composed/comprised of either first TCI state(s) as specified herein in the present disclosure or second TCI state(s) as specified herein in the present disclosure—e.g., out of the total TCI codepoints activated by the (unified) TCI state(s) activation MAC CE command as specified herein—are applied to the DCI field ‘Transmission Configuration Indication’ of/for the DCI format 1_2.
Only the first S activated TCI codepoints—e.g., out of the total TCI codepoints that are composed/comprised of either first TCI state(s) as specified herein in the present disclosure or second TCI state(s) as specified herein in the present disclosure activated by the (unified) TCI state(s) activation MAC CE command as specified herein—are applied to the DCI field ‘Transmission Configuration Indication’ of/for the DCI format 1_2.
Only the first S activated TCI codepoints that are composed/comprised of at least one TCI codepoint that is composed/comprised of a first TCI state for DL and/or UL channel(s)/signal(s) or a pair of a first TCI state for DL channel(s)/signal(s) and a first TCI state for UL channel(s)/signal(s), and a second TCI state for DL and/or UL channel(s)/signal(s) or a pair of a second TCI state for DL channel(s)/signal(s) and a second TCI state for UL channel(s)/signal(s) as specified herein in the present disclosure, and/or at least one TCI codepoint that is composed/comprised of at least first TCI state(s) as specified herein in the present disclosure and another TCI codepoint that is composed/comprised of at least second TCI state(s) as specified herein in the present disclosure—e.g., out of the total TCI codepoints activated by the (unified) TCI state(s) activation MAC CE command as specified herein—are applied to the DCI field ‘Transmission Configuration Indication’ of/for the DCI format 1_2.
Only the first S activated TCI codepoints—e.g., out of the total TCI codepoints that are composed/comprised of at least one TCI codepoint that is composed/comprised of a first TCI state for DL and/or UL channel(s)/signal(s) or a pair of a first TCI state for DL channel(s)/signal(s) and a first TCI state for UL channel(s)/signal(s), and a second TCI state for DL and/or UL channel(s)/signal(s) or a pair of a second TCI state for DL channel(s)/signal(s) and a second TCI state for UL channel(s)/signal(s) as specified herein in the present disclosure, and/or at least one TCI codepoint that is composed/comprised of at least first TCI state(s) as specified herein in the present disclosure and another TCI codepoint that is composed/comprised of at least second TCI state(s) as specified herein in the present disclosure activated by the (unified) TCI state(s) activation MAC CE command as specified herein—are applied to the DCI field ‘Transmission Configuration Indication’ of/for the DCI format 1_2.

When a UE is provided in PDCCH-Config two values of coresetPoolIndex (e.g., 0 and 1) in CORESET(s)/ControlResourceSet, the DCI format 1_2 as specified herein in the present disclosure and the (unified) TCI state(s) activation MAC CE command as specified herein in the present disclosure could be specific to a/the same value of coresetPoolIndex (i.e., 0 or 1). That is, when/if a UE receives a (unified) TCI state(s) activation MAC CE command—e.g., a first (unified) TCI state(s) activation MAC CE command or a second (unified) TCI state(s) activation MAC CE command or a third (unified) TCI state(s) activation MAC CE command or a fourth (unified) TCI state(s) activation MAC CE command as specified herein in the present disclosure—that is specific to a value of coresetPoolIndex, e.g., 0 (or 1)—e.g., the value of coresetPoolIndex is provided/indicated in the MAC CE command, and/or when/if the DCI field ‘Transmission Configuration Indication’ is present in DCI format 1_2 specific to the same value of coresetPoolIndex, i.e., 0 (or 1), and/or when/if the number of codepoints S in the DCI field ‘Transmission Configuration Indication’ of the DCI format 1_2 specific to the same value of coresetPoolIndex, i.e., 0 (or 1), is smaller than the number of TCI codepoints that are activated by the (unified) TCI state(s) activation MAC CE command—e.g., a first (unified) TCI state(s) activation MAC CE command or a second (unified) TCI state(s) activation MAC CE command or a third (unified) TCI state(s) activation MAC CE command or a fourth (unified) TCI state(s) activation MAC CE command as specified herein in the present disclosure—specific to the same value of coresetPoolIndex, i.e., 0 (or 1), one of:
Only the first S activated TCI codepoints that are composed/comprised of either first TCI state(s) as specified herein in the present disclosure or second TCI state(s) as specified herein in the present disclosure—e.g., out of the total TCI codepoints activated by the (unified) TCI state(s) activation MAC CE command as specified herein specific to the same value of coresetPoolIndex, i.e., 0 (or 1)—are applied to the DCI field ‘Transmission Configuration Indication’ of/for the DCI format 1_2 specific to the same value of coresetPoolIndex, i.e., 0 (or 1).
Only the first S activated TCI codepoints—e.g., out of the total TCI codepoints that are composed/comprised of either first TCI state(s) as specified herein in the present disclosure or second TCI state(s) as specified herein in the present disclosure activated by the (unified) TCI state(s) activation MAC CE command as specified herein specific to the same value of coresetPoolIndex, i.e., 0 (or 1)—are applied to the DCI field ‘Transmission Configuration Indication’ of/for the DCI format 1_2 specific to the same value of coresetPoolIndex, i.e., 0 (or 1).
Only the first S activated TCI codepoints that are composed/comprised of at least one TCI codepoint that is composed/comprised of a first TCI state for DL and/or UL channel(s)/signal(s) or a pair of a first TCI state for DL channel(s)/signal(s) and a first TCI state for UL channel(s)/signal(s), and a second TCI state for DL and/or UL channel(s)/signal(s) or a pair of a second TCI state for DL channel(s)/signal(s) and a second TCI state for UL channel(s)/signal(s) as specified herein in the present disclosure, and/or at least one TCI codepoint that is composed/comprised of at least first TCI state(s) as specified herein in the present disclosure and another TCI codepoint that is composed/comprised of at least second TCI state(s) as specified herein in the present disclosure—e.g., out of the total TCI codepoints activated by the (unified) TCI state(s) activation MAC CE command as specified herein specific to the same value of coresetPoolIndex, i.e., 0 (or 1)—are applied to the DCI field ‘Transmission Configuration Indication’ of/for the DCI format 12 specific to the same value of coresetPoolIndex, i.e., 0 (or 1).
Only the first S activated TCI codepoints—e.g., out of the total TCI codepoints that are composed/comprised of at least one TCI codepoint that is composed/comprised of a first TCI state for DL and/or UL channel(s)/signal(s) or a pair of a first TCI state for DL channel(s)/signal(s) and a first TCI state for UL channel(s)/signal(s), and a second TCI state for DL and/or UL channel(s)/signal(s) or a pair of a second TCI state for DL channel(s)/signal(s) and a second TCI state for UL channel(s)/signal(s) as specified herein in the present disclosure, and/or at least one TCI codepoint that is composed/comprised of at least first TCI state(s) as specified herein in the present disclosure and another TCI codepoint that is composed/comprised of at least second TCI state(s) as specified herein in the present disclosure activated by the (unified) TCI state(s) activation MAC CE command as specified herein specific to the same value of coresetPoolIndex, i.e., 0 (or 1)—are applied to the DCI field ‘Transmission Configuration Indication’ of/for the DCI format 1_2 specific to the same value of coresetPoolIndex, i.e., 0 (or 1).

Here, the DCI format 1_2 is specific to a value of coresetPoolIndex when/if the PDCCH candidate(s) that carries the DCI format 1_2 is received in CORESET(s) associated/configured/specific to/with the same value of coresetPoolIndex. In addition to the specified/described design examples herein, the UE could be indicated/configured/provided by the network, e.g., via higher layer RRC signaling(s)/parameter(s) and/or MAC CE command(s) and/or dynamic DCI based L1 signaling(s), which S out of the total TCI codepoints activated by the (unified) TCI state(s) activation MAC CE command as specified herein could be applied to the DCI field ‘Transmission Configuration Indication’ of/for the DCI format 1_2. For example, the UE could be indicated/configured/provided by the network, e.g., via higher layer RRC signaling(s)/parameter(s) and/or MAC CE command(s)—e.g., the (unified) TCI state(s) activation MAC CE command as specified herein in the present disclosure—and/or dynamic DCI based L1 signaling(s), a bitmap with each entry/bit position of the bitmap corresponding/associated to a TCI codepoint activated by/in the (unified) TCI state(s) activation MAC CE command; in this case, when/if an entry/bit position of the bitmap is set to ‘1’ (or ‘0’), the activated TCI codepoint corresponding/associated to the entry/bit position could belong to the S activated TCI codepoints as specified herein in the present disclosure. For another example, each of the TCI codepoints activated by/in the (unified) TCI state(s) activation MAC CE command could be associated with/to an indicator; in this case, when/if an indicator is set to ‘1’ (or ‘0’), the activated TCI codepoint corresponding/associated to the indicator could belong to the S activated TCI codepoints as specified herein in the present disclosure.

Alternatively or optionally, when/if a UE is provided/configured with dl-OrJointTCI-StateList and/or ul-TCI-StateList, and/or when/if the UE receives a (unified) TCI state(s) activation MAC CE command—e.g., a first (unified) TCI state(s) activation MAC CE command or a second (unified) TCI state(s) activation MAC CE command or a third (unified) TCI state(s) activation MAC CE command or a fourth (unified) TCI state(s) activation MAC CE command as specified herein in the present disclosure, and/or when/if the DCI field ‘Transmission Configuration Indication’ is present in DCI format 1_2, the UE may not expect or may not be expected that the number of codepoints S in the DCI field ‘Transmission Configuration Indication’ of the DCI format 1_2 is smaller than the number of TCI codepoints that are activated by the (unified) TCI state(s) activation MAC CE command—e.g., a first (unified) TCI state(s) activation MAC CE command or a second (unified) TCI state(s) activation MAC CE command or a third (unified) TCI state(s) activation MAC CE command or a fourth (unified) TCI state(s) activation MAC CE command as specified herein in the present disclosure. That is, when/if a UE is provided/configured with dl-OrJointTCI-StateList and/or ul-TCI-StateList, and/or when/if the UE receives a (unified) TCI state(s) activation MAC CE command—e.g., a first (unified) TCI state(s) activation MAC CE command or a second (unified) TCI state(s) activation MAC CE command or a third (unified) TCI state(s) activation MAC CE command or a fourth (unified) TCI state(s) activation MAC CE command as specified herein in the present disclosure, and/or when/if the DCI field ‘Transmission Configuration Indication’ is present in DCI format 1_2 (i.e., higher layer parameter tci-PresentDCI-1-2 is configured/provided), and/or when/if the number of bits of the ‘Transmission Configuration Indication’ field in the DCI format 1_2 determined by higher layer parameter tci-PresetnDCI-1-2 is x (i.e., x-bit, where x could be 1 or 2 or 3), the UE may not expect or may not be expected that 2^{x} is smaller than the number of TCI codepoints that are activated by the (unified) TCI state(s) activation MAC CE command—e.g., a first (unified) TCI state(s) activation MAC CE command or a second (unified) TCI state(s) activation MAC CE command or a third (unified) TCI state(s) activation MAC CE command or a fourth (unified) TCI state(s) activation MAC CE command as specified herein in the present disclosure.

Or, when/if a UE is provided/configured with dl-OrJointTCI-StateList and/or ul-TCI-StateList, and/or when/if the UE receives a (unified) TCI state(s) activation MAC CE command—e.g., a first (unified) TCI state(s) activation MAC CE command or a second (unified) TCI state(s) activation MAC CE command or a third (unified) TCI state(s) activation MAC CE command or a fourth (unified) TCI state(s) activation MAC CE command as specified herein in the present disclosure, and/or when/if the DCI field ‘Transmission Configuration Indication’ is present in DCI format 1_2, the UE could expect or could be expected that the number of codepoints S in the DCI field ‘Transmission Configuration Indication’ of the DCI format 1_2 is greater than or equal to the number of TCI codepoints that are activated by the (unified) TCI state(s) activation MAC CE command—e.g., a first (unified) TCI state(s) activation MAC CE command or a second (unified) TCI state(s) activation MAC CE command or a third (unified) TCI state(s) activation MAC CE command or a fourth (unified) TCI state(s) activation MAC CE command as specified herein in the present disclosure. That is, when/if a UE is provided/configured with dl-OrJointTCI-StateList and/or ul-TCI-StateList, and/or when/if the UE receives a (unified) TCI state(s) activation MAC CE command—e.g., a first (unified) TCI state(s) activation MAC CE command or a second (unified) TCI state(s) activation MAC CE command or a third (unified) TCI state(s) activation MAC CE command or a fourth (unified) TCI state(s) activation MAC CE command as specified herein in the present disclosure, and/or when/if the DCI field ‘Transmission Configuration Indication’ is present in DCI format 1_2 (i.e., higher layer parameter tci-PresentDCI-1-2 is configured/provided), and/or when/if the number of bits of the ‘Transmission Configuration Indication’ field in the DCI format 1_2 determined by higher layer parameter tci-PresetnDCI-1-2 is x (i.e., x-bit, where x could be 1 or 2 or 3), the UE could expect or could be expected that 2× is greater than or equal to the number of TCI codepoints that are activated by the (unified) TCI state(s) activation MAC CE command—e.g., a first (unified) TCI state(s) activation MAC CE command or a second (unified) TCI state(s) activation MAC CE command or a third (unified) TCI state(s) activation MAC CE command or a fourth (unified) TCI state(s) activation MAC CE command as specified herein in the present disclosure.

Furthermore, the S TCI codepoints—e.g., activated by/in the (unified) TCI state(s) activation MAC CE command specific to a value of coresetPoolIndex (e.g., 1) when/if the UE is provided in PDCCH-Config two values of coresetPoolIndex in ControlResourceSet—applied to the DCI format 1_2 could be comprised of at least one TCI codepoint comprised of/mapped to a DL TCI state or a TCI state for DL channel(s)/signal(s), or equivalently, the UE may not expect or may not be expected that the S TCI codepoints—e.g., activated by/in the (unified) TCI state(s) activation MAC CE command specific to a value of coresetPoolIndex (e.g., 1) when/if the UE is provided in PDCCH-Config two values of coresetPoolIndex in ControlResourceSet—applied to the DCI format 1_2 are comprise of or are mapped to only UL TCI state(s) or TCI state(s) for UL channel(s)/signal(s). When/if the UE is provided only ul-TCI-StateList (i.e., the UE is not provided dl-OrJointTCI-StateList), the UE could expect or could be expected that the S TCI codepoints—e.g., activated by/in the (unified) TCI state(s) activation MAC CE command specific to a value of coresetPoolIndex (e.g., 1) when/if the UE is provided in PDCCH-Config two values of coresetPoolIndex in ControlResourceSet—applied to the DCI format 1_2 are comprise of or are mapped to only UL TCI state(s) or TCI state(s) for UL channel(s)/signal(s). The described/specified design examples herein/procedures could be applied when one or more of the following conditions are held/satisfied/achieved:
After a UE receives an initial higher layer configuration of one or more or more than one TCI state(s) for DL channel(s)/signal(s), and before application of an indicated TCI state specific to a value of coresetPoolIndex (e.g., 1) from the configured TCI states to DL channel(s)/signal(s) specific to the same value of coresetPoolIndex (e.g., 1)
After a UE receives an initial higher layer configuration of one or more or more than one TCI state(s) for DL channels/signals and/or UL channels/signals, and before application of an indicated TCI state specific to a value of coresetPoolIndex (e.g., 1) from the configured TCI states to DL and/or UL channel(s)/signal(s) specific to the same value of coresetPoolIndex (e.g., 1)
After a UE receives a higher layer configuration of one or more or more than one TCI state(s) for DL channel(s)/signal(s) as part of a Reconfiguration with sync procedure, and before application of an indicated TCI state specific to a value of coresetPoolIndex (e.g., 1) from the configured TCI states to DL channel(s)/signal(s) specific to the same value of coresetPoolIndex (e.g., 1)
After a UE receives a higher layer configuration of one or more or more than one TCI state(s) for DL channels/signals and/or UL channels/signals as part of Reconfiguration with sync procedure, and before application of an indicated TCI state specific to a value of coresetPoolIndex (e.g., 1) from the configured TCI states to DL and/or UL channel(s)/signal(s) specific to the same value of coresetPoolIndex (e.g., 1)
After a UE receives an initial higher layer configuration (e.g., in PDCCH-Config) of two values of coresetPoolIndex (i.e., 0 and 1) in ControlResourceSet, or a single value of coresetPoolIndex (e.g., 1) in ControlResourceSet
After a UE receives a higher layer configuration (e.g., in PDCCH-Config) of two values of coresetPoolIndex (i.e., 0 and 1) in ControlResourceSet, or a single value of coresetPoolIndex (e.g., 1) in ControlResourceSet, as part of a Reconfiguration with sync procedure

In one embodiment, when/if a UE is provided/configured with dl-OrJointTCI-StateList and/or ul-TCI-StateList, and/or when/if the UE is having one or two indicated TCI state(s) and/or pair(s) of TCI states, and/or when/if the UE is having first and/or second indicated TCI states, and/or when/if the UE receives from the network (e.g., the network 130) a first (unified) TCI state(s) activation MAC CE command as specified herein in the present disclosure, and/or when/if the TCI state(s)/TCI codepoint(s) activated by/in the first (unified) TCI state(s) activation MAC CE command has become applicable, and/or when/if the UE is applying one or more TCI states activated by/in the first (unified) TCI state(s) activation MAC CE command for DL and/or UL channels/signals (e.g., (i) the one or more TCI states could correspond to or could be mapped to the single TCI codepoint activated by/in the first (unified) TCI state(s) activation MAC CE command, and/or (ii) the one or more TCI states could be indicated/provided by a TCI codepoint of a TCI field in a beam indication DCI—e.g., DCI format 1_1/1_2 with or without DL assignment, and the TCI codepoint is activated by/in the first (unified) TCI state(s) activation MAC CE command),
In one example, the UE could expect or could be expected to receive from the network a second/fourth (unified) TCI state(s) activation MAC CE command as specified herein in the present disclosure. In this case/design example, when/if the DCI field ‘Transmission Configuration Indication’ is present in DCI format 1_2, and/or when/if the number of codepoints S in the DCI field ‘Transmission Configuration Indication’ of the DCI format 1_2 is smaller than the number of TCI codepoints that are activated by the second/fourth (unified) TCI state(s) activation MAC CE command, and/or when/if the S activated TCI codepoints—e.g., out of the total TCI codepoints activated by the second/fourth (unified) TCI state(s) activation MAC CE command as specified herein—that are applied to the DCI field ‘Transmission Configuration Indication’ of/for the DCI format 1_2 are determined according to one or more examples described herein, and/or when/if the TCI state(s)/TCI codepoint(s) activated by/in the second/fourth (unified) TCI state(s) activation MAC CE command has become applicable, and/or when/if one or more TCI states activated by/in the second/fourth (unified) TCI state(s) activation MAC CE command as specified herein in the present disclosure have become applicable and/or applied to the DCI format 1_2 (e.g., (i) the one or more TCI states could correspond to or could be mapped to the single TCI codepoint activated by/in the second/fourth (unified) TCI state(s) activation MAC CE command, and/or (ii) the one or more TCI states could be indicated/provided by a TCI codepoint of a TCI field in a beam indication DCI—e.g., DCI format 1_2 with or without DL assignment, and the TCI codepoint is one of the S TCI codepoints as specified herein activated by/in the second/fourth (unified) TCI state(s) activation MAC CE command),
   For example, regardless of whether the one or more TCI states—indicated by one or more of the S activated TCI codepoints as specified herein applied for the DCI format 1_2—activated by/in the second/fourth (unified) TCI state(s) activation MAC CE command corresponds to first or second TCI state(s), and/or, e.g., when/if the UE is not provided/configured/indicated by the network, the first and/or second and/or third and/or fourth indicator(s) as specified herein in the present disclosure, in/via their respective RRC/DCI signaling(s), the UE could only apply the one or more TCI states—indicated by one or more of the S activated TCI codepoints as specified herein for the DCI format 1_2—activated by/in the second/fourth (unified) TCI state(s) activation MAC CE command as specified herein in the present disclosure for DL and/or UL channels/signals. That is, for this case/design example, the UE may not expect or may not be expected to receive from or be provided/indicated/configured by the network the first indicator as specified herein in the present disclosure for PDCCH reception(s), and/or the second indicator as specified herein in the present disclosure for PDSCH reception(s), and/or the third indicator as specified herein in the present disclosure for PUCCH transmission(s), and/or the fourth indicator as specified herein in the present disclosure for PUSCH transmission(s).
   For another example, when/if the one or more TCI states—indicated by one or more of the S activated TCI codepoints as specified herein applied for the DCI format 1_2—activated by/in the second/fourth (unified) TCI state(s) activation MAC CE command as specified herein in the present disclosure correspond to first TCI state(s),
      In one example, the UE (e.g., the UE 116) could only apply the one or more TCI states—indicated by one or more of the S activated TCI codepoints as specified herein applied for the DCI format 1_2—activated by/in the second/fourth (unified) TCI state(s) activation MAC CE command as specified herein in the present disclosure—as the first TCI state(s)—for DL and/or UL channels/signals. For this case/design example, the UE may not expect or may not be expected to receive from or be provided/indicated/configured by the network the first indicator as specified herein in the present disclosure for PDCCH reception(s), and/or the second indicator as specified herein in the present disclosure for PDSCH reception(s), and/or the third indicator as specified herein in the present disclosure for PUCCH transmission(s), and/or the fourth indicator as specified herein in the present disclosure for PUSCH transmission(s)—e.g., when/if the UE is not provided/configured/indicated by the network, the first and/or second and/or third and/or fourth indicator(s) as specified herein in the present disclosure, in/via their respective RRC/DCI signaling(s). Or, when/if the UE receives from or is provided/indicated/configured by the network the first indicator as specified herein in the present disclosure for PDCCH reception(s), and/or the second indicator as specified herein in the present disclosure for PDSCH reception(s), and/or the third indicator as specified herein in the present disclosure for PUCCH transmission(s), and/or the fourth indicator as specified herein in the present disclosure for PUSCH transmission(s), (1) the UE could ignore/omit/not follow the value(s) of the first and/or second and/or third and/or fourth indicator(s) as specified herein in the present disclosure for the respective/corresponding channel(s)/signal(s), (2) the UE could expect or could be expected that the first and/or second and/or third and/or fourth indicator(s) as specified herein in the present disclosure indicates that none of the indicated TCI state(s) and/or the first TCI state(s) could be used/applied for receiving and/or transmitting the respective/corresponding channel(s)/signal(s), and/or (3) the UE may not expect or may not be expected that the first and/or second and/or third and/or fourth indicator(s) as specified herein in the present disclosure indicates that none of the indicated TCI state(s) and/or the second TCI state(s) and/or both the first and second TCI states could be used/applied for receiving and/or transmitting the respective/corresponding channel(s)/signal(s).
      In another example, the UE could apply at least the one or more TCI states—indicated by one or more of the S activated TCI codepoints as specified herein applied for the DCI format 1_2—activated by/in the second/fourth (unified) TCI state(s) activation MAC CE command as specified herein in the present disclosure for DL and/or UL channels/signals. For this case/design example, e.g., when/if the UE is provided/configured/indicated by the network, the first and/or second and/or third and/or fourth indicator(s) as specified herein in the present disclosure, in/via their respective RRC/DCI signaling(s), the UE could apply the one or more TCI states—indicated by one or more of the S activated TCI codepoints as specified herein applied for the DCI format 1_2—activated by/in the second/fourth (unified) TCI state(s) activation MAC CE command as specified herein in the present disclosure as the first TCI state(s) and the one or more TCI states activated by/in the first (unified) TCI state(s) activation MAC CE command as specified herein in the present disclosure as the second TCI state(s) for DL and/or UL channels/signals.
   For another example, when/if the one or more TCI states—indicated by one or more of the S activated TCI codepoints as specified herein applied for the DCI format 1_2—activated by/in the second/fourth (unified) TCI state(s) activation MAC CE command as specified herein in the present disclosure correspond to second TCI state(s),
      In one example, the UE could only apply the one or more TCI states—indicated by one or more of the S activated TCI codepoints as specified herein applied for the DCI format 1_2—activated by/in the second/fourth (unified) TCI state(s) activation MAC CE command as specified herein in the present disclosure—as the second TCI state(s)—for DL and/or UL channels/signals. For this case/design example, the UE may not expect or may not be expected to receive from or be provided/indicated/configured by the network the first indicator as specified herein in the present disclosure for PDCCH reception(s), and/or the second indicator as specified herein in the present disclosure for PDSCH reception(s), and/or the third indicator as specified herein in the present disclosure for PUCCH transmission(s), and/or the fourth indicator as specified herein in the present disclosure for PUSCH transmission(s)—e.g., when/if the UE is not provided/configured/indicated by the network, the first and/or second and/or third and/or fourth indicator(s) as specified herein in the present disclosure, in/via their respective RRC/DCI signaling(s). Or, when/if the UE receives from or is provided/indicated/configured by the network the first indicator as specified herein in the present disclosure for PDCCH reception(s), and/or the second indicator as specified herein in the present disclosure for PDSCH reception(s), and/or the third indicator as specified herein in the present disclosure for PUCCH transmission(s), and/or the fourth indicator as specified herein in the present disclosure for PUSCH transmission(s), (1) the UE could ignore/omit/not follow the value(s) of the first and/or second and/or third and/or fourth indicator(s) as specified herein in the present disclosure for the respective/corresponding channel(s)/signal(s), (2) the UE could expect or could be expected that the first and/or second and/or third and/or fourth indicator(s) as specified herein in the present disclosure indicates that none of the indicated TCI state(s) and/or the second TCI state(s) could be used/applied for receiving and/or transmitting the respective/corresponding channel(s)/signal(s), and/or (3) the UE may not expect or may not be expected that the first and/or second and/or third and/or fourth indicator(s) as specified herein in the present disclosure indicates that none of the indicated TCI state(s) and/or the first TCI state(s) and/or both the first and second TCI states could be used/applied for receiving and/or transmitting the respective/corresponding channel(s)/signal(s).
      In another example, the UE could apply at least the one or more TCI states—indicated by one or more of the S activated TCI codepoints as specified herein applied for the DCI format 1_2—activated by/in the second/fourth (unified) TCI state(s) activation MAC CE command as specified herein in the present disclosure for DL and/or UL channels/signals. For this case/design example, e.g., when/if the UE is provided/configured/indicated by the network, the first and/or second and/or third and/or fourth indicator(s) as specified herein in the present disclosure, in/via their respective RRC/DCI signaling(s), the UE could apply the one or more TCI states—indicated by one or more of the S activated TCI codepoints as specified herein applied for the DCI format 1_2—activated by/in the second/fourth (unified) TCI state(s) activation MAC CE command as specified herein in the present disclosure as the second TCI state(s) and the one or more TCI states activated by/in the first (unified) TCI state(s) activation MAC CE command as specified herein in the present disclosure as the first TCI state(s) for DL and/or UL channels/signals.
In another example, the UE could expect or could be expected to receive from the network a second/fourth (unified) TCI state(s) activation MAC CE command as specified herein in the present disclosure. In this case/design example, when/if the DCI field ‘Transmission Configuration Indication’ is present in DCI format 1_2, and/or when/if the number of codepoints S in the DCI field ‘Transmission Configuration Indication’ of the DCI format 1_2 is smaller than the number of TCI codepoints that are activated by the second/fourth (unified) TCI state(s) activation MAC CE command, and/or when/if the S activated TCI codepoints—e.g., out of the total TCI codepoints activated by the second/fourth (unified) TCI state(s) activation MAC CE command as specified herein—that are applied to the DCI field ‘Transmission Configuration Indication’ of/for the DCI format 1_2 are determined according to one or more examples described herein, and/or when/if the TCI state(s)/TCI codepoint(s) activated by/in the second/fourth (unified) TCI state(s) activation MAC CE command has become applicable, and/or when/if one or more TCI states activated by/in the second/fourth (unified) TCI state(s) activation MAC CE command as specified herein in the present disclosure have become applicable and/or applied to the DCI format 1_2 (e.g., (i) the one or more TCI states could correspond to or could be mapped to the single TCI codepoint activated by/in the second/fourth (unified) TCI state(s) activation MAC CE command, and/or (ii) the one or more TCI states could be indicated/provided by a TCI codepoint of a TCI field in a beam indication DCI—e.g., DCI format 1_2 with or without DL assignment, and the TCI codepoint is one of the S TCI codepoints as specified herein activated by/in the second/fourth (unified) TCI state(s) activation MAC CE command),
   For example, when/if the one or more TCI states—indicated by one or more of the S activated TCI codepoints as specified herein applied for the DCI format 1_2—activated by/in the second/fourth (unified) TCI state(s) activation MAC CE command as specified herein in the present disclosure correspond to first TCI state(s),
      In one example, the UE could only apply the one or more TCI states—indicated by one or more of the S activated TCI codepoints as specified herein applied for the DCI format 1_2—activated by/in the second/fourth (unified) TCI state(s) activation MAC CE command as specified herein in the present disclosure—as the first TCI state(s)—for DL and/or UL channels/signals. For this case/design example, the UE may not expect or may not be expected to receive from or be provided/indicated/configured by the network the first indicator as specified herein in the present disclosure for PDCCH reception(s), and/or the second indicator as specified herein in the present disclosure for PDSCH reception(s), and/or the third indicator as specified herein in the present disclosure for PUCCH transmission(s), and/or the fourth indicator as specified herein in the present disclosure for PUSCH transmission(s)—e.g., when/if the UE is not provided/configured/indicated by the network, the first and/or second and/or third and/or fourth indicator(s) as specified herein in the present disclosure, in/via their respective RRC/DCI signaling(s). Or, when/if the UE receives from or is provided/indicated/configured by the network the first indicator as specified herein in the present disclosure for PDCCH reception(s), and/or the second indicator as specified herein in the present disclosure for PDSCH reception(s), and/or the third indicator as specified herein in the present disclosure for PUCCH transmission(s), and/or the fourth indicator as specified herein in the present disclosure for PUSCH transmission(s), (1) the UE could ignore/omit/not follow the value(s) of the first and/or second and/or third and/or fourth indicator(s) as specified herein in the present disclosure for the respective/corresponding channel(s)/signal(s), (2) the UE could expect or could be expected that the first and/or second and/or third and/or fourth indicator(s) as specified herein in the present disclosure indicates that none of the indicated TCI state(s) and/or the first TCI state(s) could be used/applied for receiving and/or transmitting the respective/corresponding channel(s)/signal(s), and/or (3) the UE may not expect or may not be expected that the first and/or second and/or third and/or fourth indicator(s) as specified herein in the present disclosure indicates that none of the indicated TCI state(s) and/or the second TCI state(s) and/or both the first and second TCI states could be used/applied for receiving and/or transmitting the respective/corresponding channel(s)/signal(s).
      In another example, the UE could apply at least the one or more TCI states—indicated by one or more of the S activated TCI codepoints as specified herein applied for the DCI format 1_2—activated by/in the second/fourth (unified) TCI state(s) activation MAC CE command as specified herein in the present disclosure for DL and/or UL channels/signals. For this case/design example, e.g., when/if the UE is provided/configured/indicated by the network, the first and/or second and/or third and/or fourth indicator(s) as specified herein in the present disclosure, in/via their respective RRC/DCI signaling(s), the UE could apply the one or more TCI states—indicated by one or more of the S activated TCI codepoints as specified herein applied for the DCI format 1_2—activated by/in the second/fourth (unified) TCI state(s) activation MAC CE command as specified herein in the present disclosure as the first TCI state(s) and/or the one or more TCI states activated by/in the first (unified) TCI state(s) activation MAC CE command as specified herein in the present disclosure as the second TCI state(s) for DL and/or UL channels/signals.
   For another example, when/if the one or more TCI states—indicated by one or more of the S activated TCI codepoints as specified herein applied for the DCI format 1_2—activated by/in the second/fourth (unified) TCI state(s) activation MAC CE command as specified herein in the present disclosure correspond to second TCI state(s),
      In one example, the UE could only apply the one or more TCI states—indicated by one or more of the S activated TCI codepoints as specified herein applied for the DCI format 1_2—activated by/in the second/fourth (unified) TCI state(s) activation MAC CE command as specified herein in the present disclosure—as the second TCI state(s)—for DL and/or UL channels/signals. For this case/design example, the UE may not expect or may not be expected to receive from or be provided/indicated/configured by the network the first indicator as specified herein in the present disclosure for PDCCH reception(s), and/or the second indicator as specified herein in the present disclosure for PDSCH reception(s), and/or the third indicator as specified herein in the present disclosure for PUCCH transmission(s), and/or the fourth indicator as specified herein in the present disclosure for PUSCH transmission(s)—e.g., when/if the UE is not provided/configured/indicated by the network, the first and/or second and/or third and/or fourth indicator(s) as specified herein in the present disclosure, in/via their respective RRC/DCI signaling(s). Or, when/if the UE receives from or is provided/indicated/configured by the network the first indicator as specified herein in the present disclosure for PDCCH reception(s), and/or the second indicator as specified herein in the present disclosure for PDSCH reception(s), and/or the third indicator as specified herein in the present disclosure for PUCCH transmission(s), and/or the fourth indicator as specified herein in the present disclosure for PUSCH transmission(s), (1) the UE could ignore/omit/not follow the value(s) of the first and/or second and/or third and/or fourth indicator(s) as specified herein in the present disclosure for the respective/corresponding channel(s)/signal(s), (2) the UE could expect or could be expected that the first and/or second and/or third and/or fourth indicator(s) as specified herein in the present disclosure indicates that none of the indicated TCI state(s) and/or the second TCI state(s) could be used/applied for receiving and/or transmitting the respective/corresponding channel(s)/signal(s), and/or (3) the UE may not expect or may not be expected that the first and/or second and/or third and/or fourth indicator(s) as specified herein in the present disclosure indicates that none of the indicated TCI state(s) and/or the first TCI state(s) and/or both the first and second TCI states could be used/applied for receiving and/or transmitting the respective/corresponding channel(s)/signal(s).
      In another example, the UE could apply at least the one or more TCI states—indicated by one or more of the S activated TCI codepoints as specified herein applied for the DCI format 1_2—activated by/in the second/fourth (unified) TCI state(s) activation MAC CE command as specified herein in the present disclosure for DL and/or UL channels/signals. For this case/design example, e.g., when/if the UE is provided/configured/indicated by the network, the first and/or second and/or third and/or fourth indicator(s) as specified herein in the present disclosure, in/via their respective RRC/DCI signaling(s), the UE could apply the one or more TCI states—indicated by one or more of the S activated TCI codepoints as specified herein applied for the DCI format 1_2—activated by/in the second/fourth (unified) TCI state(s) activation MAC CE command as specified herein in the present disclosure as the second TCI state(s) and/or the one or more TCI states activated by/in the first (unified) TCI state(s) activation MAC CE command as specified herein in the present disclosure as the first TCI state(s) for DL and/or UL channels/signals.
   For another example, when/if the one or more TCI states—indicated by one or more of the S activated TCI codepoints as specified herein applied for the DCI format 1_2—activated by/in the second/fourth (unified) TCI state(s) activation MAC CE command as specified herein in the present disclosure correspond to both first and second TCI states,
      In one example, the UE could only apply one or more of the one or more TCI states—indicated by one or more of the S activated TCI codepoints as specified herein applied for the DCI format 1_2—activated by/in the second/fourth (unified) TCI state(s) activation MAC CE command that correspond(s) to the first TCI state(s) as specified herein in the present disclosure for DL and/or UL channels/signals, according to/based on/following those discussed/specified herein in the present disclosure—e.g., according to one or more examples described herein.
      In another example, the UE could only apply one or more of the one or more TCI states—indicated by one or more of the S activated TCI codepoints as specified herein applied for the DCI format 1_2—activated by/in the second/fourth (unified) TCI state(s) activation MAC CE command that correspond(s) to the second TCI state(s) as specified herein in the present disclosure for DL and/or UL channels/signals, according to/based on/following those discussed/specified herein in the present disclosure—e.g., according to one or more examples described herein.
      In another example, the UE could apply one or more of the one or more TCI states—indicated by one or more of the S activated TCI codepoints as specified herein applied for the DCI format 1_2—activated by/in the second/fourth (unified) TCI state(s) activation MAC CE command that correspond(s) to the first TCI state(s) as specified herein in the present disclosure as the first TCI state(s) and/or the one or more TCI states activated by/in the first (unified) TCI state(s) activation MAC CE command as the second TCI state(s) as specified herein in the present disclosure for DL and/or UL channels/signals, according to/based on/following those discussed/specified herein in the present disclosure—e.g., according to one or more examples described herein.
      In another example, the UE could apply one or more of the one or more TCI states—indicated by one or more of the S activated TCI codepoints as specified herein applied for the DCI format 1_2—activated by/in the second/fourth (unified) TCI state(s) activation MAC CE command that correspond(s) to the second TCI state(s) as specified herein in the present disclosure as the second TCI state(s) and/or the one or more TCI states activated by/in the first (unified) TCI state(s) activation MAC CE command as the first TCI state(s) as specified herein in the present disclosure for DL and/or UL channels/signals, according to/based on/following those discussed/specified herein in the present disclosure—e.g., according to one or more examples described herein.
      In another example, the UE could apply one or more of the one or more TCI states—indicated by one or more of the S activated TCI codepoints as specified herein applied for the DCI format 1_2 activated by/in the second/fourth (unified) TCI state(s) activation MAC CE command that correspond(s) to the first TCI state(s) as specified herein in the present disclosure as the first TCI state(s) and/or one or more of the one or more TCI states—indicated by one or more of the S activated TCI codepoints as specified herein applied for the DCI format 1_2—activated by/in the second/fourth (unified) TCI state(s) activation MAC CE command that correspond(s) to the second TCI state(s) as specified herein in the present disclosure as the second TCI state(s) for DL and/or UL channels/signals, according to/based on/following those discussed/specified herein in the present disclosure—e.g., according to one or more examples described herein.

The UE could follow one or more of the described/specified design examples herein to determine which of the indicated TCI state(s) to use/apply according to/based on: (1) fixed rule(s)/value(s) in the system specification(s), (2) network's configuration(s)/indication(s), e.g., via higher layer RRC signaling(s)/parameter(s) and/or MAC CE command(s) and/or dynamic DCI based L1 signaling(s) and/or dynamic DCI based L1 signaling(s), and/or (3) UE's autonomous determination/selection, which could be further sent to the network, e.g., via/in part of a/the CSI/beam report and/or UE's capability signaling(s).
In another example, the UE could expect or could be expected to receive from the network (e.g., the network 130) a second/fourth (unified) TCI state(s) activation MAC CE command as specified herein in the present disclosure. In this case/design example, when/if the DCI field ‘Transmission Configuration Indication’ is present in DCI format 1_2, and/or when/if the number of codepoints S in the DCI field ‘Transmission Configuration Indication’ of the DCI format 1_2 is smaller than the number of TCI codepoints that are activated by the second/fourth (unified) TCI state(s) activation MAC CE command, and/or when/if the S activated TCI codepoints—e.g., out of the total TCI codepoints activated by the second/fourth (unified) TCI state(s) activation MAC CE command as specified herein—that are applied to the DCI field ‘Transmission Configuration Indication’ of/for the DCI format 1_2 are determined according to one or more examples described herein, and/or when/if the TCI state(s)/TCI codepoint(s) activated by/in the second/fourth (unified) TCI state(s) activation MAC CE command has become applicable, and/or when/if one or more TCI states activated by/in the second/fourth (unified) TCI state(s) activation MAC CE command as specified herein in the present disclosure have become applicable and/or applied to the DCI format 1_2 (e.g., (i) the one or more TCI states could correspond to or could be mapped to the single TCI codepoint activated by/in the second/fourth (unified) TCI state(s) activation MAC CE command, and/or (ii) the one or more TCI states could be indicated/provided by a TCI codepoint of a TCI field in a beam indication DCI—e.g., DCI format 1_2 with or without DL assignment, and the TCI codepoint is one of the S TCI codepoints as specified herein activated by/in the second/fourth (unified) TCI state(s) activation MAC CE command), the UE could expect or could be expected that the one or more TCI states—indicated by one or more of the S activated TCI codepoints as specified herein applied for the DCI format 1_2—activated by/in the second/fourth (unified) TCI state(s) activation MAC CE command correspond to both first and second TCI states, wherein (i) the one or more TCI states could correspond to or could be mapped to the single TCI codepoint that is comprised of both first and second TCI states activated by/in the second/fourth (unified) TCI state(s) activation MAC CE command, and/or (ii) the one or more TCI states could be indicated/provided by a TCI codepoint that is comprised of both first and second TCI states of a TCI field in a beam indication DCI—e.g., DCI format 1_2 with or without DL assignment, and the TCI codepoint is one of the S TCI codepoints as specified herein activated by/in the second/fourth (unified) TCI state(s) activation MAC CE command (i.e., the UE could only expect or could only be expected that a TCI codepoint that is one of the S TCI codepoints as specified herein activated by/in the second/fourth (unified) TCI state(s) activation MAC CE command and comprised of both first and second TCI states is indicated/provided by the TCI field in the beam indication DCI format 1_2). Or equivalently, the UE may not expect or may not be expected the one or more TCI states—indicated by one or more of the S activated TCI codepoints as specified herein applied for the DCI format 1_2—activated by/in the second/fourth (unified) TCI state(s) activation MAC CE command to be comprised of a single TCI state/pair of TCI states—i.e., either first or second TCI state(s) as specified herein in the present disclosure. For this case/design example,
   In one example, the UE (e.g., the UE 116) could only apply one or more of the one or more TCI states—indicated by one or more of the S activated TCI codepoints as specified herein applied for the DCI format 1_2—activated by/in the second/fourth (unified) TCI state(s) activation MAC CE command that correspond(s) to the first TCI state(s) as specified herein in the present disclosure for DL and/or UL channels/signals, according to/based on/following those discussed/specified herein in the present disclosure—e.g., according to one or more examples described herein.
   In another example, the UE could only apply one or more of the one or more TCI states—indicated by one or more of the S activated TCI codepoints as specified herein applied for the DCI format 1_2—activated by/in the second/fourth (unified) TCI state(s) activation MAC CE command that correspond(s) to the second TCI state(s) as specified herein in the present disclosure for DL and/or UL channels/signals, according to/based on/following those discussed/specified herein in the present disclosure—e.g., according to one or more examples described herein.
   In another example, the UE could apply one or more of the one or more TCI states—indicated by one or more of the S activated TCI codepoints as specified herein applied for the DCI format 1_2—activated by/in the second/fourth (unified) TCI state(s) activation MAC CE command that correspond(s) to the first TCI state(s) as specified herein in the present disclosure as the first TCI state(s) and/or the one or more TCI states activated by/in the first (unified) TCI state(s) activation MAC CE command as the second TCI state(s) as specified herein in the present disclosure for DL and/or UL channels/signals, according to/based on/following those discussed/specified herein in the present disclosure—e.g., according to one or more examples described herein.
   In another example, the UE could apply one or more of the one or more TCI states—indicated by one or more of the S activated TCI codepoints as specified herein applied for the DCI format 1_2—activated by/in the second/fourth (unified) TCI state(s) activation MAC CE command that correspond(s) to the second TCI state(s) as specified herein in the present disclosure as the second TCI state(s) and/or the one or more TCI states activated by/in the first (unified) TCI state(s) activation MAC CE command as the first TCI state(s) as specified herein in the present disclosure for DL and/or UL channels/signals, according to/based on/following those discussed/specified herein in the present disclosure—e.g., according to one or more examples described herein.
   In another example, the UE could apply one or more of the one or more TCI states—indicated by one or more of the S activated TCI codepoints as specified herein applied for the DCI format 1_2—activated by/in the second/fourth (unified) TCI state(s) activation MAC CE command that correspond(s) to the first TCI state(s) as specified herein in the present disclosure as the first TCI state(s) and one or more of the one or more TCI states—indicated by one or more of the S activated TCI codepoints as specified herein applied for the DCI format 1_2—activated by/in the second/fourth (unified) TCI state(s) activation MAC CE command that correspond(s) to the second TCI state(s) as specified herein in the present disclosure as the second TCI state(s) for DL and/or UL channels/signals, according to/based on/following those discussed/specified herein in the present disclosure—e.g., according to one or more examples described herein.

In one embodiment, when/if a UE is provided/configured with dl-OrJointTCI-StateList and/or ul-TCI-StateList, and/or when/if the UE is having one or two indicated TCI state(s) and/or pair(s) of TCI states, and/or when/if the UE is having first and/or second indicated TCI states, and/or when/if the UE receives from the network a second/fourth (unified) TCI state(s) activation MAC CE command as specified herein in the present disclosure, for one or more of the following conditions (i.e., when/if one or more of the following conditions hold or are satisfied/achieved):
Condition(s) A: when/if the TCI state(s)/TCI codepoint(s) activated by/in the second/fourth (unified) TCI state(s) activation MAC CE command has become applicable, and/or when/if the UE is applying one or more TCI states activated by/in the second/fourth (unified) TCI state(s) activation MAC CE command for DL and/or UL channels/signals (e.g., (i) the one or more TCI states could correspond to or could be mapped to the single TCI codepoint activated by/in the second/fourth (unified) TCI state(s) activation MAC CE command, and/or (ii) the one or more TCI states could be indicated/provided by a TCI codepoint of a TCI field in a beam indication DCI—e.g., DCI format 1_1/1_2 with or without DL assignment, and the TCI codepoint is activated by/in the second/fourth (unified) TCI state(s) activation MAC CE command), wherein the one or more TCI states activated by/in the second/fourth (unified) TCI state(s) activation MAC CE command could also be referred to as first TCI state(s) and/or second TCI state(s) activated by/in the second/fourth (unified) TCI state(s) activation MAC CE command (e.g., (i) the first and/or second TCI state(s) as specified herein could correspond to or could be mapped to the single TCI codepoint activated by/in the second/fourth (unified) TCI state(s) activation MAC CE command, and/or (ii) the first and/or second TCI state(s) as specified herein could be indicated/provided by a TCI codepoint of a TCI field in a beam indication DCI—e.g., DCI format 1_1/1_2 with or without DL assignment, and the TCI codepoint is activated by/in the second/fourth (unified) TCI state(s) activation MAC CE command),
Condition(s) B: when/if the DCI field ‘Transmission Configuration Indication’ is present in DCI format 1_2, and/or when/if the number of codepoints S in the DCI field ‘Transmission Configuration Indication’ of the DCI format 1_2 is smaller than the number of TCI codepoints that are activated by the second/fourth (unified) TCI state(s) activation MAC CE command, and/or when/if the S activated TCI codepoints—e.g., out of the total TCI codepoints activated by the second/fourth (unified) TCI state(s) activation MAC CE command as specified herein—that are applied to the DCI field ‘Transmission Configuration Indication’ of/for the DCI format 1_2 are determined according to one or more examples described herein, and/or when/if the TCI state(s)/TCI codepoint(s) activated by/in the second/fourth (unified) TCI state(s) activation MAC CE command has become applicable, and/or when/if one or more TCI states activated by/in the second/fourth (unified) TCI state(s) activation MAC CE command as specified herein in the present disclosure have become applicable and/or applied to the DCI format 1_2 (e.g., (i) the one or more TCI states could correspond to or could be mapped to the single TCI codepoint activated by/in the second/fourth (unified) TCI state(s) activation MAC CE command, and/or (ii) the one or more TCI states could be indicated/provided by a TCI codepoint of a TCI field in a beam indication DCI—e.g., DCI format 1_2 with or without DL assignment, and the TCI codepoint is one of the S TCI codepoints as specified herein activated by/in the second/fourth (unified) TCI state(s) activation MAC CE command), the corresponding UE's behaviors/operations are specified as follows.
In one example, the UE may not expect or may not be expected to receive from the network any first (unified) TCI state(s) activation MAC CE command(s) as specified herein in the present disclosure.
In another example, the UE could expect or could be expected to receive from the network a first (unified) TCI state(s) activation MAC CE command as specified herein in the present disclosure. In this case/design example, when/if the TCI state(s)/TCI codepoint(s) activated by/in the first (unified) TCI state(s) activation MAC CE command has become applicable, and/or when/if one or more TCI states activated by/in the first (unified) TCI state(s) activation MAC CE command as specified herein in the present disclosure have become applicable (e.g., (i) the one or more TCI states could correspond to or could be mapped to the single TCI codepoint activated by/in the first (unified) TCI state(s) activation MAC CE command, and/or (ii) the one or more TCI states could be indicated/provided by a TCI codepoint of a TCI field in a beam indication DCI—e.g., DCI format 1_1/1_2 with or without DL assignment, and the TCI codepoint is activated by/in the first (unified) TCI state(s) activation MAC CE command), the UE could only apply the one or more TCI states activated by/in the first (unified) TCI state(s) activation MAC CE command as specified herein in the present disclosure for DL and/or UL channels/signals.
In another example, the UE may not expect or may not be expected to receive from the network any third (unified) TCI state(s) activation MAC CE command(s) as specified herein in the present disclosure.
In another example, the UE could expect or could be expected to receive from the network a third (unified) TCI state(s) activation MAC CE command as specified herein in the present disclosure. In this case/design example, when/if the TCI state(s)/TCI codepoint(s) activated by/in the third (unified) TCI state(s) activation MAC CE command has become applicable, and/or when/if one or more TCI states activated by/in the third (unified) TCI state(s) activation MAC CE command as specified herein in the present disclosure have become applicable (e.g., (i) the one or more TCI states could correspond to or could be mapped to the single TCI codepoint activated by/in the third (unified) TCI state(s) activation MAC CE command, and/or (ii) the one or more TCI states could be indicated/provided by a TCI codepoint of a TCI field in a beam indication DCI—e.g., DCI format 1_1/1_2 with or without DL assignment, and the TCI codepoint is activated by/in the third (unified) TCI state(s) activation MAC CE command),
   For example, e.g., when/if the UE is not provided/configured/indicated by the network, the first and/or second and/or third and/or fourth indicator(s) as specified herein in the present disclosure, in/via their respective RRC/DCI signaling(s), that is, when/if the UE may not expect or may not be expected to receive from or be provided/indicated/configured by the network the first indicator as specified herein in the present disclosure for PDCCH reception(s), and/or the second indicator as specified herein in the present disclosure for PDSCH reception(s), and/or the third indicator as specified herein in the present disclosure for PUCCH transmission(s), and/or the fourth indicator as specified herein in the present disclosure for PUSCH transmission(s),
      In one example, the UE could only apply the one or more TCI states activated by/in the third (unified) TCI state(s) activation MAC CE command as specified herein in the present disclosure for DL and/or UL channels/signals (i.e., regardless of whether the one or more TCI states activated by/in the third (unified) TCI state(s) activation MAC CE command corresponds to first or second TCI state(s)).
      In another example, when/if the one or more TCI states activated by/in the third (unified) TCI state(s) activation MAC CE command as specified herein in the present disclosure correspond to first TCI state(s), the UE could only apply the one or more TCI states activated by/in the third (unified) TCI state(s) activation MAC CE command as specified herein in the present disclosure—as the first TCI state(s)—for DL and/or UL channels/signals.
      In another example, when/if the one or more TCI states activated by/in the third (unified) TCI state(s) activation MAC CE command as specified herein in the present disclosure correspond to second TCI state(s), the UE could only apply the one or more TCI states activated by/in the third (unified) TCI state(s) activation MAC CE command as specified herein in the present disclosure—as the second TCI state(s)—for DL and/or UL channels/signals.
   For another example, e.g., when/if the UE is provided/configured/indicated by the network, the first and/or second and/or third and/or fourth indicator(s) as specified herein in the present disclosure, in/via their respective RRC/DCI signaling(s)—e.g., when/if the second indicator (or equivalently, the TCI selection field indicator) is RRC configured to be present (e.g., by setting tciSelectionPresentInDCI to ‘enabled’) in the corresponding DCI format(s) 1_1/1_2, that is, when/if the UE could expect or could be expected to receive from or be provided/indicated/configured by the network the first indicator as specified herein in the present disclosure for PDCCH reception(s), and/or the second indicator as specified herein in the present disclosure for PDSCH reception(s), and/or the third indicator as specified herein in the present disclosure for PUCCH transmission(s), and/or the fourth indicator as specified herein in the present disclosure for PUSCH transmission(s), and/or when/if the first and/or second and/or third and/or fourth indicator(s) as specified herein in the present disclosure is set to ‘first’, ‘second’, ‘both’ or ‘none’ in/via their respective RRC/DCI signaling(s), the UE could apply at least the one or more TCI states activated by/in the third (unified) TCI state(s) activation MAC CE command as specified herein in the present disclosure for DL and/or UL channels/signals.
      In one example, when/if the one or more TCI states activated by/in the third (unified) TCI state(s) activation MAC CE command as specified herein in the present disclosure correspond to first TCI state(s), the UE could only apply the one or more TCI states activated by/in the third (unified) TCI state(s) activation MAC CE command as specified herein in the present disclosure—as the first TCI state(s)—for DL and/or UL channels/signals.
      In another example, when/if the one or more TCI states activated by/in the third (unified) TCI state(s) activation MAC CE command as specified herein in the present disclosure correspond to second TCI state(s), the UE could only apply the one or more TCI states activated by/in the third (unified) TCI state(s) activation MAC CE command as specified herein in the present disclosure—as the second TCI state(s)—for DL and/or UL channels/signals.
      In another example, when/if the one or more TCI states activated by/in the third (unified) TCI state(s) activation MAC CE command as specified herein in the present disclosure correspond to first TCI state(s), the UE could apply the one or more TCI states activated by/in the third (unified) TCI state(s) activation MAC CE command as specified herein in the present disclosure as the first TCI states and/or one or more of the one or more TCI states (i) activated by/in the second/fourth (unified) TCI state(s) activation MAC CE command and/or (ii) indicated by one or more of the S activated TCI codepoints as specified herein applied for the DCI format 1_2 activated by/in the second/fourth (unified) TCI state(s) activation MAC CE command that correspond(s) to the second TCI state(s) as specified herein in the present disclosure as the second TCI state(s) for DL and/or UL channels/signals.
      In another example, when/if the one or more TCI states activated by/in the third (unified) TCI state(s) activation MAC CE command as specified herein in the present disclosure correspond to second TCI state(s), the UE could apply the one or more TCI states activated by/in the third (unified) TCI state(s) activation MAC CE command as specified herein in the present disclosure as the second TCI states and/or one or more of the one or more TCI states (i) activated by/in the second/fourth (unified) TCI state(s) activation MAC CE command and/or (ii) indicated by one or more of the S activated TCI codepoints as specified herein applied for the DCI format 1_2 activated by/in the second/fourth (unified) TCI state(s) activation MAC CE command that correspond(s) to the first TCI state(s) as specified herein in the present disclosure as the first TCI state(s) for DL and/or UL channels/signals.
In another example, when/if the DCI field ‘Transmission Configuration Indication’ is present in DCI format 1_2, and/or when/if the number of codepoints S in the DCI field ‘Transmission Configuration Indication’ of the DCI format 1_2 is smaller than the number of TCI codepoints that are activated by another second/fourth (unified) TCI state(s) activation MAC CE command, the UE may not expect or may not be expected the another second/fourth (unified) TCI state(s) activation MAC CE command to have/comprise/indicate/provide/include/contain the S activated TCI codepoints applied to the DCI field ‘Transmission Configuration Indication’ of/for the DCI format 1_2 that are determined according to one or more examples described herein.
In another example, when/if the DCI field ‘Transmission Configuration Indication’ is present in DCI format 1_2, and/or when/if the number of codepoints S in the DCI field ‘Transmission Configuration Indication’ of the DCI format 1_2 is smaller than the number of TCI codepoints that are activated by another second/fourth (unified) TCI state(s) activation MAC CE command, the UE could expect or could be expected the another second/fourth (unified) TCI state(s) activation MAC CE command to have/comprise/indicate/provide/include/contain the S activated TCI codepoints applied to the DCI field ‘Transmission Configuration Indication’ of/for the DCI format 1_2 that are determined according to one or more examples described herein. In this case/design example, when/if the S activated TCI codepoints—e.g., out of the total TCI codepoints activated by the another second/fourth (unified) TCI state(s) activation MAC CE command as specified herein—that are applied to the DCI field ‘Transmission Configuration Indication’ of/for the DCI format 1_2 are determined according to one or more examples described herein, and/or when/if the TCI state(s)/TCI codepoint(s) activated by/in the another second/fourth (unified) TCI state(s) activation MAC CE command has become applicable, and/or when/if one or more TCI states activated by/in the another second/fourth (unified) TCI state(s) activation MAC CE command as specified herein in the present disclosure have become applicable and/or applied to the DCI format 1_2 (e.g., (i) the one or more TCI states could correspond to or could be mapped to the single TCI codepoint activated by/in the another second/fourth (unified) TCI state(s) activation MAC CE command, and/or (ii) the one or more TCI states could be indicated/provided by a TCI codepoint of a TCI field in a beam indication DCI—e.g., DCI format 1_2 with or without DL assignment, and the TCI codepoint is one of the S TCI codepoints as specified herein activated by/in the another second/fourth (unified) TCI state(s) activation MAC CE command),
   For example, e.g., when/if the UE is not provided/configured/indicated by the network, the first and/or second and/or third and/or fourth indicator(s) as specified herein in the present disclosure, in/via their respective RRC/DCI signaling(s), that is, when/if the UE may not expect or may not be expected to receive from or be provided/indicated/configured by the network the first indicator as specified herein in the present disclosure for PDCCH reception(s), and/or the second indicator as specified herein in the present disclosure for PDSCH reception(s), and/or the third indicator as specified herein in the present disclosure for PUCCH transmission(s), and/or the fourth indicator as specified herein in the present disclosure for PUSCH transmission(s),
      In one example, the UE could only apply the one or more TCI states—indicated by one or more of the S activated TCI codepoints as specified herein applied for the DCI format 1_2—activated by/in the another second/fourth (unified) TCI state(s) activation MAC CE command as specified herein in the present disclosure for DL and/or UL channels/signals (i.e., regardless of whether the one or more TCI states—indicated by one or more of the S activated TCI codepoints as specified herein applied for the DCI format 1_2—activated by/in the another second/fourth (unified) TCI state(s) activation MAC CE command corresponds to first or second TCI state(s)).
      In another example, when/if the one or more TCI states—indicated by one or more of the S activated TCI codepoints as specified herein applied for the DCI format 1_2—activated by/in the another second/fourth (unified) TCI state(s) activation MAC CE command as specified herein in the present disclosure correspond to first TCI state(s), the UE could only apply the one or more TCI states—indicated by one or more of the S activated TCI codepoints as specified herein applied for the DCI format 1_2—activated by/in the another second/fourth (unified) TCI state(s) activation MAC CE command as specified herein in the present disclosure—as the first TCI state(s)—for DL and/or UL channels/signals.
      In another example, when/if the one or more TCI states—indicated by one or more of the S activated TCI codepoints as specified herein applied for the DCI format 1_2—activated by/in the another second/fourth (unified) TCI state(s) activation MAC CE command as specified herein in the present disclosure correspond to second TCI state(s), the UE could only apply the one or more TCI states—indicated by one or more of the S activated TCI codepoints as specified herein applied for the DCI format 1_2—activated by/in the another second/fourth (unified) TCI state(s) activation MAC CE command as specified herein in the present disclosure—as the second TCI state(s)—for DL and/or UL channels/signals.
   For another example, e.g., when/if the UE is provided/configured/indicated by the network, the first and/or second and/or third and/or fourth indicator(s) as specified herein in the present disclosure, in/via their respective RRC/DCI signaling(s)—e.g., when/if the second indicator (or equivalently, the TCI selection field indicator) is RRC configured to be present (e.g., by setting tciSelectionPresentInDCI to ‘enabled’) in the corresponding DCI format(s) 1_1/1_2, that is, when/if the UE could expect or could be expected to receive from or be provided/indicated/configured by the network (e.g., the network 130) the first indicator as specified herein in the present disclosure for PDCCH reception(s), and/or the second indicator as specified herein in the present disclosure for PDSCH reception(s), and/or the third indicator as specified herein in the present disclosure for PUCCH transmission(s), and/or the fourth indicator as specified herein in the present disclosure for PUSCH transmission(s), and/or when/if the first and/or second and/or third and/or fourth indicator(s) as specified herein in the present disclosure is set to ‘first’, ‘second’, ‘both’ or ‘none’ in/via their respective RRC/DCI signaling(s), the UE could apply at least the one or more TCI states—indicated by one or more of the S activated TCI codepoints as specified herein applied for the DCI format 1_2—activated by/in the another second/fourth (unified) TCI state(s) activation MAC CE command as specified herein in the present disclosure for DL and/or UL channels/signals.
      In one example, when/if the one or more TCI states—indicated by one or more of the S activated TCI codepoints as specified herein applied for the DCI format 1_2—activated by/in the another second/fourth (unified) TCI state(s) activation MAC CE command as specified herein in the present disclosure correspond to first TCI state(s), the UE could only apply the one or more TCI states—indicated by one or more of the S activated TCI codepoints as specified herein applied for the DCI format 1_2—activated by/in the another second/fourth (unified) TCI state(s) activation MAC CE commands specified herein in the present disclosure—as the first TCI state(s)—for DL and/or UL channels/signals.
      In another example, when/if the one or more TCI states—indicated by one or more of the S activated TCI codepoints as specified herein applied for the DCI format 1_2—activated by/in the another second/fourth (unified) TCI state(s) activation MAC CE command as specified herein in the present disclosure correspond to second TCI state(s), the UE could only apply the one or more TCI states—indicated by one or more of the S activated TCI codepoints as specified herein applied for the DCI format 1_2—activated by/in the another second/fourth (unified) TCI state(s) activation MAC CE command as specified herein in the present disclosure—as the second TCI state(s)—for DL and/or UL channels/signals.
      In another example, when/if the one or more TCI states—indicated by one or more of the S activated TCI codepoints as specified herein applied for the DCI format 1_2—activated by/in the another second/fourth (unified) TCI state(s) activation MAC CE command as specified herein in the present disclosure correspond to first TCI state(s), the UE could apply the one or more TCI states—indicated by one or more of the S activated TCI codepoints as specified herein applied for the DCI format 1_2—activated by/in the another second/fourth (unified) TCI state(s) activation MAC CE command as specified herein in the present disclosure as the first TCI states and/or one or more of the one or more TCI states (i) activated by/in the (previous/prior) second/fourth (unified) TCI state(s) activation MAC CE command and/or (ii) indicated by one or more of the S activated TCI codepoints as specified herein applied for the DCI format 1_2 activated by/in the (previous/prior) second/fourth (unified) TCI state(s) activation MAC CE command that correspond(s) to the second TCI state(s) as specified herein in the present disclosure as the second TCI state(s) for DL and/or UL channels/signals.
      In another example, when/if the one or more TCI states—indicated by one or more of the S activated TCI codepoints as specified herein applied for the DCI format 1_2—activated by/in the another second/fourth (unified) TCI state(s) activation MAC CE command as specified herein in the present disclosure correspond to second TCI state(s), the UE could apply the one or more TCI states—indicated by one or more of the S activated TCI codepoints as specified herein applied for the DCI format 1_2—activated by/in the another second/fourth (unified) TCI state(s) activation MAC CE command as specified herein in the present disclosure as the second TCI states and/or one or more of the one or more TCI states (i) activated by/in the (previous/prior) second/fourth (unified) TCI state(s) activation MAC CE command and/or (ii) indicated by one or more of the S activated TCI codepoints as specified herein applied for the DCI format 1_2 activated by/in the (previous/prior) second/fourth (unified) TCI state(s) activation MAC CE command that correspond(s) to the first TCI state(s) as specified herein in the present disclosure as the first TCI state(s) for DL and/or UL channels/signals.

In one embodiment, when/if a UE (e.g., the UE 116) is provided/configured with dl—OrJointTCI-StateList and/or ul-TCI-StateList, and/or when/if the UE is having one or two indicated TCI state(s) and/or pair(s) of TCI states, and/or when/if the UE is having first and/or second indicated TCI states, for one or more of the following conditions (i.e., when/if one or more of the following conditions hold or are satisfied/achieved):
Condition(s) C: when/if the UE receives from the network a third (unified) TCI state(s) activation MAC CE command as specified herein in the present disclosure, and/or when/if the TCI state(s)/TCI codepoint(s) activated by/in the third (unified) TCI state(s) activation MAC CE command has become applicable, and/or when/if the UE is applying one or more TCI states activated by/in the third (unified) TCI state(s) activation MAC CE command for DL and/or UL channels/signals (e.g., (i) the one or more TCI states could correspond to or could be mapped to the single TCI codepoint activated by/in the third (unified) TCI state(s) activation MAC CE command, and/or (ii) the one or more TCI states could be indicated/provided by a TCI codepoint of a TCI field in a beam indication DCI—e.g., DCI format 1_1/1_2 with or without DL assignment, and the TCI codepoint is activated by/in the third (unified) TCI state(s) activation MAC CE command), and the one or more TCI states could correspond to first TCI state(s) or second TCI state(s) according to those specified herein in the present disclosure,
Condition(s) D: when/if the DCI field ‘Transmission Configuration Indication’ is present in DCI format 1_2, and/or when/if the number of codepoints S in the DCI field ‘Transmission Configuration Indication’ of the DCI format 1_2 is smaller than the number of TCI codepoints that are activated by the second/fourth (unified) TCI state(s) activation MAC CE command, and/or when/if the S activated TCI codepoints—e.g., out of the total TCI codepoints activated by the second/fourth (unified) TCI state(s) activation MAC CE command as specified herein—that are applied to the DCI field ‘Transmission Configuration Indication’ of/for the DCI format 1_2 are determined according to one or more examples described herein, and/or when/if the TCI state(s)/TCI codepoint(s) activated by/in the second/fourth (unified) TCI state(s) activation MAC CE command has become applicable, and/or when/if one or more TCI states activated by/in the second/fourth (unified) TCI state(s) activation MAC CE command as specified herein in the present disclosure have become applicable and/or applied to the DCI format 1_2 (e.g., (i) the one or more TCI states could correspond to or could be mapped to the single TCI codepoint activated by/in the second/fourth (unified) TCI state(s) activation MAC CE command, and/or (ii) the one or more TCI states could be indicated/provided by a TCI codepoint of a TCI field in a beam indication DCI—e.g., DCI format 1_2 with or without DL assignment, and the TCI codepoint is one of the S TCI codepoints as specified herein activated by/in the second/fourth (unified) TCI state(s) activation MAC CE command), the corresponding UE's behaviors/operations are specified as follows.
In one example, the UE may not expect or may not be expected to receive from the network any first (unified) TCI state(s) activation MAC CE command(s) as specified herein in the present disclosure.
In another example, the UE could expect or could be expected to receive from the network a first (unified) TCI state(s) activation MAC CE command as specified herein in the present disclosure. In this case/design example, when/if the TCI state(s)/TCI codepoint(s) activated by/in the first (unified) TCI state(s) activation MAC CE command has become applicable, and/or when/if one or more TCI states activated by/in the first (unified) TCI state(s) activation MAC CE command as specified herein in the present disclosure have become applicable (e.g., (i) the one or more TCI states could correspond to or could be mapped to the single TCI codepoint activated by/in the first (unified) TCI state(s) activation MAC CE command, and/or (ii) the one or more TCI states could be indicated/provided by a TCI codepoint of a TCI field in a beam indication DCI—e.g., DCI format 1_1/1_2 with or without DL assignment, and the TCI codepoint is activated by/in the first (unified) TCI state(s) activation MAC CE command), the UE could only apply the one or more TCI states activated by/in the first (unified) TCI state(s) activation MAC CE command as specified herein in the present disclosure for DL and/or UL channels/signals.
In another example, the UE may not expect or may not be expected to receive from the network any third (unified) TCI state(s) activation MAC CE command(s) as specified herein in the present disclosure.
In another example, the UE could expect or could be expected to receive from the network another third (unified) TCI state(s) activation MAC CE command as specified herein in the present disclosure. In this case/design example, when/if the TCI state(s)/TCI codepoint(s) activated by/in the another third (unified) TCI state(s) activation MAC CE command has become applicable, and/or when/if one or more TCI states activated by/in the another third (unified) TCI state(s) activation MAC CE command as specified herein in the present disclosure have become applicable (e.g., (i) the one or more TCI states could correspond to or could be mapped to the single TCI codepoint activated by/in the another third (unified) TCI state(s) activation MAC CE command, and/or (ii) the one or more TCI states could be indicated/provided by a TCI codepoint of a TCI field in a beam indication DCI—e.g., DCI format 1_1/1_2 with or without DL assignment, and the TCI codepoint is activated by/in the another third (unified) TCI state(s) activation MAC CE command),
   For example, e.g., when/if the UE is not provided/configured/indicated by the network, the first and/or second and/or third and/or fourth indicator(s) as specified herein in the present disclosure, in/via their respective RRC/DCI signaling(s), that is, when/if the UE may not expect or may not be expected to receive from or be provided/indicated/configured by the network the first indicator as specified herein in the present disclosure for PDCCH reception(s), and/or the second indicator as specified herein in the present disclosure for PDSCH reception(s), and/or the third indicator as specified herein in the present disclosure for PUCCH transmission(s), and/or the fourth indicator as specified herein in the present disclosure for PUSCH transmission(s),
      In one example, the UE could only apply the one or more TCI states activated by/in the another third (unified) TCI state(s) activation MAC CE command as specified herein in the present disclosure for DL and/or UL channels/signals (i.e., regardless of whether the one or more TCI states activated by/in the another third (unified) TCI state(s) activation MAC CE command corresponds to first or second TCI state(s)).
      In another example, when/if the one or more TCI states activated by/in the another third (unified) TCI state(s) activation MAC CE command as specified herein in the present disclosure correspond to first TCI state(s), the UE could only apply the one or more TCI states activated by/in the another third (unified) TCI state(s) activation MAC CE command as specified herein in the present disclosure—as the first TCI state(s)—for DL and/or UL channels/signals.
      In another example, when/if the one or more TCI states activated by/in the another third (unified) TCI state(s) activation MAC CE command as specified herein in the present disclosure correspond to second TCI state(s), the UE could only apply the one or more TCI states activated by/in the another third (unified) TCI state(s) activation MAC CE command as specified herein in the present disclosure—as the second TCI state(s)—for DL and/or UL channels/signals.
   For another example, e.g., when/if the UE is provided/configured/indicated by the network, the first and/or second and/or third and/or fourth indicator(s) as specified herein in the present disclosure, in/via their respective RRC/DCI signaling(s)—e.g., when/if the second indicator (or equivalently, the TCI selection field indicator) is RRC configured to be present (e.g., by setting tciSelectionPresentInDCI to ‘enabled’) in the corresponding DCI format(s) 1_1/1_2, that is, when/if the UE could expect or could be expected to receive from or be provided/indicated/configured by the network the first indicator as specified herein in the present disclosure for PDCCH reception(s), and/or the second indicator as specified herein in the present disclosure for PDSCH reception(s), and/or the third indicator as specified herein in the present disclosure for PUCCH transmission(s), and/or the fourth indicator as specified herein in the present disclosure for PUSCH transmission(s), and/or when/if the first and/or second and/or third and/or fourth indicator(s) as specified herein in the present disclosure is set to ‘first’, ‘second’, ‘both’ or ‘none’ in/via their respective RRC/DCI signaling(s), the UE could apply at least the one or more TCI states activated by/in the another third (unified) TCI state(s) activation MAC CE command as specified herein in the present disclosure for DL and/or UL channels/signals.
      In one example, when/if the one or more TCI states activated by/in the another third (unified) TCI state(s) activation MAC CE command as specified herein in the present disclosure correspond to first TCI state(s), the UE could only apply the one or more TCI states activated by/in the another third (unified) TCI state(s) activation MAC CE command as specified herein in the present disclosure—as the first TCI state(s)—for DL and/or UL channels/signals.
      In another example, when/if the one or more TCI states activated by/in the another third (unified) TCI state(s) activation MAC CE command as specified herein in the present disclosure correspond to second TCI state(s), the UE could only apply the one or more TCI states activated by/in the another third (unified) TCI state(s) activation MAC CE command as specified herein in the present disclosure—as the second TCI state(s)—for DL and/or UL channels/signals.
      In another example, when/if the one or more TCI states activated by/in the another third (unified) TCI state(s) activation MAC CE command as specified herein in the present disclosure correspond to first TCI state(s), the UE could apply the one or more TCI states activated by/in the another third (unified) TCI state(s) activation MAC CE command as specified herein in the present disclosure as the first TCI states and/or the one or more TCI states (corresponding to either first or second TCI state(s) as specified herein) (i) activated by/in the (previous/prior) third (unified) TCI state(s) activation MAC CE command and/or (ii) indicated by one or more of the S activated TCI codepoints as specified herein applied for the DCI format 1_2 activated by/in the second/fourth (unified) TCI state(s) activation MAC CE command as the second TCI state(s) for DL and/or UL channels/signals.
      In another example, when/if the one or more TCI states activated by/in the another third (unified) TCI state(s) activation MAC CE command as specified herein in the present disclosure correspond to second TCI state(s), the UE could apply the one or more TCI states activated by/in the another third (unified) TCI state(s) activation MAC CE command as specified herein in the present disclosure as the second TCI states and/or the one or more TCI states (corresponding to either first or second TCI state(s) as specified herein) (i) activated by/in the (previous/prior) third (unified) TCI state(s) activation MAC CE command and/or (ii) indicated by one or more of the S activated TCI codepoints as specified herein applied for the DCI format 1_2 activated by/in the second/fourth (unified) TCI state(s) activation MAC CE command as the first TCI state(s) for DL and/or UL channels/signals.
In another example, when/if the DCI field ‘Transmission Configuration Indication’ is present in DCI format 1_2, and/or when/if the number of codepoints S in the DCI field ‘Transmission Configuration Indication’ of the DCI format 1_2 is smaller than the number of TCI codepoints that are activated by another second/fourth (unified) TCI state(s) activation MAC CE command, the UE may not expect or may not be expected the another second/fourth (unified) TCI state(s) activation MAC CE command to have/comprise/indicate/provide/include/contain the S activated TCI codepoints applied to the DCI field ‘Transmission Configuration Indication’ of/for the DCI format 1_2 that are determined according to one or more examples described herein.
In another example, when/if the DCI field ‘Transmission Configuration Indication’ is present in DCI format 1_2, and/or when/if the number of codepoints S in the DCI field ‘Transmission Configuration Indication’ of the DCI format 1_2 is smaller than the number of TCI codepoints that are activated by another second/fourth (unified) TCI state(s) activation MAC CE command, the UE could expect or could be expected the another second/fourth (unified) TCI state(s) activation MAC CE command to have/comprise/indicate/provide/include/contain the S activated TCI codepoints applied to the DCI field ‘Transmission Configuration Indication’ of/for the DCI format 1_2 that are determined according to one or more examples described herein. In this case/design example, when/if the S activated TCI codepoints—e.g., out of the total TCI codepoints activated by the another second/fourth (unified) TCI state(s) activation MAC CE command as specified herein—that are applied to the DCI field ‘Transmission Configuration Indication’ of/for the DCI format 1_2 are determined according to one or more examples described herein, and/or when/if the TCI state(s)/TCI codepoint(s) activated by/in the another second/fourth (unified) TCI state(s) activation MAC CE command has become applicable, and/or when/if one or more TCI states activated by/in the another second/fourth (unified) TCI state(s) activation MAC CE command as specified herein in the present disclosure have become applicable and/or applied to the DCI format 12 (e.g., (i) the one or more TCI states could correspond to or could be mapped to the single TCI codepoint activated by/in the another second/fourth (unified) TCI state(s) activation MAC CE command, and/or (ii) the one or more TCI states could be indicated/provided by a TCI codepoint of a TCI field in a beam indication DCI—e.g., DCI format 1_2 with or without DL assignment, and the TCI codepoint is one of the S TCI codepoints as specified herein activated by/in the another second/fourth (unified) TCI state(s) activation MAC CE command),
   For example, e.g., when/if the UE is not provided/configured/indicated by the network, the first and/or second and/or third and/or fourth indicator(s) as specified herein in the present disclosure, in/via their respective RRC/DCI signaling(s), that is, when/if the UE may not expect or may not be expected to receive from or be provided/indicated/configured by the network the first indicator as specified herein in the present disclosure for PDCCH reception(s), and/or the second indicator as specified herein in the present disclosure for PDSCH reception(s), and/or the third indicator as specified herein in the present disclosure for PUCCH transmission(s), and/or the fourth indicator as specified herein in the present disclosure for PUSCH transmission(s),
      In one example, the UE could only apply the one or more TCI states—indicated by one or more of the S activated TCI codepoints as specified herein applied for the DCI format 1_2—activated by/in the another second/fourth (unified) TCI state(s) activation MAC CE command as specified herein in the present disclosure for DL and/or UL channels/signals (i.e., regardless of whether the one or more TCI states—indicated by one or more of the S activated TCI codepoints as specified herein applied for the DCI format 1_2—activated by/in the another second/fourth (unified) TCI state(s) activation MAC CE command corresponds to first or second TCI state(s)).
      In another example, when/if the one or more TCI states—indicated by one or more of the S activated TCI codepoints as specified herein applied for the DCI format 1_2—activated by/in the another second/fourth (unified) TCI state(s) activation MAC CE command as specified herein in the present disclosure correspond to first TCI state(s), the UE could only apply the one or more TCI states—indicated by one or more of the S activated TCI codepoints as specified herein applied for the DCI format 1_2—activated by/in the another second/fourth (unified) TCI state(s) activation MAC CE command as specified herein in the present disclosure—as the first TCI state(s)—for DL and/or UL channels/signals.
      In another example, when/if the one or more TCI states—indicated by one or more of the S activated TCI codepoints as specified herein applied for the DCI format 1_2—activated by/in the another second/fourth (unified) TCI state(s) activation MAC CE command as specified herein in the present disclosure correspond to second TCI state(s), the UE could only apply the one or more TCI states—indicated by one or more of the S activated TCI codepoints as specified herein applied for the DCI format 1_2—activated by/in the another second/fourth (unified) TCI state(s) activation MAC CE command as specified herein in the present disclosure—as the second TCI state(s)—for DL and/or UL channels/signals.
   For another example, e.g., when/if the UE is provided/configured/indicated by the network, the first and/or second and/or third and/or fourth indicator(s) as specified herein in the present disclosure, in/via their respective RRC/DCI signaling(s)—e.g., when/if the second indicator (or equivalently, the TCI selection field indicator) is RRC configured to be present (e.g., by setting tciSelectionPresentInDCI to ‘enabled’) in the corresponding DCI format(s) 1_1/1_2, that is, when/if the UE could expect or could be expected to receive from or be provided/indicated/configured by the network the first indicator as specified herein in the present disclosure for PDCCH reception(s), and/or the second indicator as specified herein in the present disclosure for PDSCH reception(s), and/or the third indicator as specified herein in the present disclosure for PUCCH transmission(s), and/or the fourth indicator as specified herein in the present disclosure for PUSCH transmission(s), and/or when/if the first and/or second and/or third and/or fourth indicator(s) as specified herein in the present disclosure is set to ‘first’, ‘second’, ‘both’ or ‘none’ in/via their respective RRC/DCI signaling(s), the UE could apply at least the one or more TCI states—indicated by one or more of the S activated TCI codepoints as specified herein applied for the DCI format 1_2—activated by/in the another second/fourth (unified) TCI state(s) activation MAC CE command as specified herein in the present disclosure for DL and/or UL channels/signals.
      In one example, when/if the one or more TCI states—indicated by one or more of the S activated TCI codepoints as specified herein applied for the DCI format 1_2—activated by/in the another second/fourth (unified) TCI state(s) activation MAC CE command as specified herein in the present disclosure correspond to first TCI state(s), the UE could only apply the one or more TCI states—indicated by one or more of the S activated TCI codepoints as specified herein applied for the DCI format 1_2—activated by/in the another second/fourth (unified) TCI state(s) activation MAC CE command as specified herein in the present disclosure—as the first TCI state(s)—for DL and/or UL channels/signals.
      In another example, when/if the one or more TCI states—indicated by one or more of the S activated TCI codepoints as specified herein applied for the DCI format 1_2—activated by/in the another second/fourth (unified) TCI state(s) activation MAC CE command as specified herein in the present disclosure correspond to second TCI state(s), the UE could only apply the one or more TCI states
      indicated by one or more of the S activated TCI codepoints as specified herein applied for the DCI format 1_2—activated by/in the another second/fourth (unified) TCI state(s) activation MAC CE command as specified herein in the present disclosure—as the second TCI state(s)—for DL and/or UL channels/signals.
      In another example, when/if the one or more TCI states—indicated by one or more of the S activated TCI codepoints as specified herein applied for the DCI format 1_2—activated by/in the another second/fourth (unified) TCI state(s) activation MAC CE command as specified herein in the present disclosure correspond to first TCI state(s), the UE could apply the one or more TCI states—indicated by one or more of the S activated TCI codepoints as specified herein applied for the DCI format 1_2—activated by/in the another second/fourth (unified) TCI state(s) activation MAC CE command as specified herein in the present disclosure as the first TCI states and/or the one or more TCI states (corresponding to either first or second TCI state(s) as specified herein) (i) activated by/in the third (unified) TCI state(s) activation MAC CE command and/or (ii) indicated by one or more of the S activated TCI codepoints as specified herein applied for the DCI format 1_2 activated by/in the (previous/prior) second/fourth (unified) TCI state(s) activation MAC CE command as the second TCI state(s) for DL and/or UL channels/signals.
      In another example, when/if the one or more TCI states—indicated by one or more of the S activated TCI codepoints as specified herein applied for the DCI format 1_2—activated by/in the another second/fourth (unified) TCI state(s) activation MAC CE command as specified herein in the present disclosure correspond to second TCI state(s), the UE could apply the one or more TCI states—indicated by one or more of the S activated TCI codepoints as specified herein applied for the DCI format 1_2—activated by/in the another second/fourth (unified) TCI state(s) activation MAC CE command as specified herein in the present disclosure as the second TCI states and/or the one or more TCI states (corresponding to either first or second TCI state(s) as specified herein) (i) activated by/in the third (unified) TCI state(s) activation MAC CE command and/or (ii) indicated by one or more of the S activated TCI codepoints as specified herein applied for the DCI format 1_2 activated by/in the (previous/prior) second/fourth (unified) TCI state(s) activation MAC CE command as the first TCI state(s) for DL and/or UL channels/signals.
In another example, when/if the DCI field ‘Transmission Configuration Indication’ is present in DCI format 1_2, and/or when/if the number of codepoints S in the DCI field ‘Transmission Configuration Indication’ of the DCI format 1_2 is smaller than the number of TCI codepoints that are activated by another second/fourth (unified) TCI state(s) activation MAC CE command, the UE may not expect or may not be expected the another second/fourth (unified) TCI state(s) activation MAC CE command to have/comprise/indicate/provide/include/contain the S activated TCI codepoints applied to the DCI field ‘Transmission Configuration Indication’ of/for the DCI format 1_2 that are determined according to one or more examples described herein.
In another example, when/if the DCI field ‘Transmission Configuration Indication’ is present in DCI format 1_2, and/or when/if the number of codepoints S in the DCI field ‘Transmission Configuration Indication’ of the DCI format 1_2 is smaller than the number of TCI codepoints that are activated by another second/fourth (unified) TCI state(s) activation MAC CE command, the UE could expect or could be expected the another second/fourth (unified) TCI state(s) activation MAC CE command to have/comprise/indicate/provide/include/contain the S activated TCI codepoints applied to the DCI field ‘Transmission Configuration Indication’ of/for the DCI format 1_2 that are determined according to one or more examples described herein. In this case/design example, when/if the S activated TCI codepoints—e.g., out of the total TCI codepoints activated by the another second/fourth (unified) TCI state(s) activation MAC CE command as specified herein—that are applied to the DCI field ‘Transmission Configuration Indication’ of/for the DCI format 1_2 are determined according to one or more examples described herein, and/or when/if the TCI state(s)/TCI codepoint(s) activated by/in the another second/fourth (unified) TCI state(s) activation MAC CE command has become applicable, and/or when/if one or more TCI states activated by/in the another second/fourth (unified) TCI state(s) activation MAC CE command as specified herein in the present disclosure have become applicable and/or applied to the DCI format 12 (e.g., (i) the one or more TCI states could correspond to or could be mapped to the single TCI codepoint activated by/in the another second/fourth (unified) TCI state(s) activation MAC CE command, and/or (ii) the one or more TCI states could be indicated/provided by a TCI codepoint of a TCI field in a beam indication DCI—e.g., DCI format 1_2 with or without DL assignment, and the TCI codepoint is one of the S TCI codepoints as specified herein activated by/in the another second/fourth (unified) TCI state(s) activation MAC CE command),
   For example, when/if the one or more TCI states—indicated by one or more of the S activated TCI codepoints as specified herein applied for the DCI format 1_2—activated by/in the another second/fourth (unified) TCI state(s) activation MAC CE command as specified herein in the present disclosure correspond to first TCI state(s),
      In one example, the UE (e.g., the UE 116) could only apply the one or more TCI states—indicated by one or more of the S activated TCI codepoints as specified herein applied for the DCI format 1_2—activated by/in the another second/fourth (unified) TCI state(s) activation MAC CE command as specified herein in the present disclosure—as the first TCI state(s)—for DL and/or UL channels/signals. For this case/design example, the UE may not expect or may not be expected to receive from or be provided/indicated/configured by the network (e.g., the network 130) the first indicator as specified herein in the present disclosure for PDCCH reception(s), and/or the second indicator as specified herein in the present disclosure for PDSCH reception(s), and/or the third indicator as specified herein in the present disclosure for PUCCH transmission(s), and/or the fourth indicator as specified herein in the present disclosure for PUSCH transmission(s)—e.g., when/if the UE is not provided/configured/indicated by the network, the first and/or second and/or third and/or fourth indicator(s) as specified herein in the present disclosure, in/via their respective RRC/DCI signaling(s). Or, when/if the UE receives from or is provided/indicated/configured by the network the first indicator as specified herein in the present disclosure for PDCCH reception(s), and/or the second indicator as specified herein in the present disclosure for PDSCH reception(s), and/or the third indicator as specified herein in the present disclosure for PUCCH transmission(s), and/or the fourth indicator as specified herein in the present disclosure for PUSCH transmission(s), (1) the UE could ignore/omit/not follow the value(s) of the first and/or second and/or third and/or fourth indicator(s) as specified herein in the present disclosure for the respective/corresponding channel(s)/signal(s), (2) the UE could expect or could be expected that the first and/or second and/or third and/or fourth indicator(s) as specified herein in the present disclosure indicates that none of the indicated TCI state(s) and/or the first TCI state(s) could be used/applied for receiving and/or transmitting the respective/corresponding channel(s)/signal(s), and/or (3) the UE may not expect or may not be expected that the first and/or second and/or third and/or fourth indicator(s) as specified herein in the present disclosure indicates that none of the indicated TCI state(s) and/or the second TCI state(s) and/or both the first and second TCI states could be used/applied for receiving and/or transmitting the respective/corresponding channel(s)/signal(s).
      In another example, the UE could apply at least the one or more TCI states—indicated by one or more of the S activated TCI codepoints as specified herein applied for the DCI format 1_2—activated by/in the another second/fourth (unified) TCI state(s) activation MAC CE command as specified herein in the present disclosure for DL and/or UL channels/signals. For this case/design example, e.g., when/if the UE is provided/configured/indicated by the network, the first and/or second and/or third and/or fourth indicator(s) as specified herein in the present disclosure, in/via their respective RRC/DCI signaling(s), the UE could apply the one or more TCI states—indicated by one or more of the S activated TCI codepoints as specified herein applied for the DCI format 1_2—activated by/in the another second/fourth (unified) TCI state(s) activation MAC CE command as specified herein in the present disclosure as the first TCI state(s) and/or the one or more TCI states (corresponding to either first or second TCI state(s) as specified herein) (i) activated by/in the third (unified) TCI state(s) activation MAC CE command and/or (ii) indicated by one or more of the S activated TCI codepoints as specified herein applied for the DCI format 1_2 activated by/in the (previous/prior) second/fourth (unified) TCI state(s) activation MAC CE command as specified herein in the present disclosure as the second TCI state(s) for DL and/or UL channels/signals.
   For another example, when/if the one or more TCI states—indicated by one or more of the S activated TCI codepoints as specified herein applied for the DCI format 1_2—activated by/in the another second/fourth (unified) TCI state(s) activation MAC CE command as specified herein in the present disclosure correspond to second TCI state(s),
   In one example, the UE could only apply the one or more TCI states—indicated by one or more of the S activated TCI codepoints as specified herein applied for the DCI format 1_2—activated by/in the another second/fourth (unified) TCI state(s) activation MAC CE command as specified herein in the present disclosure—as the second TCI state(s)—for DL and/or UL channels/signals. For this case/design example, the UE may not expect or may not be expected to receive from or be provided/indicated/configured by the network the first indicator as specified herein in the present disclosure for PDCCH reception(s), and/or the second indicator as specified herein in the present disclosure for PDSCH reception(s), and/or the third indicator as specified herein in the present disclosure for PUCCH transmission(s), and/or the fourth indicator as specified herein in the present disclosure for PUSCH transmission(s)—e.g., when/if the UE is not provided/configured/indicated by the network, the first and/or second and/or third and/or fourth indicator(s) as specified herein in the present disclosure, in/via their respective RRC/DCI signaling(s). Or, when/if the UE receives from or is provided/indicated/configured by the network the first indicator as specified herein in the present disclosure for PDCCH reception(s), and/or the second indicator as specified herein in the present disclosure for PDSCH reception(s), and/or the third indicator as specified herein in the present disclosure for PUCCH transmission(s), and/or the fourth indicator as specified herein in the present disclosure for PUSCH transmission(s), (1) the UE could ignore/omit/not follow the value(s) of the first and/or second and/or third and/or fourth indicator(s) as specified herein in the present disclosure for the respective/corresponding channel(s)/signal(s), (2) the UE could expect or could be expected that the first and/or second and/or third and/or fourth indicator(s) as specified herein in the present disclosure indicates that none of the indicated TCI state(s) and/or the second TCI state(s) could be used/applied for receiving and/or transmitting the respective/corresponding channel(s)/signal(s), and/or (3) the UE may not expect or may not be expected that the first and/or second and/or third and/or fourth indicator(s) as specified herein in the present disclosure indicates that none of the indicated TCI state(s) and/or the first TCI state(s) and/or both the first and second TCI states could be used/applied for receiving and/or transmitting the respective/corresponding channel(s)/signal(s).
      In another example, the UE could apply at least the one or more TCI states—indicated by one or more of the S activated TCI codepoints as specified herein applied for the DCI format 1_2—activated by/in the another second/fourth (unified) TCI state(s) activation MAC CE command as specified herein in the present disclosure for DL and/or UL channels/signals. For this case/design example, e.g., when/if the UE is provided/configured/indicated by the network, the first and/or second and/or third and/or fourth indicator(s) as specified herein in the present disclosure, in/via their respective RRC/DCI signaling(s), the UE could apply the one or more TCI states—indicated by one or more of the S activated TCI codepoints as specified herein applied for the DCI format 1_2—activated by/in the another second/fourth (unified) TCI state(s) activation MAC CE command as specified herein in the present disclosure as the second TCI state(s) and/or the one or more TCI states (corresponding to either first or second TCI state(s) as specified herein) (i) activated by/in the third (unified) TCI state(s) activation MAC CE command and/or (ii) indicated by one or more of the S activated TCI codepoints as specified herein applied for the DCI format 1_2 activated by/in the (previous/prior) second/fourth (unified) TCI state(s) activation MAC CE command as specified herein in the present disclosure as the first TCI state(s) for DL and/or UL channels/signals.
   For another example, when/if the one or more TCI states—indicated by one or more of the S activated TCI codepoints as specified herein applied for the DCI format 1_2—activated by/in the another second/fourth (unified) TCI state(s) activation MAC CE command as specified herein in the present disclosure correspond to both first and second TCI states,
      In one example, the UE could only apply one or more of the one or more TCI states—indicated by one or more of the S activated TCI codepoints as specified herein applied for the DCI format 1_2—activated by/in the another second/fourth (unified) TCI state(s) activation MAC CE command that correspond(s) to the first TCI state(s) as specified herein in the present disclosure for DL and/or UL channels/signals, according to/based on/following those discussed/specified herein in the present disclosure—e.g., according to one or more examples described herein.
      In another example, the UE could only apply one or more of the one or more TCI states—indicated by one or more of the S activated TCI codepoints as specified herein applied for the DCI format 1_2—activated by/in the another second/fourth (unified) TCI state(s) activation MAC CE command that correspond(s) to the second TCI state(s) as specified herein in the present disclosure for DL and/or UL channels/signals, according to/based on/following those discussed/specified herein in the present disclosure—e.g., according to one or more examples described herein.
      In another example, the UE could apply one or more of the one or more TCI states—indicated by one or more of the S activated TCI codepoints as specified herein applied for the DCI format 1_2—activated by/in the another second/fourth (unified) TCI state(s) activation MAC CE command that correspond(s) to the first TCI state(s) as specified herein in the present disclosure as the first TCI state(s) and/or the one or more TCI states (corresponding to either first or second TCI state(s) as specified herein) (i) activated by/in the third (unified) TCI state(s) activation MAC CE command and/or (ii) indicated by one or more of the S activated TCI codepoints as specified herein applied for the DCI format 1_2 activated by/in the (previous/prior) second/fourth (unified) TCI state(s) activation MAC CE command as the second TCI state(s) as specified herein in the present disclosure for DL and/or UL channels/signals, according to/based on/following those discussed/specified herein in the present disclosure—e.g., according to one or more examples described herein.
      In another example, the UE could apply one or more of the one or more TCI states—indicated by one or more of the S activated TCI codepoints as specified herein applied for the DCI format 1_2 activated by/in the another second/fourth (unified) TCI state(s) activation MAC CE command that correspond(s) to the second TCI state(s) as specified herein in the present disclosure as the second TCI state(s) and/or the one or more TCI states (corresponding to either first or second TCI state(s) as specified herein) (i) activated by/in the third (unified) TCI state(s) activation MAC CE command and/or (ii) indicated by one or more of the S activated TCI codepoints as specified herein applied for the DCI format 1_2 activated by/in the (previous/prior) second/fourth (unified) TCI state(s) activation MAC CE command as the first TCI state(s) as specified herein in the present disclosure for DL and/or UL channels/signals, according to/based on/following those discussed/specified herein in the present disclosure—e.g., according to one or more examples described herein
      In another example, the UE could apply one or more of the one or more TCI states—indicated by one or more of the S activated TCI codepoints as specified herein applied for the DCI format 1_2—activated by/in the another second/fourth (unified) TCI state(s) activation MAC CE command that correspond(s) to the first TCI state(s) as specified herein in the present disclosure as the first TCI state(s) and/or one or more of the one or more TCI states—indicated by one or more of the S activated TCI codepoints as specified herein applied for the DCI format 1_2—activated by/in the another second/fourth (unified) TCI state(s) activation MAC CE command that correspond(s) to the second TCI state(s) as specified herein in the present disclosure as the second TCI state(s) for DL and/or UL channels/signals, according to/based on/following those discussed/specified herein in the present disclosure—e.g., according to one or more examples described herein.

The UE could follow one or more of the described/specified design examples herein to determine which of the indicated TCI state(s) to use/apply according to/based on: (1) fixed rule(s)/value(s) in the system specification(s), (2) network's configuration(s)/indication(s), e.g., via higher layer RRC signaling(s)/parameter(s) and/or MAC CE command(s) and/or dynamic DCI based L1 signaling(s) and/or dynamic DCI based L1 signaling(s), and/or (3) UE's autonomous determination/selection, which could be further sent to the network, e.g., via/in part of a/the CSI/beam report and/or UE's capability signaling(s).
In another example, when/if the DCI field ‘Transmission Configuration Indication’ is present in DCI format 1_2, and/or when/if the number of codepoints S in the DCI field ‘Transmission Configuration Indication’ of the DCI format 1_2 is smaller than the number of TCI codepoints that are activated by another second/fourth (unified) TCI state(s) activation MAC CE command, the UE could expect or could be expected the another second/fourth (unified) TCI state(s) activation MAC CE command to have/comprise/indicate/provide/include/contain the S activated TCI codepoints applied to the DCI field ‘Transmission Configuration Indication’ of/for the DCI format 1_2 that are determined according to one or more examples described herein. In this case/design example, when/if the S activated TCI codepoints—e.g., out of the total TCI codepoints activated by the another second/fourth (unified) TCI state(s) activation MAC CE command as specified herein—that are applied to the DCI field ‘Transmission Configuration Indication’ of/for the DCI format 1_2 are determined according to one or more examples described herein, and/or when/if the TCI state(s)/TCI codepoint(s) activated by/in the another second/fourth (unified) TCI state(s) activation MAC CE command has become applicable, and/or when/if one or more TCI states activated by/in the another second/fourth (unified) TCI state(s) activation MAC CE command as specified herein in the present disclosure have become applicable and/or applied to the DCI format 12 (e.g., (i) the one or more TCI states could correspond to or could be mapped to the single TCI codepoint activated by/in the another second/fourth (unified) TCI state(s) activation MAC CE command, and/or (ii) the one or more TCI states could be indicated/provided by a TCI codepoint of a TCI field in a beam indication DCI—e.g., DCI format 1_2 with or without DL assignment, and the TCI codepoint is one of the S TCI codepoints as specified herein activated by/in the another second/fourth (unified) TCI state(s) activation MAC CE command), the UE could expect or could be expected that the one or more TCI states—indicated by one or more of the S activated TCI codepoints as specified herein applied for the DCI format 1_2—activated by/in the another second/fourth (unified) TCI state(s) activation MAC CE command correspond to both first and second TCI states, wherein (i) the one or more TCI states could correspond to or could be mapped to the single TCI codepoint that is comprised of both first and second TCI states activated by/in the another second/fourth (unified) TCI state(s) activation MAC CE command, and/or (ii) the one or more TCI states could be indicated/provided by a TCI codepoint that is comprised of both first and second TCI states of a TCI field in a beam indication DCI—e.g., DCI format 1_2 with or without DL assignment, and the TCI codepoint is one of the S TCI codepoints as specified herein activated by/in the another second/fourth (unified) TCI state(s) activation MAC CE command (i.e., the UE could only expect or could only be expected that a TCI codepoint that is one of the S TCI codepoints as specified herein activated by/in the another second/fourth (unified) TCI state(s) activation MAC CE command and comprised of both first and second TCI states is indicated/provided by the TCI field in the beam indication DCI format 1_2). Or equivalently, the UE may not expect or may not be expected the one or more TCI states—indicated by one or more of the S activated TCI codepoints as specified herein applied for the DCI format 1_2—activated by/in the another second/fourth (unified) TCI state(s) activation MAC CE command to be comprised of a single TCI state/pair of TCI states—i.e., either first or second TCI state(s) as specified herein in the present disclosure. For this case/design example,
   In one example, the UE could only apply one or more of the one or more TCI states—indicated by one or more of the S activated TCI codepoints as specified herein applied for the DCI format 1_2—activated by/in the another second/fourth (unified) TCI state(s) activation MAC CE command that correspond(s) to the first TCI state(s) as specified herein in the present disclosure for DL and/or UL channels/signals, according to/based on/following those discussed/specified herein in the present disclosure—e.g., according to one or more examples described herein.
   In another example, the UE could only apply one or more of the one or more TCI states—indicated by one or more of the S activated TCI codepoints as specified herein applied for the DCI format 1_2—activated by/in the another second/fourth (unified) TCI state(s) activation MAC CE command that correspond(s) to the second TCI state(s) as specified herein in the present disclosure for DL and/or UL channels/signals, according to/based on/following those discussed/specified herein in the present disclosure—e.g., according to one or more examples described herein.
   In another example, the UE could apply one or more of the one or more TCI states—indicated by one or more of the S activated TCI codepoints as specified herein applied for the DCI format 1_2—activated by/in the another second/fourth (unified) TCI state(s) activation MAC CE command that correspond(s) to the first TCI state(s) as specified herein in the present disclosure as the first TCI state(s) and/or the one or more TCI states (corresponding to either first or second TCI state(s) as specified herein) (i) activated by/in the third (unified) TCI state(s) activation MAC CE command and/or (ii) indicated by one or more of the S activated TCI codepoints as specified herein applied for the DCI format 1_2 activated by/in the (previous/prior) second/fourth (unified) TCI state(s) activation MAC CE command as specified herein in the present disclosure as the second TCI state(s) for DL and/or UL channels/signals, according to/based on/following those discussed/specified herein in the present disclosure—e.g., according to one or more examples described herein.
   In another example, the UE could apply one or more of the one or more TCI states—indicated by one or more of the S activated TCI codepoints as specified herein applied for the DCI format 1_2—activated by/in the another second/fourth (unified) TCI state(s) activation MAC CE command that correspond(s) to the second TCI state(s) as specified herein in the present disclosure as the second TCI state(s) and/or the one or more TCI states (corresponding to either first or second TCI state(s) as specified herein) (i) activated by/in the third (unified) TCI state(s) activation MAC CE command and/or (ii) indicated by one or more of the S activated TCI codepoints as specified herein applied for the DCI format 1_2 activated by/in the (previous/prior) second/fourth (unified) TCI state(s) activation MAC CE command as specified herein in the present disclosure as the first TCI state(s) for DL and/or UL channels/signals, according to/based on/following those discussed/specified herein in the present disclosure—e.g., according to one or more examples described herein.
   In another example, the UE could apply one or more of the one or more TCI states—indicated by one or more of the S activated TCI codepoints as specified herein applied for the DCI format 1_2—activated by/in the another second/fourth (unified) TCI state(s) activation MAC CE command that correspond(s) to the first TCI state(s) as specified herein in the present disclosure as the first TCI state(s) and one or more of the one or more TCI states—indicated by one or more of the S activated TCI codepoints as specified herein applied for the DCI format 1_2—activated by/in the another second/fourth (unified) TCI state(s) activation MAC CE command that correspond(s) to the second TCI state(s) as specified herein in the present disclosure as the second TCI state(s) for DL and/or UL channels/signals, according to/based on/following those discussed/specified herein in the present disclosure—e.g., according to one or more examples described herein.

Throughout the present disclosure, setting a first indicator for PDCCH reception(s) as specified herein in the present disclosure as ‘00’ is equivalent to setting the first indicator for PDCCH reception(s) as specified herein in the present disclosure as ‘first’, and/or setting a first indicator for PDCCH reception(s) as specified herein in the present disclosure as ‘01’ is equivalent to setting the first indicator for PDCCH reception(s) as specified herein in the present disclosure as ‘second’, and/or setting a first indicator for PDCCH reception(s) as specified herein in the present disclosure as ‘10’ (or ‘11’) is equivalent to setting the first indicator for PDCCH reception(s) as specified herein in the present disclosure as ‘both’, and/or setting a first indicator for PDCCH reception(s) as specified herein in the present disclosure as ‘11’ (or ‘10’) is equivalent to setting the first indicator for PDCCH reception(s) as specified herein in the present disclosure as ‘none’.

Throughout the present disclosure, setting a second indicator for PDSCH reception(s) as specified herein in the present disclosure as ‘00’ is equivalent to setting the second indicator for PDSCH reception(s) as specified herein in the present disclosure as ‘first’, and/or setting a second indicator for PDSCH reception(s) as specified herein in the present disclosure as ‘01’ is equivalent to setting the second indicator for PDSCH reception(s) as specified herein in the present disclosure as ‘second’, and/or setting a second indicator for PDSCH reception(s) as specified herein in the present disclosure as ‘10’ (or ‘11’) is equivalent to setting the second indicator for PDSCH reception(s) as specified herein in the present disclosure as ‘both’, and/or setting a second indicator for PDSCH reception(s) as specified herein in the present disclosure as ‘11’ (or ‘10’) is equivalent to setting the second indicator for PDSCH reception(s) as specified herein in the present disclosure as ‘none’.

Throughout the present disclosure, setting a third indicator for PUCCH transmission(s) as specified herein in the present disclosure as ‘00’ is equivalent to setting the third indicator for PUCCH transmission(s) as specified herein in the present disclosure as ‘first’, and/or setting a third indicator for PUCCH transmission(s) as specified herein in the present disclosure as ‘01’ is equivalent to setting the third indicator for PUCCH transmission(s) as specified herein in the present disclosure as ‘second’, and/or setting a third indicator for PUCCH transmission(s) as specified herein in the present disclosure as ‘10’ (or ‘11’) is equivalent to setting the third indicator for PUCCH transmission(s) as specified herein in the present disclosure as ‘both’, and/or setting a third indicator for PUCCH transmission(s) as specified herein in the present disclosure as ‘11’ (or ‘10’) is equivalent to setting the third indicator for PUCCH transmission(s) as specified herein in the present disclosure as ‘none’.

Throughout the present disclosure, setting a fourth indicator for PUSCH transmission(s) as specified herein in the present disclosure as ‘00’ is equivalent to setting the fourth indicator for PUSCH transmission(s) as specified herein in the present disclosure as ‘first’, and/or setting a fourth indicator for PUSCH transmission(s) as specified herein in the present disclosure as ‘01’ is equivalent to setting the fourth indicator for PUSCH transmission(s) as specified herein in the present disclosure as ‘second’, and/or setting a fourth indicator for PUSCH transmission(s) as specified herein in the present disclosure as ‘10’ (or ‘11’) is equivalent to setting the fourth indicator for PUSCH transmission(s) as specified herein in the present disclosure as ‘both’, and/or setting a fourth indicator for PUSCH transmission(s) as specified herein in the present disclosure as ‘11’ (or ‘10’) is equivalent to setting the fourth indicator for PUSCH transmission(s) as specified herein in the present disclosure as ‘none’.

Throughout the present disclosure, i.e., for the design examples/procedures specified herein in the present disclosure, a/the UE could be provided/configured with dl-OrJointTCI-StateList and/or ul-TCI-StateList.

As specified in Rel-17, a unified TCI framework could indicate/include N≥1 DL TCI states and/or M≥1 UL TCI states, wherein the indicated TCI state could be at least one of:
A DL TCI state and/or its corresponding/associated TCI state ID
An UL TCI state and/or its corresponding/associated TCI state ID
A joint DL and UL TCI state and/or its corresponding/associated TCI state ID
Separate DL TCI state and UL TCI state and/or their corresponding/associated TCI state ID(s)

There could be various design options/channels to indicate to the UE a beam (i.e., a TCI state) for the transmission/reception of a PDCCH or a PDSCH. As described in the 3GPP Rel-17,
In one example, a MAC CE could be used to indicate to the UE a beam (i.e., a TCI state and/or a TCI state ID) for the transmission/reception of a PDCCH or a PDSCH.
In another example, a DCI could be used to indicate to the UE a beam (i.e., a TCI state and/or a TCI state ID) for the transmission/reception of a PDCCH or a PDSCH
   For example, a DL related DCI (e.g., DCI format 1_0, DCI format 1_1 or DCI format 1_2) could be used to indicate to the UE a beam (i.e., a TCI state and/or a TCI state ID) for the transmission/reception of a PDCCH or a PDSCH, wherein the DL related DCI may or may not include a DL assignment.
   For another example, an UL related DCI (e.g., DCI format 0_0, DCI format 0_1, DCI format 0_2) could be used to indicate to the UE a beam (i.e., a TCI state and/or a TCI state ID) for the transmission/reception of a PDCCH or a PDSCH, wherein the UL related DCI may or may not include an UL scheduling grant.
   Yet for another example, a custom/purpose designed DCI format could be used to indicate to the UE a beam (i.e., a TCI state and/or a TCI state ID) for the transmission/reception of a PDCCH or a PDSCH.

Rel-17 introduced the unified TCI framework, where a unified or master or main TCI state is signaled to the UE. The unified or master or main TCI state can be one of:
In case of joint TCI state indication, wherein a same beam is used for DL and UL channels, a joint TCI state that can be used at least for UE-dedicated DL channels and UE-dedicated UL channels.
In case of separate TCI state indication, wherein different beams are used for DL and UL channels, a DL TCI state can be used at least for UE-dedicated DL channels.
In case of separate TCI state indication, wherein different beams are used for DL and UL channels, a UL TCI state can be used at least for UE-dedicated UL channels.
   The unified (master or main) TCI state is TCI state of UE-dedicated reception on PDSCH/PDCCH or dynamic-grant/configured-grant based PUSCH and dedicated PUCCH resources.

In a (single-DCI based) multi-TRP system, a UE could be indicated/provided/configured by the network, e.g., via a beam indication MAC CE or a DCI (e.g., via one or more TCI codepoints of one or more TCI fields in the corresponding DCI 1_1/1_2 with or without DL assignment), a set of one or more (e.g., N>1) TCI states/pairs of TCI states, wherein a TCI state could be a joint DL and UL TCI state or a separate DL TCI state provided by TCI-State/DLorJointTCI-State, or a separate UL TCI state provided by TCI-State/UL-TCIState, and a pair of TCI states could include/contain a separate DL TCI state provided by TCI-State/DLorJointTCI-State or a separate UL TCI State provided by TCI-State/UL-TCIState, under the unified TCI framework.

For PDCCH reception or PDCCH candidate monitoring in a (single-DCI based) multi-TRP system, a UE (e.g., the UE 116) could be configured/provided/indicated by the network (e.g., the network 130) via higher layer RRC signaling/parameter and/or MAC CE command and/or dynamic DCI based L1 signaling—e.g., in higher layer RRC signaling/parameter ControlResourceSet that configures a CORESET—a first indicator to indicate which one or more of the set of TCI states/pairs of TCI states indicated, e.g., by a TCI codepoint, in a beam indication DCI or MAC CE as specified herein in the present disclosure, to use/apply for receiving/monitoring the PDCCH(s)/PDCCH candidate(s) in the corresponding CORESET. For instance, for N=2 (i.e., a set of two TCI states/pairs of TCI states are indicated), the first indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for receiving/monitoring the PDCCH(s)/PDCCH candidate(s) in the corresponding CORESET, ‘01’ indicating that the second TCI state(s) among the set of TCI states/pairs of TCI states indicated, e.g., by a TCI codepoint, in a beam indication DCI or MAC CE as specified herein in the present disclosure, could be used/applied for receiving/monitoring the PDCCH(s)/PDCCH candidate(s) in the corresponding CORESET, ‘10’ indicating that the first and second TCI states among the set of TCI states/pairs of TCI states indicated, e.g., by a TCI codepoint, in a beam indication DCI or MAC CE as specified herein in the present disclosure, could be respectively used/applied for receiving/monitoring the PDCCH(s)/PDCCH candidate(s)—e.g., first and second PDCCH candidates—in the corresponding CORESET(s), and ‘11’ indicating that the second and first TCI states among the set of TCI states/pairs of TCI states indicated, e.g., by a TCI codepoint, in a beam indication DCI or MAC CE as specified herein in the present disclosure, or none of the indicated TCI states, could be (respectively) used/applied for receiving/monitoring the PDCCH(s)/PDCCH candidate(s)—e.g., first and second PDCCH candidates—in the corresponding CORESET(s), wherein the first and second PDCCH candidates could be received in search space sets that are higher layer linked via SearchSpaceLinking and/or the first and second PDCCH candidates carry the same/identical DCI payload. Furthermore, throughout the present disclosure, the first TCI state(s) or the second TCI state(s)—specified herein in the present disclosure—could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states. Throughout the present disclosure, the first indicator could also be referred to as or could correspond to a higher layer parameter applylndicatedTCIState configured/provided in PDCCH-Config/ControlResourceSet, which could be set to ‘none’, ‘first’, ‘second’ or ‘both’ respectively indicating/providing that none of the indicated TCI states, the first indicated TCI state(s), the second indicated TCI state(s) or both the first and second indicated TCI states could be used for PDCCH reception(s).

For PDSCH reception in a (single-DCI based) multi-TRP system, a UE could be configured/provided/indicated by the network via higher layer RRC signaling/parameter and/or MAC CE command and/or dynamic DCI based L1 signaling—e.g., in a DL DCI (e.g., DCI format 1_0/1_1/1_2) that schedules the PDSCH—a second indicator to indicate which one or more of the set of TCI states/pairs of TCI states indicated, e.g., by a TCI codepoint, in a beam indication DCI or MAC CE as specified herein in the present disclosure, to use/apply for receiving the PDSCH(s). For instance, for N=2 (i.e., a set of two TCI states/pairs of TCI states are indicated), the second indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for receiving the corresponding PDSCH(s)—e.g., scheduled by the DL DCI/PDCCH, ‘01’ indicating that the second TCI state(s) among the set of TCI states/pairs of TCI states indicated, e.g., by a TCI codepoint, in a beam indication DCI or MAC CE as specified herein in the present disclosure, could be used/applied for receiving the corresponding PDSCH(s)—e.g., scheduled by the DL DCI/PDCCH, ‘10’ indicating that the first and second TCI states among the set of TCI states/pairs of TCI states indicated, e.g., by a TCI codepoint, in a beam indication DCI or MAC CE as specified herein in the present disclosure, could be respectively used/applied for receiving the corresponding PDSCH(s)—e.g., first and second PDSCHs—e.g., scheduled by the DL DCI/PDCCH, and ‘11’ indicating that the second and first TCI states among the set of TCI states/pairs of TCI states indicated, e.g., by a TCI codepoint, in a beam indication DCI or MAC CE as specified herein in the present disclosure, could be respectively used/applied for receiving the corresponding PDSCH(s)—e.g., first and second PDSCHs—e.g., scheduled by the DL DCI/PDCCH, wherein the first and second PDSCHs could correspond to two PDSCH transmission occasions or repetition in space, time and/or frequency.

Furthermore, throughout the present disclosure, the first TCI state(s) or the second TCI state(s)—specified herein in the present disclosure—could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states. Throughout the present disclosure, the second indicator could also be referred to as or could correspond to a DCI indicator ‘TCI selection’ field in DCI format 1_1/1_2 (present when a higher layer parameter tciSelectionPresentInDCI is configured/present and/or set to ‘enabled’), which could be set to ‘none’, ‘first’, ‘second’ or ‘both’ respectively indicating/providing that none of the indicated TCI states, the first indicated TCI state(s), the second indicated TCI state(s) or both the first and second indicated TCI states could be used for PDSCH reception(s).

That is, for PDSCH reception in a (single-DCI based) multi-TRP system, when a UE is configured with dl-OrJointTCI-StateList and is having two indicated TCI-states, if the UE does not report its capability indicating support of “two default beams for S-DCI based MTRP” in frequency range 2 and when the offset between the reception of the scheduling/activation DCI format 1_0/1_1/1_2 and the scheduled or activated PDSCH reception is less than timeDurationForQCL in frequency range 2, the UE shall apply the first indicated TCI-State to the scheduled or activated PDSCH reception. When a UE is configured with dl-OrJointTCI-StateList and is having two indicated TCI-states:
Regardless of the offset between the reception of the scheduling DCI format 1_0/1_1/1_2 and the scheduled/activated PDSCH reception, if the UE is in frequency range 1, or the UE reports its capability indicating support of “two default beams for S-DCI based MTRP” in frequency range 2, or
If the UE does not report its capability indicating support of “two default beams for S-DCI based MTRP” in frequency range 2 and if the scheduling offset between the reception of the scheduling DCI format 1_0/1_1/1_2 and the scheduled/activated PDSCH reception is equal to or larger than timeDurationForQCL
   The UE can be configured by higher layer parameter applyIndicatedTCIState to indicate whether the first, the second, or both of the indicated TCI-state(s) is/are applied to PDSCH reception scheduled or activated by DCI format 1_0. The UE can be configured with applyIndicatedTCIState with value both only when the UE is configured with cjtSchemePDSCH and the UE reports its capability indicating support of two joint TCI states for PDSCH-CJT or the UE is configured with sfnSchemePdsch. In that case, the UE shall apply both indicated TCI-states to PDSCH reception scheduled or activated by DCI format 1_0 on a search space other than Type0/0A/2 common search space (CSS) on CORESET #0.
   If the UE is not configured with applyIndicatedTCIState, the first indicated TCI-state is applied to PDSCH reception scheduled or activated by DCI format 1_0.
   When the UE is configured with tciSelection-PresentInDCIjointly for both DCI formats 1_1 and 1_2 in the same DL BWP, and when the UE receives a DCI format 1_1/1_2 that schedules or activates PDSCH reception, the UE shall determine the indicated joint/DL TCI state(s) for the PDSCH reception according to the following:
      If the DCI format 1_1/1_2 indicates codepoint “00” for the TCI selection field (or equivalently, the second indicator as specified herein in the present disclosure), the UE shall apply the first one of two indicated joint/DL TCI states to PDSCH DM-RS port(s) of corresponding PDSCH transmission occasions(s) scheduled or activated by the DCI format 1_1/1_2.
      If the DCI format 1_1/1_2 indicates codepoint “01” for the TCI selection field (or equivalently, the second indicator as specified herein in the present disclosure), the UE shall apply the second one of two indicated joint/DL TCI states to PDSCH DM-RS port(s) of corresponding PDSCH transmission occasion(s) scheduled or activated by the DCI format 1_1/1_2.
      If the DCI format 1_1/1_2 indicates codepoint “10” for the TCI selection field (or equivalently, the second indicator as specified herein in the present disclosure), the UE shall apply both indicated joint/DL TCI states to the PDSCH reception scheduled or activated by the DCI format 1_1/1_2.
   If the UE is not configured with tciSelection-PresentInDCI and when the UE receives a DCI format 1_1/1_2 that schedules/activates PDSCH reception, the UE shall apply both indicated TCI-States to the scheduled or activated PDSCH reception.

For PUCCH transmission in a (single-DCI based) multi-TRP system, a UE could be configured/provided/indicated by the network via higher layer RRC signaling/parameter and/or MAC CE command and/or dynamic DCI based L1 signaling—e.g., in higher layer RRC signaling/parameter PUCCH-Config that configures PUCCH(s)/PUCCH resource(s)—a third indicator to indicate which one or more of the set of TCI states/pairs of TCI states indicated, e.g., by a TCI codepoint, in a beam indication DCI or MAC CE as specified herein in the present disclosure, to use/apply for transmitting the PUCCH(s)/PUCCH resource(s). For instance, for N=2 (i.e., a set of two TCI states/pairs of TCI states are indicated), the third indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for transmitting the PUCCH(s)/PUCCH resource(s), ‘01’ indicating that the second TCI state(s) among the set of TCI states/pairs of TCI states indicated, e.g., by a TCI codepoint, in a beam indication DCI or MAC CE as specified herein in the present disclosure, could be used/applied for transmitting the PUCCH(s)/PUCCH resource(s), ‘10’ indicating that the first and second TCI states among the set of TCI states/pairs of TCI states indicated, e.g., by a TCI codepoint, in a beam indication DCI or MAC CE as specified herein in the present disclosure, could be respectively used/applied for transmitting the PUCCH(s)/PUCCH resource(s)—e.g., first PUCCH/PUCCH resource and second PUCCH/PUCCH resource, and ‘11’ indicating that the second and first TCI states among the set of TCI states/pairs of TCI states indicated, e.g., by a TCI codepoint, in a beam indication DCI or MAC CE as specified herein in the present disclosure, or none of the indicated TCI states, could be (respectively) used/applied for transmitting the PUCCH(s)/PUCCH resource(s)—e.g., first PUCCH/PUCCH resource and second PUCCH/PUCCH resource, wherein the first and second PUCCHs/PUCCH resources could correspond to two PUCCH transmission occasions or repetitions in space, time and/or frequency. Furthermore, throughout the present disclosure, the first TCI state(s) or the second TCI state(s)—specified herein in the present disclosure—could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states. Throughout the present disclosure, the third indicator could also be referred to as or could correspond to a higher layer parameter applyIndicatedTCIState configured/provided in higher layer parameter(s) that configures/provides a PUCCH resource/resource group, which could be set to ‘none’, ‘first’, ‘second’ or ‘both’ respectively indicating/providing that none of the indicated TCI states, the first indicated TCI state(s), the second indicated TCI state(s) or both the first and second indicated TCI states could be used for PUCCH transmission(s).

For PUSCH transmission in a (single-DCI based) multi-TRP system, a UE could be configured/provided/indicated by the network via higher layer RRC signaling/parameter and/or MAC CE command and/or dynamic DCI based L1 signaling—e.g., in an UL DCI (e.g., DCI format 0_0/0_1/0_2) that schedules the PUSCH—a fourth indicator to indicate which one or more of the set of TCI states/pairs of TCI states indicated, e.g., by a TCI codepoint, in a beam indication DCI or MAC CE as specified herein in the present disclosure, to use/apply for transmitting the PUSCH(s). For instance, for N=2 (i.e., a set of two TCI states/pairs of TCI states are indicated), the fourth indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for transmitting the corresponding PUSCH(s)—e.g., scheduled by the UL DCI/PDCCH, ‘01’ indicating that the second TCI state(s) among the set of TCI states/pairs of TCI states indicated, e.g., by a TCI codepoint, in a beam indication DCI or MAC CE as specified herein in the present disclosure, could be used/applied for transmitting the corresponding PUSCH(s)—e.g., scheduled by the UL DCI/PDCCH, ‘10’ indicating that the first and second TCI states among the set of TCI states/pairs of TCI states indicated, e.g., by a TCI codepoint, in a beam indication DCI or MAC CE as specified herein in the present disclosure, could be respectively used/applied for transmitting the corresponding PUSCH(s)—e.g., first and second PUSCHs—e.g., scheduled by the UL DCI/PDCCH, and ‘11’ indicating that the second and first TCI states among the set of TCI states/pairs of TCI states indicated, e.g., by a TCI codepoint, in a beam indication DCI or MAC CE as specified herein in the present disclosure, could be respectively used/applied for transmitting the corresponding PUSCH(s)—e.g., first and second PUSCHs—e.g., scheduled by the UL DCI/PDCCH, wherein the first and second PUSCHs could correspond to two PUSCH transmission occasions or repetition in space, time and/or frequency. Furthermore, throughout the present disclosure, the first TCI state(s) or the second TCI state(s)—specified herein in the present disclosure—could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states. Throughout the present disclosure, the fourth indicator could also be referred to as or could correspond to a DCI indicator ‘SRS resource set’ field in DCI format 0_1/0_2, which could be set to ‘none’, ‘first’, ‘second’ or ‘both’ respectively indicating/providing that none of the indicated TCI states, the first indicated TCI state(s), the second indicated TCI state(s) or both the first and second indicated TCI states could be used for PUSCH transmission(s).

In a (multi-DCI based) multi-TRP system, a UE could be indicated/provided/configured by the network, e.g., in PDCCH-Config, two values (i.e., 0 and 1) of CORESET pool index (denoted by CORESETPoolIndex), wherein each CORESET could be configured with a value of CORESETPoolIndex. Furthermore, a UE could be indicated/provided/configured by the network, e.g., via a beam indication MAC CE or a DCI (e.g., via one or more TCI codepoints of one or more TCI fields in the corresponding DCI format 1_1/1_2 with or without DL assignment) associated to a CORESET pool index value (e.g., 0 or 1), one or more TCI states/pairs of TCI states for the same (or different) CORESET pool index value, wherein a TCI state could be a joint DL and UL TCI state or a separate DL TCI state provided by TCI-State/DLorJointTCI-State or a separate UL TCI state provided by TCI-State/UL-TCIState indicated for channels/signals such as PDCCH, PDSCH, PUCCH and PUSCH associated to the same (or different) CORESET pool index value, and a pair of TCI states could include/contain a separate DL TCI state provided by TCI-State/DLorJointTCI-State or a separate UL TCI State provided by TCI-State/UL-TCIState indicated for channels/signals such as PDCCH, PDSCH, PUCCH and PUSCH associated to the same (or different) CORESET pool index value, under the unified TCI framework.

Throughout the present disclosure, setting a first indicator for PDCCH reception(s) as specified herein in the present disclosure as ‘00’ is equivalent to setting the first indicator for PDCCH reception(s) as specified herein in the present disclosure as ‘first’, and/or setting a first indicator for PDCCH reception(s) as specified herein in the present disclosure as ‘01’ is equivalent to setting the first indicator for PDCCH reception(s) as specified herein in the present disclosure as ‘second’, and/or setting a first indicator for PDCCH reception(s) as specified herein in the present disclosure as ‘10’ (or ‘11’) is equivalent to setting the first indicator for PDCCH reception(s) as specified herein in the present disclosure as ‘both’, and/or setting a first indicator for PDCCH reception(s) as specified herein in the present disclosure as ‘11’ (or ‘10’) is equivalent to setting the first indicator for PDCCH reception(s) as specified herein in the present disclosure as ‘none’.

Throughout the present disclosure, setting a second indicator for PDSCH reception(s) as specified herein in the present disclosure as ‘00’ is equivalent to setting the second indicator for PDSCH reception(s) as specified herein in the present disclosure as ‘first’, and/or setting a second indicator for PDSCH reception(s) as specified herein in the present disclosure as ‘01’ is equivalent to setting the second indicator for PDSCH reception(s) as specified herein in the present disclosure as ‘second’, and/or setting a second indicator for PDSCH reception(s) as specified herein in the present disclosure as ‘10’ (or ‘11’) is equivalent to setting the second indicator for PDSCH reception(s) as specified herein in the present disclosure as ‘both’, and/or setting a second indicator for PDSCH reception(s) as specified herein in the present disclosure as ‘11’ (or ‘10’) is equivalent to setting the second indicator for PDSCH reception(s) as specified herein in the present disclosure as ‘none’.

Throughout the present disclosure, setting a third indicator for PUCCH transmission(s) as specified herein in the present disclosure as ‘00’ is equivalent to setting the third indicator for PUCCH transmission(s) as specified herein in the present disclosure as ‘first’, and/or setting a third indicator for PUCCH transmission(s) as specified herein in the present disclosure as ‘01’ is equivalent to setting the third indicator for PUCCH transmission(s) as specified herein in the present disclosure as ‘second’, and/or setting a third indicator for PUCCH transmission(s) as specified herein in the present disclosure as ‘10’ (or ‘11’) is equivalent to setting the third indicator for PUCCH transmission(s) as specified herein in the present disclosure as ‘both’, and/or setting a third indicator for PUCCH transmission(s) as specified herein in the present disclosure as ‘11’ (or ‘10’) is equivalent to setting the third indicator for PUCCH transmission(s) as specified herein in the present disclosure as ‘none’.

Throughout the present disclosure, setting a fourth indicator for PUSCH transmission(s) as specified herein in the present disclosure as ‘00’ is equivalent to setting the fourth indicator for PUSCH transmission(s) as specified herein in the present disclosure as ‘first’, and/or setting a fourth indicator for PUSCH transmission(s) as specified herein in the present disclosure as ‘01’ is equivalent to setting the fourth indicator for PUSCH transmission(s) as specified herein in the present disclosure as ‘second’, and/or setting a fourth indicator for PUSCH transmission(s) as specified herein in the present disclosure as ‘10’ (or ‘11’) is equivalent to setting the fourth indicator for PUSCH transmission(s) as specified herein in the present disclosure as ‘both’, and/or setting a fourth indicator for PUSCH transmission(s) as specified herein in the present disclosure as ‘11’ (or ‘10’) is equivalent to setting the fourth indicator for PUSCH transmission(s) as specified herein in the present disclosure as ‘none’.

If a UE receives a higher layer configuration of dl-OrJoint-TCIStateList with a set of up to two (or one or two) joint TCI states or TCI states for DL and UL channels/signals, that can be used as indicated TCI state(s),
When/if the set comprises a single TCI state (e.g., corresponding to a first TCI state or a second TCI state in the set), the UE could obtain the QCL assumptions from the configured TCI state for DM-RS of PDSCH and DM-RS of PDCCH, and the CSI-RS applying the indicated TCI state, and/or the UE could determine an UL TX spatial filter, if applicable, from the configured TCI state for dynamic-grant and configured-grant based PUSCH and PUCCH, and SRS applying the indicated TCI state.
When/if the set comprises a first joint TCI state and a second joint TCI state,
   When/if the UE is in frequency range 1, or the UE reports its capability of supporting two (default) beams for S-DCI based multi-TRP (MTRP) in frequency range 2, the UE could apply both configured first and second joint TCI states to PDCCH reception and PDSCH reception, and/or PUCCH transmission, PUSCH transmission, and transmission of SRS applying the indicated TCI state, and/or the UE could apply the configured first or second joint TCI state to the reception of CSI-RS applying the indicated TCI state according to the RRC configuration applyUnifiedTCIState provided to the CSI-RS resource or the CSI resource set that comprises the CSI-RS resource.
   Otherwise, the UE could obtain the QCL assumptions from the configured first or second joint TCI state for DM-RS of PDSCH (e.g., according to the RRC configuration applyUnifiedTCIState provided to the PDSCH scheduled/activated by DCI format 01) and DM-RS of PDCCH (e.g., according to the RRC configuration applyUnifiedTCIState provided to the PDCCH/CORESET), and the CSI-RS applying the indicated TCI state (e.g., according to the RRC configuration applyUnifiedTCIState provided to the CSI-RS resource or the CSI resource set that comprises the CSI-RS resource), and/or the UE could determine an UL TX spatial filter, if applicable, from the configured first or second joint TCI state for dynamic-grant and configured-grant based PUSCH and PUCCH (e.g., according to the RRC configuration applyUnifiedTCIState provided to the PUSCH/PUCCH resource), and SRS applying the indicated TCI state.

Throughout the present disclosure, the RRC configuration/parameter applyUnifiedTCIState could be set to ‘00’, ‘01’, ‘10’ or ‘11’, and/or ‘first’, ‘second’ or ‘both’, indicating that the first, second or both configured TCI states can be applied to the corresponding channels/signals.

If a UE receives a higher layer configuration of dl-OrJoint-TCIStateList and/or a higher layer configuration of ul-TCIState-List with a set of up to two (none or one or two) DL TCI states or TCI states for DL channels/signals and/or up to two (none or one or two) UL TCI states or TCI states for UL channels/signals, that can be used as indicated TCI state(s),
When/if the set comprises a single DL TCI state or a single TCI state for DL channels/signals (e.g., corresponding to a first DL TCI state or a second DL TCI state), the UE could obtain the QCL assumptions from the configured DL TCI state for DM-RS of PDSCH and DM-RS of PDCCH, and the CSI-RS applying the indicated TCI state.
When/if the set comprises a first DL TCI state and a second DL TCI state,
   When/if the UE is in frequency range 1, or the UE reports its capability of supporting two (default) beams for S-DCI based MTRP in frequency range 2, the UE could apply both configured first and second DL TCI states to PDCCH reception and PDSCH reception, and/or the UE could apply the configured first or second TCI state to the reception of CSI-RS applying the indicated TCI state according to the RRC configuration applyUnifiedTCIState provided to the CSI-RS resource or the CSI resource set that comprises the CSI-RS resource.
   Otherwise, the UE could obtain the QCL assumptions from the configured first or second DL TCI state for DM-RS of PDSCH (e.g., according to the RRC configuration applyUnifiedTCIState provided to the PDSCH scheduled/activated by DCI format 0_1) and DM-RS of PDCCH (e.g., according to the RRC configuration applyUnifiedTCIState provided to the PDCCH/CORESET), and the CSI-RS applying the indicated TCI state (e.g., according to the RRC configuration applyUnifiedTCIState provided to the CSI-RS resource or the CSI resource set that comprises the CSI-RS resource).
When/if the set comprises a single UL TCI state or a single TCI state for UL channels/signals (e.g., corresponding to a first UL TCI state or a second UL TCI state), the UE could determine an UL TX spatial filter, if applicable, from the configured TCI state for dynamic-grant and configured-grant based PUSCH and PUCCH, and SRS applying the indicated TCI state.
When/if the set comprises a first UL TCI state and a second UL TCI state,
   When/if the UE is in frequency range 1, or the UE reports its capability of supporting two (default) beams for S-DCI based MTRP in frequency range 2, the UE could apply both configured first and second DL TCI states to PUCCH transmission, PUSCH transmission, and transmission of SRS applying the indicated TCI state.
   Otherwise, the UE could determine an UL TX spatial filter, if applicable, from the configured first or second UL TCI state for dynamic-grant and configured-grant based PUSCH and PUCCH (e.g., according to the RRC configuration applyUnifiedTCIState provided to the PUSCH/PUCCH resource), and SRS applying the indicated TCI state.

Throughout the present disclosure, the RRC configuration/parameter applyUnifiedTCIState could be set to ‘00’, ‘01’, ‘10’ or ‘11’, and/or ‘first’, ‘second’ or ‘both’, indicating that the first, second or both configured TCI states can be applied to the corresponding channels/signals.

When/if a UE (e.g., the UE 116) is provided in PDCCH-Config two values of coresetPoolIndex (e.g., 0 and 1) in CORESET/ControlResourceSet, and/or if a UE receives a higher layer configuration of dl-OrJoint-TCIStateList with up to two (or one or two) joint TCI states or TCI states for DL and UL channels/signals, that can be used as indicated TCI state(s),
When/if a single joint TCI state is configured, the UE could obtain the QCL assumptions from the configured TCI state for DM-RSs of PDSCHs and DM-RSs of PDCCHs, and the CSI-RSs applying the indicated TCI state respectively specific to values 0 and 1 of coresetPoolIndex, and/or the UE could determine UL TX spatial filters, if applicable, from the configured TCI state for dynamic-grant and configured-grant based PUSCHs and PUCCHs, and SRSs applying the indicated TCI state respectively specific to values 0 and 1 of coresetPoolIndex.
When/if a first and a second joint TCI states are configured,
   The UE could obtain the QCL assumptions from the configured first or second joint TCI state for DM-RSs of PDSCHs and DM-RSs of PDCCHs, and the CSI-RSs applying the indicated TCI state respectively specific to values 0 and 1 of coresetPoolIndex, and/or the UE could determine UL TX spatial filters, if applicable, from the configured first or second joint TCI state for dynamic-grant and configured-grant based PUSCHs and PUCCHs, and SRSs applying the indicated TCI state respectively specific to values 0 and 1 of coresetPoolIndex.
   The UE could obtain the QCL assumptions from the configured first joint TCI state for DM-RS of PDSCH and DM-RS of PDCCH, and the CSI-RS applying the indicated TCI state specific to value 0 of coresetPoolIndex, and/or the UE could determine an UL TX spatial filter, if applicable, from the configured first joint TCI state for dynamic-grant and configured-grant based PUSCH and PUCCH, and SRS applying the indicated TCI state specific to value 0 of coresetPoolIndex.
   The UE could obtain the QCL assumptions from the configured second joint TCI state for DM-RS of PDSCH and DM-RS of PDCCH, and the CSI-RS applying the indicated TCI state specific to value 1 of coresetPoolIndex, and/or the UE could determine an UL TX spatial filter, if applicable, from the configured second joint TCI state for dynamic-grant and configured-grant based PUSCH and PUCCH, and SRS applying the indicated TCI state specific to value 1 of coresetPoolIndex.

When/if a UE is provided in PDCCH-Config two values of coresetPoolIndex (e.g., 0 and 1) in CORESET/ControlResourceSet, and/or if a UE receives a higher layer configuration of dl-OrJoint-TCIStateList and/or a higher layer configuration of ul-TCIState-List with up to two (none or one or two) DL TCI states or TCI states for DL channels/signals and/or up to two (none or one or two) UL TCI states or TCI states for UL channels/signals, that can be used as indicated TCI state(s),
When/if a single DL TCI state is configured, the UE could obtain the QCL assumptions from the configured DL TCI state for DM-RSs of PDSCHs and DM-RSs of PDCCHs, and the CSI-RSs applying the indicated TCI state respectively specific to values 0 and 1 of coresetPoolIndex.
When/if a first and a second DL TCI states are configured,
   The UE could obtain the QCL assumptions from the configured first or second DL TCI state for DM-RSs of PDSCHs and DM-RSs of PDCCHs, and the CSI-RSs applying the indicated TCI state respectively specific to values 0 and 1 of coresetPoolIndex.
   The UE could obtain the QCL assumptions from the configured first DL TCI state for DM-RS of PDSCH and DM-RS of PDCCH, and the CSI-RS applying the indicated TCI state specific to value 0 of coresetPoolIndex.
   The UE could obtain the QCL assumptions from the configured second DL TCI state for DM-RS of PDSCH and DM-RS of PDCCH, and the CSI-RS applying the indicated TCI state specific to value 1 of coresetPoolIndex.
When/if a single UL TCI state is configured, the UE could determine UL TX spatial filters, if applicable, from the configured UL TCI state for dynamic-grant and configured-grant based PUSCHs and PUCCHs, and SRSs applying the indicated TCI state respectively specific to values 0 and 1 of coresetPoolIndex.
When/if a first and a second UL TCI states are configured,
   The UE could determine UL TX spatial filters, if applicable, from the configured first or second UL TCI state for dynamic-grant and configured-grant based PUSCHs and PUCCHs, and SRSs applying the indicated TCI state respectively specific to values 0 and 1 of coresetPoolIndex.
   The UE could determine an UL TX spatial filter, if applicable, from the configured first UL TCI state for dynamic-grant and configured-grant based PUSCH and PUCCH, and SRS applying the indicated TCI state specific to value 0 of coresetPoolIndex.
   The UE could determine an UL TX spatial filter, if applicable, from the configured second UL TCI state for dynamic-grant and configured-grant based PUSCH and PUCCH, and SRS applying the indicated TCI state specific to value 1 of coresetPoolIndex.

When/if a UE is provided in PDCCH-Config two values of coresetPoolIndex (e.g., 0 and 1) in CORESET/ControlResourceSet, and/or if a UE receives a higher layer configuration of dl-OrJoint-TCIStateList that is specific to a value of coresetPoolIndex (i.e., 0 or 1) with a single joint TCI state or a single TCI state for DL and UL channels/signals, that can be used as indicated TCI state(s), the UE could obtain the QCL assumptions from the configured TCI state for DM-RS of PDSCH and DM-RS of PDCCH, and the CSI-RS applying the indicated TCI state specific to the same value of coresetPoolIndex (i.e., 0 or 1), and/or the UE could determine an UL TX spatial filter, if applicable, from the configured TCI state for dynamic-grant and configured-grant based PUSCH and PUCCH, and SRS applying the indicated TCI state specific to the same value of coresetPoolIndex (i.e., 0 or 1).

When/if a UE is provided in PDCCH-Config two values of coresetPoolIndex (e.g., 0 and 1) in CORESET/ControlResourceSet, and/or if a UE receives a higher layer configuration of dl-OrJoint-TCIStateList that is specific to a value of coresetPoolIndex (i.e., 0 or 1) with a single DL TCI state or a single TCI state for DL channels/signals, that can be used as indicated TCI state(s), the UE could obtain the QCL assumptions from the configured TCI state for DM-RS of PDSCH and DM-RS of PDCCH, and the CSI-RS applying the indicated TCI state specific to the same value of coresetPoolIndex (i.e., 0 or 1).

When/if a UE is provided in PDCCH-Config two values of coresetPoolIndex (e.g., 0 and 1) in CORESET/ControlResourceSet, and/or if a UE receives a higher layer configuration of ul-TCIState-List that is specific to a value of coresetPoolIndex (i.e., 0 or 1) with a single UL TCI state or a single TCI state for UL channels/signals, that can be used as indicated TCI state(s), the UE could determine an UL TX spatial filter, if applicable, from the configured TCI state for dynamic-grant and configured-grant based PUSCH and PUCCH, and SRS applying the indicated TCI state specific to the same value of coresetPoolIndex (i.e., 0 or 1).

When/if a UE is provided in PDCCH-Config two values of coresetPoolIndex (e.g., 0 and 1) in CORESET/ControlResourceset, and/or if a UE configured with dl-OrJoint-TCIStateList would transmit a PUCCH with hybrid automatic repeat request acknowledgement (HARQ-ACK) information or a PUSCH with HARQ-ACK information corresponding to the DCI—specific to a value of coresetPoolIndex, e.g., 0 (or 1) —carrying the TCI State indication for DL/UL channel(s)/signal(s) specific to the same value of coresetPoolIndex, e.g., 0 (or 1) and without DL assignment, or corresponding to the PDSCH scheduled by the DCI—specific to a value of coresetPoolIndex, e.g., 0 (or 1)—carrying the TCI State indication for DL/UL channel(s)/signal(s) specific to the same value of coresetPoolIndex, e.g., 0 (or 1), and if the indicated TCI State specific to value 0 (or 1) of coresetPoolIndex is different from the previously indicated one specific to value 0 (or 1) of coresetPoolIndex, the indicated TCI-State and/or TCI-UL-State specific to value 0 (or 1) of coresetPoolIndex should be applied starting from the first slot that is at least beamAppTime symbols after the last symbol of the PUCCH or the PUSCH specific to value 0 (or 1) of coresetPoolIndex. The first slot and the beamAppTime symbols are both determined on the active BWP with the smallest sub-carrier spacing (SCS) among the BWP(s) from the CCs applying the indicated TCI-State or TCI-UL-State that are active at the end of the PUCCH or the PUSCH carrying the HARQ-ACK information.

Furthermore, when/if a UE is provided in PDCCH-Config two values of coresetPoolIndex (e.g., 0 and 1), and/or when the UE would transmit a PUCCH with HARQ-ACK information in slot n corresponding to the PDSCH carrying the activation command specific to a value of coresetPoolIndex, e.g., 0 (or 1)—the PUCCH with HARQ-ACK information could also be said to be specific to the same value of coresetPoolIndex, e.g., 0 (or 1), the indicated mapping between TCI states and codepoints of the DCI field ‘Transmission Configuration Indication’ specific to the same value of coresetPoolIndex, e.g., 0 (or 1), should be applied starting from the first slot that is after slot

$$n + 3 {N}_{s l o t}^{subframe , μ} + \frac{{2}^{μ}}{{2}^{{μ}_{{K}_{mac}}}} \cdot {k}_{m a c}$$

where is the SCS configuration for the PUCCH and μ_{K}_{_{mac}} is the subcarrier spacing configuration for k_{mac} with a value of 0 for frequency range 1, and k_{mac} is provided by K-Mac or k_{mac}=0 if K-Mac is not provided. If tci-PresentInDCI is set to ‘enabled’ or tci-PresentDCI-1-2 is configured for the CORESET associated/configured with value 0 (or 1) of coresetPoolIndex scheduling the PDSCH specific to value 0 (or 1) of coresetPoolIndex, and the time offset between the reception of the DL DCI in the CORESET associated/configured with value 0 (or 1) of coresetPoolIndex and the corresponding PDSCH specific to value 0 (or 1) of coresetPoolIndex is equal to or greater than timeDurationForQCL if applicable, after a UE receives an initial higher layer configuration of TCI states and before reception of the activation command specific to value 0 (or 1) of coresetPoolIndex, the UE may expect that the DM-RS ports of PDSCH specific to value 0 (or 1) of coresetPoolIndex of a serving cell are quasi co-located with the synchronization signal/physical broadcast channel (SS/PBCH) block determined in the initial access procedure with respect to qcl-Type set to ‘typeA’, and when applicable, also with respect to qcl-Type set to ‘typeD, wherein determined SS/PBCH block could also be associated/specific to the same value of coresetPoolIndex, e.g., 0 (or 1), as that for the PDSCH.

For PDSCH scheduled by DCI format 1_1/1_2, when/if a UE is provided/configured with dl-OrJointTCI-StateList and/or ul-TCI-StateList, and/or when the UE is configured with sfnSchemePdcch set to ‘sfnSchemeA’ and/or applying two indicated TCI states for the corresponding CORESET(s)—e.g., when/if the first indicator as specified herein in the present disclosure (or equivalently, the higher layer parameter applylndicatedTCIState) configured for the CORESET(s) is set to ‘10’ or ‘11’ or ‘both’, and sfnSchemepdsch is not configured, and/or when the UE is having two indicated TCI states (and/or is determined to use/apply one indicated TCI state to PDSCH), the UE could expect the TCI selection field (i.e., the second indicator as specified herein in the present disclosure) present in DCI format 1_1/1_2—i.e., the UE could report its capability of supporting the TCI selection field present in DCI format 1_1/1_2 and/or the UE is configured with tciSelection-PresentlnDCl (e.g., set to ‘enabled’) jointly for both DCI formats 1_1 and 1_2 in the same DL BWP (in this case, the DCI format 1_1/1_2 could indicate codepoint “00” for the TCI selection field (or equivalently, the second indicator as specified herein in the present disclosure) indicating that the first indicated TCI state(s) could be used/applied for PDSCH reception(s)) or codepoint “01” for the TCI selection field (or equivalently, the second indicator as specified herein in the present disclosure) indicating that the second indicated TCI state(s) could be used/applied for PDSCH reception(s) or codepoint “10” for the TCI selection field (or equivalently, the second indicator as specified herein in the present disclosure) indicating that both first and second indicated TCI states could be used/applied for PDSCH reception(s)). That is, in this case, when/if the time offset between the reception of the DL DCI and the corresponding PDSCH is larger (or smaller) than or equal to the threshold timeDurationForQCL if applicable, and the CORESET which schedules the PDSCH is indicated with two TCI states, the UE could expect or identify or determine the TCI state or the QCL assumption for the PDSCH according to/based on the indicated TCI state(s) and the TCI selection field as follows.
If the DCI format 1_1/1_2 indicates codepoint “00” for the TCI selection field (or equivalently, the second indicator as specified herein in the present disclosure), the UE could apply the first one of two indicated joint/DL TCI states to the PDSCH.
If the DCI format 1_1/1_2 indicates codepoint “01” for the TCI selection field (or equivalently, the second indicator as specified herein in the present disclosure), the UE could apply the second one of two indicated joint/DL TCI states to the PDSCH.
If the DCI format 1_1/1_2 indicates codepoint “10” for the TCI selection field (or equivalently, the second indicator as specified herein in the present disclosure), the UE could apply either the first one or the second one of two indicated joint/DL TCI states to the PDSCH according to: (i) fixed rule(s) in system specification(s), (ii) network's configuration(s) or indication(s) via/in higher layer RRC signaling(s)/parameter(s) and/or MAC CE command(s) and/or dynamic DCI based L1 signaling(s), and/or (iii) UE's autonomous determination/selection, which could be further reported to the network, e.g., in/via part of a CSI/beam report and/or UE's capability signaling(s).

Alternatively, when the UE does not report its capability of supporting the TCI selection field present in DCI format 1_1/1_2, and/or the UE is not provided/configured with tciSelection-PresentlnDCl for DCI format 1_1/1_2, and/or the UE provided/configured with tciSelection-PresentlnDCl set to ‘disabled’ for DCI format 1_1/1_2, and/or when/if the UE is provided/configured with dl-OrJointTCI-StateList and/or ul-TCI-StateList, and/or when the UE is having one or two indicated TCI states, the UE may not expect or may not be expected that the UE could be configured with sfnSchemePdcch set to ‘sfnSchemeA’ and/or applying two indicated TCI states for the corresponding CORESET(s)—e.g., when/if the first indicator as specified herein in the present disclosure (or equivalently, the higher layer parameter applylndicatedTCIState) configured for the CORESET(s) is set to ‘10’ or ‘11’ or ‘both’ and sfnSchemepdsch not configured for PDSCH reception scheduled/activated by DCI format 1_1/1_2, or equivalently the UE may not expect or may not be expected one or more of:
the UE is configured with sfnSchemePdcch set to ‘sfnSchemeA’ and/or applying two indicated TCI states for the corresponding CORESET(s)—e.g., when/if the first indicator as specified herein in the present disclosure (or equivalently, the higher layer parameter applylndicatedTCIState) configured for the CORESET(s) is set to ‘10’ or ‘11’ or ‘both’,
the UE is not configured with sfnSchemepdsch for PDSCH reception scheduled/activated by DCI format 1_1/1_2.

For PDSCH scheduled by DCI format 1_1/1_2, when/if a UE is provided/configured with dl-OrJointTCI-StateList and/or ul-TCI-StateList, and/or when the UE is configured with sfnSchemePdcch set to ‘sfnSchemeA’ and/or ‘sfnSchemeB’ and/or applying two indicated TCI states for the corresponding CORESET(s)—e.g., when/if the first indicator as specified herein in the present disclosure (or equivalently, the higher layer parameter applylndicatedTCIState) configured for the CORESET(s) is set to ‘10’ or ‘11’ or ‘both’, and/or when the UE is applying two indicated TCI states to receive PDCCH candidates associated with search space sets configured with searchSpaceLinking—e.g., when/if the first indicator as specified herein in the present disclosure (or equivalently, the higher layer parameter applylndicatedTCIState) configured for the CORESET(s)—in which the PDCCH candidates are received/monitored—is set to ‘10’ or ‘11’ or ‘both’, and/or when the UE is having two indicated TCI states and determined to use/apply one indicated TCI state to PDSCH—e.g., when the UE is not configured with sfnSchemepdsch and/or repetitionScheme (e.g., the higher layer parameter repetitionScheme is not set to ‘fdmSchemeA’ or ‘fdmSchemeB’ or ‘tdmSchemeA’) and/or repetitionNumber (e.g., when the UE is not indicated with a DCI that DCI field ‘Time domain resource assignment’ indicating an entry which contains repetitionNumber in PDSCH-TimeDomainResourceAllocation), the UE could expect the TCI selection field (i.e., the second indicator as specified herein in the present disclosure) present in DCI format 1_1/1_2—i.e., the UE could report its capability of supporting the TCI selection field present in DCI format 1_1/1_2 and/or the UE is configured with tciSelection-PresentlnDCl (e.g., set to ‘enabled’) jointly for both DCI formats 1_1 and 1_2 in the same DL BWP (in this case, the DCI format 1_1/1_2 could indicate codepoint “00” for the TCI selection field (or equivalently, the second indicator as specified herein in the present disclosure) indicating that the first indicated TCI state(s) could be used/applied for PDSCH reception(s)) or codepoint “01” for the TCI selection field (or equivalently, the second indicator as specified herein in the present disclosure) indicating that the second indicated TCI state(s) could be used/applied for PDSCH reception(s) or codepoint “10” for the TCI selection field (or equivalently, the second indicator as specified herein in the present disclosure) indicating that both first and second indicated TCI states could be used/applied for PDSCH reception(s)). That is, in this case, when/if the time offset between the reception of the DL DCI and the corresponding PDSCH is larger (or smaller) than or equal to the threshold timeDurationForQCL if applicable, and the CORESET which schedules the PDSCH is indicated with two TCI states, the UE could expect or identify or determine the TCI state or the QCL assumption for the PDSCH according to/based on the indicated TCI state(s) and the TCI selection field as follows.
If the DCI format 1_1/1_2 indicates codepoint “00” for the TCI selection field (or equivalently, the second indicator as specified herein in the present disclosure), the UE could apply the first one of two indicated joint/DL TCI states to the PDSCH.
If the DCI format 1_1/1_2 indicates codepoint “01” for the TCI selection field (or equivalently, the second indicator as specified herein in the present disclosure), the UE could apply the second one of two indicated joint/DL TCI states to the PDSCH.
If the DCI format 1_1/1_2 indicates codepoint “10” for the TCI selection field (or equivalently, the second indicator as specified herein in the present disclosure), the UE could apply either the first one or the second one of two indicated joint/DL TCI states to the PDSCH according to: (i) fixed rule(s) in system specification(s), (ii) network's configuration(s) or indication(s) via/in higher layer RRC signaling(s)/parameter(s) and/or MAC CE command(s) and/or dynamic DCI based L1 signaling(s), and/or (iii) UE's autonomous determination/selection, which could be further reported to the network, e.g., in/via part of a CSI/beam report and/or UE's capability signaling(s).

Alternatively, when the UE does not report its capability of supporting the TCI selection field present in DCI format 1_1/1_2, and/or the UE is not provided/configured with tciSelection-PresentlnDCl for DCI format 1_1/1_2, and/or the UE provided/configured with tciSelection-PresentlnDCl set to ‘disabled’ for DCI format 1_1/1_2, and/or when/if the UE is provided/configured with dl-OrJointTCI-StateList and/or ul-TCI-StateList, and/or when the UE is having one or two indicated TCI states, the UE may not expect or may not be expected one or more of:
the UE is configured with sfnSchemePdcch set to ‘sfnSchemeA’ and/or ‘sfnSchemeB’ and/or applying two indicated TCI states for the corresponding CORESET(s)—e.g., when/if the first indicator as specified herein in the present disclosure (or equivalently, the higher layer parameter applylndicatedTCIState) configured for the CORESET(s) is set to ‘10’ or ‘11’ or ‘both’,
the UE is applying two indicated TCI states to receive PDCCH candidates associated with search space sets configured with searchSpaceLinking—e.g., when/if the first indicator as specified herein in the present disclosure (or equivalently, the higher layer parameter applylndicatedTCIState) configured for the CORESET(s)—in which the PDCCH candidates are received/monitored—is set to ‘10’ or ‘11’ or ‘both’,
the UE is having two indicated TCI states and determined to use/apply one indicated TCI state to PDSCH—e.g., when the UE is not configured with sfnSchemepdsch and/or repetitionScheme (e.g., the higher layer parameter repetitionScheme is not set to ‘fdmSchemeA’ or ‘fdmSchemeB’ or ‘tdmSchemeA’) and/or repetitionNumber (e.g., when the UE is not indicated with a DCI that DCI field ‘Time domain resource assignment’ indicating an entry which contains repetitionNumber in PDSCH-TimeDomainResourceAllocation).

For PDSCH scheduled by DCI format 1_1/1_2, when/if a UE is provided/configured with dl-OrJointTCI-StateList and/or ul-TCI-StateList, and/or when the UE is configured with sfnSchemePdcch set to ‘sfnSchemeA’ and/or applying two indicated TCI states for the corresponding CORESET(s)—e.g., when/if the first indicator as specified herein in the present disclosure (or equivalently, the higher layer parameter applylndicatedTCIState) configured for the CORESET(s) is set to ‘10’ or ‘11’ or ‘both’, and sfnSchemepdsch is not configured, and/or when the UE is having two indicated TCI states (and/or is determined to use/apply one indicated TCI state to PDSCH), and/or when/if the TCI selection field (i.e., the second indicator as specified herein in the present disclosure) is not present (or absent) in DCI format 1_1/1_2—i.e., the UE may not report its capability of supporting the TCI selection field present in DCI format 1_1/1_2 and/or the UE is not configured with tciSelection-PresentlnDCl jointly for both DCI formats 1_1 and 1_2 in the same DL BWP and/or the UE is configured with tciSelection-PresentInDCIjointly for both DCI formats 1_1 and 1_2 in the same DL BWP but set to ‘disabled’, and/or when/if the time offset between the reception of the DL DCI and the corresponding PDSCH is larger (or smaller) than or equal to the threshold timeDurationForQCL if applicable, and the CORESET which schedules the PDSCH is indicated with two TCI states, the UE could expect or identify or determine that the TCI state or the QCL assumption for the PDSCH is identical to the first or second indicated TCI state(s) or QCL assumption in the first or second indicated TCI state(s) according to/based on at least one of:
Fixed rule(s) in the system specification—e.g., in this case/design example, the UE could expect or identify or determine that the TCI state or the QCL assumption for the PDSCH is identical to the first indicated TCI state(s) or QCL assumption in the first indicated TCI state.
Network's configuration(s) or indication(s) via/in higher layer RRC signaling(s)/parameter(s) and/or MAC CE command(s) and/or dynamic DCI based L1 signaling(s)—e.g., a RRC configuration/parameter applyUnifiedTCIState to the PDSCH.
   If the RRC configuration/parameter applyUnifiedTCIState for the PDSCH is set to ‘first’, the UE could apply the first one of two indicated joint/DL TCI states to the PDSCH.
   If the RRC configuration/parameter applyUnifiedTCIState for the PDSCH is set to ‘second’, the UE could apply the second one of two indicated joint/DL TCI states to the PDSCH.
   If the RRC configuration/parameter applyUnifiedTCIState for the PDSCH is set to ‘both’, the UE could apply either the first one or the second one of two indicated joint/DL TCI states to the PDSCH according to: (i) fixed rule(s) in system specification(s), (ii) network's configuration(s) or indication(s) via/in higher layer RRC signaling(s)/parameter(s) and/or MAC CE command(s) and/or dynamic DCI based L1 signaling(s), and/or (iii) UE's autonomous determination/selection, which could be further reported to the network, e.g., in/via part of a CSI/beam report and/or UE's capability signaling(s).

For PDSCH scheduled by DCI format 1_1/1_2, when/if a UE is provided/configured with dl-OrJointTCI-StateList and/or ul-TCI-StateList, and/or when the UE is configured with sfnSchemePdcch set to ‘sfnSchemeA’ and/or ‘sfnSchemeB’ and/or applying two indicated TCI states for the corresponding CORESET(s)—e.g., when/if the first indicator as specified herein in the present disclosure (or equivalently, the higher layer parameter applylndicatedTCIState) configured for the CORESET(s) is set to ‘10’ or ‘11’ or ‘both’, and/or when the UE is applying two indicated TCI states to receive PDCCH candidates associated with search space sets configured with searchSpaceLinking—e.g., when/if the first indicator as specified herein in the present disclosure (or equivalently, the higher layer parameter applylndicatedTCIState) configured for the CORESET(s)—in which the PDCCH candidates are received/monitored—is set to ‘10’ or ‘11’ or ‘both’, and/or when the UE is having two indicated TCI states and determined to use/apply one indicated TCI state to PDSCH—e.g., when the UE is not configured with sfnSchemepdsch and/or repetitionScheme (e.g., the higher layer parameter repetitionScheme is not set to ‘fdmSchemeA’ or ‘fdmSchemeB’ or ‘tdmSchemeA’) and/or repetitionNumber (e.g., when the UE is not indicated with a DCI that DCI field ‘Time domain resource assignment’ indicating an entry which contains repetitionNumber in PDSCH-TimeDomainResourceAllocation), and/or when/if the TCI selection field (i.e., the second indicator as specified herein in the present disclosure) is not present (or absent) in DCI format 1_1/1_2—i.e., the UE may not report its capability of supporting the TCI selection field present in DCI format 1_1/1_2 and/or the UE is not configured with tciSelection-PresentlnDCl jointly for both DCI formats 1_1 and 1_2 in the same DL BWP and/or the UE is configured with tciSelection-PresentInDCIjointly for both DCI formats 1_1 and 1_2 in the same DL BWP but set to ‘disabled’, and/or when/if the time offset between the reception of the DL DCI and the corresponding PDSCH is larger (or smaller) than or equal to the threshold timeDurationForQCL if applicable, and the CORESET which schedules the PDSCH is indicated with two TCI states, the UE could expect or identify or determine that the TCI state or the QCL assumption for the PDSCH is identical to the first or second indicated TCI state(s) or QCL assumption in the first or second indicated TCI state(s) according to/based on at least one of:
Fixed rule(s) in the system specification—e.g., in this case/design example, the UE (e.g., the UE 116) could expect or identify or determine that the TCI state or the QCL assumption for the PDSCH is identical to the first indicated TCI state(s) or QCL assumption in the first indicated TCI state.
Network's configuration(s) or indication(s) via/in higher layer RRC signaling(s)/parameter(s) and/or MAC CE command(s) and/or dynamic DCI based L1 signaling(s)—e.g., a RRC configuration/parameter applyUnifiedTCIState to the PDSCH.
   If the RRC configuration/parameter applyUnifiedTCIState for the PDSCH is set to ‘first’, the UE could apply the first one of two indicated joint/DL TCI states to the PDSCH.
   If the RRC configuration/parameter applyUnifiedTCIState for the PDSCH is set to ‘second’, the UE could apply the second one of two indicated joint/DL TCI states to the PDSCH.
   If the RRC configuration/parameter applyUnifiedTCIState for the PDSCH is set to ‘both’, the UE could apply either the first one or the second one of two indicated joint/DL TCI states to the PDSCH according to: (i) fixed rule(s) in system specification(s), (ii) network's configuration(s) or indication(s) via/in higher layer RRC signaling(s)/parameter(s) and/or MAC CE command(s) and/or dynamic DCI based L1 signaling(s), and/or (iii) UE's autonomous determination/selection, which could be further reported to the network, e.g., in/via part of a CSI/beam report and/or UE's capability signaling(s).

For PDSCH scheduled by DCI format 1_0, when/if a UE is provided/configured with dl-OrJointTCI-StateList and/or ul-TCI-StateList, and/or when the UE is configured with sfnSchemePdcch set to ‘sfnSchemeA’ and/or applying two indicated TCI states for the corresponding CORESET(s)—e.g., when/if the first indicator as specified herein in the present disclosure (or equivalently, the higher layer parameter applylndicatedTCIState) configured for the CORESET(s) is set to ‘10’ or ‘11’ or ‘both’, and sfnSchemepdsch is not configured, and/or when the UE is having two indicated TCI states (and/or is determined to use/apply one indicated TCI state to PDSCH), the UE could expect the higher layer RRC configuration/parameter applyUnifiedTCIState present/configured/provided for the PDSCH. That is, in this case, when/if the time offset between the reception of the DL DCI and the corresponding PDSCH is larger (or smaller) than or equal to the threshold timeDurationForQCL if applicable, and the CORESET which schedules the PDSCH is indicated with two TCI states, the UE could expect or identify or determine the TCI state or the QCL assumption for the PDSCH according to/based on the indicated TCI state(s) and the higher layer RRC configuration/parameter applyUnifiedTCIState for/to the PDSCH as follows.
If the RRC configuration/parameter applyUnifiedTCIState for the PDSCH is set to ‘first’, the UE could apply the first one of two indicated joint/DL TCI states to the PDSCH.
If the RRC configuration/parameter applyUnifiedTCIState for the PDSCH is set to ‘second’, the UE could apply the second one of two indicated joint/DL TCI states to the PDSCH.
If the RRC configuration/parameter applyUnifiedTCIState for the PDSCH is set to ‘both’, the UE could apply either the first one or the second one of two indicated joint/DL TCI states to the PDSCH according to: (i) fixed rule(s) in system specification(s), (ii) network's configuration(s) or indication(s) via/in higher layer RRC signaling(s)/parameter(s) and/or MAC CE command(s) and/or dynamic DCI based L1 signaling(s), and/or (iii) UE's autonomous determination/selection, which could be further reported to the network, e.g., in/via part of a CSI/beam report and/or UE's capability signaling(s).

Alternatively, when the UE is not provided/configured with the higher layer RRC configuration/parameter/signaling applyUnifiedTCIState to/for the PDSCH scheduled/activated by DCI format 1_0, and/or when/if the UE is provided/configured with dl-OrJointTCI-StateList and/or ul-TCI-StateList, and/or when the UE is having one or two indicated TCI states, the UE may not expect or may not be expected that the UE could be configured with sfnSchemePdcch set to ‘sfnSchemeA’ and/or applying two indicated TCI states for the corresponding CORESET(s)—e.g., when/if the first indicator as specified herein in the present disclosure (or equivalently, the higher layer parameter applylndicatedTCIState) configured for the CORESET(s) is set to ‘10’ or ‘11’ or ‘both’ and sfnSchemepdsch not configured for PDSCH reception scheduled/activated by DCI format 1_0, or equivalently the UE may not expect or may not be expected one or more of:
the UE is configured with sfnSchemePdcch set to ‘sfnSchemeA’ and/or applying two indicated TCI states for the corresponding CORESET(s)—e.g., when/if the first indicator as specified herein in the present disclosure (or equivalently, the higher layer parameter applyIndicatedTCIState) configured for the CORESET(s) is set to ‘10’ or ‘11’ or ‘both’,
the UE is not configured with sfnSchemepdsch for PDSCH reception scheduled/activated by DCI format 1_0.

For PDSCH scheduled by DCI format 1_0, when/if a UE is provided/configured with dl-OrJointTCI-StateList and/or ul-TCI-StateList, and/or when the UE is configured with sfnSchemePdcch set to ‘sfnSchemeA’ and/or ‘sfnSchemeB’ and/or applying two indicated TCI states for the corresponding CORESET(s)—e.g., when/if the first indicator as specified herein in the present disclosure (or equivalently, the higher layer parameter applyIndicatedTCIState) configured for the CORESET(s) is set to ‘10’ or ‘11’ or ‘both’, and/or when the UE is applying two indicated TCI states to receive PDCCH candidates associated with search space sets configured with searchSpaceLinking—e.g., when/if the first indicator as specified herein in the present disclosure (or equivalently, the higher layer parameter applylndicatedTCIState) configured for the CORESET(s)—in which the PDCCH candidates are received/monitored—is set to ‘10’ or ‘11’ or ‘both’, and/or when the UE is having two indicated TCI states and determined to use/apply one indicated TCI state to PDSCH—e.g., when the UE is not configured with sfnSchemepdsch and/or repetitionScheme (e.g., the higher layer parameter repetitionScheme is not set to ‘fdmSchemeA’ or ‘fdmSchemeB’ or ‘tdmSchemeA’) and/or repetitionNumber (e.g., when the UE is not indicated with a DCI that DCI field ‘Time domain resource assignment’ indicating an entry which contains repetitionNumber in PDSCH-TimeDomainResourceAllocation), the UE could expect the higher layer RRC configuration/parameter applyUnifiedTCIState present/configured/provided for the PDSCH. That is, in this case, when/if the time offset between the reception of the DL DCI and the corresponding PDSCH is larger (or smaller) than or equal to the threshold timeDurationForQCL if applicable, and the CORESET which schedules the PDSCH is indicated with two TCI states, the UE could expect or identify or determine the TCI state or the QCL assumption for the PDSCH according to/based on the indicated TCI state(s) and the higher layer RRC configuration/parameter applyUnifiedTCIState for/to the PDSCH as follows.
If the RRC configuration/parameter applyUnifiedTCIState for the PDSCH is set to ‘first’, the UE could apply the first one of two indicated joint/DL TCI states to the PDSCH.
If the RRC configuration/parameter applyUnifiedTCIState for the PDSCH is set to ‘second’, the UE could apply the second one of two indicated joint/DL TCI states to the PDSCH.
If the RRC configuration/parameter applyUnifiedTCIState for the PDSCH is set to ‘both’, the UE could apply either the first one or the second one of two indicated joint/DL TCI states to the PDSCH according to: (i) fixed rule(s) in system specification(s), (ii) network's configuration(s) or indication(s) via/in higher layer RRC signaling(s)/parameter(s) and/or MAC CE command(s) and/or dynamic DCI based L1 signaling(s), and/or (iii) UE's autonomous determination/selection, which could be further reported to the network, e.g., in/via part of a CSI/beam report and/or UE's capability signaling(s).

Alternatively, when the UE is not provided/configured with the higher layer RRC configuration/parameter/signaling applyUnifiedTCIState to/for the PDSCH scheduled/activated by DCI format 1_0, and/or when/if the UE is provided/configured with dl-OrJointTCI-StateList and/or ul-TCI-StateList, and/or when the UE is having one or two indicated TCI states, the UE may not expect or may not be expected one or more of:
the UE is configured with sfnSchemePdcch set to ‘sfnSchemeA’ and/or ‘sfnSchemeB’ and/or applying two indicated TCI states for the corresponding CORESET(s)—e.g., when/if the first indicator as specified herein in the present disclosure (or equivalently, the higher layer parameter applyIndicatedTCIState) configured for the CORESET(s) is set to ‘10’ or ‘11’ or ‘both’,
the UE is applying two indicated TCI states to receive PDCCH candidates associated with search space sets configured with searchSpaceLinking—e.g., when/if the first indicator as specified herein in the present disclosure (or equivalently, the higher layer parameter applyIndicatedTCIState) configured for the CORESET(s)—in which the PDCCH candidates are received/monitored—is set to ‘10’ or ‘11’ or ‘both’,
the UE is having two indicated TCI states and determined to use/apply one indicated TCI state to PDSCH—e.g., when the UE is not configured with sfnSchemepdsch and/or repetitionScheme (e.g., the higher layer parameter repetitionScheme is not set to ‘fdmSchemeA’ or ‘fdmSchemeB’ or ‘tdmSchemeA’) and/or repetitionNumber (e.g., when the UE is not indicated with a DCI that DCI field ‘Time domain resource assignment’ indicating an entry which contains repetitionNumber in PDSCH-TimeDomainResourceAllocation).

For PDSCH scheduled by DCI format 1_0, when/if a UE is provided/configured with dl-OrJointTCI-StateList and/or ul-TCI-StateList, and/or when the UE is configured with sfnSchemePdcch set to ‘sfnSchemeA’ and/or applying two indicated TCI states for the corresponding CORESET(s)—e.g., when/if the first indicator as specified herein in the present disclosure (or equivalently, the higher layer parameter applylndicatedTCIState) configured for the CORESET(s) is set to ‘10’ or ‘11’ or ‘both’, and sfnSchemepdsch is not configured, and/or when the UE is having two indicated TCI states (and/or is determined to use/apply one indicated TCI state to PDSCH), and/or when/if the UE is not provided/configured with the higher layer RRC configuration/parameter/signaling applyUnifiedTCIState to/for the PDSCH scheduled/activated by DCI format 1_0, and/or when/if the time offset between the reception of the DL DCI and the corresponding PDSCH is larger (or smaller) than or equal to the threshold timeDurationForQCL if applicable, and the CORESET which schedules the PDSCH is indicated with two TCI states, the UE could expect or identify or determine that the TCI state or the QCL assumption for the PDSCH is identical to the first or second indicated TCI state(s) or QCL assumption in the first or second indicated TCI state(s) according to/based on at least one of:
Fixed rule(s) in the system specification—e.g., in this case/design example, the UE could expect or identify or determine that the TCI state or the QCL assumption for the PDSCH is identical to the first indicated TCI state(s) or QCL assumption in the first indicated TCI state.
Network's configuration(s) or indication(s) via/in higher layer RRC signaling(s)/parameter(s) and/or MAC CE command(s) and/or dynamic DCI based L1 signaling(s).

For PDSCH scheduled by DCI format 1_0, when/if a UE is provided/configured with dl-OrJointTCI-StateList and/or ul-TCI-StateList, and/or when the UE is configured with sfnSchemePdcch set to ‘sfnSchemeA’ and/or ‘sfnSchemeB’ and/or applying two indicated TCI states for the corresponding CORESET(s)—e.g., when/if the first indicator as specified herein in the present disclosure (or equivalently, the higher layer parameter applylndicatedTCIState) configured for the CORESET(s) is set to ‘10’ or ‘11’ or ‘both’, and/or when the UE is applying two indicated TCI states to receive PDCCH candidates associated with search space sets configured with searchSpaceLinking—e.g., when/if the first indicator as specified herein in the present disclosure (or equivalently, the higher layer parameter applylndicatedTCIState) configured for the CORESET(s)—in which the PDCCH candidates are received/monitored—is set to ‘10’ or ‘11’ or ‘both’, and/or when the UE is having two indicated TCI states and determined to use/apply one indicated TCI state to PDSCH—e.g., when the UE is not configured with sfnSchemepdsch and/or repetitionScheme (e.g., the higher layer parameter repetitionScheme is not set to ‘fdmSchemeA’ or ‘fdmSchemeB’ or ‘tdmSchemeA’) and/or repetitionNumber (e.g., when the UE is not indicated with a DCI that DCI field ‘Time domain resource assignment’ indicating an entry which contains repetitionNumber in PDSCH-TimeDomainResourceAllocation), and/or when/if the UE is not provided/configured with the higher layer RRC configuration/parameter/signaling applyUnifiedTCIState to/for the PDSCH scheduled/activated by DCI format 1_0, and/or when/if the time offset between the reception of the DL DCI and the corresponding PDSCH is larger (or smaller) than or equal to the threshold timeDurationForQCL if applicable, and the CORESET which schedules the PDSCH is indicated with two TCI states, the UE could expect or identify or determine that the TCI state or the QCL assumption for the PDSCH is identical to the first or second indicated TCI state(s) or QCL assumption in the first or second indicated TCI state(s) according to/based on at least one of:
Fixed rule(s) in the system specification—e.g., in this case/design example, the UE could expect or identify or determine that the TCI state or the QCL assumption for the PDSCH is identical to the first indicated TCI state(s) or QCL assumption in the first indicated TCI state.
Network's configuration(s) or indication(s) via/in higher layer RRC signaling(s)/parameter(s) and/or MAC CE command(s) and/or dynamic DCI based L1 signaling(s).

For a multi-slot PDSCH or a UE is configured with higher layer parameter pdschTimeDomainAllocationListForMultiPDSCH-r17, the indicated TCI state(s) could be based on the activated TCI states in the first slot with the scheduled PDSCH(s), and the UE could expect the activated TCI states are the same across the slots with the scheduled PDSCH(s). Furthermore, when/if the UE is provided/configured with dl-OrJointTCI-StateList and/or ul-TCI-StateList, and/or when/if the TCI selection field (i.e., the second indicator as specified herein in the present disclosure) is present in DCI format 1_1/1_2—i.e., the UE could report its capability of supporting the TCI selection field present in DCI format 1_1/1_2 and/or the UE is configured with tciSelection-PresentlnDCl (e.g., set to ‘enabled’) jointly for both DCI formats 1_1 and 1_2 in the same DL BWP, the TCI selection field indicated on/in a (or each) slot could be applied to the scheduled PDSCH on/in the same (or each) slot.

In addition, for a multi-slot PUSCH or a UE is configured with higher layer parameter pusch-TimeDomainAllocationListForMultiPUSCH-r16, the indicated TCI state(s) could be based on the activated TCI states in the first slot with the scheduled PUSCH(s), and the UE could expect the activated TCI states are the same across the slots with the scheduled PUSCH(s). Furthermore, when/if the UE is provided/configured with dl-OrJointTCI-StateList and/or ul-TCI-StateList, and/or when/if the SRS resource set indicator field (i.e., the fourth indicator as specified herein in the present disclosure) is present in DCI format 0_1/0_2, the SRS resource set indicator field indicated on/in a (or each) slot could be applied to the scheduled PUSCH on/in the same (or each) slot.

When/if a UE is provided/configured with dl-OrJointTCI-StateList and/or ul-TCI-StateList, and/or when/if the UE is having two indicated TCI states to be applied to PDSCH,
For example, for the PDSCH scheduled/activated by DCI format 1_1/1_2 with the TCI selection field present in DCI format 1_1/1_2—e.g., the UE could report its capability of supporting the TCI selection field present in DCI format 1_1/1_2 and/or the UE is configured with tciSelection-PresentInDCI (e.g., set to ‘enabled’) jointly for both DCI formats 1_1 and 1_2 in the same DL BWP, the DCI format 1_1/1_2 could indicate codepoint “10” for the TCI selection field (or equivalently, the second indicator as specified herein in the present disclosure) such that the UE could apply the two indicated joint/DL TCI states to the PDSCH
For another example, for the PDSCH scheduled/activated by DCI format 1_0, the RRC configuration/parameter applyUnifiedTCIState for the PDSCH could be present/configured/provided and set to ‘both’ such that the UE could apply the two indicated joint/DL TCI states to the PDSCH and the UE receives the DM-RS for PDSCH and an SS/PBCH block in the same OFDM symbol(s), then the UE may expect that at least one DM-RS port for the PDSCH and SS/PBCH block are quasi co-located with ‘QCL-TypeD’, if ‘QCL-TypeD’ is applicable.

As specified herein in the present disclosure, the TCI selection field (i.e., the second indicator as specified herein in the present disclosure) could be present in DCI format 1_1/1_2 on a per DL BWP basis—i.e., the UE could report its capability of supporting the TCI selection field present in DCI format 1_1/1_2 for a DL BWP and/or the UE could be configured with tciSelection-PresentInDCI (e.g., set to ‘enabled’) jointly for both DCI formats 1_1 and 1_2 in the same DL BWP.
In one embodiment, the UE could be indicated/instructed/informed by the network, e.g., via a DCI carrying the BWP switching command, to switch from a (DL) BWP—denoted by (DL) BWP 0—to another (DL) BWP—denoted by (DL) BWP 1.
In one example, the TCI selection field could be present in DCI format 1_1/1_2 for the (DL) BWP 0—i.e., the UE could report its capability of supporting the TCI selection field present in DCI format 1_1/1_2 for the (DL) BWP 0 and/or the UE could be configured with tciSelection-PresentInDCI (e.g., set to ‘enabled’) jointly for both DCI formats 1_1 and 1_2 in the (DL) BWP 0, while the TCI selection field may not be present (or absent) in DCI format 1_1/1_2 for the (DL) BWP 1—i.e., the UE may not report its capability of supporting the TCI selection field present in DCI format 1_1/1_2 for the (DL) BWP 1 and/or the UE is not configured with tciSelection-PresentInDCIjointly for both DCI formats 1_1 and 1_2 in the (DL) BWP 1 and/or the UE is configured with tciSelection-PresentInDCIjointly for both DCI formats 1_1 and 1_2 in the (DL) BWP 1 but set to ‘disabled’. In this case/design example, e.g., after the UE has been switched from the (DL) BWP 0 to the (DL) BWP 1 as specified herein in the present disclosure
   For example, before application of any configured and/or activated and/or indicated TCI state(s) specific to the (DL) BWP 1, the UE could use/apply/follow the TCI state(s) and/or the TCI selection field indicated in/for the (DL) BWP 0 for PDSCH reception in the (DL) BWP 1.
   For another example, before application of any configured and/or activated and/or indicated TCI state(s) specific to the (DL) BWP 1, (1) when/if the UE is in frequency range 1 and/or reports its capability of supporting two beams for MTRP operation, the UE could use/apply/follow two default joint/DL TCI states specific to the (DL) BWP 1 for PDSCH reception in the (DL) BWP 1, (2) otherwise, the UE could use/apply/follow a single default joint/DL TCI state specific to the (DL) BWP 1 for PDSCH reception in the (DL) BWP 1, wherein the default joint/DL TCI state(s) could be determined/identified according to: (i) fixed rule(s) in system specification(s)—e.g., same as the TCI state(s) indicated/applied for the (DL) BWP 0, having the same TCI state index(es) as the TCI state(s) indicated/applied for the (DL) BWP 0 but determined from the TCI state(s) specific to the (DL) BWP 1, (ii) network's signaling(s), indication(s) or configuration(s), e.g., via/in higher layer RRC signaling(s)/parameter(s) and/or MAC CE command(s) and/or dynamic DCI based L1 signaling, and/or (iii) UE's determination/selection, which could be further reported to the network, e.g., in/via part of a CSI/beam report and/or UE's capability signaling(s).
In another example, the TCI selection field could be present in DCI format 1_1/1_2 for the (DL) BWP 0—i.e., the UE could report its capability of supporting the TCI selection field present in DCI format 1_1/1_2 for the (DL) BWP 0 and/or the UE could be configured with tciSelection-PresentInDCI (e.g., set to ‘enabled’) jointly for both DCI formats 1_1 and 1_2 in the (DL) BWP 0, and the TCI selection field could also be present in DCI format 1_1/1_2 for the (DL) BWP 1—i.e., the UE could report its capability of supporting the TCI selection field present in DCI format 1_1/1_2 for the (DL) BWP 1 and/or the UE could be configured with tciSelection-PresentlnDCl (e.g., set to ‘enabled’) jointly for both DCI formats 1_1 and 12 in the (DL) BWP 1. In this case/design example, e.g., after the UE has been switched from the (DL) BWP 0 to the (DL) BWP 1 as specified herein in the present disclosure
   For example, before application of any configured and/or activated and/or indicated TCI state(s) and/or the TCI selection field specific to the (DL) BWP 1, the UE could use/apply/follow the TCI state(s) and/or the TCI selection field indicated in/for the (DL) BWP 0 for PDSCH reception in the (DL) BWP 1.
   For another example, before application of any configured and/or activated and/or indicated TCI state(s) specific to the (DL) BWP 1 and/or after the TCI selection field specific to the (DL) BWP 1 has become applicable, the UE could use/apply/follow the TCI selection field specific to the (DL) BWP 1 to determine which of the applicable TCI state(s) to use/apply for PDSCH reception in the (DL) BWP 1, wherein:
      The applicable TCI state(s) could correspond to the TCI state(s) indicated in/for the (DL) BWP 0, and/or
      The applicable TCI state(s) could be determined/identified according to: (i) fixed rule(s) in system specification(s)—e.g., same as the TCI state(s) indicated/applied for the (DL) BWP 0, having the same TCI state index(es) as the TCI state(s) indicated/applied for the (DL) BWP 0 but determined from the TCI state(s) specific to the (DL) BWP 1, (ii) network's signaling(s), indication(s) or configuration(s), e.g., via/in higher layer RRC signaling(s)/parameter(s) and/or MAC CE command(s) and/or dynamic DCI based L1 signaling, and/or (iii) UE's determination/selection, which could be further reported to the network, e.g., in/via part of a CSI/beam report and/or UE's capability signaling(s).
   For another example, before application of any configured and/or activated and/or indicated TCI state(s) and/or the TCI selection field specific to the (DL) BWP 1, (1) when/if the UE is in frequency range 1 and/or reports its capability of supporting two beams for MTRP operation, the UE could use/apply/follow two default joint/DL TCI states specific to the (DL) BWP 1 for PDSCH reception in the (DL) BWP 1, (2) otherwise, the UE could use/apply/follow a single default joint/DL TCI state specific to the (DL) BWP 1 for PDSCH reception in the (DL) BWP 1, wherein the default joint/DL TCI state(s) could be determined/identified according to: (i) fixed rule(s) in system specification(s)—e.g., same as the TCI state(s) indicated/applied for the (DL) BWP 0, having the same TCI state index(es) as the TCI state(s) indicated/applied for the (DL) BWP 0 but determined from the TCI state(s) specific to the (DL) BWP 1, (ii) network's signaling(s), indication(s) or configuration(s), e.g., via/in higher layer RRC signaling(s)/parameter(s) and/or MAC CE command(s) and/or dynamic DCI based L1 signaling, and/or (iii) UE's determination/selection, which could be further reported to the network, e.g., in/via part of a CSI/beam report and/or UE's capability signaling(s).
In another example, the TCI selection field may not be present (or absent) in DCI format 1_1/1_2 for the (DL) BWP 0—i.e., the UE may not report its capability of supporting the TCI selection field present in DCI format 1_1/1_2 for the (DL) BWP 0 and/or the UE is not configured with tciSelection-PresentInDCIjointly for both DCI formats 1_1 and 1_2 in the (DL) BWP 0 and/or the UE is configured with tciSelection-PresentInDCIjointly for both DCI formats 1_1 and 1_2 in the (DL) BWP 0 but set to ‘disabled’, while the TCI selection field could be present in DCI format 1_1/1_2 for the (DL) BWP 1—i.e., the UE could report its capability of supporting the TCI selection field present in DCI format 1_1/1_2 for the (DL) BWP 1 and/or the UE could be configured with tciSelection-PresentInDCI (e.g., set to ‘enabled’) jointly for both DCI formats 1_1 and 1_2 in the (DL) BWP 1. In this case/design example, e.g., after the UE has been switched from the (DL) BWP 0 to the (DL) BWP 1 as specified herein in the present disclosure
   For example, before application of any configured and/or activated and/or indicated TCI state(s) specific to the (DL) BWP 1 and/or after the TCI selection field specific to the (DL) BWP 1 has become applicable, the UE could use/apply/follow the TCI selection field specific to the (DL) BWP 1 to determine which of the applicable TCI state(s) to use/apply for PDSCH reception in the (DL) BWP 1, wherein:
      The applicable TCI state(s) could correspond to the TCI state(s) indicated in/for the (DL) BWP 0, and/or
      The applicable TCI state(s) could be determined/identified according to: (i) fixed rule(s) in system specification(s)—e.g., same as the TCI state(s) indicated/applied for the (DL) BWP 0, having the same TCI state index(es) as the TCI state(s) indicated/applied for the (DL) BWP 0 but determined from the TCI state(s) specific to the (DL) BWP 1, (ii) network's signaling(s), indication(s) or configuration(s), e.g., via/in higher layer RRC signaling(s)/parameter(s) and/or MAC CE command(s) and/or dynamic DCI based L1 signaling, and/or (iii) UE's determination/selection, which could be further reported to the network, e.g., in/via part of a CSI/beam report and/or UE's capability signaling(s).
   For another example, before application of any configured and/or activated and/or indicated TCI state(s) and/or the TCI selection field specific to the (DL) BWP 1, (1) when/if the UE is in frequency range 1 and/or reports its capability of supporting two beams for MTRP operation, the UE could use/apply/follow two default joint/DL TCI states specific to the (DL) BWP 1 for PDSCH reception in the (DL) BWP 1, (2) otherwise, the UE could use/apply/follow a single default joint/DL TCI state specific to the (DL) BWP 1 for PDSCH reception in the (DL) BWP 1, wherein the default joint/DL TCI state(s) could be determined/identified according to: (i) fixed rule(s) in system specification(s)—e.g., same as the TCI state(s) indicated/applied for the (DL) BWP 0, having the same TCI state index(es) as the TCI state(s) indicated/applied for the (DL) BWP 0 but determined from the TCI state(s) specific to the (DL) BWP 1, (ii) network's signaling(s), indication(s) or configuration(s), e.g., via/in higher layer RRC signaling(s)/parameter(s) and/or MAC CE command(s) and/or dynamic DCI based L1 signaling, and/or (iii) UE's determination/selection, which could be further reported to the network, e.g., in/via part of a CSI/beam report and/or UE's capability signaling(s).
In another example, the TCI selection field may not be present (or absent) in DCI format 1_1/1_2 for the (DL) BWP 0—i.e., the UE (e.g., the UE 116) may not report its capability of supporting the TCI selection field present in DCI format 1_1/1_2 for the (DL) BWP 0 and/or the UE is not configured with tciSelection-PresentInDCIjointly for both DCI formats 1_1 and 1_2 in the (DL) BWP 0 and/or the UE is configured with tciSelection-PresentInDCIjointly for both DCI formats 1_1 and 1_2 in the (DL) BWP 0 but set to ‘disabled’, and the TCI selection field also may not be present (or absent) in DCI format 1_1/1_2 for the (DL) BWP 1—i.e., the UE may not report its capability of supporting the TCI selection field present in DCI format 1_1/1_2 for the (DL) BWP 1 and/or the UE is not configured with tciSelection-PresentInDCIjointly for both DCI formats 1_1 and 1_2 in the (DL) BWP 1 and/or the UE is configured with tciSelection-PresentInDCIjointly for both DCI formats 1_1 and 1_2 in the (DL) BWP 1 but set to ‘disabled’. In this case/design example, e.g., after the UE has been switched from the (DL) BWP 0 to the (DL) BWP 1 as specified herein in the present disclosure, and before application of any configured and/or activated and/or indicated TCI state(s) specific to the (DL) BWP 1, (1) when/if the UE is in frequency range 1 and/or reports its capability of supporting two beams for MTRP operation, the UE could use/apply/follow two default joint/DL TCI states specific to the (DL) BWP 1 for PDSCH reception in the (DL) BWP 1, (2) otherwise, the UE could use/apply/follow a single default joint/DL TCI state specific to the (DL) BWP 1 for PDSCH reception in the (DL) BWP 1, wherein the default joint/DL TCI state(s) could be determined/identified according to: (i) fixed rule(s) in system specification(s)—e.g., same as the TCI state(s) indicated/applied for the (DL) BWP 0, having the same TCI state index(es) as the TCI state(s) indicated/applied for the (DL) BWP 0 but determined from the TCI state(s) specific to the (DL) BWP 1, (ii) network's signaling(s), indication(s) or configuration(s), e.g., via/in higher layer RRC signaling(s)/parameter(s) and/or MAC CE command(s) and/or dynamic DCI based L1 signaling, and/or (iii) UE's determination/selection, which could be further reported to the network, e.g., in/via part of a CSI/beam report and/or UE's capability signaling(s).

A SS/PBCH block symbol is a symbol of an SS/PBCH block with candidate SS/PBCH block index corresponding to the SS/PBCH block index indicated to a UE by ssb-PositionsInBurst in SIB1 or ssb-PositionsInBurst in ServingCellConfigCommon or, if the UE is not provided dl-OrJointTCI-StateList, by ssb-PositionsInBurst in SSB-MTCAdditionalPCJ associated to physical cell ID with active TCI states for PDCCH or PDSCH, or by ssb-PositionsInBurst-r18 in LTM-SSB-Config-r18 associated to physical cell ID—e.g., provided by ltm-CandidatePCI-r18 in the corresponding higher layer parameter LTM-Candidate-r18—e.g., with active TCI states for at least PDCCH or PDSCH (e.g., associated/specific to the physical cell ID), or for a set of symbols of a slot corresponding to SS/PBCH blocks configured for L1 beam measurement/reporting. For unpaired spectrum, the UE determines the N_{PUCCH}^{repeat} slots for a PUCCH transmission starting from a slot indicated to the UE as described in clause 9.2.3 in the 3GPP TS 38.213 for HARQ-ACK reporting, or a slot determined as described in clause 9.2.4 in the 3GPP TS 38.213 for SR reporting or in clause 5.2.1.4 of [6, the 3GPP TS 38.214] for CSI reporting and having
an UL symbol, as described in clause 11.1 in the 3GPP TS 38.213, or flexible symbol that is not SS/PBCH block symbol provided by startingSymbolIndex as a first symbol, and
consecutive UL symbols, as described in clause 11.1 in the 3GPP TS 38.213, or flexible symbols that are not SS/PBCH block symbols, starting from the first symbol, equal to or larger than a number of symbols provided by nrofsymbols.

For monitoring of a PDCCH candidate by a UE, if the UE
has received ssb-PositionsInBurst-r18 in LTM-SSB-Config-r18 associated to physical cell ID—e.g., provided by ltm-CandidatePCI-r18 in the corresponding higher layer parameter LTM-Candidate-r18—e.g., with active TCI states for at least PDCCH or PDSCH (e.g., associated/specific to the physical cell ID), wherein the LTM-SSB-Config-r18 and/or LTM-Candidate-r18 could be provided or configured for a serving cell, and/or
has received ssb-PositionsInBurst-r18 in LTM-SSB-Config-r18/LTM-Candidate-r18 for a serving cell, and
at least one RE for a PDCCH candidate overlaps with at least one RE of a candidate SS/PBCH block, after puncturing if applicable, corresponding to a SS/PBCH block index provided by ssb-PositionsInBurst in LTM-SSB-Config-r18 with same physical cell identity as the one associated with a RS having same quasi-collocation properties as a CORESET for the PDCCH candidate, the UE is not required to monitor the PDCCH candidate.

For operation on a single carrier in unpaired spectrum, for a set of symbols of a slot indicated to a UE for reception of SS/PBCH blocks by ssb-PositionsInBurst in SIB1 or by ssb-PositionsInBurst in ServingCellConfigCommon or, if the UE is not provided dl-OrJointTCI-StateList, by ssb-PositionsInBurst in SSB-MTCAdditionalPCJ associated to physical cell ID with active TCI states for PDCCH or PDSCH, or by ssb-PositionsInBurst-r18 in LTM-SSB-Config-r18 associated to physical cell ID—e.g., provided by ltm-CandidatePCl-r18 in the corresponding higher layer parameter LTM-Candidate-r18—e.g., with active TCI states for at least PDCCH or PDSCH (e.g., associated/specific to the physical cell ID), or for a set of symbols of a slot corresponding to SS/PBCH blocks configured for L1 beam measurement/reporting, the UE does not transmit PUSCH, PUCCH, physical random access channel (PRACH) in the slot if a transmission would overlap with any symbol from the set of symbols and the UE does not transmit SRS in the set of symbols of the slot. The UE does not expect the set of symbols of the slot to be indicated as uplink by tdd-UL-DL-ConfigurationCommon, or tdd-UL-DL-ConfigurationDedicated, when provided to the UE.

If a UE
is configured with multiple serving cells and is provided with directionalCollisionHandling-r16=‘enabled’ for a set of serving cell(s) among the multiple serving cells, and
indicates support of half-DuplexTDD-CA-SameSCS-r16 capability, and
is not configured to monitor PDCCH for detection of DCI format 2_0 on any of the multiple serving cells,
   for a set of symbols of a slot that are indicated to the UE for reception of SS/PBCH blocks in a first cell of the multiple serving cells by ssb-PositionsInBurst in SystemInformationBlockType1 or by ssb-PositionsInBurst in ServingCellConfigCommon or, if the UE is not provided dl-OrJointTCI-StateList, by ssb-PositionsInBurst in SSB-MTCAdditionalPCJ associated to physical cell ID with active TCI states for PDCCH or PDSCH, or by ssb-PositionsInBurst-r18 in LTM-SSB-Config-r18 associated to physical cell ID—e.g., provided by ltm-CandidatePCl-r18 in the corresponding higher layer parameter LTM-Candidate-r18—e.g., with active TCI states for at least PDCCH or PDSCH (e.g., associated/specific to the physical cell ID), or for a set of symbols of a slot corresponding to SS/PBCH blocks configured for L1 beam measurement/reporting, the UE does not transmit PUSCH, PUCCH, or PRACH in the slot if a transmission would overlap with any symbol from the set of symbols, and the UE does not transmit SRS in the set of symbols of the slot in
any of the multiple serving cells if the UE is not capable of simultaneous transmission and reception as indicated by simultaneousRxTxInterBandCA among the multiple serving cells, and
any one of the cells corresponding to the same band as the first cell, irrespective of any capability indicated by simultaneousRxTxInterBandCA.

For a set of symbols of a slot corresponding to SS/PBCH blocks with candidate SS/PBCH block indices corresponding to the SS/PBCH block indexes indicated to a UE by ssb-PositionsInBurst in SIB1, or by ssb-PositionsInBurst in ServingCellConfigCommon, as described in clause 4.1, or by NonCellDefiningSSB or, if the UE is not provided dl-OrJointTCI-StateList, by ssb-PositionsInBurst in SSB-MTCAdditionalPCI associated to physical cell ID with active TCI states for PDCCH or PDSCH, or by ssb-PositionsInBurst-r18 in LTM-SSB-Config-r18 associated to physical cell ID—e.g., provided by ltm-CandidatePCI-r18 in the corresponding higher layer parameter LTM-Candidate-r18—e.g., with active TCI states for at least PDCCH or PDSCH (e.g., associated/specific to the physical cell ID), or for a set of symbols of a slot corresponding to SS/PBCH blocks configured for L1 beam measurement/reporting, the UE does not expect to detect a DCI format 2_0 with an slot format indication (SFI)—index field value indicating the set of symbols of the slot as uplink.

When a UE configured with dl-OrJointTCI-StateList and having two indicated TCI-states would transmit a PUCCH with positive HARQ-ACK or a PUSCH with positive HARQ-ACK corresponding to the DCI carrying the TCI State(s) indication and without DL assignment, or corresponding to the PDSCH scheduled by the DCI carrying the TCI State(s) indication, and
if the TCI State(s) indication comprises first TCI State(s), and the indicated first TCI State(s) is/are different from the previously indicated first TCI State(s), the indicated first TCI-State(s) and/or TCI-UL-State(s) should be applied starting from the first slot that is at least beamAppTime symbols after the last symbol of the PUCCH or the PUSCH, and/or
if the TCI State(s) indication comprises second TCI State(s), and the indicated second TCI State(s) is/are different from the previously indicated second TCI State(s), the indicated second TCI-State(s) and/or TCI-UL-State(s) should be applied starting from the first slot that is at least beamAppTime symbols after the last symbol of the PUCCH or the PUSCH.

When a UE is configured by higher layer parameter PDCCH-Config that contains two different values of coresetPoolIndex in ControlResourceSet, and when the UE configured with dl-OrJointTCI-StateList and having two indicated TCI-states would transmit a PUCCH with positive HARQ-ACK or a PUSCH with positive HARQ-ACK corresponding to the DCI, for the corresponding coresetPoolIndex value when applicable, carrying the TCI State(s) indication and without DL assignment, or corresponding to the PDSCH scheduled by the DCI, for the corresponding coresetPoolIndex value when applicable, carrying the TCI State(s) indication, wherein as aforementioned the DCI is received in CORESET(s) associated/specific to a value of coresetPoolIndex (e.g., 0 or 1), and if the indicated TCI State(s)—specific to the (same) value of coresetPoolIndex—is/are different from the previously indicated TCI State(s)—specific to the (same) value of coresetPoolIndex, the indicated TCI-State(s) and/or TCI-UL-State(s) should be applied starting from the first slot that is at least beamAppTime symbols after the last symbol of the PUCCH or the PUSCH. In this case, when/if the value of coresetPoolIndex is 0, the indicated TCI State(s) and the previously indicated TCI State(s) herein could be specific to the first indicated or indicated first TCI State(s) specific to coresetPoolIndex of value 0, and when/if the value of coresetPoolIndex is 1, the indicated TCI State(s) and the previously indicated TCI State(s) herein could be specific to the second indicated or indicated second TCI State(s) specific to coresetPoolIndex of value 1.

When a UE configured with dl-OrJointTCI-StateList would transmit a PUCCH with positive HARQ-ACK or a PUSCH with positive HARQ-ACK corresponding to the DCI carrying the TCI State indication and without DL assignment, or corresponding to the PDSCH scheduled by the DCI carrying the TCI State indication, and if the UE receives more than one indicated TCI state, e.g., respectively in different or separate DCIs or more than one DCI in time (hence by/of different or separate TCI codepoints or more than one TCI codepoint of different or separate TCI fields or more than one TCI field in the corresponding DCIs), for a CC/BWP to be applied starting from the first slot that is at least beamAppTime symbols after the last symbol of the PUCCH or the PUSCH, the indicated TCI state carried in the latest DCI, for the corresponding coresetPoolIndex value when applicable, in time corresponding to positive HARQ-ACK value is applied.

When a UE configured with dl-OrJointTCI-StateList and having two indicated TCI-states would transmit a PUCCH with positive HARQ-ACK or a PUSCH with positive HARQ-ACK corresponding to the DCI carrying the TCI State(s) indication and without DL assignment, or corresponding to the PDSCH scheduled by the DCI carrying the TCI State(s) indication, and if the UE receives more than one indicated first TCI state, e.g., respectively in different or separate DCIs or more than one DCI in time (hence by/of different or separate TCI codepoints or more than one TCI codepoint of different or separate TCI fields or more than one TCI field in the corresponding DCIs), for a CC/BWP to be applied starting from the first slot that is at least beamAppTime symbols after the last symbol of the PUCCH or the PUSCH, the indicated first TCI state carried in the latest DCI, for the corresponding coresetPoolIndex value when applicable, in time corresponding to positive HARQ-ACK value is applied, and/or if the UE receives more than one indicated second TCI state, e.g., respectively in different or separate DCIs or more than one DCI in time (hence by/of different or separate TCI codepoints or more than one TCI codepoint of different or separate TCI fields or more than one TCI field in the corresponding DCIs), for a CC/BWP to be applied starting from the first slot that is at least beamAppTime symbols after the last symbol of the PUCCH or the PUSCH, the indicated second TCI state carried in the latest DCI, for the corresponding coresetPoolIndex value when applicable, in time corresponding to positive HARQ-ACK value is applied.

The first slot and the beamAppTime symbols as specified/defined herein in the present disclosure are both determined on the active BWP with the smallest SCS among the BWP(s) from the CCs applying the indicated (first and/or second) TCI-State(s) or TCI-UL-State(s) that are active at the end of the corresponding PUCCH or the PUSCH carrying the positive HARQ-ACK.

The specified/described design examples herein/procedures for PDSCH reception during BWP switching can be extended/applied to PUSCH transmission by replacing the TCI selection field in DCI format 1_1/1_2 with the SRS resource set indicator field in DCI format 0_1/0_2, and by replacing the PDSCH reception with the PUSCH transmission.

Throughout the present disclosure, i.e., for the design examples/procedures specified herein in the present disclosure, a/the UE could be provided/configured with dl-OrJointTCI-StateList and/or ul-TCI-StateList.

In a multi-TRP system, a UE could apply one or more (e.g., 2) indicated TCI states for PDSCH reception(s). Furthermore, determination of the one or more indicated TCI states could be based on or according to various conditions including network's configuration(s)/indication(s), e.g., via higher layer RRC signaling(s)/parameter(s) and/or MAC CE command(s) and/or dynamic DCI based L1 signaling(s). In this case, how a UE would determine or identify demodulation reference signal (DMRS) antenna port(s) for PDSCH reception(s) needs to be specified.

This disclosure specifies various design aspects and/or conditions related to DMRS antenna ports determination for PDSCH reception(s) in a multi-TRP system under unified TCI framework, wherein one or more indicated TCI states can be used/applied for PDSCH reception(s) according to/based on various conditions and/or network's configuration(s)/indication(s).

As specified in Rel-17, a unified TCI framework could indicate/include N≥1 DL TCI states and/or M≥1 UL TCI states, wherein the indicated TCI state could be at least one of:
A DL TCI state and/or its corresponding/associated TCI state ID
An UL TCI state and/or its corresponding/associated TCI state ID
A joint DL and UL TCI state and/or its corresponding/associated TCI state ID
Separate DL TCI state and UL TCI state and/or their corresponding/associated TCI state ID(s)

There could be various design options/channels to indicate to the UE a beam (i.e., a TCI state) for the transmission/reception of a PDCCH or a PDSCH. As described in the 3GPP Rel-17,
In one example, a MAC CE could be used to indicate to the UE a beam (i.e., a TCI state and/or a TCI state ID) for the transmission/reception of a PDCCH or a PDSCH.
In another example, a DCI could be used to indicate to the UE a beam (i.e., a TCI state and/or a TCI state ID) for the transmission/reception of a PDCCH or a PDSCH
   For example, a DL related DCI (e.g., DCI format 1_0, DCI format 1_1 or DCI format 1_2) could be used to indicate to the UE a beam (i.e., a TCI state and/or a TCI state ID) for the transmission/reception of a PDCCH or a PDSCH, wherein the DL related DCI may or may not include a DL assignment.
   For another example, an UL related DCI (e.g., DCI format 0_0, DCI format 0_1, DCI format 0_2) could be used to indicate to the UE a beam (i.e., a TCI state and/or a TCI state ID) for the transmission/reception of a PDCCH or a PDSCH, wherein the UL related DCI may or may not include an UL scheduling grant.
   Yet for another example, a custom/purpose designed DCI format could be used to indicate to the UE a beam (i.e., a TCI state and/or a TCI state ID) for the transmission/reception of a PDCCH or a PDSCH.

Rel-17 introduced the unified TCI framework, where a unified or master or main TCI state is signaled to the UE. The unified or master or main TCI state can be one of:
In case of joint TCI state indication, wherein a same beam is used for DL and UL channels, a joint TCI state that can be used at least for UE-dedicated DL channels and UE-dedicated UL channels.
In case of separate TCI state indication, wherein different beams are used for DL and UL channels, a DL TCI state can be used at least for UE-dedicated DL channels.
In case of separate TCI state indication, wherein different beams are used for DL and UL channels, a UL TCI state can be used at least for UE-dedicated UL channels.

The unified (master or main) TCI state is TCI state of UE-dedicated reception on PDSCH/PDCCH or dynamic-grant/configured-grant based PUSCH and dedicated PUCCH resources.

In a (single-DCI based) multi-TRP system, a UE could be indicated/provided/configured by the network, e.g., via a beam indication MAC CE or a DCI (e.g., via one or more TCI codepoints of one or more TCI fields in the corresponding DCI 1_1/1_2 with or without DL assignment), a set of one or more (e.g., N>1) TCI states/pairs of TCI states, wherein a TCI state could be a joint DL and UL TCI state or a separate DL TCI state provided by TCI-State/DLorJointTCI-State, or a separate UL TCI state provided by TCI-State/UL-TCIState, and a pair of TCI states could include/contain a separate DL TCI state provided by TCI-State/DLorJointTCI-State or a separate UL TCI State provided by TCI-State/UL-TCIState, under the unified TCI framework.

For PDCCH reception or PDCCH candidate monitoring in a (single-DCI based) multi-TRP system, a UE could be configured/provided/indicated by the network (e.g., the network 130) via higher layer RRC signaling/parameter and/or MAC CE command and/or dynamic DCI based L1 signaling—e.g., in higher layer RRC signaling/parameter ControlResourceSet that configures a CORESET—a first indicator to indicate which one or more of the set of TCI states/pairs of TCI states indicated, e.g., by a TCI codepoint, in a beam indication DCI or MAC CE as specified herein in the present disclosure, to use/apply for receiving/monitoring the PDCCH(s)/PDCCH candidate(s) in the corresponding CORESET. For instance, for N=2 (i.e., a set of two TCI states/pairs of TCI states are indicated), the first indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for receiving/monitoring the PDCCH(s)/PDCCH candidate(s) in the corresponding CORESET, ‘01’ indicating that the second TCI state(s) among the set of TCI states/pairs of TCI states indicated, e.g., by a TCI codepoint, in a beam indication DCI or MAC CE as specified herein in the present disclosure, could be used/applied for receiving/monitoring the PDCCH(s)/PDCCH candidate(s) in the corresponding CORESET, ‘10’ indicating that the first and second TCI states among the set of TCI states/pairs of TCI states indicated, e.g., by a TCI codepoint, in a beam indication DCI or MAC CE as specified herein in the present disclosure, could be respectively used/applied for receiving/monitoring the PDCCH(s)/PDCCH candidate(s)—e.g., first and second PDCCH candidates—in the corresponding CORESET(s), and ‘11’ indicating that the second and first TCI states among the set of TCI states/pairs of TCI states indicated, e.g., by a TCI codepoint, in a beam indication DCI or MAC CE as specified herein in the present disclosure, or none of the indicated TCI states, could be (respectively) used/applied for receiving/monitoring the PDCCH(s)/PDCCH candidate(s)—e.g., first and second PDCCH candidates—in the corresponding CORESET(s), wherein the first and second PDCCH candidates could be received in search space sets that are higher layer linked via SearchSpaceLinking and/or the first and second PDCCH candidates carry the same/identical DCI payload. Furthermore, throughout the present disclosure, the first TCI state(s) or the second TCI state(s)—specified herein in the present disclosure—could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states. Throughout the present disclosure, the first indicator could also be referred to as or could correspond to a higher layer parameter applylndicatedTCIState configured/provided in PDCCH-Config/ControlResourceSet, which could be set to ‘none’, ‘first’, ‘second’ or ‘both’ respectively indicating/providing that none of the indicated TCI states, the first indicated TCI state(s), the second indicated TCI state(s) or both the first and second indicated TCI states could be used for PDCCH reception(s).

For PDSCH reception in a (single-DCI based) multi-TRP system, a UE could be configured/provided/indicated by the network via higher layer RRC signaling/parameter and/or MAC CE command and/or dynamic DCI based L1 signaling—e.g., in a DL DCI (e.g., DCI format 1_0/1_1/1_2) that schedules the PDSCH—a second indicator to indicate which one or more of the set of TCI states/pairs of TCI states indicated, e.g., by a TCI codepoint, in a beam indication DCI or MAC CE as specified herein in the present disclosure, to use/apply for receiving the PDSCH(s). For instance, for N=2 (i.e., a set of two TCI states/pairs of TCI states are indicated), the second indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for receiving the corresponding PDSCH(s)—e.g., scheduled by the DL DCI/PDCCH, ‘01’ indicating that the second TCI state(s) among the set of TCI states/pairs of TCI states indicated, e.g., by a TCI codepoint, in a beam indication DCI or MAC CE as specified herein in the present disclosure, could be used/applied for receiving the corresponding PDSCH(s)—e.g., scheduled by the DL DCI/PDCCH, ‘10’ indicating that the first and second TCI states among the set of TCI states/pairs of TCI states indicated, e.g., by a TCI codepoint, in a beam indication DCI or MAC CE as specified herein in the present disclosure, could be respectively used/applied for receiving the corresponding PDSCH(s)—e.g., first and second PDSCHs—e.g., scheduled by the DL DCI/PDCCH, and ‘11’ indicating that the second and first TCI states among the set of TCI states/pairs of TCI states indicated, e.g., by a TCI codepoint, in a beam indication DCI or MAC CE as specified herein in the present disclosure, could be respectively used/applied for receiving the corresponding PDSCH(s)—e.g., first and second PDSCHs—e.g., scheduled by the DL DCI/PDCCH, wherein the first and second PDSCHs could correspond to two PDSCH transmission occasions or repetition in space, time and/or frequency. Furthermore, throughout the present disclosure, the first TCI state(s) or the second TCI state(s)—specified herein in the present disclosure—could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states. Throughout the present disclosure, the second indicator could also be referred to as or could correspond to a DCI indicator ‘TCI selection’ field in DCI format 1_1/1_2 (present when a higher layer parameter tciSelectionPresentInDCI is set to ‘enabled’), which could be set to ‘none’, ‘first’, ‘second’ or ‘both’ respectively indicating/providing that none of the indicated TCI states, the first indicated TCI state(s), the second indicated TCI state(s) or both the first and second indicated TCI states could be used for PDSCH reception(s).

That is, for PDSCH reception in a (single-DCI based) multi-TRP system, when a UE is configured with dl-OrJointTCI-StateList and is having two indicated TCI-states, if the UE does not report its capability indicating support of “two default beams for S-DCI based MTRP” in frequency range 2 and when the offset between the reception of the scheduling/activation DCI format 1_0/1_1/1_2 and the scheduled or activated PDSCH reception is less than timeDurationForQCL in frequency range 2, the UE shall apply the first indicated TCI-State to the scheduled or activated PDSCH reception. When a UE is configured with dl-OrJointTCI-StateList and is having two indicated TCI-states:
Regardless of the offset between the reception of the scheduling DCI format 1_0/1_1/1_2 and the scheduled/activated PDSCH reception, if the UE is in frequency range 1, or the UE reports its capability indicating support of “two default beams for S-DCI basedMTRP” in frequency range 2, or
If the UE does not report its capability indicating support of “two default beams for S-DCI basedMTRP” in frequency range 2 and if the scheduling offset between the reception of the scheduling DCI format 1_0/1_1/1_2 and the scheduled/activated PDSCH reception is equal to or larger than timeDurationForQCL
   The UE can be configured by higher layer parameter applyIndicatedTCIState to indicate whether the first, the second, or both of the indicated TCI-state(s) is/are applied to PDSCH reception scheduled or activated by DCI format 1_0. The UE can be configured with applyIndicatedTCIState with value both only when the UE is configured with cjtSchemePDSCH and the UE reports its capability indicating support of two joint TCI states for PDSCH-CJT or the UE is configured with sfnSchemePdsch. In that case, the UE shall apply both indicated TCI-states to PDSCH reception scheduled or activated by DCI format 1_0 on a search space other than Type0/0A/2 CSS on CORESET #0.
   If the UE (e.g., the UE 116) is not configured with applyIndicatedTCIState, the first indicated TCI-state is applied to PDSCH reception scheduled or activated by DCI format 1_0.
   When the UE is configured with tciSelection-PresentInDCIjointly for both DCI formats 1_1 and 1_2 in the same DL BWP, and when the UE receives a DCI format 1_1/1_2 that schedules or activates PDSCH reception, the UE shall determine the indicated joint/DL TCI state(s) for the PDSCH reception according to the following:
      If the DCI format 1_1/1_2 indicates codepoint “00” for the TCI selection field (or equivalently, the second indicator as specified herein in the present disclosure), the UE shall apply the first one of two indicated joint/DL TCI states to PDSCH DM-RS port(s) of corresponding PDSCH transmission occasions(s) scheduled or activated by the DCI format 1_1/1_2.
      If the DCI format 1_1/1_2 indicates codepoint “01” for the TCI selection field (or equivalently, the second indicator as specified herein in the present disclosure), the UE shall apply the second one of two indicated joint/DL TCI states to PDSCH DM-RS port(s) of corresponding PDSCH transmission occasion(s) scheduled or activated by the DCI format 1_1/1_2.
      If the DCI format 1_1/1_2 indicates codepoint “10” for the TCI selection field (or equivalently, the second indicator as specified herein in the present disclosure), the UE shall apply both indicated joint/DL TCI states to the PDSCH reception scheduled or activated by the DCI format 1_1/1_2.
   If the UE is not configured with tciSelection-PresentInDCI and when the UE receives a DCI format 1_1/1_2 that schedules/activates PDSCH reception, the UE shall apply both indicated TCI-States to the scheduled or activated PDSCH reception.

For PUCCH transmission in a (single-DCI based) multi-TRP system, a UE could be configured/provided/indicated by the network via higher layer RRC signaling/parameter and/or MAC CE command and/or dynamic DCI based L1 signaling—e.g., in higher layer RRC signaling/parameter PUCCH-Config that configures PUCCH(s)/PUCCH resource(s)—a third indicator to indicate which one or more of the set of TCI states/pairs of TCI states indicated, e.g., by a TCI codepoint, in a beam indication DCI or MAC CE as specified herein in the present disclosure, to use/apply for transmitting the PUCCH(s)/PUCCH resource(s). For instance, for N=2 (i.e., a set of two TCI states/pairs of TCI states are indicated), the third indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for transmitting the PUCCH(s)/PUCCH resource(s), ‘01’ indicating that the second TCI state(s) among the set of TCI states/pairs of TCI states indicated, e.g., by a TCI codepoint, in a beam indication DCI or MAC CE as specified herein in the present disclosure, could be used/applied for transmitting the PUCCH(s)/PUCCH resource(s), ‘10’ indicating that the first and second TCI states among the set of TCI states/pairs of TCI states indicated, e.g., by a TCI codepoint, in a beam indication DCI or MAC CE as specified herein in the present disclosure, could be respectively used/applied for transmitting the PUCCH(s)/PUCCH resource(s)—e.g., first PUCCH/PUCCH resource and second PUCCH/PUCCH resource, and ‘11’ indicating that the second and first TCI states among the set of TCI states/pairs of TCI states indicated, e.g., by a TCI codepoint, in a beam indication DCI or MAC CE as specified herein in the present disclosure, or none of the indicated TCI states, could be (respectively) used/applied for transmitting the PUCCH(s)/PUCCH resource(s)—e.g., first PUCCH/PUCCH resource and second PUCCH/PUCCH resource, wherein the first and second PUCCHs/PUCCH resources could correspond to two PUCCH transmission occasions or repetitions in space, time and/or frequency. Furthermore, throughout the present disclosure, the first TCI state(s) or the second TCI state(s)—specified herein in the present disclosure—could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states. Throughout the present disclosure, the third indicator could also be referred to as or could correspond to a higher layer parameter applyIndicatedTCIState configured/provided in higher layer parameter(s) that configures/provides a PUCCH resource/resource group, which could be set to ‘none’, ‘first’, ‘second’ or ‘both’ respectively indicating/providing that none of the indicated TCI states, the first indicated TCI state(s), the second indicated TCI state(s) or both the first and second indicated TCI states could be used for PUCCH transmission(s).

For PUSCH transmission in a (single-DCI based) multi-TRP system, a UE could be configured/provided/indicated by the network via higher layer RRC signaling/parameter and/or MAC CE command and/or dynamic DCI based L1 signaling—e.g., in an UL DCI (e.g., DCI format 0_0/0_1/0_2) that schedules the PUSCH—a fourth indicator to indicate which one or more of the set of TCI states/pairs of TCI states indicated, e.g., by a TCI codepoint, in a beam indication DCI or MAC CE as specified herein in the present disclosure, to use/apply for transmitting the PUSCH(s). For instance, for N=2 (i.e., a set of two TCI states/pairs of TCI states are indicated), the fourth indicator could be a two-bit indicator with ‘00’ indicating that the first TCI state(s) among the set of TCI states/pairs of TCI states indicated, e.g., by a TCI codepoint, in a beam indication DCI or MAC CE as specified herein in the present disclosure, could be used/applied for transmitting the corresponding PUSCH(s)—e.g., scheduled by the UL DCI/PDCCH, ‘01’ indicating that the second TCI state(s) among the set of TCI states/pairs of TCI states indicated, e.g., by a TCI codepoint, in a beam indication DCI or MAC CE as specified herein in the present disclosure, could be used/applied for transmitting the corresponding PUSCH(s)—e.g., scheduled by the UL DCI/PDCCH, ‘10’ indicating that the first and second TCI states among the set of TCI states/pairs of TCI states indicated, e.g., by a TCI codepoint, in a beam indication DCI or MAC CE as specified herein in the present disclosure, could be respectively used/applied for transmitting the corresponding PUSCH(s)—e.g., first and second PUSCHs—e.g., scheduled by the UL DCI/PDCCH, and ‘11’ indicating that the second and first TCI states among the set of TCI states/pairs of TCI states indicated, e.g., by a TCI codepoint, in a beam indication DCI or MAC CE as specified herein in the present disclosure, could be respectively used/applied for transmitting the corresponding PUSCH(s)—e.g., first and second PUSCHs—e.g., scheduled by the UL DCI/PDCCH, wherein the first and second PUSCHs could correspond to two PUSCH transmission occasions or repetition in space, time and/or frequency. Furthermore, throughout the present disclosure, the first TCI state(s) or the second TCI state(s)—specified herein in the present disclosure—could correspond to a joint DL and UL TCI state provided by TCI-State/DLorJointTCI-State, a separate DL TCI state provided by TCI-State/DLorJointTCI-State, a separate UL TCI state provided by TCI-State/UL-TCIState, or a pair of separate DL and separate UL TCI states. Throughout the present disclosure, the fourth indicator could also be referred to as or could correspond to a DCI indicator ‘SRS resource set’ field in DCI format 0_1/0_2, which could be set to ‘none’, ‘first’, ‘second’ or ‘both’ respectively indicating/providing that none of the indicated TCI states, the first indicated TCI state(s), the second indicated TCI state(s) or both the first and second indicated TCI states could be used for PUSCH transmission(s).

In a (multi-DCI based) multi-TRP system, a UE could be indicated/provided/configured by the network, e.g., in PDCCH-Config, two values (i.e., 0 and 1) of CORESET pool index (denoted by CORESETPoolIndex), wherein each CORESET could be configured with a value of CORESETPoolIndex. Furthermore, a UE could be indicated/provided/configured by the network, e.g., via a beam indication MAC CE or a DCI (e.g., via one or more TCI codepoints of one or more TCI fields in the corresponding DCI format 1_1/1_2 with or without DL assignment) associated to a CORESET pool index value (e.g., 0 or 1), one or more TCI states/pairs of TCI states for the same (or different) CORESET pool index value, wherein a TCI state could be a Joint DL and UL TCI state or a separate DL TCI state provided by TCI-State/DLorJointTCI-State or a separate UL TCI state provided by TCI-State/UL-TCIState indicated for channels/signals such as PDCCH, PDSCH, PUCCH and PUSCH associated to the same (or different) CORESET pool index value, and a pair of TCI states could include/contain a separate DL TCI state provided by TCI-State/DLorJointTCI-State or a separate UL TCI State provided by TCI-State/UL-TCIState indicated for channels/signals such as PDCCH, PDSCH, PUCCH and PUSCH associated to the same (or different) CORESET pool index value, under the unified TCI framework.

The following tables could be used for determining DM-RS antenna port(s) for PDSCH reception(s).

TABLE 1
Antenna port(s) (1000 + DMRS port), dmrs-Type = 1, maxLength
= 1 One Codeword: Codeword 0 enabled, Codeword 1 disabled

| | Number of DMRS CDM group(s) | DMRS |
|---|---|---|
| Value | without data | port(s) |
| 0 | 1 | 0 |
| 1 | 1 | 1 |
| 2 | 1 | 0, 1 |
| 3 | 2 | 0 |
| 4 | 2 | 1 |
| 5 | 2 | 2 |
| 6 | 2 | 3 |
| 7 | 2 | 0, 1 |
| 8 | 2 | 2, 3 |
| 9 | 2 | 0-2 |
| 10 | 2 | 0-3 |
| 11 | 2 | 0, 2 |
| 12-15 | Reserved | Reserved |

TABLE 1A
Antenna port(s) (1000 + DMRS port), dmrs-Type = 1, maxLength = 1
One Codeword:
Codeword 0 enabled,
Codeword 1 disabled

| | Number of DMRS CDM group(s) | DMRS |
|---|---|---|
| Value | without data | port(s) |
| 0 | 1 | 0 |
| 1 | 1 | 1 |
| 2 | 1 | 0, 1 |
| 3 | 2 | 0 |
| 4 | 2 | 1 |
| 5 | 2 | 2 |
| 6 | 2 | 3 |
| 7 | 2 | 0, 1 |
| 8 | 2 | 2, 3 |
| 9 | 2 | 0-2 |
| 10 | 2 | 0-3 |
| 11 | 2 | 0, 2 |
| 12 | 2 | 0, 2, 3 |
| 13-15 | Reserved | Reserved |

TABLE 2
Antenna port(s) (1000 + DMRS port), dmrs-Type = 1, maxLength = 2

| One Codeword: | | | | Two Codewords: | | | |
|---|---|---|---|---|---|---|---|
| Codeword 0 enabled, | | | | Codeword 0 enabled, | | | |
| Codeword 1 disabled | | | | Codeword 1 enabled | | | |
| | Number of | | Number of | | Number of | | Number of |
| | DMRS CDM | | front- | | DMRS CDM | | front- |
| | group(s) | DMRS | load | | group(s) | DMRS | load |
| Value | without data | port(s) | symbols | Value | without data | port(s) | symbols |
| 0 | 1 | 0 | 1 | 0 | 2 | 0-4 | 2 |
| 1 | 1 | 1 | 1 | 1 | 2 | 0, 1, 2, 3, 4, 6 | 2 |
| 2 | 1 | 0, 1 | 1 | 2 | 2 | 0, 1, 2, 3, 4, 5, 6 | 2 |
| 3 | 2 | 0 | 1 | 3 | 2 | 0, 1, 2, 3, 4, 5, 6, 7 | 2 |
| 4 | 2 | 1 | 1 | 4-31 | reserved | reserved | reserved |
| 5 | 2 | 2 | 1 | | | | |
| 6 | 2 | 3 | 1 | | | | |
| 7 | 2 | 0, 1 | 1 | | | | |
| 8 | 2 | 2, 3 | 1 | | | | |
| 9 | 2 | 0-2 | 1 | | | | |
| 10 | 2 | 0-3 | 1 | | | | |
| 11 | 2 | 0, 2 | 1 | | | | |
| 12 | 2 | 0 | 2 | | | | |
| 13 | 2 | 1 | 2 | | | | |
| 14 | 2 | 2 | 2 | | | | |
| 15 | 2 | 3 | 2 | | | | |
| 16 | 2 | 4 | 2 | | | | |
| 17 | 2 | 5 | 2 | | | | |
| 18 | 2 | 6 | 2 | | | | |
| 19 | 2 | 7 | 2 | | | | |
| 20 | 2 | 0, 1 | 2 | | | | |
| 21 | 2 | 2, 3 | 2 | | | | |
| 22 | 2 | 4, 5 | 2 | | | | |
| 23 | 2 | 6, 7 | 2 | | | | |
| 24 | 2 | 0, 4 | 2 | | | | |
| 25 | 2 | 2, 6 | 2 | | | | |
| 26 | 2 | 0, 1, 4 | 2 | | | | |
| 27 | 2 | 2, 3, 6 | 2 | | | | |
| 28 | 2 | 0, 1, 4, 5 | 2 | | | | |
| 29 | 2 | 2, 3, 6, 7 | 2 | | | | |
| 30 | 2 | 0, 2, 4, 6 | 2 | | | | |
| 31 | Reserved | Reserved | Reserved | | | | |

TABLE 2A
Antenna port(s) (1000 + DMRS port), dmrs-Type = 1, maxLength = 2

| One Codeword: | | | | Two Codewords: | | | |
|---|---|---|---|---|---|---|---|
| Codeword 0 enabled, | | | | Codeword 0 enabled, | | | |
| Codeword 1 disabled | | | | Codeword 1 enabled | | | |
| | Number of | | Number of | | Number of | | Number of |
| | DMRS CDM | | front- | | DMRS CDM | | front- |
| | group(s) | DMRS | load | | group(s) | DMRS | load |
| Value | without data | port(s) | symbols | Value | without data | port(s) | symbols |
| 0 | 1 | 0 | 1 | 0 | 2 | 0-4 | 2 |
| 1 | 1 | 1 | 1 | 1 | 2 | 0, 1, 2, 3, 4, 6 | 2 |
| 2 | 1 | 0, 1 | 1 | 2 | 2 | 0, 1, 2, 3, 4, 5, 6 | 2 |
| 3 | 2 | 0 | 1 | 3 | 2 | 0, 1, 2, 3, 4, 5, 6, 7 | 2 |
| 4 | 2 | 1 | 1 | 4-31 | reserved | reserved | reserved |
| 5 | 2 | 2 | 1 | | | | |
| 6 | 2 | 3 | 1 | | | | |
| 7 | 2 | 0, 1 | 1 | | | | |
| 8 | 2 | 2, 3 | 1 | | | | |
| 9 | 2 | 0-2 | 1 | | | | |
| 10 | 2 | 0-3 | 1 | | | | |
| 11 | 2 | 0, 2 | 1 | | | | |
| 12 | 2 | 0 | 2 | | | | |
| 13 | 2 | 1 | 2 | | | | |
| 14 | 2 | 2 | 2 | | | | |
| 15 | 2 | 3 | 2 | | | | |
| 16 | 2 | 4 | 2 | | | | |
| 17 | 2 | 5 | 2 | | | | |
| 18 | 2 | 6 | 2 | | | | |
| 19 | 2 | 7 | 2 | | | | |
| 20 | 2 | 0, 1 | 2 | | | | |
| 21 | 2 | 2, 3 | 2 | | | | |
| 22 | 2 | 4, 5 | 2 | | | | |
| 23 | 2 | 6, 7 | 2 | | | | |
| 24 | 2 | 0, 4 | 2 | | | | |
| 25 | 2 | 2, 6 | 2 | | | | |
| 26 | 2 | 0, 1, 4 | 2 | | | | |
| 27 | 2 | 2, 3, 6 | 2 | | | | |
| 28 | 2 | 0, 1, 4, 5 | 2 | | | | |
| 29 | 2 | 2, 3, 6, 7 | 2 | | | | |
| 30 | 2 | 0, 2, 4, 6 | 2 | | | | |
| 31 | 2 | 0, 2, 3 | 1 | | | | |

TABLE 3
Antenna port(s) (1000 + DMRS port), dmrs-Type = 2, maxLength = 1

| One codeword: | | | Two codewords: | | |
|---|---|---|---|---|---|
| Codeword 0 enabled, | | | Codeword 0 enabled, | | |
| Codeword 1 disabled | | | Codeword 1 enabled | | |
| | Number of DMRS CDM | DMRS | | Number of DMRS CDM | DMRS |
| Value | group(s) without data | port(s) | Value | group(s) without data | port(s) |
| 0 | 1 | 0 | 0 | 3 | 0-4 |
| 1 | 1 | 1 | 1 | 3 | 0-5 |
| 2 | 1 | 0, 1 | 2-31 | reserved | reserved |
| 3 | 2 | 0 | | | |
| 4 | 2 | 1 | | | |
| 5 | 2 | 2 | | | |
| 6 | 2 | 3 | | | |
| 7 | 2 | 0, 1 | | | |
| 8 | 2 | 2, 3 | | | |
| 9 | 2 | 0-2 | | | |
| 10 | 2 | 0-3 | | | |
| 11 | 3 | 0 | | | |
| 12 | 3 | 1 | | | |
| 13 | 3 | 2 | | | |
| 14 | 3 | 3 | | | |
| 15 | 3 | 4 | | | |
| 16 | 3 | 5 | | | |
| 17 | 3 | 0, 1 | | | |
| 18 | 3 | 2, 3 | | | |
| 19 | 3 | 4, 5 | | | |
| 20 | 3 | 0-2 | | | |
| 21 | 3 | 3-5 | | | |
| 22 | 3 | 0-3 | | | |
| 23 | 2 | 0, 2 | | | |
| 24-31 | Reserved | Reserved | | | |

TABLE 3A
Antenna port(s) (1000 + DMRS port), dmrs-Type = 2, maxLength = 1

| One codeword: | | | Two codewords: | | |
|---|---|---|---|---|---|
| Codeword 0 enabled, | | | Codeword 0 enabled, | | |
| Codeword 1 disabled | | | Codeword 1 enabled | | |
| | Number of DMRS CDM | DMRS | | Number of DMRS CDM | DMRS |
| Value | group(s) without data | port(s) | Value | group(s) without data | port(s) |
| 0 | 1 | 0 | 0 | 3 | 0-4 |
| 1 | 1 | 1 | 1 | 3 | 0-5 |
| 2 | 1 | 0, 1 | 2-31 | reserved | reserved |
| 3 | 2 | 0 | | | |
| 4 | 2 | 1 | | | |
| 5 | 2 | 2 | | | |
| 6 | 2 | 3 | | | |
| 7 | 2 | 0, 1 | | | |
| 8 | 2 | 2, 3 | | | |
| 9 | 2 | 0-2 | | | |
| 10 | 2 | 0-3 | | | |
| 11 | 3 | 0 | | | |
| 12 | 3 | 1 | | | |
| 13 | 3 | 2 | | | |
| 14 | 3 | 3 | | | |
| 15 | 3 | 4 | | | |
| 16 | 3 | 5 | | | |
| 17 | 3 | 0, 1 | | | |
| 18 | 3 | 2, 3 | | | |
| 19 | 3 | 4, 5 | | | |
| 20 | 3 | 0-2 | | | |
| 21 | 3 | 3-5 | | | |
| 22 | 3 | 0-3 | | | |
| 23 | 2 | 0, 2 | | | |
| 24 | 2 | 0, 2, 3 | | | |
| 25-31 | Reserved | Reserved | | | |

TABLE 4
Antenna port(s) (1000 + DMRS port), dmrs-Type = 2, maxLength = 2

| One codeword: | | | | Two Codewords: | | | |
|---|---|---|---|---|---|---|---|
| Codeword 0 enabled, | | | | Codeword 0 enabled, | | | |
| Codeword 1 disabled | | | | Codeword 1 enabled | | | |
| | Number of | | Number of | | Number of | | Number of |
| | DMRS CDM | | front- | | DMRS CDM | | front- |
| | group(s) | DMRS | load | | group(s) | DMRS | load |
| Value | without data | port(s) | symbols | Value | without data | port(s) | symbols |
| 0 | 1 | 0 | 1 | 0 | 3 | 0-4 | 1 |
| 1 | 1 | 1 | 1 | 1 | 3 | 0-5 | 1 |
| 2 | 1 | 0, 1 | 1 | 2 | 2 | 0, 1, 2, 3, 6 | 2 |
| 3 | 2 | 0 | 1 | 3 | 2 | 0, 1, 2, 3, 6, 8 | 2 |
| 4 | 2 | 1 | 1 | 4 | 2 | 0, 1, 2, 3, 6, 7, 8 | 2 |
| 5 | 2 | 2 | 1 | 5 | 2 | 0, 1, 2, 3, 6, 7, 8, 9 | 2 |
| 6 | 2 | 3 | 1 | 6-63 | Reserved | Reserved | Reserved |
| 7 | 2 | 0, 1 | 1 | | | | |
| 8 | 2 | 2, 3 | 1 | | | | |
| 9 | 2 | 0-2 | 1 | | | | |
| 10 | 2 | 0-3 | 1 | | | | |
| 11 | 3 | 0 | 1 | | | | |
| 12 | 3 | 1 | 1 | | | | |
| 13 | 3 | 2 | 1 | | | | |
| 14 | 3 | 3 | 1 | | | | |
| 15 | 3 | 4 | 1 | | | | |
| 16 | 3 | 5 | 1 | | | | |
| 17 | 3 | 0, 1 | 1 | | | | |
| 18 | 3 | 2, 3 | 1 | | | | |
| 19 | 3 | 4, 5 | 1 | | | | |
| 20 | 3 | 0-2 | 1 | | | | |
| 21 | 3 | 3-5 | 1 | | | | |
| 22 | 3 | 0-3 | 1 | | | | |
| 23 | 2 | 0, 2 | 1 | | | | |
| 24 | 3 | 0 | 2 | | | | |
| 25 | 3 | 1 | 2 | | | | |
| 26 | 3 | 2 | 2 | | | | |
| 27 | 3 | 3 | 2 | | | | |
| 28 | 3 | 4 | 2 | | | | |
| 29 | 3 | 5 | 2 | | | | |
| 30 | 3 | 6 | 2 | | | | |
| 31 | 3 | 7 | 2 | | | | |
| 32 | 3 | 8 | 2 | | | | |
| 33 | 3 | 9 | 2 | | | | |
| 34 | 3 | 10 | 2 | | | | |
| 35 | 3 | 11 | 2 | | | | |
| 36 | 3 | 0, 1 | 2 | | | | |
| 37 | 3 | 2, 3 | 2 | | | | |
| 38 | 3 | 4, 5 | 2 | | | | |
| 39 | 3 | 6, 7 | 2 | | | | |
| 40 | 3 | 8, 9 | 2 | | | | |
| 41 | 3 | 10, 11 | 2 | | | | |
| 42 | 3 | 0, 1, 6 | 2 | | | | |
| 43 | 3 | 2, 3, 8 | 2 | | | | |
| 44 | 3 | 4, 5, 10 | 2 | | | | |
| 45 | 3 | 0, 1, 6, 7 | 2 | | | | |
| 46 | 3 | 2, 3, 8, 9 | 2 | | | | |
| 47 | 3 | 4, 5, 10, 11 | 2 | | | | |
| 48 | 1 | 0 | 2 | | | | |
| 49 | 1 | 1 | 2 | | | | |
| 50 | 1 | 6 | 2 | | | | |
| 51 | 1 | 7 | 2 | | | | |
| 52 | 1 | 0, 1 | 2 | | | | |
| 53 | 1 | 6, 7 | 2 | | | | |
| 54 | 2 | 0, 1 | 2 | | | | |
| 55 | 2 | 2, 3 | 2 | | | | |
| 56 | 2 | 6, 7 | 2 | | | | |
| 57 | 2 | 8, 9 | 2 | | | | |
| 58-63 | Reserved | Reserved | Reserved | | | | |

TABLE 4A
Antenna port(s) (1000 + DMRS port), dmrs-Type = 2, maxLength = 2

| One codeword: | | | | Two Codewords: | | | |
|---|---|---|---|---|---|---|---|
| Codeword 0 enabled, | | | | Codeword 0 enabled, | | | |
| Codeword 1 disabled | | | | Codeword 1 enabled | | | |
| | Number of | | Number of | | Number of | | Number of |
| | DMRS CDM | | front- | | DMRS CDM | | front- |
| | group(s) | DMRS | load | | group(s) | DMRS | load |
| Value | without data | port(s) | symbols | Value | without data | port(s) | symbols |
| 0 | 1 | 0 | 1 | 0 | 3 | 0-4 | 1 |
| 1 | 1 | 1 | 1 | 1 | 3 | 0-5 | 1 |
| 2 | 1 | 0, 1 | 1 | 2 | 2 | 0, 1, 2, 3, 6 | 2 |
| 3 | 2 | 0 | 1 | 3 | 2 | 0, 1, 2, 3, 6, 8 | 2 |
| 4 | 2 | 1 | 1 | 4 | 2 | 0, 1, 2, 3, 6, 7, 8 | 2 |
| 5 | 2 | 2 | 1 | 5 | 2 | 0, 1, 2, 3, 6, 7, 8, 9 | 2 |
| 6 | 2 | 3 | 1 | 6-63 | Reserved | Reserved | Reserved |
| 7 | 2 | 0, 1 | 1 | | | | |
| 8 | 2 | 2, 3 | 1 | | | | |
| 9 | 2 | 0-2 | 1 | | | | |
| 10 | 2 | 0-3 | 1 | | | | |
| 11 | 3 | 0 | 1 | | | | |
| 12 | 3 | 1 | 1 | | | | |
| 13 | 3 | 2 | 1 | | | | |
| 14 | 3 | 3 | 1 | | | | |
| 15 | 3 | 4 | 1 | | | | |
| 16 | 3 | 5 | 1 | | | | |
| 17 | 3 | 0, 1 | 1 | | | | |
| 18 | 3 | 2, 3 | 1 | | | | |
| 19 | 3 | 4, 5 | 1 | | | | |
| 20 | 3 | 0-2 | 1 | | | | |
| 21 | 3 | 3-5 | 1 | | | | |
| 22 | 3 | 0-3 | 1 | | | | |
| 23 | 2 | 0, 2 | 1 | | | | |
| 24 | 3 | 0 | 2 | | | | |
| 25 | 3 | 1 | 2 | | | | |
| 26 | 3 | 2 | 2 | | | | |
| 27 | 3 | 3 | 2 | | | | |
| 28 | 3 | 4 | 2 | | | | |
| 29 | 3 | 5 | 2 | | | | |
| 30 | 3 | 6 | 2 | | | | |
| 31 | 3 | 7 | 2 | | | | |
| 32 | 3 | 8 | 2 | | | | |
| 33 | 3 | 9 | 2 | | | | |
| 34 | 3 | 10 | 2 | | | | |
| 35 | 3 | 11 | 2 | | | | |
| 36 | 3 | 0, 1 | 2 | | | | |
| 37 | 3 | 2, 3 | 2 | | | | |
| 38 | 3 | 4, 5 | 2 | | | | |
| 39 | 3 | 6, 7 | 2 | | | | |
| 40 | 3 | 8, 9 | 2 | | | | |
| 41 | 3 | 10, 11 | 2 | | | | |
| 42 | 3 | 0, 1, 6 | 2 | | | | |
| 43 | 3 | 2, 3, 8 | 2 | | | | |
| 44 | 3 | 4, 5, 10 | 2 | | | | |
| 45 | 3 | 0, 1, 6, 7 | 2 | | | | |
| 46 | 3 | 2, 3, 8, 9 | 2 | | | | |
| 47 | 3 | 4, 5, 10, 11 | 2 | | | | |
| 48 | 1 | 0 | 2 | | | | |
| 49 | 1 | 1 | 2 | | | | |
| 50 | 1 | 6 | 2 | | | | |
| 51 | 1 | 7 | 2 | | | | |
| 52 | 1 | 0, 1 | 2 | | | | |
| 53 | 1 | 6, 7 | 2 | | | | |
| 54 | 2 | 0, 1 | 2 | | | | |
| 55 | 2 | 2, 3 | 2 | | | | |
| 56 | 2 | 6, 7 | 2 | | | | |
| 57 | 2 | 8, 9 | 2 | | | | |
| 58 | 2 | 0, 2, 3 | 1 | | | | |
| 59-63 | Reserved | Reserved | Reserved | | | | |

TABLE 5
Antenna port(s) (1000 + DMRS port), dmrs-Type = 1,
enhanced-dmrs-Type is configured, maxLength = 1

| One Codeword: | | | Two Codewords: | | |
|---|---|---|---|---|---|
| Codeword 0 enabled, | | | Codeword 0 enabled, | | |
| Codeword 1 disabled | | | Codeword 1 enabled | | |
| | Number of DMRS CDM | | | Number of DMRS CDM | |
| Value | group(s) without data | DMRS port(s) | Value | group(s) without data | DMRS port(s) |
| 0 | 1 | 0 | 0 | 2 | 0, 1, 2, 3, 8 |
| 1 | 1 | 1 | 1 | 2 | 0, 1, 2, 3, 8, 10 |
| 2 | 1 | 0, 1 | 2 | 2 | 0, 1, 2, 3, 8, 9, 10 |
| 3 | 2 | 0 | 3 | 2 | 0, 1, 2, 3, 8, 9, 10, 11 |
| 4 | 2 | 1 | | | |
| 5 | 2 | 2 | | | |
| 6 | 2 | 3 | | | |
| 7 | 2 | 0, 1 | | | |
| 8 | 2 | 2, 3 | | | |
| 9 | 2 | 0-2 | | | |
| 10 | 2 | 0-3 | | | |
| 11 | 2 | 0, 2 | | | |
| 12 | 1 | 8 | | | |
| 13 | 1 | 9 | | | |
| 14 | 1 | 8, 9 | | | |
| 15 | 2 | 8 | | | |
| 16 | 2 | 9 | | | |
| 17 | 2 | 10 | | | |
| 18 | 2 | 11 | | | |
| 19 | 2 | 8, 9 | | | |
| 20 | 2 | 10, 11 | | | |
| 21 | 1 | 0, 1, 8 | | | |
| 22 | 1 | 0, 1, 8, 9 | | | |
| 23 | 2 | 0, 1, 8 | | | |
| 24 | 2 | 0, 1, 8, 9 | | | |
| 25 | 2 | 2, 3, 10 | | | |
| 26 | 2 | 2, 3, 10, 11 | | | |
| 27-31 | Reserved | Reserved | | | |

TABLE 5A
Antenna port(s) (1000 + DMRS port), dmrs-Type = 1,
enhanced-dmrs-Type is configured, maxLength = 1

| One Codeword: | | | Two Codewords: | | |
|---|---|---|---|---|---|
| Codeword 0 enabled, | | | Codeword 0 enabled, | | |
| Codeword 1 disabled | | | Codeword 1 enabled | | |
| | Number of DMRS CDM | DMRS | | Number of DMRS CDM | |
| Value | group(s) without data | port(s) | Value | group(s) without data | DMRS port(s) |
| 0 | 1 | 0 | 0 | 2 | 0, 1, 2, 3, 8 |
| 1 | 1 | 1 | 1 | 2 | 0, 1, 2, 3, 8, 10 |
| 2 | 1 | 0, 1 | 2 | 2 | 0, 1, 2, 3, 8, 9, 10 |
| 3 | 2 | 0 | 3 | 2 | 0, 1, 2, 3, 8, 9, 10, 11 |
| 4 | 2 | 1 | | | |
| 5 | 2 | 2 | | | |
| 6 | 2 | 3 | | | |
| 7 | 2 | 0, 1 | | | |
| 8 | 2 | 2, 3 | | | |
| 9 | 2 | 0-2 | | | |
| 10 | 2 | 0-3 | | | |
| 11 | 2 | 0, 2 | | | |
| 12 | 1 | 8 | | | |
| 13 | 1 | 9 | | | |
| 14 | 1 | 8, 9 | | | |
| 15 | 2 | 8 | | | |
| 16 | 2 | 9 | | | |
| 17 | 2 | 10 | | | |
| 18 | 2 | 11 | | | |
| 19 | 2 | 8, 9 | | | |
| 20 | 2 | 10, 11 | | | |
| 21 | 1 | 0, 1, 8 | | | |
| 22 | 1 | 0, 1, 8, 9 | | | |
| 23 | 2 | 0, 1, 8 | | | |
| 24 | 2 | 0, 1, 8, 9 | | | |
| 25 | 2 | 2, 3, 10 | | | |
| 26 | 2 | 2, 3, 10, 11 | | | |
| 27 | 2 | 0, 2, 3 | | | |
| 28-31 | Reserved | Reserved | | | |

TABLE 6
Antenna port(s) (1000 + DMRS port), dmrs-Type = 1,
enhanced-dmrs-Type is configured, maxLength = 2

| One Codeword: | | | | Two Codewords: | | | |
|---|---|---|---|---|---|---|---|
| Codeword 0 enabled, | | | | Codeword 0 enabled, | | | |
| Codeword 1 disabled | | | | Codeword 1 enabled | | | |
| | Number of | | Number of | | Number of | | Number of |
| | DMRS CDM | | front- | | DMRS CDM | | front- |
| | group(s) | DMRS | load | | group(s) | DMRS | load |
| Value | without data | port(s) | symbols | Value | without data | port(s) | symbols |
| 0 | 1 | 0 | 1 | 0 | 2 | 0-4 | 2 |
| 1 | 1 | 1 | 1 | 1 | 2 | 0, 1, 2, 3, 4, 6 | 2 |
| 2 | 1 | 0, 1 | 1 | 2 | 2 | 0, 1, 2, 3, 4, 5, 6 | 2 |
| 3 | 2 | 0 | 1 | 3 | 2 | 0, 1, 2, 3, 4, 5, 6, 7 | 2 |
| 4 | 2 | 1 | 1 | 4 | 2 | 0, 1, 2, 3, 8 | 1 |
| 5 | 2 | 2 | 1 | 5 | 2 | 0, 1, 2, 3, 8, 10 | 1 |
| 6 | 2 | 3 | 1 | 6 | 2 | 0, 1, 2, 3, 8, 9, 10 | 1 |
| 7 | 2 | 0, 1 | 1 | 7 | 2 | 0, 1, 2, 3, 8, 9, 10, 11 | 1 |
| 8 | 2 | 2, 3 | 1 | 8 | 1 | 0, 1, 4, 5, 8 | 2 |
| 9 | 2 | 0-2 | 1 | 9 | 1 | 0, 1, 4, 5, 8, 12 | 2 |
| 10 | 2 | 0-3 | 1 | 10 | 1 | 0, 1, 4, 5, 8, 9, 12 | 2 |
| 11 | 2 | 0, 2 | 1 | 11 | 1 | 0, 1, 4, 5, 8, 9, 12, 13 | 2 |
| 12 | 2 | 0 | 2 | 12 | 2 | 0, 1, 4, 5, 8 | 2 |
| 13 | 2 | 1 | 2 | 13 | 2 | 0, 1, 4, 5, 8, 12 | 2 |
| 14 | 2 | 2 | 2 | 14 | 2 | 0, 1, 4, 5, 8, 9, 12 | 2 |
| 15 | 2 | 3 | 2 | 15 | 2 | 0, 1, 4, 5, 8, 9, 12, 13 | 2 |
| 16 | 2 | 4 | 2 | 16~127 | Reserved | Reserved | Reserved |
| 17 | 2 | 5 | 2 | | | | |
| 18 | 2 | 6 | 2 | | | | |
| 19 | 2 | 7 | 2 | | | | |
| 20 | 2 | 0, 1 | 2 | | | | |
| 21 | 2 | 2, 3 | 2 | | | | |
| 22 | 2 | 4, 5 | 2 | | | | |
| 23 | 2 | 6, 7 | 2 | | | | |
| 24 | 2 | 0, 4 | 2 | | | | |
| 25 | 2 | 2, 6 | 2 | | | | |
| 26 | 2 | 0, 1, 4 | 2 | | | | |
| 27 | 2 | 2, 3, 6 | 2 | | | | |
| 28 | 2 | 0, 1, 4, 5 | 2 | | | | |
| 29 | 2 | 2, 3, 6, 7 | 2 | | | | |
| 30 | 2 | 0, 2, 4, 6 | 2 | | | | |
| 31 | 1 | 8 | 1 | | | | |
| 32 | 1 | 9 | 1 | | | | |
| 33 | 1 | 8, 9 | 1 | | | | |
| 34 | 2 | 8 | 1 | | | | |
| 35 | 2 | 9 | 1 | | | | |
| 36 | 2 | 10 | 1 | | | | |
| 37 | 2 | 11 | 1 | | | | |
| 38 | 2 | 8, 9 | 1 | | | | |
| 39 | 2 | 10, 11 | 1 | | | | |
| 40 | 2 | 8 | 2 | | | | |
| 41 | 2 | 9 | 2 | | | | |
| 42 | 2 | 10 | 2 | | | | |
| 43 | 2 | 11 | 2 | | | | |
| 44 | 2 | 12 | 2 | | | | |
| 45 | 2 | 13 | 2 | | | | |
| 46 | 2 | 14 | 2 | | | | |
| 47 | 2 | 15 | 2 | | | | |
| 48 | 2 | 8, 9 | 2 | | | | |
| 49 | 2 | 10, 11 | 2 | | | | |
| 50 | 2 | 12, 13 | 2 | | | | |
| 51 | 2 | 14, 15 | 2 | | | | |
| 52 | 1 | 0, 1, 8 | 1 | | | | |
| 53 | 1 | 0, 1, 8, 9 | 1 | | | | |
| 54 | 2 | 0, 1, 8 | 1 | | | | |
| 55 | 2 | 0, 1, 8, 9 | 1 | | | | |
| 56 | 2 | 2, 3, 10 | 1 | | | | |
| 57 | 2 | 2, 3, 10, 11 | 1 | | | | |
| 58 | 2 | 0, 1, 8 | 2 | | | | |
| 59 | 2 | 0, 1, 8, 9 | 2 | | | | |
| 60 | 2 | 4, 5, 12 | 2 | | | | |
| 61 | 2 | 4, 5, 12, 13 | 2 | | | | |
| 62 | 2 | 2, 3, 10 | 2 | | | | |
| 63 | 2 | 2, 3, 10, 11 | 2 | | | | |
| 64 | 2 | 6, 7, 14 | 2 | | | | |
| 65 | 2 | 6, 7, 14, 15 | 2 | | | | |
| 66-127 | Reserved | Reserved | Reserved | | | | |

TABLE 6A
Antenna port(s) (1000 + DMRS port), dmrs-Type = 1,
enhanced-dmrs-Type is configured, maxLength = 2

| One Codeword: | | | | Two Codewords: | | | |
|---|---|---|---|---|---|---|---|
| Codeword 0 enabled, | | | | Codeword 0 enabled, | | | |
| Codeword 1 disabled | | | | Codeword 1 enabled | | | |
| | Number of | | Number of | | Number of | | Number of |
| | DMRS CDM | | front- | | DMRS CDM | | front- |
| | group(s) | DMRS | load | | group(s) | DMRS | load |
| Value | without data | port(s) | symbols | Value | without data | port(s) | symbols |
| 0 | 1 | 0 | 1 | 0 | 2 | 0-4 | 2 |
| 1 | 1 | 1 | 1 | 1 | 2 | 0, 1, 2, 3, 4, 6 | 2 |
| 2 | 1 | 0, 1 | 1 | 2 | 2 | 0, 1, 2, 3, 4, 5, 6 | 2 |
| 3 | 2 | 0 | 1 | 3 | 2 | 0, 1, 2, 3, 4, 5, 6, 7 | 2 |
| 4 | 2 | 1 | 1 | 4 | 2 | 0, 1, 2, 3, 8 | 1 |
| 5 | 2 | 2 | 1 | 5 | 2 | 0, 1, 2, 3, 8, 10 | 1 |
| 6 | 2 | 3 | 1 | 6 | 2 | 0, 1, 2, 3, 8, 9, 10 | 1 |
| 7 | 2 | 0, 1 | 1 | 7 | 2 | 0, 1, 2, 3, 8, 9, 10, 11 | 1 |
| 8 | 2 | 2, 3 | 1 | 8 | 1 | 0, 1, 4, 5, 8 | 2 |
| 9 | 2 | 0-2 | 1 | 9 | 1 | 0, 1, 4, 5, 8, 12 | 2 |
| 10 | 2 | 0-3 | 1 | 10 | 1 | 0, 1, 4, 5, 8, 9, 12 | 2 |
| 11 | 2 | 0, 2 | 1 | 11 | 1 | 0, 1, 4, 5, 8, 9, 12, 13 | 2 |
| 12 | 2 | 0 | 2 | 12 | 2 | 0, 1, 4, 5, 8 | 2 |
| 13 | 2 | 1 | 2 | 13 | 2 | 0, 1, 4, 5, 8, 12 | 2 |
| 14 | 2 | 2 | 2 | 14 | 2 | 0, 1, 4, 5, 8, 9, 12 | 2 |
| 15 | 2 | 3 | 2 | 15 | 2 | 0, 1, 4, 5, 8, 9, 12, 13 | 2 |
| 16 | 2 | 4 | 2 | 16~127 | Reserved | Reserved | Reserved |
| 17 | 2 | 5 | 2 | | | | |
| 18 | 2 | 6 | 2 | | | | |
| 19 | 2 | 7 | 2 | | | | |
| 20 | 2 | 0, 1 | 2 | | | | |
| 21 | 2 | 2, 3 | 2 | | | | |
| 22 | 2 | 4, 5 | 2 | | | | |
| 23 | 2 | 6, 7 | 2 | | | | |
| 24 | 2 | 0, 4 | 2 | | | | |
| 25 | 2 | 2, 6 | 2 | | | | |
| 26 | 2 | 0, 1, 4 | 2 | | | | |
| 27 | 2 | 2, 3, 6 | 2 | | | | |
| 28 | 2 | 0, 1, 4, 5 | 2 | | | | |
| 29 | 2 | 2, 3, 6, 7 | 2 | | | | |
| 30 | 2 | 0, 2, 4, 6 | 2 | | | | |
| 31 | 1 | 8 | 1 | | | | |
| 32 | 1 | 9 | 1 | | | | |
| 33 | 1 | 8, 9 | 1 | | | | |
| 34 | 2 | 8 | 1 | | | | |
| 35 | 2 | 9 | 1 | | | | |
| 36 | 2 | 10 | 1 | | | | |
| 37 | 2 | 11 | 1 | | | | |
| 38 | 2 | 8, 9 | 1 | | | | |
| 39 | 2 | 10, 11 | 1 | | | | |
| 40 | 2 | 8 | 2 | | | | |
| 41 | 2 | 9 | 2 | | | | |
| 42 | 2 | 10 | 2 | | | | |
| 43 | 2 | 11 | 2 | | | | |
| 44 | 2 | 12 | 2 | | | | |
| 45 | 2 | 13 | 2 | | | | |
| 46 | 2 | 14 | 2 | | | | |
| 47 | 2 | 15 | 2 | | | | |
| 48 | 2 | 8, 9 | 2 | | | | |
| 49 | 2 | 10, 11 | 2 | | | | |
| 50 | 2 | 12, 13 | 2 | | | | |
| 51 | 2 | 14, 15 | 2 | | | | |
| 52 | 1 | 0, 1, 8 | 1 | | | | |
| 53 | 1 | 0, 1, 8, 9 | 1 | | | | |
| 54 | 2 | 0, 1, 8 | 1 | | | | |
| 55 | 2 | 0, 1, 8, 9 | 1 | | | | |
| 56 | 2 | 2, 3, 10 | 1 | | | | |
| 57 | 2 | 2, 3, 10, 11 | 1 | | | | |
| 58 | 2 | 0, 1, 8 | 2 | | | | |
| 59 | 2 | 0, 1, 8, 9 | 2 | | | | |
| 60 | 2 | 4, 5, 12 | 2 | | | | |
| 61 | 2 | 4, 5, 12, 13 | 2 | | | | |
| 62 | 2 | 2, 3, 10 | 2 | | | | |
| 63 | 2 | 2, 3, 10, 11 | 2 | | | | |
| 64 | 2 | 6, 7, 14 | 2 | | | | |
| 65 | 2 | 6, 7, 14, 15 | 2 | | | | |
| 66 | 2 | 0, 2, 3 | 1 | | | | |
| 67-127 | Reserved | Reserved | Reserved | | | | |

TABLE 7
Antenna port(s) (1000 + DMRS port), dmrs-Type = 2,
enhanced-dmrs-Type is configured, maxLength = 1

| | | | Two codewords: | | |
|---|---|---|---|---|---|
| One codeword: | | | Codeword 0 enabled, | | |
| Codeword 0 enabled, | | | Codeword 1 enabled | | |
| Codeword 1 disabled | | | | Number of DMRS | |
| | Number of DMRS CDM | DMRS | | CDM group(s) | |
| Value | group(s) without data | port(s) | Value | without data | DMRS port(s) |
| 0 | 1 | 0 | 0 | 3 | 0-4 |
| 1 | 1 | 1 | 1 | 3 | 0-5 |
| 2 | 1 | 0, 1 | 2 | 2 | 0, 1, 2, 3, 12 |
| 3 | 2 | 0 | 3 | 2 | 0, 1, 2, 3, 12, 14 |
| 4 | 2 | 1 | 4 | 2 | 0-3, 12-14 |
| 5 | 2 | 2 | 5 | 2 | 0-3, 12-15 |
| 6 | 2 | 3 | 6 | 3 | 0, 1, 2, 3, 12 |
| 7 | 2 | 0, 1 | 7 | 3 | 0, 1, 2, 3, 12, 14 |
| 8 | 2 | 2, 3 | 8 | 3 | 0-3, 12-14 |
| 9 | 2 | 0-2 | 9 | 3 | 0-3, 12-15 |
| 10 | 2 | 0-3 | 10~63 | Reserved | Reserved |
| 11 | 3 | 0 | | | |
| 12 | 3 | 1 | | | |
| 13 | 3 | 2 | | | |
| 14 | 3 | 3 | | | |
| 15 | 3 | 4 | | | |
| 16 | 3 | 5 | | | |
| 17 | 3 | 0, 1 | | | |
| 18 | 3 | 2, 3 | | | |
| 19 | 3 | 4, 5 | | | |
| 20 | 3 | 0-2 | | | |
| 21 | 3 | 3-5 | | | |
| 22 | 3 | 0-3 | | | |
| 23 | 2 | 0, 2 | | | |
| 24 | 1 | 12 | | | |
| 25 | 1 | 13 | | | |
| 26 | 1 | 12, 13 | | | |
| 27 | 2 | 12 | | | |
| 28 | 2 | 13 | | | |
| 29 | 2 | 14 | | | |
| 30 | 2 | 15 | | | |
| 31 | 2 | 12, 13 | | | |
| 32 | 2 | 14, 15 | | | |
| 33 | 3 | 12 | | | |
| 34 | 3 | 13 | | | |
| 35 | 3 | 14 | | | |
| 36 | 3 | 15 | | | |
| 37 | 3 | 16 | | | |
| 38 | 3 | 17 | | | |
| 39 | 3 | 12, 13 | | | |
| 40 | 3 | 14, 15 | | | |
| 41 | 3 | 16, 17 | | | |
| 42 | 1 | 0, 1, 12 | | | |
| 43 | 1 | 0, 1, 12, 13 | | | |
| 44 | 2 | 0, 1, 12 | | | |
| 45 | 2 | 0, 1, 12, 13 | | | |
| 46 | 2 | 2, 3, 14 | | | |
| 47 | 2 | 2, 3, 14, 15 | | | |
| 48 | 3 | 0, 1, 12 | | | |
| 49 | 3 | 0, 1, 12, 13 | | | |
| 50 | 3 | 2, 3, 14 | | | |
| 51 | 3 | 2, 3, 14, 15 | | | |
| 52 | 3 | 4, 5, 16 | | | |
| 53 | 3 | 4, 5, 16, 17 | | | |
| 54-63 | Reserved | Reserved | | | |

TABLE 7A
Antenna port(s) (1000 + DMRS port), dmrs-Type = 2,
enhanced-dmrs-Type is configured, maxLength = 1

| One codeword: | | | Two codewords: | | |
|---|---|---|---|---|---|
| Codeword 0 enabled, | | | Codeword 0 enabled, | | |
| Codeword 1 disabled | | | Codeword 1 enabled | | |
| | Number of DMRS CDM | DMRS | | Number of DMRS CDM | |
| Value | group(s) without data | port(s) | Value | group(s) without data | DMRS port(s) |
| 0 | 1 | 0 | 0 | 3 | 0-4 |
| 1 | 1 | 1 | 1 | 3 | 0-5 |
| 2 | 1 | 0, 1 | 2 | 2 | 0, 1, 2, 3, 12 |
| 3 | 2 | 0 | 3 | 2 | 0, 1, 2, 3, 12, 14 |
| 4 | 2 | 1 | 4 | 2 | 0-3, 12-14 |
| 5 | 2 | 2 | 5 | 2 | 0-3, 12-15 |
| 6 | 2 | 3 | 6 | 3 | 0, 1, 2, 3, 12 |
| 7 | 2 | 0, 1 | 7 | 3 | 0, 1, 2, 3, 12, 14 |
| 8 | 2 | 2, 3 | 8 | 3 | 0-3, 12-14 |
| 9 | 2 | 0-2 | 9 | 3 | 0-3, 12-15 |
| 10 | 2 | 0-3 | 10~63 | Reserved | Reserved |
| 11 | 3 | 0 | | | |
| 12 | 3 | 1 | | | |
| 13 | 3 | 2 | | | |
| 14 | 3 | 3 | | | |
| 15 | 3 | 4 | | | |
| 16 | 3 | 5 | | | |
| 17 | 3 | 0, 1 | | | |
| 18 | 3 | 2, 3 | | | |
| 19 | 3 | 4, 5 | | | |
| 20 | 3 | 0-2 | | | |
| 21 | 3 | 3-5 | | | |
| 22 | 3 | 0-3 | | | |
| 23 | 2 | 0, 2 | | | |
| 24 | 1 | 12 | | | |
| 25 | 1 | 13 | | | |
| 26 | 1 | 12, 13 | | | |
| 27 | 2 | 12 | | | |
| 28 | 2 | 13 | | | |
| 29 | 2 | 14 | | | |
| 30 | 2 | 15 | | | |
| 31 | 2 | 12, 13 | | | |
| 32 | 2 | 14, 15 | | | |
| 33 | 3 | 12 | | | |
| 34 | 3 | 13 | | | |
| 35 | 3 | 14 | | | |
| 36 | 3 | 15 | | | |
| 37 | 3 | 16 | | | |
| 38 | 3 | 17 | | | |
| 39 | 3 | 12, 13 | | | |
| 40 | 3 | 14, 15 | | | |
| 41 | 3 | 16, 17 | | | |
| 42 | 1 | 0, 1, 12 | | | |
| 43 | 1 | 0, 1, 12, 13 | | | |
| 44 | 2 | 0, 1, 12 | | | |
| 45 | 2 | 0, 1, 12, 13 | | | |
| 46 | 2 | 2, 3, 14 | | | |
| 47 | 2 | 2, 3, 14, 15 | | | |
| 48 | 3 | 0, 1, 12 | | | |
| 49 | 3 | 0, 1, 12, 13 | | | |
| 50 | 3 | 2, 3, 14 | | | |
| 51 | 3 | 2, 3, 14, 15 | | | |
| 52 | 3 | 4, 5, 16 | | | |
| 53 | 3 | 4, 5, 16, 17 | | | |
| 54 | 2 | 0, 2, 3 | | | |
| 55-63 | Reserved | Reserved | | | |

TABLE 8
Antenna port(s) (1000 + DMRS port), dmrs-Type = 2, enhanced-dmrs-Type is configured, maxLength = 2

| One codeword: | | | | Two Codewords: | | | |
|---|---|---|---|---|---|---|---|
| Codeword 0 enabled, | | | | Codeword 0 enabled, | | | |
| Codeword 1 disabled | | | | Codeword 1 enabled | | | |
| | Number of | | Number of | | Number of | | Number of |
| | DMRS CDM | | front- | | DMRS CDM | | front- |
| | group(s) | DMRS | load | | group(s) | DMRS | load |
| Value | without data | port(s) | symbols | Value | without data | port(s) | symbols |
| 0 | 1 | 0 | 1 | 0 | 3 | 0-4 | 1 |
| 1 | 1 | 1 | 1 | 1 | 3 | 0-5 | 1 |
| 2 | 1 | 0, 1 | 1 | 2 | 2 | 0, 1, 2, 3, 6 | 2 |
| 3 | 2 | 0 | 1 | 3 | 2 | 0, 1, 2, 3, 6, 8 | 2 |
| 4 | 2 | 1 | 1 | 4 | 2 | 0, 1, 2, 3, 6, 7, 8 | 2 |
| 5 | 2 | 2 | 1 | 5 | 2 | 0, 1, 2, 3, 6, 7, 8, 9 | 2 |
| 6 | 2 | 3 | 1 | 6 | 2 | 0, 1, 2, 3, 12 | 1 |
| 7 | 2 | 0, 1 | 1 | 7 | 2 | 0-3, 12, 14 | 1 |
| 8 | 2 | 2, 3 | 1 | 8 | 2 | 0-3, 12-14 | 1 |
| 9 | 2 | 0-2 | 1 | 9 | 2 | 0-3, 12-15 | 1 |
| 10 | 2 | 0-3 | 1 | 10 | 3 | 0, 1, 2, 3, 12 | 1 |
| 11 | 3 | 0 | 1 | 11 | 3 | 0-3, 12, 14 | 1 |
| 12 | 3 | 1 | 1 | 12 | 3 | 0-3, 12-14 | 1 |
| 13 | 3 | 2 | 1 | 13 | 3 | 0-3, 12-15 | 1 |
| 14 | 3 | 3 | 1 | 14 | 1 | 0, 1, 6, 7, 12 | 2 |
| 15 | 3 | 4 | 1 | 15 | 1 | 0, 1, 6, 7, 12, 18 | 2 |
| 16 | 3 | 5 | 1 | 16 | 1 | 0, 1, 6, 7, 12, 13, 18 | 2 |
| 17 | 3 | 0, 1 | 1 | 17 | 1 | 0, 1, 6, 7, 12, 13, 18, 19 | 2 |
| 18 | 3 | 2, 3 | 1 | 18 | 2 | 0, 1, 6, 7, 12 | 2 |
| 19 | 3 | 4, 5 | 1 | 19 | 2 | 0, 1, 6, 7, 12, 18 | 2 |
| 20 | 3 | 0-2 | 1 | 20 | 2 | 0, 1, 6, 7, 12, 13, 18 | 2 |
| 21 | 3 | 3-5 | 1 | 21 | 2 | 0, 1, 6, 7, 12, 13, 18, 19 | 2 |
| 22 | 3 | 0-3 | 1 | 22 | 3 | 0, 1, 6, 7, 12 | 2 |
| 23 | 2 | 0, 2 | 1 | 23 | 3 | 0, 1, 6, 7, 12, 18 | 2 |
| 24 | 3 | 0 | 2 | 24 | 3 | 0, 1, 6, 7, 12, 13, 18 | 2 |
| 25 | 3 | 1 | 2 | 25 | 3 | 0, 1, 6, 7, 12, 13, 18, 19 | 2 |
| 26 | 3 | 2 | 2 | 26~255 | Reserved | Reserved | Reserved |
| 27 | 3 | 3 | 2 | | | | |
| 28 | 3 | 4 | 2 | | | | |
| 29 | 3 | 5 | 2 | | | | |
| 30 | 3 | 6 | 2 | | | | |
| 31 | 3 | 7 | 2 | | | | |
| 32 | 3 | 8 | 2 | | | | |
| 33 | 3 | 9 | 2 | | | | |
| 34 | 3 | 10 | 2 | | | | |
| 35 | 3 | 11 | 2 | | | | |
| 36 | 3 | 0, 1 | 2 | | | | |
| 37 | 3 | 2, 3 | 2 | | | | |
| 38 | 3 | 4, 5 | 2 | | | | |
| 39 | 3 | 6, 7 | 2 | | | | |
| 40 | 3 | 8, 9 | 2 | | | | |
| 41 | 3 | 10, 11 | 2 | | | | |
| 42 | 3 | 0, 1, 6 | 2 | | | | |
| 43 | 3 | 2, 3, 8 | 2 | | | | |
| 44 | 3 | 4, 5, 10 | 2 | | | | |
| 45 | 3 | 0, 1, 6, 7 | 2 | | | | |
| 46 | 3 | 2, 3, 8, 9 | 2 | | | | |
| 47 | 3 | 4, 5, 10, 11 | 2 | | | | |
| 48 | 1 | 0 | 2 | | | | |
| 49 | 1 | 1 | 2 | | | | |
| 50 | 1 | 6 | 2 | | | | |
| 51 | 1 | 7 | 2 | | | | |
| 52 | 1 | 0, 1 | 2 | | | | |
| 53 | 1 | 6, 7 | 2 | | | | |
| 54 | 2 | 0, 1 | 2 | | | | |
| 55 | 2 | 2, 3 | 2 | | | | |
| 56 | 2 | 6, 7 | 2 | | | | |
| 57 | 2 | 8, 9 | 2 | | | | |
| 58 | 1 | 12 | 1 | | | | |
| 59 | 1 | 13 | 1 | | | | |
| 60 | 1 | 12, 13 | 1 | | | | |
| 61 | 2 | 12 | 1 | | | | |
| 62 | 2 | 13 | 1 | | | | |
| 63 | 2 | 14 | 1 | | | | |
| 64 | 2 | 15 | 1 | | | | |
| 65 | 2 | 12, 13 | 1 | | | | |
| 66 | 2 | 14, 15 | 1 | | | | |
| 67 | 3 | 12 | 1 | | | | |
| 68 | 3 | 13 | 1 | | | | |
| 69 | 3 | 14 | 1 | | | | |
| 70 | 3 | 15 | 1 | | | | |
| 71 | 3 | 16 | 1 | | | | |
| 72 | 3 | 17 | 1 | | | | |
| 73 | 3 | 12, 13 | 1 | | | | |
| 74 | 3 | 14, 15 | 1 | | | | |
| 75 | 3 | 16, 17 | 1 | | | | |
| 76 | 3 | 12 | 2 | | | | |
| 77 | 3 | 13 | 2 | | | | |
| 78 | 3 | 14 | 2 | | | | |
| 79 | 3 | 15 | 2 | | | | |
| 80 | 3 | 16 | 2 | | | | |
| 81 | 3 | 17 | 2 | | | | |
| 82 | 3 | 18 | 2 | | | | |
| 83 | 3 | 19 | 2 | | | | |
| 84 | 3 | 20 | 2 | | | | |
| 85 | 3 | 21 | 2 | | | | |
| 86 | 3 | 22 | 2 | | | | |
| 87 | 3 | 23 | 2 | | | | |
| 88 | 3 | 12, 13 | 2 | | | | |
| 89 | 3 | 14, 15 | 2 | | | | |
| 90 | 3 | 16, 17 | 2 | | | | |
| 91 | 3 | 18, 19 | 2 | | | | |
| 92 | 3 | 20, 21 | 2 | | | | |
| 93 | 3 | 22, 23 | 2 | | | | |
| 94 | 1 | 12 | 2 | | | | |
| 95 | 1 | 13 | 2 | | | | |
| 96 | 1 | 18 | 2 | | | | |
| 97 | 1 | 19 | 2 | | | | |
| 98 | 1 | 12, 13 | 2 | | | | |
| 99 | 1 | 18, 19 | 2 | | | | |
| 100 | 2 | 12, 13 | 2 | | | | |
| 101 | 2 | 14, 15 | 2 | | | | |
| 102 | 2 | 18, 19 | 2 | | | | |
| 103 | 2 | 20, 21 | 2 | | | | |
| 104 | 1 | 0, 1, 12 | 1 | | | | |
| 105 | 1 | 0, 1, 12, 13 | 1 | | | | |
| 106 | 2 | 0, 1, 12 | 1 | | | | |
| 107 | 2 | 0, 1, 12, 13 | 1 | | | | |
| 108 | 2 | 2, 3, 14 | 1 | | | | |
| 109 | 2 | 2, 3, 14, 15 | 1 | | | | |
| 110 | 3 | 0, 1, 12 | 1 | | | | |
| 111 | 3 | 0, 1, 12, 13 | 1 | | | | |
| 112 | 3 | 2, 3, 14 | 1 | | | | |
| 113 | 3 | 2, 3, 14, 15 | 1 | | | | |
| 114 | 3 | 4, 5, 16 | 1 | | | | |
| 115 | 3 | 4, 5, 16, 17 | 1 | | | | |
| 116 | 2 | 0, 1, 12 | 2 | | | | |
| 117 | 2 | 0, 1, 12, 13 | 2 | | | | |
| 118 | 2 | 6, 7, 18 | 2 | | | | |
| 119 | 2 | 6, 7, 18, 19 | 2 | | | | |
| 120 | 2 | 2, 3, 14 | 2 | | | | |
| 121 | 2 | 2, 3, 14, 15 | 2 | | | | |
| 122 | 2 | 8, 9, 20 | 2 | | | | |
| 123 | 2 | 8, 9, 20, 21 | 2 | | | | |
| 124 | 3 | 0, 1, 12 | 2 | | | | |
| 125 | 3 | 0, 1, 12, 13 | 2 | | | | |
| 126 | 3 | 6, 7, 18 | 2 | | | | |
| 127 | 3 | 6, 7, 18, 19 | 2 | | | | |
| 128 | 3 | 2, 3, 14 | 2 | | | | |
| 129 | 3 | 2, 3, 14, 15 | 2 | | | | |
| 130 | 3 | 8, 9, 20 | 2 | | | | |
| 131 | 3 | 8, 9, 20, 21 | 2 | | | | |
| 132 | 3 | 4, 5, 16 | 2 | | | | |
| 133 | 3 | 4, 5, 16, 17 | 2 | | | | |
| 134 | 3 | 10, 11, 22 | 2 | | | | |
| 135 | 3 | 10, 11, 22, 23 | 2 | | | | |
| 136-255 | Reserved | Reserved | Reserved | | | | |

TABLE 8A
Antenna port(s) (1000 + DMRS port), dmrs-Type = 2, enhanced-dmrs-Type is configured, maxLength = 2

| One codeword: | | | | Two Codewords: | | | |
|---|---|---|---|---|---|---|---|
| Codeword 0 enabled, | | | | Codeword 0 enabled, | | | |
| Codeword 1 disabled | | | | Codeword 1 enabled | | | |
| | Number of | | Number of | | Number of | | Number of |
| | DMRS CDM | | front- | | DMRS CDM | | front- |
| | group(s) | DMRS | load | | group(s) | DMRS | load |
| Value | without data | port(s) | symbols | Value | without data | port(s) | symbols |
| 0 | 1 | 0 | 1 | 0 | 3 | 0-4 | 1 |
| 1 | 1 | 1 | 1 | 1 | 3 | 0-5 | 1 |
| 2 | 1 | 0, 1 | 1 | 2 | 2 | 0, 1, 2, 3, 6 | 2 |
| 3 | 2 | 0 | 1 | 3 | 2 | 0, 1, 2, 3, 6, 8 | 2 |
| 4 | 2 | 1 | 1 | 4 | 2 | 0, 1, 2, 3, 6, 7, 8 | 2 |
| 5 | 2 | 2 | 1 | 5 | 2 | 0, 1, 2, 3, 6, 7, 8, 9 | 2 |
| 6 | 2 | 3 | 1 | 6 | 2 | 0, 1, 2, 3, 12 | 1 |
| 7 | 2 | 0, 1 | 1 | 7 | 2 | 0-3, 12, 14 | 1 |
| 8 | 2 | 2, 3 | 1 | 8 | 2 | 0-3, 12-14 | 1 |
| 9 | 2 | 0-2 | 1 | 9 | 2 | 0-3, 12-15 | 1 |
| 10 | 2 | 0-3 | 1 | 10 | 3 | 0, 1, 2, 3, 12 | 1 |
| 11 | 3 | 0 | 1 | 11 | 3 | 0-3, 12, 14 | 1 |
| 12 | 3 | 1 | 1 | 12 | 3 | 0-3, 12-14 | 1 |
| 13 | 3 | 2 | 1 | 13 | 3 | 0-3, 12-15 | 1 |
| 14 | 3 | 3 | 1 | 14 | 1 | 0, 1, 6, 7, 12 | 2 |
| 15 | 3 | 4 | 1 | 15 | 1 | 0, 1, 6, 7, 12, 18 | 2 |
| 16 | 3 | 5 | 1 | 16 | 1 | 0, 1, 6, 7, 12, 13, 18 | 2 |
| 17 | 3 | 0, 1 | 1 | 17 | 1 | 0, 1, 6, 7, 12, 13, 18, 19 | 2 |
| 18 | 3 | 2, 3 | 1 | 18 | 2 | 0, 1, 6, 7, 12 | 2 |
| 19 | 3 | 4, 5 | 1 | 19 | 2 | 0, 1, 6, 7, 12, 18 | 2 |
| 20 | 3 | 0-2 | 1 | 20 | 2 | 0, 1, 6, 7, 12, 13, 18 | 2 |
| 21 | 3 | 3-5 | 1 | 21 | 2 | 0, 1, 6, 7, 12, 13, 18, 19 | 2 |
| 22 | 3 | 0-3 | 1 | 22 | 3 | 0, 1, 6, 7, 12 | 2 |
| 23 | 2 | 0, 2 | 1 | 23 | 3 | 0, 1, 6, 7, 12, 18 | 2 |
| 24 | 3 | 0 | 2 | 24 | 3 | 0, 1, 6, 7, 12, 13, 18 | 2 |
| 25 | 3 | 1 | 2 | 25 | 3 | 0, 1, 6, 7, 12, 13, 18, 19 | 2 |
| 26 | 3 | 2 | 2 | 26~255 | Reserved | Reserved | Reserved |
| 27 | 3 | 3 | 2 | | | | |
| 28 | 3 | 4 | 2 | | | | |
| 29 | 3 | 5 | 2 | | | | |
| 30 | 3 | 6 | 2 | | | | |
| 31 | 3 | 7 | 2 | | | | |
| 32 | 3 | 8 | 2 | | | | |
| 33 | 3 | 9 | 2 | | | | |
| 34 | 3 | 10 | 2 | | | | |
| 35 | 3 | 11 | 2 | | | | |
| 36 | 3 | 0, 1 | 2 | | | | |
| 37 | 3 | 2, 3 | 2 | | | | |
| 38 | 3 | 4, 5 | 2 | | | | |
| 39 | 3 | 6, 7 | 2 | | | | |
| 40 | 3 | 8, 9 | 2 | | | | |
| 41 | 3 | 10, 11 | 2 | | | | |
| 42 | 3 | 0, 1, 6 | 2 | | | | |
| 43 | 3 | 2, 3, 8 | 2 | | | | |
| 44 | 3 | 4, 5, 10 | 2 | | | | |
| 45 | 3 | 0, 1, 6, 7 | 2 | | | | |
| 46 | 3 | 2, 3, 8, 9 | 2 | | | | |
| 47 | 3 | 4, 5, 10, 11 | 2 | | | | |
| 48 | 1 | 0 | 2 | | | | |
| 49 | 1 | 1 | 2 | | | | |
| 50 | 1 | 6 | 2 | | | | |
| 51 | 1 | 7 | 2 | | | | |
| 52 | 1 | 0, 1 | 2 | | | | |
| 53 | 1 | 6, 7 | 2 | | | | |
| 54 | 2 | 0, 1 | 2 | | | | |
| 55 | 2 | 2, 3 | 2 | | | | |
| 56 | 2 | 6, 7 | 2 | | | | |
| 57 | 2 | 8, 9 | 2 | | | | |
| 58 | 1 | 12 | 1 | | | | |
| 59 | 1 | 13 | 1 | | | | |
| 60 | 1 | 12, 13 | 1 | | | | |
| 61 | 2 | 12 | 1 | | | | |
| 62 | 2 | 13 | 1 | | | | |
| 63 | 2 | 14 | 1 | | | | |
| 64 | 2 | 15 | 1 | | | | |
| 65 | 2 | 12, 13 | 1 | | | | |
| 66 | 2 | 14, 15 | 1 | | | | |
| 67 | 3 | 12 | 1 | | | | |
| 68 | 3 | 13 | 1 | | | | |
| 69 | 3 | 14 | 1 | | | | |
| 70 | 3 | 15 | 1 | | | | |
| 71 | 3 | 16 | 1 | | | | |
| 72 | 3 | 17 | 1 | | | | |
| 73 | 3 | 12, 13 | 1 | | | | |
| 74 | 3 | 14, 15 | 1 | | | | |
| 75 | 3 | 16, 17 | 1 | | | | |
| 76 | 3 | 12 | 2 | | | | |
| 77 | 3 | 13 | 2 | | | | |
| 78 | 3 | 14 | 2 | | | | |
| 79 | 3 | 15 | 2 | | | | |
| 80 | 3 | 16 | 2 | | | | |
| 81 | 3 | 17 | 2 | | | | |
| 82 | 3 | 18 | 2 | | | | |
| 83 | 3 | 19 | 2 | | | | |
| 84 | 3 | 20 | 2 | | | | |
| 85 | 3 | 21 | 2 | | | | |
| 86 | 3 | 22 | 2 | | | | |
| 87 | 3 | 23 | 2 | | | | |
| 88 | 3 | 12, 13 | 2 | | | | |
| 89 | 3 | 14, 15 | 2 | | | | |
| 90 | 3 | 16, 17 | 2 | | | | |
| 91 | 3 | 18, 19 | 2 | | | | |
| 92 | 3 | 20, 21 | 2 | | | | |
| 93 | 3 | 22, 23 | 2 | | | | |
| 94 | 1 | 12 | 2 | | | | |
| 95 | 1 | 13 | 2 | | | | |
| 96 | 1 | 18 | 2 | | | | |
| 97 | 1 | 19 | 2 | | | | |
| 98 | 1 | 12, 13 | 2 | | | | |
| 99 | 1 | 18, 19 | 2 | | | | |
| 100 | 2 | 12, 13 | 2 | | | | |
| 101 | 2 | 14, 15 | 2 | | | | |
| 102 | 2 | 18, 19 | 2 | | | | |
| 103 | 2 | 20, 21 | 2 | | | | |
| 104 | 1 | 0, 1, 12 | 1 | | | | |
| 105 | 1 | 0, 1, 12, 13 | 1 | | | | |
| 106 | 2 | 0, 1, 12 | 1 | | | | |
| 107 | 2 | 0, 1, 12, 13 | 1 | | | | |
| 108 | 2 | 2, 3, 14 | 1 | | | | |
| 109 | 2 | 2, 3, 14, 15 | 1 | | | | |
| 110 | 3 | 0, 1, 12 | 1 | | | | |
| 111 | 3 | 0, 1, 12, 13 | 1 | | | | |
| 112 | 3 | 2, 3, 14 | 1 | | | | |
| 113 | 3 | 2, 3, 14, 15 | 1 | | | | |
| 114 | 3 | 4, 5, 16 | 1 | | | | |
| 115 | 3 | 4, 5, 16, 17 | 1 | | | | |
| 116 | 2 | 0, 1, 12 | 2 | | | | |
| 117 | 2 | 0, 1, 12, 13 | 2 | | | | |
| 118 | 2 | 6, 7, 18 | 2 | | | | |
| 119 | 2 | 6, 7, 18, 19 | 2 | | | | |
| 120 | 2 | 2, 3, 14 | 2 | | | | |
| 121 | 2 | 2, 3, 14, 15 | 2 | | | | |
| 122 | 2 | 8, 9, 20 | 2 | | | | |
| 123 | 2 | 8, 9, 20, 21 | 2 | | | | |
| 124 | 3 | 0, 1, 12 | 2 | | | | |
| 125 | 3 | 0, 1, 12, 13 | 2 | | | | |
| 126 | 3 | 6, 7, 18 | 2 | | | | |
| 127 | 3 | 6, 7, 18, 19 | 2 | | | | |
| 128 | 3 | 2, 3, 14 | 2 | | | | |
| 129 | 3 | 2, 3, 14, 15 | 2 | | | | |
| 130 | 3 | 8, 9, 20 | 2 | | | | |
| 131 | 3 | 8, 9, 20, 21 | 2 | | | | |
| 132 | 3 | 4, 5, 16 | 2 | | | | |
| 133 | 3 | 4, 5, 16, 17 | 2 | | | | |
| 134 | 3 | 10, 11, 22 | 2 | | | | |
| 135 | 3 | 10, 11, 22, 23 | 2 | | | | |
| 136 | 2 | 0, 2, 3 | 1 | | | | |
| 137-255 | Reserved | Reserved | Reserved | | | | |

As specified herein in the present disclosure, As specified herein in the present disclosure, a e.g., the UE 116) could receive from the network (e.g., the network 130) a first (unified) TCI state(s) activation MAC CE command, used to map up to 8 TCI states and/or pairs of TCI states, with each pair comprising of one TCI state for DL channels/signals and/or one TCI state for UL channels/signals, to the codepoints of the DCI field ‘Transmission Configuration Indication’ for one or for a set of CCs/DL BWPs, and/or a second (unified) TCI state(s) activation MAC CE command, used to map up to 8 sets of TCI states, wherein each set could be comprised of up to two (e.g., none, one or two) TCI states for DL and UL signals/channels, and/or up to two (e.g., none, one or two) TCI state(s) for DL channels/signals and/or up to two (e.g., none, one or two) TCI state(s) for UL channels/signals to the codepoints of the DCI field “Transmission Configuration Indication” for one or for a set of CCs/DL BWPs, and if applicable, for one or for a set of CCs/UL BWPs. When a set of TCI state IDs are activated for a set of CCs/DL BWPs and if applicable, for a set of CCs/UL BWPs, where the applicable list of CCs is determined by the indicated CC in the activation command, the same set of TCI state IDs are applied for DL and/or UL BWPs in the indicated CCs. If the first/second MAC CE activation command maps TCI-State(s) and/or TCI-UL-State(s) to only one TCI codepoint, the UE shall apply the indicated TCI-State(s) and/or TCI-UL-State(s) to one or to a set of CCs/DL BWPs, and if applicable, to one or to a set of CCs/UL BWPs once the indicated mapping for the one single TCI codepoint is applied. That is, e.g., when/if the UE is provided/configured with dl-OrJointTCI-StateList and/or ul-TCI-StateList and/or is having one or two indicated TCI states and/or is having first and/or second indicated TCI states, an activated TCI codepoint in the second MAC CE activation command could be composed/comprised of one of:
Case 1: a first TCI state for DL channel(s)/signal(s)
Case 2: a first TCI state for DL channel(s)/signal(s) and a second TCI state for DL channel(s)/signal(s)
Case 3: a first TCI state for DL channel(s)/signal(s) and a second TCI state for UL channel(s)/signal(s)
Case 4: a first TCI state for DL channel(s)/signal(s) and a pair of a second TCI state for DL channel(s)/signal(s) and a second TCI state for UL channel(s)/signal(s)
Case 5: a first TCI state for UL channel(s)/signal(s)
Case 6: a first TCI state for UL channel(s)/signal(s) and a second TCI state for DL channel(s)/signal(s)
Case 7: a first TCI state for UL channel(s)/signal(s) and a second TCI state for UL channel(s)/signal(s)
Case 8: a first TCI state for UL channel(s)/signal(s) and a pair of a second TCI state for DL channel(s)/signal(s) and a second TCI state for UL channel(s)/signal(s)
Case 9: a pair of a first TCI state for DL channel(s)/signal(s) and a first TCI state for UL channel(s)/signal(s)
Case 10: a pair of a first TCI state for DL channel(s)/signal(s) and a first TCI state for UL channel(s)/signal(s) and a second TCI state for DL channel(s)/signal(s)
Case 11: a pair of a first TCI state for DL channel(s)/signal(s) and a first TCI state for UL channel(s)/signal(s) and a second TCI state for UL channel(s)/signal(s)
Case 12: a pair of a first TCI state for DL channel(s)/signal(s) and a first TCI state for UL channel(s)/signal(s) and a pair of a second TCI state for DL channel(s)/signal(s) and a second TCI state for UL channel(s)/signal(s)
Case 13: a second TCI state for DL channel(s)/signal(s)
Case 14: a second TCI state for UL channel(s)/signal(s)
Case 15: a pair of a second TCI state for DL channel(s)/signal(s) and a second TCI state for UL channel(s)/signal(s)
Case 16: a first TCI state for DL channel(s)/signal(s) and UL channel(s)/signal(s)
Case 17: a second TCI state for DL channel(s)/signal(s) and UL channel(s)/signal(s)
Case 18: a pair of a first TCI state for DL channel(s)/signal(s) and UL channel(s)/signal(s) and a second TCI state for DL channel(s)/signal(s) and UL channel(s)/signal(s)

Furthermore, when/if the UE is configured by higher layer parameter PDCCH-Config that contains two values of coresetPoolIndex (e.g., 0 and 1) in ControlResourceSet, the first/second (unified) TCI state(s) activation command as specified herein in the present disclosure could also incorporate/provide/indicate/include/contain a value of coresetPoolIndex (e.g., 0 or 1). For this case, the TCI state(s)/TCI codepoint(s) activated by/in the first/second (unified) TCI state(s) activation command could be specific to the same coresetPoolIndex value (i.e., 0 or 1) provided/indicated therein.

In one example, when/if the UE is not provided/configured with two values of coresetPoolIndex (e.g., 0 and 1) in PDCCH-Config and/or ControlResourceSet, and/or when/if the UE is provided/configured by higher layer parameter PDCCH-Config that contains a single value of coresetPoolIndex (e.g., 0) in ControlResourceSet, the UE may or may not expect, or may or may not be expected to receive a third (unified) TCI state(s) activation MAC CE command, wherein the TCI codepoint(s) activated by/in the third (unified) TCI state(s) activation MAC CE command could be comprised of or mapped to or could correspond to one of:
Case 19: first TCI state(s) for DL channels/signals, and/or first TCI state(s) for UL channels/signals, and/or pair(s) of TCI states with each pair comprising of a first TCI state for DL channels/signals and a first TCI state for UL channels/signals
Case 20: second TCI state(s) for DL channels/signals, and/or second TCI state(s) for UL channels/signals, and/or pair(s) of TCI states with each pair comprising of a second TCI state for DL channels/signals and a second TCI state for UL channels/signals
Case 21: first TCI state(s) for both DL and UL channels/signals
Case 22: second TCI state(s) for both DL and UL channels/signals

That is, the TCI codepoint(s) activated by/in a third (unified) TCI state(s) activation command could be comprised of or mapped to either first joint/DL/UL TCI state(s)/pair(s) of first DL and UL TCI states or second joint/DL/UL TCI state(s)/pair(s) of second DL and UL TCI states.

In another example, when/if the UE is not provided/configured with two values of coresetPoolIndex (e.g., 0 and 1) in PDCCH-Config and/or ControlResourceSet, and/or when/if the UE is provided/configured by higher layer parameter PDCCH-Config that contains a single value of coresetPoolIndex (e.g., 0) in ControlResourceSet, the UE may or may not expect, or may or may not be expected to receive a fourth (unified) TCI state(s) activation MAC CE command as specified herein in the present disclosure with (1) at least one TCI codepoint activated therein composing/comprising of a first TCI state for DL and/or UL channel(s)/signal(s) or a pair of a first TCI state for DL channel(s)/signal(s) and a first TCI state for UL channel(s)/signal(s), and a second TCI state for DL and/or UL channel(s)/signal(s) or a pair of a second TCI state for DL channel(s)/signal(s) and a second TCI state for UL channel(s)/signal(s), and/or (2) at least one TCI codepoint activated therein composing/comprising of at least first TCI state(s) as specified herein in the present disclosure and another TCI codepoint activated therein composing/comprising of at least second TCI state(s) as specified herein in the present disclosure. That is, for this case/design example, the UE may or may not expect, or may or may not be expected to receive a fourth (unified) TCI state(s) activation MAC CE command as specified herein in the present disclosure with (1) at least one TCI codepoint activated therein composing/comprising of one of:
Case 2: a first TCI state for DL channel(s)/signal(s) and a second TCI state for DL channel(s)/signal(s)
Case 3: a first TCI state for DL channel(s)/signal(s) and a second TCI state for UL channel(s)/signal(s)
Case 4: a first TCI state for DL channel(s)/signal(s) and a pair of a second TCI state for DL channel(s)/signal(s) and a second TCI state for UL channel(s)/signal(s)
Case 6: a first TCI state for UL channel(s)/signal(s) and a second TCI state for DL channel(s)/signal(s)
Case 7: a first TCI state for UL channel(s)/signal(s) and a second TCI state for UL channel(s)/signal(s)
Case 8: a first TCI state for UL channel(s)/signal(s) and a pair of a second TCI state for DL channel(s)/signal(s) and a second TCI state for UL channel(s)/signal(s)
Case 10: a pair of a first TCI state for DL channel(s)/signal(s) and a first TCI state for UL channel(s)/signal(s) and a second TCI state for DL channel(s)/signal(s)
Case 11: a pair of a first TCI state for DL channel(s)/signal(s) and a first TCI state for UL channel(s)/signal(s) and a second TCI state for UL channel(s)/signal(s)
Case 12: a pair of a first TCI state for DL channel(s)/signal(s) and a first TCI state for UL channel(s)/signal(s) and a pair of a second TCI state for DL channel(s)/signal(s) and a second TCI state for UL channel(s)/signal(s)
Case 18: a pair of a first TCI state for DL channel(s)/signal(s) and UL channel(s)/signal(s) and a second TCI state for DL channel(s)/signal(s) and UL channel(s)/signal(s), and/or (2) at least one TCI codepoint activated therein composing/comprising of one of:
Case 1: a first TCI state for DL channel(s)/signal(s)
Case 2: a first TCI state for DL channel(s)/signal(s) and a second TCI state for DL channel(s)/signal(s)
Case 3: a first TCI state for DL channel(s)/signal(s) and a second TCI state for UL channel(s)/signal(s)
Case 4: a first TCI state for DL channel(s)/signal(s) and a pair of a second TCI state for DL channel(s)/signal(s) and a second TCI state for UL channel(s)/signal(s)
Case 5: a first TCI state for UL channel(s)/signal(s)
Case 6: a first TCI state for UL channel(s)/signal(s) and a second TCI state for DL channel(s)/signal(s)
Case 7: a first TCI state for UL channel(s)/signal(s) and a second TCI state for UL channel(s)/signal(s)
Case 8: a first TCI state for UL channel(s)/signal(s) and a pair of a second TCI state for DL channel(s)/signal(s) and a second TCI state for UL channel(s)/signal(s)
Case 9: a pair of a first TCI state for DL channel(s)/signal(s) and a first TCI state for UL channel(s)/signal(s)
Case 10: a pair of a first TCI state for DL channel(s)/signal(s) and a first TCI state for UL channel(s)/signal(s) and a second TCI state for DL channel(s)/signal(s)
Case 11: a pair of a first TCI state for DL channel(s)/signal(s) and a first TCI state for UL channel(s)/signal(s) and a second TCI state for UL channel(s)/signal(s)
Case 12: a pair of a first TCI state for DL channel(s)/signal(s) and a first TCI state for UL channel(s)/signal(s) and a pair of a second TCI state for DL channel(s)/signal(s) and a second TCI state for UL channel(s)/signal(s)
Case 16: a first TCI state for DL channel(s)/signal(s) and UL channel(s)/signal(s)
Case 18: a pair of a first TCI state for DL channel(s)/signal(s) and UL channel(s)/signal(s) and a second TCI state for DL channel(s)/signal(s) and UL channel(s)/signal(s), and another TCI codepoint activated therein composing/comprising of one of:
Case 2: a first TCI state for DL channel(s)/signal(s) and a second TCI state for DL channel(s)/signal(s)
Case 3: a first TCI state for DL channel(s)/signal(s) and a second TCI state for UL channel(s)/signal(s)
Case 4: a first TCI state for DL channel(s)/signal(s) and a pair of a second TCI state for DL channel(s)/signal(s) and a second TCI state for UL channel(s)/signal(s)
Case 6: a first TCI state for UL channel(s)/signal(s) and a second TCI state for DL channel(s)/signal(s)
Case 7: a first TCI state for UL channel(s)/signal(s) and a second TCI state for UL channel(s)/signal(s)
Case 8: a first TCI state for UL channel(s)/signal(s) and a pair of a second TCI state for DL channel(s)/signal(s) and a second TCI state for UL channel(s)/signal(s)
Case 10: a pair of a first TCI state for DL channel(s)/signal(s) and a first TCI state for UL channel(s)/signal(s) and a second TCI state for DL channel(s)/signal(s)
Case 11: a pair of a first TCI state for DL channel(s)/signal(s) and a first TCI state for UL channel(s)/signal(s) and a second TCI state for UL channel(s)/signal(s)
Case 12: a pair of a first TCI state for DL channel(s)/signal(s) and a first TCI state for UL channel(s)/signal(s) and a pair of a second TCI state for DL channel(s)/signal(s) and a second TCI state for UL channel(s)/signal(s)
Case 13: a second TCI state for DL channel(s)/signal(s)
Case 14: a second TCI state for UL channel(s)/signal(s)
Case 15: a pair of a second TCI state for DL channel(s)/signal(s) and a second TCI state for UL channel(s)/signal(s)
Case 17: a second TCI state for DL channel(s)/signal(s) and UL channel(s)/signal(s)
Case 18: a pair of a first TCI state for DL channel(s)/signal(s) and UL channel(s)/signal(s) and a second TCI state for DL channel(s)/signal(s) and UL channel(s)/signal(s)

DCI format 1_1 is used for the scheduling of one or multiple PDSCH in one cell. The following information is transmitted by means of the DCI format 1_1 with cyclic redundancy check (CRC) scrambled by cell-radio network temporary identifier (C-RNTI) or CSI-RNTI or modulation and coding scheme (MCS)-C-RNTI:

Antenna port(s)—4, 5, 6, 7 or 8 bits as defined by Tables 1/2/3/4/5/6/7/8 and Tables 1A/2A/3A/4A/5A/6A/7A/8A as provided/specified in the present disclosure, where the number of CDM groups without data of values 1, 2, and 3 refers to CDM groups {0}, {0,1}, and {0, 1,2}respectively. The antenna ports {p₀, . . . , pᵥ₋₁}shall be determined according to the ordering of DMRS port(s) given by Tables 1/2/3/4/5/6/7/8 or Tables 1A/2A/3A/4A/5A/6A/7A/8A as provided/specified herein in the present disclosure.
In one example, when a UE is not configured/provided with dl-OrJointTCI-StateList,
   when the UE receives an activation command that maps at least one codepoint of DCI field ‘Transmission Configuration Indication’ to two TCI states, the UE could use Table 1A/2A/3A/4A/5A/6A/7A/8A as provided/specified herein in the present disclosure;
   otherwise, the UE could use Tables 1/2/3/4/5/6/7/8.
The UE can receive an entry with DMRS ports equals to 1000, 1002, 1003 when two TCI states are indicated in a codepoint of DCI field ‘Transmission Configuration Indication’.
In another example, when a UE is configured/provided with dl-OrJointTCI-StateList,
   when one or more of the following conditions hold or are achieved/satisfied, the UE could use Table 1A/2A/3A/4A/5A/6A/7A/8A as provided/specified herein in the present disclosure.
      Condition-0: when the UE receives an activation command that maps at least one codepoint of DCI field ‘Transmission Configuration Indication’ to two joint/DL TCI states
      Condition-1: when the UE receives an activation command that maps at least one codepoint of DCI field ‘Transmission Configuration Indication’ to two joint TCI states or TCI states for both DL and UL channels/signals
      Condition-2: when the UE receives an activation command that maps at least one codepoint of DCI field ‘Transmission Configuration Indication’ to at least two DL TCI states or TCI states for DL channels/signals
      Condition-3: when the UE is using at least a/the first indicated joint/DL TCI state for PDSCH reception—e.g., scheduled/activated by the DCI format 1_1, and/or when the UE receives an activation command that maps at least one codepoint of DCI field ‘Transmission Configuration Indication’ to a/the second (indicated) joint/DL TCI state
      Condition-4: when the UE is using at least a/the second indicated joint/DL TCI state for PDSCH reception—e.g., scheduled/activated by the DCI format 1_1, and/or when the UE receives an activation command that maps at least one codepoint of DCI field ‘Transmission Configuration Indication’ to a/the first (indicated) joint/DL TCI state
      Condition-5: when the UE receives an activation command with at least one TCI codepoint activated/indicated/provided therein mapped to/comprising of at least a/the first joint/DL TCI state and at least one (or another) TCI codepoint activated/indicated/provided therein mapped to/comprising of at least a/the second joint/DL TCI state
      Condition-6a: when the UE receives an activation command, wherein the TCI codepoints activated/indicated/provided in the activation command are not mapped to/comprising of either only first joint/DL TCI state(s) or only second joint/DL TCI state(s)—or equivalently, when the UE receives an activation command, wherein the TCI codepoints activated/indicated/provided in the activation command are not mapped to/comprising of single joint/DL TCI state(s) and/or single pair(s) of DL and UL TCI states (e.g., either first or second TCI state(s))
      Condition-6b: when the UE receives an activation command, wherein not all the TCI codepoints activated/indicated/provided in the activation command are mapped to/comprising of either only first joint/DL TCI state(s) or only second joint/DL TCI state(s)—or equivalently, when the UE receives an activation command, wherein not all the TCI codepoints activated/indicated/provided in the activation command are mapped to/comprising of single joint/DL TCI state(s) and/or single pair(s) of DL and UL TCI states (e.g., either first or second TCI state(s))
      Condition-7: when the TCI selection field (or equivalently, the second indicator as specified herein in the present disclosure) is present (or 2 bits) in DCI format 1_1/1_2—e.g., the UE could report its capability of supporting the TCI selection field (or equivalently, the second indicator as specified herein in the present disclosure) configured to be present in DCI format 1_1/1_2, and/or the UE could be configured/provided with the higher layer parameter tciSelection-PresentInDCI (e.g., set to ‘enabled’)
      Condition-8: when the TCI selection field (or equivalently, the second indicator as specified herein in the present disclosure) is not present (or absent or 0 bit) in DCI format 1_1/1_2—e.g., the UE is not capable of supporting or is not able to support the TCI selection field (or equivalently, the second indicator as specified herein in the present disclosure) configured to be present in DCI format 1_1/1_2, and/or the UE may not be configured/provided with the higher layer parameter tciSelection-PresentInDCI, and/or the UE could be configured/provided with the higher layer parameter tciSelection-PresentInDCI but the higher layer parameter tciSelection-PresentInDCI is set to ‘disabled
      Condition-9a: the UE is having one indicated joint/DL TCI state to be applied for/to PDSCH(s)/PDSCH reception(s)—e.g., scheduled/activated by the DCI format 1_1
      Condition-9b: the UE is having two indicated joint/DL TCI states to be applied for/to PDSCH(s)/PDSCH reception(s)—e.g., scheduled/activated by the DCI format 1_1
      Condition-10: when the UE receives a Rel-18 (unified) TCI state(s) activation MAC CE command—or the second, third or fourth (unified) TCI state(s) activation MAC CE command(s) as specified herein in the present disclosure
      Condition-11, when the UE does not receive any Rel-17 (unified) TCI state(s) activation MAC CE command—or, the first (unified) TCI state(s) activation MAC CE command as specified herein in the present disclosure, and/or when the UE does not receive any third (unified) TCI state(s) activation MAC CE command(s) as specified herein in the present disclosure
   Otherwise (e.g., when/if one or more of the described/specified conditions herein including Condition-0—Condition-11 are not achieved/satisfied or do not hold), e.g., when the UE is having only one joint/DL TCI state to be applied for/to PDSCH/PDSCH reception(s)—e.g., scheduled/activated by the DCI format 1_1, and/or when the TCI codepoints activated/indicated/provided in a received activation command are mapped to/comprising of single joint/DL TCI state(s) and/or single pair(s) of DL and UL TCI states (e.g., either first or second TCI state(s)), and/or when none of the TCI codepoints activated/indicated/provided in a received activation command is mapped/comprising of two joint/DL TCI states, and/or when the UE receives a Rel-17 (unified) TCI state(s) activation MAC CE command—or equivalently a first (unified) TCI state(s) activation MAC CE command as specified herein in the present disclosure, and/or receives a third (unified) TCI state(s) activation MAC CE command as specified herein in the present disclosure, and/or when the UE does not receive any Rel-18 (unified) TCI state(s) activation MAC CE command(s)—or, the second, third or fourth (unified) TCI state(s) activation MAC CE command(s) as specified herein in the present disclosure, the UE could use Tables 1/2/3/4/5/6/7/8 as provided/specified herein in the present disclosure.

When/if one or more of the described/specified conditions herein (e.g., Condition-0—Condition-11 as specified herein in the present disclosure) are achieved/satisfied or hold—e.g., when a UE is having/using two indicated joint/DL TCI states to be applied to/for PDSCH(s)/PDSCH reception(s)—e.g., scheduled/activated by the DCI format 1_1, the UE can receive an entry with DMRS ports equals to 1000, 1002, 1003.

In one embodiment, when/if a UE is provided/configured with dl-OrJointTCI-StateList and/or ul-TCI-StateList, and/or when/if the UE receives a (unified) TCI state(s) activation MAC CE command—e.g., a first (unified) TCI state(s) activation MAC CE command or a second (unified) TCI state(s) activation MAC CE command or a third (unified) TCI state(s) activation MAC CE command or a fourth (unified) TCI state(s) activation MAC CE command as specified herein in the present disclosure, and/or when/if the DCI field ‘Transmission Configuration Indication’ is present in DCI format 1_2, and/or when/if the number of codepoints S in the DCI field ‘Transmission Configuration Indication’ of the DCI format 1_2 is smaller than the number of TCI codepoints that are activated by the (unified) TCI state(s) activation MAC CE command—e.g., a first (unified) TCI state(s) activation MAC CE command or a second (unified) TCI state(s) activation MAC CE command or a third (unified) TCI state(s) activation MAC CE command or a fourth (unified) TCI state(s) activation MAC CE command as specified herein in the present disclosure, only the first S activated TCI codepoints—e.g., out of the total TCI codepoints activated by the (unified) TCI state(s) activation MAC CE command as specified herein—are applied to the DCI field ‘Transmission Configuration Indication’ of/for the DCI format 1_2. When a UE is provided in PDCCH-Config two values of coresetPoolIndex (e.g., 0 and 1) in CORESET(s)/ControlResourceSet, the DCI format 1_2 as specified herein in the present disclosure and the (unified) TCI state(s) activation MAC CE command as specified herein in the present disclosure (and therefore, the first S activated TCI codepoints among the TCI codepoints activated therein) could be specific to a/the same value of coresetPoolIndex (i.e., 0 or 1). That is, when/if a UE receives a (unified) TCI state(s) activation MAC CE command—e.g., a first (unified) TCI state(s) activation MAC CE command or a second (unified) TCI state(s) activation MAC CE command or a third (unified) TCI state(s) activation MAC CE command or a fourth (unified) TCI state(s) activation MAC CE command as specified herein in the present disclosure—that is specific to a value of coresetPoolIndex, e.g., 0 (or 1)—e.g., the value of coresetPoolIndex is provided/indicated in the MAC CE command, and/or when/if the DCI field ‘Transmission Configuration Indication’ is present in DCI format 1_2 specific to the same value of coresetPoolIndex, i.e., 0 (or 1), and/or when/if the number of codepoints S in the DCI field ‘Transmission Configuration Indication’ of the DCI format 12 specific to the same value of coresetPoolIndex, i.e., 0 (or 1), is smaller than the number of TCI codepoints that are activated by the (unified) TCI state(s) activation MAC CE command—e.g., a first (unified) TCI state(s) activation MAC CE command or a second (unified) TCI state(s) activation MAC CE command or a third (unified) TCI state(s) activation MAC CE command or a fourth (unified) TCI state(s) activation MAC CE command as specified herein in the present disclosure—specific to the same value of coresetPoolIndex, i.e., 0 (or 1), only the first S activated TCI codepoints—e.g., out of the total TCI codepoints activated by the (unified) TCI state(s) activation MAC CE command as specified herein specific to the same value of coresetPoolIndex, i.e., 0 (or 1)—are applied to the DCI field ‘Transmission Configuration Indication’ of/for the DCI format 12 specific to the same value of coresetPoolIndex, i.e., 0 (or 1), wherein the DCI format 1_2 is specific to a value of coresetPoolIndex when/if the PDCCH candidate(s) that carries the DCI format 1_2 is received in CORESET(s) associated/configured/specific to/with the same value of coresetPoolIndex. With reference to FIG. 7, a conceptual example of applying the first S activated TCI codepoints—e.g., out of the total TCI codepoints activated by the (unified) TCI state(s) activation MAC CE command—to/for the DCI format 12 is provided.
In one example, the UE could expect that each of the (first) S activated TCI codepoints applied for the DCI format 1_2 could be comprised of one TCI state for both DL and UL channels/signals, one TCI state for DL channels/signals, one TCI state for UL channels/signals, or a pair of TCI states comprising of one TCI state for DL channels/signals and one TCI state for UL channels/signals—i.e., the same TCI codepoint definition as that for the first (unified) TCI state(s) activation MAC CE command as specified herein in the present disclosure.
In another example, the UE could expect that each of the (first) S activated TCI codepoints applied for the DCI format 1_2 could be comprised of a set of TCI states with the set comprising of up to two (e.g., none, one or two) TCI states for DL and UL channels/signals and/or up to two (e.g., none, one or two) TCI state(s) for DL channels/signals and/or up to two (e.g., none, one or two) TCI state(s) for UL channels/signals—i.e., the same TCI codepoint definition as that for the second (unified) TCI state(s) activation MAC CE command as specified herein in the present disclosure.
In another example, the UE could expect that the (first) S activated TCI codepoints applied for the DCI format 1_2 could correspond to one of:
   Case 19: first TCI state(s) for DL channels/signals, and/or first TCI state(s) for UL channels/signals, and/or pair(s) of TCI states with each pair comprising of a first TCI state for DL channels/signals and a first TCI state for UL channels/signals
   Case 20: second TCI state(s) for DL channels/signals, and/or second TCI state(s) for UL channels/signals, and/or pair(s) of TCI states with each pair comprising of a second TCI state for DL channels/signals and a second TCI state for UL channels/signals
   Case 21: first TCI state(s) for both DL and UL channels/signals
   Case 22: second TCI state(s) for both DL and UL channels/signals

That is, the same TCI codepoint definition as that for the third (unified) TCI state(s) activation MAC CE command as specified herein in the present disclosure is retained in this case/design example—the (first) S activated TCI codepoint(s) applied for the DCI format 1_2 could be comprised of or mapped to either first joint/DL/UL TCI state(s)/pair(s) of first DL and UL TCI states or second joint/DL/UL TCI state(s)/pair(s) of second DL and UL TCI states.
In another example, the UE may not expect that the (first) S activated TCI codepoints applied for the DCI format 1_2 could correspond to one of:
   Case 19: first TCI state(s) for DL channels/signals, and/or first TCI state(s) for UL channels/signals, and/or pair(s) of TCI states with each pair comprising of a first TCI state for DL channels/signals and a first TCI state for UL channels/signals
   Case 20: second TCI state(s) for DL channels/signals, and/or second TCI state(s) for UL channels/signals, and/or pair(s) of TCI states with each pair comprising of a second TCI state for DL channels/signals and a second TCI state for UL channels/signals
   Case 21: first TCI state(s) for both DL and UL channels/signals
   Case 22: second TCI state(s) for both DL and UL channels/signals
In another example, the UE could expect that the (first) S activated TCI codepoints applied for the DCI format 1_2 could comprise/include/contain at least one activated TCI codepoint that is composed/comprised of a first TCI state for DL and/or UL channel(s)/signal(s) or a pair of a first TCI state for DL channel(s)/signal(s) and a first TCI state for UL channel(s)/signal(s), and a second TCI state for DL and/or UL channel(s)/signal(s) or a pair of a second TCI state for DL channel(s)/signal(s) and a second TCI state for UL channel(s)/signal(s); i.e., for this case/design example, at least one activated TCI codepoint out of the (first) S activated TCI codepoints applied for the DCI format 1_2 could be composed/comprised of one of:
Case 2: a first TCI state for DL channel(s)/signal(s) and a second TCI state for DL channel(s)/signal(s)
Case 3: a first TCI state for DL channel(s)/signal(s) and a second TCI state for UL channel(s)/signal(s)
Case 4: a first TCI state for DL channel(s)/signal(s) and a pair of a second TCI state for DL channel(s)/signal(s) and a second TCI state for UL channel(s)/signal(s)
Case 6: a first TCI state for UL channel(s)/signal(s) and a second TCI state for DL channel(s)/signal(s)
Case 7: a first TCI state for UL channel(s)/signal(s) and a second TCI state for UL channel(s)/signal(s)
Case 8: a first TCI state for UL channel(s)/signal(s) and a pair of a second TCI state for DL channel(s)/signal(s) and a second TCI state for UL channel(s)/signal(s)
Case 10: a pair of a first TCI state for DL channel(s)/signal(s) and a first TCI state for UL channel(s)/signal(s) and a second TCI state for DL channel(s)/signal(s)
Case 11: a pair of a first TCI state for DL channel(s)/signal(s) and a first TCI state for UL channel(s)/signal(s) and a second TCI state for UL channel(s)/signal(s)
Case 12: a pair of a first TCI state for DL channel(s)/signal(s) and a first TCI state for UL channel(s)/signal(s) and a pair of a second TCI state for DL channel(s)/signal(s) and a second TCI state for UL channel(s)/signal(s)
Case 18: a pair of a first TCI state for DL channel(s)/signal(s) and UL channel(s)/signal(s) and a second TCI state for DL channel(s)/signal(s) and UL channel(s)/signal(s)

That is, the same TCI codepoint definition as that for the fourth (unified) TCI state(s) activation MAC CE command as specified herein in the present disclosure is retained in this case/design example.
In another example, the UE could expect that the (first) S activated TCI codepoints applied for the DCI format 1_2 may not comprise/include/contain any activated TCI codepoint(s) that is composed/comprised of a first TCI state for DL and/or UL channel(s)/signal(s) or a pair of a first TCI state for DL channel(s)/signal(s) and a first TCI state for UL channel(s)/signal(s), and a second TCI state for DL and/or UL channel(s)/signal(s) or a pair of a second TCI state for DL channel(s)/signal(s) and a second TCI state for UL channel(s)/signal(s); i.e., for this case/design example, none of the (first) S activated TCI codepoints applied for the DCI format 1_2 could be composed/comprised of any of:
Case 2: a first TCI state for DL channel(s)/signal(s) and a second TCI state for DL channel(s)/signal(s)
Case 3: a first TCI state for DL channel(s)/signal(s) and a second TCI state for UL channel(s)/signal(s)
Case 4: a first TCI state for DL channel(s)/signal(s) and a pair of a second TCI state for DL channel(s)/signal(s) and a second TCI state for UL channel(s)/signal(s)
Case 6: a first TCI state for UL channel(s)/signal(s) and a second TCI state for DL channel(s)/signal(s)
Case 7: a first TCI state for UL channel(s)/signal(s) and a second TCI state for UL channel(s)/signal(s)
Case 8: a first TCI state for UL channel(s)/signal(s) and a pair of a second TCI state for DL channel(s)/signal(s) and a second TCI state for UL channel(s)/signal(s)
Case 10: a pair of a first TCI state for DL channel(s)/signal(s) and a first TCI state for UL channel(s)/signal(s) and a second TCI state for DL channel(s)/signal(s)
Case 11: a pair of a first TCI state for DL channel(s)/signal(s) and a first TCI state for UL channel(s)/signal(s) and a second TCI state for UL channel(s)/signal(s)
Case 12: a pair of a first TCI state for DL channel(s)/signal(s) and a first TCI state for UL channel(s)/signal(s) and a pair of a second TCI state for DL channel(s)/signal(s) and a second TCI state for UL channel(s)/signal(s)
Case 18: a pair of a first TCI state for DL channel(s)/signal(s) and UL channel(s)/signal(s) and a second TCI state for DL channel(s)/signal(s) and UL channel(s)/signal(s)
In another example, the UE could expect that the (first) S activated TCI codepoints applied for the DCI format 1_2 could comprise/include/contain at least one TCI codepoint that is composed/comprised of at least first TCI state(s) as specified herein in the present disclosure and another TCI codepoint that is composed/comprised of at least second TCI state(s) as specified herein in the present disclosure; i.e., for this case/design example, at least one activated TCI codepoint out of the (first) S activated TCI codepoints applied for the DCI format 1_2 could be composed/comprised of one of:
   Case 1: a first TCI state for DL channel(s)/signal(s)
   Case 2: a first TCI state for DL channel(s)/signal(s) and a second TCI state for DL channel(s)/signal(s)
   Case 3: a first TCI state for DL channel(s)/signal(s) and a second TCI state for UL channel(s)/signal(s)
   Case 4: a first TCI state for DL channel(s)/signal(s) and a pair of a second TCI state for DL channel(s)/signal(s) and a second TCI state for UL channel(s)/signal(s)
   Case 5: a first TCI state for UL channel(s)/signal(s)
   Case 6: a first TCI state for UL channel(s)/signal(s) and a second TCI state for DL channel(s)/signal(s)
   Case 7: a first TCI state for UL channel(s)/signal(s) and a second TCI state for UL channel(s)/signal(s)
   Case 8: a first TCI state for UL channel(s)/signal(s) and a pair of a second TCI state for DL channel(s)/signal(s) and a second TCI state for UL channel(s)/signal(s)
   Case 9: a pair of a first TCI state for DL channel(s)/signal(s) and a first TCI state for UL channel(s)/signal(s)
   Case 10: a pair of a first TCI state for DL channel(s)/signal(s) and a first TCI state for UL channel(s)/signal(s) and a second TCI state for DL channel(s)/signal(s)
   Case 11: a pair of a first TCI state for DL channel(s)/signal(s) and a first TCI state for UL channel(s)/signal(s) and a second TCI state for UL channel(s)/signal(s)
   Case 12: a pair of a first TCI state for DL channel(s)/signal(s) and a first TCI state for UL channel(s)/signal(s) and a pair of a second TCI state for DL channel(s)/signal(s) and a second TCI state for UL channel(s)/signal(s)
   Case 16: a first TCI state for DL channel(s)/signal(s) and UL channel(s)/signal(s)
   Case 18: a pair of a first TCI state for DL channel(s)/signal(s) and UL channel(s)/signal(s) and a second TCI state for DL channel(s)/signal(s) and UL channel(s)/signal(s), and another TCI codepoint out of the (first) S activated TCI codepoints applied for the DCI format 1_2 could be composed/comprised of one of:
   Case 2: a first TCI state for DL channel(s)/signal(s) and a second TCI state for DL channel(s)/signal(s)
   Case 3: a first TCI state for DL channel(s)/signal(s) and a second TCI state for UL channel(s)/signal(s)
   Case 4: a first TCI state for DL channel(s)/signal(s) and a pair of a second TCI state for DL channel(s)/signal(s) and a second TCI state for UL channel(s)/signal(s)
   Case 6: a first TCI state for UL channel(s)/signal(s) and a second TCI state for DL channel(s)/signal(s)
   Case 7: a first TCI state for UL channel(s)/signal(s) and a second TCI state for UL channel(s)/signal(s)
   Case 8: a first TCI state for UL channel(s)/signal(s) and a pair of a second TCI state for DL channel(s)/signal(s) and a second TCI state for UL channel(s)/signal(s)
   Case 10: a pair of a first TCI state for DL channel(s)/signal(s) and a first TCI state for UL channel(s)/signal(s) and a second TCI state for DL channel(s)/signal(s)
   Case 11: a pair of a first TCI state for DL channel(s)/signal(s) and a first TCI state for UL channel(s)/signal(s) and a second TCI state for UL channel(s)/signal(s)
   Case 12: a pair of a first TCI state for DL channel(s)/signal(s) and a first TCI state for UL channel(s)/signal(s) and a pair of a second TCI state for DL channel(s)/signal(s) and a second TCI state for UL channel(s)/signal(s)
   Case 13: a second TCI state for DL channel(s)/signal(s)
   Case 14: a second TCI state for UL channel(s)/signal(s)
   Case 15: a pair of a second TCI state for DL channel(s)/signal(s) and a second TCI state for UL channel(s)/signal(s)
   Case 17: a second TCI state for DL channel(s)/signal(s) and UL channel(s)/signal(s)
   Case 18: a pair of a first TCI state for DL channel(s)/signal(s) and UL channel(s)/signal(s) and a second TCI state for DL channel(s)/signal(s) and UL channel(s)/signal(s)

That is, the same TCI codepoint definition as that for the fourth (unified) TCI state(s) activation MAC CE command as specified herein in the present disclosure is retained in this case/design example.
In another example, when/if the (first) S activated TCI codepoints applied for the DCI format 1_2 comprise/include/contain at least one TCI codepoint that is composed/comprised of at least first TCI state(s) as specified herein in the present disclosure, the UE could expect that the (first) S activated TCI codepoints applied for the DCI format 1_2 may not comprise/include/contain any TCI codepoint that is composed/comprised of second TCI state(s) as specified herein in the present disclosure.
In another example, when/if the (first) S activated TCI codepoints applied for the DCI format 1_2 comprise/include/contain at least one TCI codepoint that is composed/comprised of at least second TCI state(s) as specified herein in the present disclosure, the UE could expect that the (first) S activated TCI codepoints applied for the DCI format 1_2 may not comprise/include/contain any TCI codepoint that is composed/comprised of first TCI state(s) as specified herein in the present disclosure.

In one embodiment, when/if a UE is provided/configured with dl-OrJointTCI-StateList and/or ul-TCI-StateList, and/or when/if the UE receives a (unified) TCI state(s) activation MAC CE command—e.g., a first (unified) TCI state(s) activation MAC CE command or a second (unified) TCI state(s) activation MAC CE command or a third (unified) TCI state(s) activation MAC CE command or a fourth (unified) TCI state(s) activation MAC CE command as specified herein in the present disclosure, and/or when/if the DCI field ‘Transmission Configuration Indication’ is present in DCI format 1_2, and/or when/if the number of codepoints S in the DCI field ‘Transmission Configuration Indication’ of the DCI format 1_2 is smaller than the number of TCI codepoints that are activated by the (unified) TCI state(s) activation MAC CE command—e.g., a first (unified) TCI state(s) activation MAC CE command or a second (unified) TCI state(s) activation MAC CE command or a third (unified) TCI state(s) activation MAC CE command or a fourth (unified) TCI state(s) activation MAC CE command as specified herein in the present disclosure, one of:
Only the first S activated TCI codepoints that are composed/comprised of either first TCI state(s) as specified herein in the present disclosure or second TCI state(s) as specified herein in the present disclosure—e.g., out of the total TCI codepoints activated by the (unified) TCI state(s) activation MAC CE command as specified herein—are applied to the DCI field ‘Transmission Configuration Indication’ of/for the DCI format 1_2.
Only the first S activated TCI codepoints—e.g., out of the total TCI codepoints that are composed/comprised of either first TCI state(s) as specified herein in the present disclosure or second TCI state(s) as specified herein in the present disclosure activated by the (unified) TCI state(s) activation MAC CE command as specified herein—are applied to the DCI field ‘Transmission Configuration Indication’ of/for the DCI format 1_2.
Only the first S activated TCI codepoints that are composed/comprised of at least one TCI codepoint that is composed/comprised of a first TCI state for DL and/or UL channel(s)/signal(s) or a pair of a first TCI state for DL channel(s)/signal(s) and a first TCI state for UL channel(s)/signal(s), and a second TCI state for DL and/or UL channel(s)/signal(s) or a pair of a second TCI state for DL channel(s)/signal(s) and a second TCI state for UL channel(s)/signal(s) as specified herein in the present disclosure, and/or at least one TCI codepoint that is composed/comprised of at least first TCI state(s) as specified herein in the present disclosure and another TCI codepoint that is composed/comprised of at least second TCI state(s) as specified herein in the present disclosure—e.g., out of the total TCI codepoints activated by the (unified) TCI state(s) activation MAC CE command as specified herein—are applied to the DCI field ‘Transmission Configuration Indication’ of/for the DCI format 1_2.
Only the first S activated TCI codepoints—e.g., out of the total TCI codepoints that are composed/comprised of at least one TCI codepoint that is composed/comprised of a first TCI state for DL and/or UL channel(s)/signal(s) or a pair of a first TCI state for DL channel(s)/signal(s) and a first TCI state for UL channel(s)/signal(s), and a second TCI state for DL and/or UL channel(s)/signal(s) or a pair of a second TCI state for DL channel(s)/signal(s) and a second TCI state for UL channel(s)/signal(s) as specified herein in the present disclosure, and/or at least one TCI codepoint that is composed/comprised of at least first TCI state(s) as specified herein in the present disclosure and another TCI codepoint that is composed/comprised of at least second TCI state(s) as specified herein in the present disclosure activated by the (unified) TCI state(s) activation MAC CE command as specified herein—are applied to the DCI field ‘Transmission Configuration Indication’ of/for the DCI format 1_2.

When a UE is provided in PDCCH-Config two values of coresetPoolIndex (e.g., 0 and 1) in CORESET(s)/ControlResourceSet, the DCI format 1_2 as specified herein in the present disclosure and the (unified) TCI state(s) activation MAC CE command as specified herein in the present disclosure could be specific to a/the same value of coresetPoolIndex (i.e., 0 or 1). That is, when/if a UE receives a (unified) TCI state(s) activation MAC CE command—e.g., a first (unified) TCI state(s) activation MAC CE command or a second (unified) TCI state(s) activation MAC CE command or a third (unified) TCI state(s) activation MAC CE command or a fourth (unified) TCI state(s) activation MAC CE command as specified herein in the present disclosure—that is specific to a value of coresetPoolIndex, e.g., 0 (or 1)—e.g., the value of coresetPoolIndex is provided/indicated in the MAC CE command, and/or when/if the DCI field ‘Transmission Configuration Indication’ is present in DCI format 1_2 specific to the same value of coresetPoolIndex, i.e., 0 (or 1), and/or when/if the number of codepoints S in the DCI field ‘Transmission Configuration Indication’ of the DCI format 1_2 specific to the same value of coresetPoolIndex, i.e., 0 (or 1), is smaller than the number of TCI codepoints that are activated by the (unified) TCI state(s) activation MAC CE command—e.g., a first (unified) TCI state(s) activation MAC CE command or a second (unified) TCI state(s) activation MAC CE command or a third (unified) TCI state(s) activation MAC CE command or a fourth (unified) TCI state(s) activation MAC CE command as specified herein in the present disclosure—specific to the same value of coresetPoolIndex, i.e., 0 (or 1), one of:
Only the first S activated TCI codepoints that are composed/comprised of either first TCI state(s) as specified herein in the present disclosure or second TCI state(s) as specified herein in the present disclosure—e.g., out of the total TCI codepoints activated by the (unified) TCI state(s) activation MAC CE command as specified herein specific to the same value of coresetPoolIndex, i.e., 0 (or 1)—are applied to the DCI field ‘Transmission Configuration Indication’ of/for the DCI format 1_2 specific to the same value of coresetPoolIndex, i.e., 0 (or 1).
Only the first S activated TCI codepoints—e.g., out of the total TCI codepoints that are composed/comprised of either first TCI state(s) as specified herein in the present disclosure or second TCI state(s) as specified herein in the present disclosure activated by the (unified) TCI state(s) activation MAC CE command as specified herein specific to the same value of coresetPoolIndex, i.e., 0 (or 1)—are applied to the DCI field ‘Transmission Configuration Indication’ of/for the DCI format 1_2 specific to the same value of coresetPoolIndex, i.e., 0 (or 1).
Only the first S activated TCI codepoints that are composed/comprised of at least one TCI codepoint that is composed/comprised of a first TCI state for DL and/or UL channel(s)/signal(s) or a pair of a first TCI state for DL channel(s)/signal(s) and a first TCI state for UL channel(s)/signal(s), and a second TCI state for DL and/or UL channel(s)/signal(s) or a pair of a second TCI state for DL channel(s)/signal(s) and a second TCI state for UL channel(s)/signal(s) as specified herein in the present disclosure, and/or at least one TCI codepoint that is composed/comprised of at least first TCI state(s) as specified herein in the present disclosure and another TCI codepoint that is composed/comprised of at least second TCI state(s) as specified herein in the present disclosure—e.g., out of the total TCI codepoints activated by the (unified) TCI state(s) activation MAC CE command as specified herein specific to the same value of coresetPoolIndex, i.e., 0 (or 1)—are applied to the DCI field ‘Transmission Configuration Indication’ of/for the DCI format 12 specific to the same value of coresetPoolIndex, i.e., 0 (or 1).
Only the first S activated TCI codepoints—e.g., out of the total TCI codepoints that are composed/comprised of at least one TCI codepoint that is composed/comprised of a first TCI state for DL and/or UL channel(s)/signal(s) or a pair of a first TCI state for DL channel(s)/signal(s) and a first TCI state for UL channel(s)/signal(s), and a second TCI state for DL and/or UL channel(s)/signal(s) or a pair of a second TCI state for DL channel(s)/signal(s) and a second TCI state for UL channel(s)/signal(s) as specified herein in the present disclosure, and/or at least one TCI codepoint that is composed/comprised of at least first TCI state(s) as specified herein in the present disclosure and another TCI codepoint that is composed/comprised of at least second TCI state(s) as specified herein in the present disclosure activated by the (unified) TCI state(s) activation MAC CE command as specified herein specific to the same value of coresetPoolIndex, i.e., 0 (or 1)—are applied to the DCI field ‘Transmission Configuration Indication’ of/for the DCI format 1_2 specific to the same value of coresetPoolIndex, i.e., 0 (or 1).

Here, the DCI format 1_2 is specific to a value of coresetPoolIndex when/if the PDCCH candidate(s) that carries the DCI format 1_2 is received in CORESET(s) associated/configured/specific to/with the same value of coresetPoolIndex. In addition to the specified/described design examples herein, the UE could be indicated/configured/provided by the network, e.g., via higher layer RRC signaling(s)/parameter(s) and/or MAC CE command(s) and/or dynamic DCI based L1 signaling(s), which S out of the total TCI codepoints activated by the (unified) TCI state(s) activation MAC CE command as specified herein could be applied to the DCI field ‘Transmission Configuration Indication’ of/for the DCI format 1_2. For example, the UE could be indicated/configured/provided by the network, e.g., via higher layer RRC signaling(s)/parameter(s) and/or MAC CE command(s)—e.g., the (unified) TCI state(s) activation MAC CE command as specified herein in the present disclosure—and/or dynamic DCI based L1 signaling(s), a bitmap with each entry/bit position of the bitmap corresponding/associated to a TCI codepoint activated by/in the (unified) TCI state(s) activation MAC CE command; in this case, when/if an entry/bit position of the bitmap is set to ‘1’ (or ‘0’), the activated TCI codepoint corresponding/associated to the entry/bit position could belong to the S activated TCI codepoints as specified herein in the present disclosure. For another example, each of the TCI codepoints activated by/in the (unified) TCI state(s) activation MAC CE command could be associated with/to an indicator; in this case, when/if an indicator is set to ‘1’ (or ‘0’), the activated TCI codepoint corresponding/associated to the indicator could belong to the S activated TCI codepoints as specified herein in the present disclosure.
DCI format 1_2 is used for the scheduling of PDSCH in one cell. The following information is transmitted by means of the DCI format 1_2 with CRC scrambled by C-RNTI or CS-RNTI or MCS-C-RNTI.

Antenna port(s)—0, 4, 5, 6, 7 or 8 bits; 0 bit if higher layer parameter antennaPortsFieldPresenceDCI-1-2 is not configured; otherwise 4, 5, 6, 7 or 8 bits as defined by Tables 1/2/3/4/5/6/7/8 and Tables 1A/2A/3A/4A/5A/6A/7A/8A as provided/specified herein in the present disclosure, where the number of CDM groups without data of values 1, 2, and 3 refers to CDM groups {0}, {0,1}, and {0, 1,2}respectively. The antenna ports {p₀, . . . , pv_1}shall be determined according to the ordering of DMRS port(s) given by Tables 1/2/3/4/5/6/7/8 or Tables 1A/2A/3A/4A/5A/6A/7A/8A as provided/specified herein in the present disclosure.
In one example, when a UE is not configured/provided with dl-OrJointTCI-StateList,
   when the UE receives an activation command that maps at least one codepoint of DCI field ‘Transmission Configuration Indication’ to two TCI states, the UE could use Table 1A/2A/3A/4A/5A/6A/7A/8A as provided/specified herein in the present disclosure;
   otherwise, the UE could use Tables 1/2/3/4/5/6/7/8.

The UE can receive an entry with DMRS ports equals to 1000, 1002, 1003 when two TCI states are indicated in a codepoint of DCI field ‘Transmission Configuration Indication’.
In another example, when a UE is configured/provided with dl-OrJointTCI-StateList,
   when one or more of the Condition-0—Condition-11 as specified herein in the present disclosure hold or are achieved/satisfied, the UE could use Table 1A/2A/3A/4A/5A/6A/7A/8A as provided/specified herein in the present disclosure.
   when/if the DCI field ‘Transmission Configuration Indication’ is present in DCI format 1_2, and/or when/if the number of codepoints S in the DCI field ‘Transmission Configuration Indication’ of the DCI format 1_2 is smaller than the number of TCI codepoints that are activated by a received (unified) TCI state(s) activation MAC CE command, and/or when one or more of the following conditions hold or are achieved/satisfied, the UE could use Table 1A/2A/3A/4A/5A/6A/7A/8A as provided/specified herein in the present disclosure.
      Condition-12: when the UE receives an activation command, wherein the activation command contains/includes/indicates/provides the S activated TCI codepoints according to those specified herein in the present disclosure (e.g., the first S activated TCI codepoints in the activation command) that map at least one codepoint of DCI field ‘Transmission Configuration Indication’ to two joint/DL TCI states
      Condition-13: when the UE receives an activation command, wherein the activation command contains/includes/indicates/provides the S activated TCI codepoints according to those specified herein in the present disclosure (e.g., the first S activated TCI codepoints in the activation command) that map at least one codepoint of DCI field ‘Transmission Configuration Indication’ to two joint TCI states or TCI states for both DL and UL channels/signals
      Condition-14: when the UE receives an activation command, wherein the activation command contains/includes/indicates/provides the S activated TCI codepoints according to those specified herein in the present disclosure (e.g., the first S activated TCI codepoints in the activation command) that map at least one codepoint of DCI field ‘Transmission Configuration Indication’ to at least two DL TCI states or TCI states for DL channels/signals
      Condition-15: when the UE is using at least a/the first indicated joint/DL TCI state for PDSCH reception—e.g., scheduled/activated by the DCI format 1_2, and/or when the UE receives an activation command, wherein the activation command contains/includes/indicates/provides the S activated TCI codepoints according to those specified herein in the present disclosure (e.g., the first S activated TCI codepoints in the activation command) that map at least one codepoint of DCI field ‘Transmission Configuration Indication’ to a/the second (indicated) joint/DL TCI state
      Condition-16: when the UE is using at least a/the second indicated joint/DL TCI state for PDSCH reception—e.g., scheduled/activated by the DCI format 1_2, and/or when the UE receives an activation command, wherein the activation command contains/includes/indicates/provides the S activated TCI codepoints according to those specified herein in the present disclosure (e.g., the first S activated TCI codepoints in the activation command) that map at least one codepoint of DCI field ‘Transmission Configuration Indication’ to a/the first (indicated) joint/DL TCI state
      Condition-17: when the UE receives an activation command, wherein the activation command contains/includes/indicates/provides the S activated TCI codepoints according to those specified herein in the present disclosure (e.g., the first S activated TCI codepoints in the activation command) with at least one TCI codepoint mapped to/comprising of at least a/the first joint/DL TCI state and at least one (or another) TCI codepoint mapped to/comprising of at least a/the second joint/DL TCI state
      Condition-18a: when the UE receives an activation command, wherein the activation command contains/includes/indicates/provides the S activated TCI codepoints according to those specified herein in the present disclosure (e.g., the first S activated TCI codepoints in the activation command), and the S activated TCI codepoints are not mapped to/comprising of either only first joint/DL TCI state(s) or only second joint/DL TCI state(s)—or equivalently, when the UE receives an activation command, wherein the activation command contains/includes/indicates/provides the S activated TCI codepoints according to those specified herein in the present disclosure (e.g., the first S activated TCI codepoints in the activation command), and the S activated TCI codepoints are not mapped to/comprising of single joint/DL TCI state(s) and/or single pair(s) of DL and UL TCI states (e.g., either first or second TCI state(s))
      Condition-18b: when the UE receives an activation command, wherein the activation command contains/includes/indicates/provides the S activated TCI codepoints according to those specified herein in the present disclosure (e.g., the first S activated TCI codepoints in the activation command), and not all the S activated TCI codepoints are mapped to/comprising of either only first joint/DL TCI state(s) or only second joint/DL TCI state(s)—or equivalently, when the UE receives an activation command, wherein the activation command contains/includes/indicates/provides the S activated TCI codepoints according to those specified herein in the present disclosure (e.g., the first S activated TCI codepoints in the activation command), and not all the S activated TCI codepoints are mapped to/comprising of single joint/DL TCI state(s) and/or single pair(s) of DL and UL TCI states (e.g., either first or second TCI state(s))
      Condition-19: when the UE receives a Rel-18 (unified) TCI state(s) activation MAC CE command—or, the second, third or fourth (unified) TCI state(s) activation MAC CE command(s) as specified herein in the present disclosure, wherein the received activation command contains/includes/indicates/provides the S activated TCI codepoints according to those specified herein in the present disclosure (e.g., the first S activated TCI codepoints in the activation command)
      Condition-20, when the UE does not receive any Rel-17 (unified) TCI state(s) activation MAC CE command—or, the first (unified) TCI state(s) activation MAC CE command as specified herein in the present disclosure, and/or when the UE does not receive any third (unified) TCI state(s) activation MAC CE command(s) as specified herein in the present disclosure
      Condition-21, when the UE receives a Rel-17 (unified) TCI state(s) activation MAC CE command—or, the first (unified) TCI state(s) activation MAC CE command as specified herein in the present disclosure, and/or when the UE receives a third (unified) TCI state(s) activation MAC CE command(s) as specified herein in the present disclosure, wherein the received activation command does not contain/include/indicate/provide the S activated TCI codepoints as specified herein in the present disclosure
   Otherwise (e.g., when/if one or more of the described/specified conditions herein including Condition-0-Condition-21 are not achieved/satisfied or do not hold), e.g., when the UE is having only one joint/DL TCI state to be applied for/to PDSCH/PDSCH reception(s)—e.g., scheduled/activated by the DCI format 1_2, and/or when the TCI codepoints activated/indicated/provided in a received activation command are mapped to/comprising of single joint/DL TCI state(s) and/or single pair(s) of DL and UL TCI states (e.g., either first or second TCI state(s)), and/or when the S activated TCI codepoints according to those specified herein in the present disclosure in a received activation command are mapped to/comprising of single joint/DL TCI state(s) and/or single pair(s) of DL and UL TCI states (e.g., either first or second TCI state(s)), and/or when none of the TCI codepoints activated/indicated/provided in a received activation command is mapped/comprising of two joint/DL TCI states, and/or when none of the S activated TCI codepoints according to those specified herein in the present disclosure in a received activation command is mapped/comprising of two joint/DL TCI states, and/or when the UE receives a Rel-17 (unified) TCI state(s) activation MAC CE command—or equivalently a first (unified) TCI state(s) activation MAC CE command as specified herein in the present disclosure and/or receives a third (unified) TCI state(s) activation MAC CE command as specified herein in the present disclosure, wherein the received activation command contains/includes/indicates/provides the S activated TCI codepoints according to those specified herein in the present disclosure (e.g., the first S activated TCI codepoints in the activation command), and/or when the UE does not receive any Rel-18 (unified) TCI state(s) activation MAC CE command(s)—or, the second, third or fourth (unified) TCI state(s) activation MAC CE command(s) as specified herein in the present disclosure, and/or when the UE receives a Rel-18 (unified) TCI state(s) activation MAC CE command—or, the second, third or fourth (unified) TCI state(s) activation MAC CE command(s) as specified herein in the present disclosure, wherein the received activation command does not contain/include/indicate/provide the S activated TCI codepoints as specified herein in the present disclosure, the UE could use Tables 1/2/3/4/5/6/7/8 as provided/specified herein in the present disclosure. Furthermore, when/if the UE is not configured with higher layer parameter antennaPortsFieldPresenceDCI-1-2, antenna port(s) are defined assuming bit field index value 0 in 1/2/3/4/5/6/7/8 as provided/specified herein in the present disclosure.

When/if one or more of the described/specified conditions herein (e.g., Condition-0—Condition-21 as specified herein in the present disclosure) are achieved/satisfied or hold—e.g., when a UE is having/using two indicated joint/DL TCI states to be applied to/for PDSCH(s)/PDSCH reception(s)—e.g., scheduled/activated by the DCI format 1_2, the UE can receive an entry with DMRS ports equals to 1000, 1002, 1003.

If the UE is not configured with higher layer parameter antennaPortsFieldPresenceDCI-1-2, antenna port(s) are defined assuming bit field index value 0 in 1/2/3/4/5/6/7/8 as provided/specified herein in the present disclosure.

Throughout the present disclosure, setting a first indicator for PDCCH reception(s) as specified herein in the present disclosure as ‘00’ is equivalent to setting the first indicator for PDCCH reception(s) as specified herein in the present disclosure as ‘first’, and/or setting a first indicator for PDCCH reception(s) as specified herein in the present disclosure as ‘01’ is equivalent to setting the first indicator for PDCCH reception(s) as specified herein in the present disclosure as ‘second’, and/or setting a first indicator for PDCCH reception(s) as specified herein in the present disclosure as ‘10’ (or ‘11’) is equivalent to setting the first indicator for PDCCH reception(s) as specified herein in the present disclosure as ‘both’, and/or setting a first indicator for PDCCH reception(s) as specified herein in the present disclosure as ‘11’ (or ‘10’) is equivalent to setting the first indicator for PDCCH reception(s) as specified herein in the present disclosure as ‘none’.

Throughout the present disclosure, setting a second indicator for PDSCH reception(s) as specified herein in the present disclosure as ‘00’ is equivalent to setting the second indicator for PDSCH reception(s) as specified herein in the present disclosure as ‘first’, and/or setting a second indicator for PDSCH reception(s) as specified herein in the present disclosure as ‘01’ is equivalent to setting the second indicator for PDSCH reception(s) as specified herein in the present disclosure as ‘second’, and/or setting a second indicator for PDSCH reception(s) as specified herein in the present disclosure as ‘10’ (or ‘11’) is equivalent to setting the second indicator for PDSCH reception(s) as specified herein in the present disclosure as ‘both’, and/or setting a second indicator for PDSCH reception(s) as specified herein in the present disclosure as ‘11’ (or ‘10’) is equivalent to setting the second indicator for PDSCH reception(s) as specified herein in the present disclosure as ‘none’.

Throughout the present disclosure, setting a third indicator for PUCCH transmission(s) as specified herein in the present disclosure as ‘00’ is equivalent to setting the third indicator for PUCCH transmission(s) as specified herein in the present disclosure as ‘first’, and/or setting athird indicator for PUCCH transmission(s) as specified herein in the present disclosure as ‘01’ is equivalent to setting the third indicator for PUCCH transmission(s) as specified herein in the present disclosure as ‘second’, and/or setting a third indicator for PUCCH transmission(s) as specified herein in the present disclosure as ‘10’ (or ‘11’) is equivalent to setting the third indicator for PUCCH transmission(s) as specified herein in the present disclosure as ‘both’, and/or setting a third indicator for PUCCH transmission(s) as specified herein in the present disclosure as ‘11’ (or ‘10’) is equivalent to setting the third indicator for PUCCH transmission(s) as specified herein in the present disclosure as ‘none’.

Throughout the present disclosure, setting a fourth indicator for PUSCH transmission(s) as specified herein in the present disclosure as ‘00’ is equivalent to setting the fourth indicator for PUSCH transmission(s) as specified herein in the present disclosure as ‘first’, and/or setting a fourth indicator for PUSCH transmission(s) as specified herein in the present disclosure as ‘01’ is equivalent to setting the fourth indicator for PUSCH transmission(s) as specified herein in the present disclosure as ‘second’, and/or setting a fourth indicator for PUSCH transmission(s) as specified herein in the present disclosure as ‘10’ (or ‘11’) is equivalent to setting the fourth indicator for PUSCH transmission(s) as specified herein in the present disclosure as ‘both’, and/or setting a fourth indicator for PUSCH transmission(s) as specified herein in the present disclosure as ‘11’ (or ‘10’) is equivalent to setting the fourth indicator for PUSCH transmission(s) as specified herein in the present disclosure as ‘none’.

Throughout the present disclosure, i.e., for the design examples/procedures specified herein in the present disclosure, a/the UE could be provided/configured with dl-OrJointTCI-StateList and/or ul-TCI-StateList.

Any of the above variation embodiments can be utilized independently or in combination with at least one other variation embodiment.

The above flowchart(s) illustrate example methods that can be implemented in accordance with the principles of the present disclosure and various changes could be made to the methods illustrated in the flowcharts herein. For example, while shown as a series of steps, various steps in each figure could overlap, occur in parallel, occur in a different order, or occur multiple times. In another example, steps may be omitted or replaced by other steps.

Although the figures illustrate different examples of user equipment, various changes may be made to the figures. For example, the user equipment can include any number of each component in any suitable arrangement. In general, the figures do not limit the scope of the present disclosure to any particular configuration(s). Moreover, while figures illustrate operational environments in which various user equipment features disclosed in this patent document can be used, these features can be used in any other suitable system.

Although the present disclosure has been described with exemplary embodiments, various changes and modifications may be suggested to one skilled in the art. It is intended that the present disclosure encompass such changes and modifications as fall within the scope of the appended claims. None of the descriptions in this application should be read as implying that any particular element, step, or function is an essential element that must be included in the claims scope. The scope of patented subject matter is defined by the claims.

What is claimed is:

1. A user equipment (UE), comprising:
a transceiver configured to:
receive, in a transmission configuration indication (TCI) state activation/deactivation medium access control control element (MAC CE) command, L activated TCI codepoints, where L≥1, wherein each of the L activated TCI codepoints is mapped to a first or second TCI state; and
receive a downlink control information (DCI) with a TCI field having S TCI codepoints, where S≥1; and
a processor operably coupled to the transceiver, the processor configured to:
identify, the L activated TCI codepoints that are mapped to the S TCI codepoints; and
apply the first TCI state and the second TCI state for transmission and reception,
wherein the transceiver is further configured to receive, in a first DCI and a second DCI, a first indication of the first TCI state and a second indication of the first TCI state, respectively, and
wherein the processor is further configured to identify, based on a time of reception of the first and second DCIs, the first or second indication of the first TCI state to use to update the first TCI state after a beam application time.

2. The UE of claim 1, wherein:
when S is less than L, first S of the L activated TCI codepoints are mapped to the TCI field, and
at least one of the first S of the L activated TCI codepoints includes a joint TCI state or a downlink (DL) TCI state.

3. The UE of claim 1, wherein:
when the time of reception of the first DCI is later than the second DCI, the first indication of the first TCI state is used to update the first TCI state; and
when the time of reception of the second DCI is later than the first DCI, the second indication of the first TCI state is used to update the first TCI state.

4. The UE of claim 1, wherein:
the transceiver is further configured to receive, in a third DCI and a fourth DCI, a first indication of the second TCI state and a second indication of the second TCI state; and
the processor is further configured to identify, based on a time of reception of the third and fourth DCIs, the first or second indication of the second TCI state to use to update the second TCI state after the beam application time.

5. The UE of claim 4, wherein:
when the time of reception of the third DCI is later than the fourth DCI, the first indication of the second TCI state is used to update the second TCI state; and
when the time of reception of the fourth DCI is later than the third DCI, the second indication of the second TCI state is used to update the second TCI state.

6. The UE of claim 1, wherein the first and second DCIs are received in control resource sets (CORESETs) associated with a same value of coresetPoolIndex.

7. The UE of claim 1, wherein:
when the time of reception of the first DCI is later than the second DCI, the processor is further configured to determine the beam application time based on the first DCI; and
when the time of reception of the second DCI is later than the first DCI, the processor is further configured to determine the beam application time based on the second DCI.

8. A base station (BS), comprising:
a processor; and
a transceiver operably coupled to the processor, the transceiver configured to:
transmit, in a transmission configuration indication (TCI) state activation/deactivation medium access control control element (MAC CE) command, L activated TCI codepoints, where L≥1, wherein each of the L activated TCI codepoints is mapped to a first or second TCI state used for transmission and reception;
transmit a downlink control information (DCI) with a TCI field having S TCI codepoints, where S≥1, wherein the L activated TCI codepoints are mapped to the S TCI codepoints; and
transmit, in a first DCI and a second DCI, a first indication of the first TCI state and a second indication of the first TCI state, respectively,
wherein, based on a time of reception of the first and second DCIs, the first or second indication of the first TCI state indicates to update the first TCI state after a beam application time.

9. The BS of claim 8, wherein:
when S is less than L, first S of the L activated TCI codepoints are mapped to the TCI field, and
at least one of the first S of the L activated TCI codepoints includes a joint TCI state or a downlink (DL) TCI state.

10. The BS of claim 8, wherein:
when the time of reception of the first DCI is later than the second DCI, the first indication of the first TCI state indicates to update the first TCI state; and
when the time of reception of the second DCI is later than the first DCI, the second indication of the first TCI state indicates to update the first TCI state.

11. The BS of claim 8, wherein:
the transceiver is further configured to transmit, in a third DCI and a fourth DCI, a first indication of the second TCI state and a second indication of the second TCI state; and
based on a time of reception of the third and fourth DCIs, the first or second indication of the second TCI state indicates to update the second TCI state after the beam application time.

12. The BS of claim 11, wherein:
when the time of reception of the third DCI is later than the fourth DCI, the first indication of the second TCI state is used to update the second TCI state; and
when the time of reception of the fourth DCI is later than the third DCI, the second indication of the second TCI state is used to update the second TCI state.

13. The BS of claim 8, wherein the first and second DCIs are received in control resource sets (CORESETs) associated with a same value of coresetPoolIndex.

14. The BS of claim 8, wherein:
when the time of reception of the first DCI is later than the second DCI, the beam application time is based on the first DCI; and
when the time of reception of the second DCI is later than the first DCI, the beam application time is based on the second DCI.

15. A method performed by a user equipment (UE), the method comprising:
receiving, in a transmission configuration indication (TCI) state activation/deactivation medium access control control element (MAC CE) command, L activated TCI codepoints, where L≥1, wherein each of the L activated TCI codepoints is mapped to a first or second TCI state;
receiving a downlink control information (DCI) with a TCI field having S TCI codepoints, where S≥1;
identifying, the L activated TCI codepoints that are mapped to the S TCI codepoints;
applying the first TCI state and the second TCI state for transmission and reception;
receiving, in a first DCI and a second DCI, a first indication of the first TCI state and a second indication of the first TCI state, respectively; and
identifying, based on a time of reception of the first and second DCIs, the first or second indication of the first TCI state to use to update the first TCI state after a beam application time.

16. The method of claim 15, wherein:
when S is less than L, first S of the L activated TCI codepoints are mapped to the TCI field, and
at least one of the first S of the L activated TCI codepoints includes a joint TCI state or a downlink (DL) TCI state.

17. The method of claim 15, wherein:
when the time of reception of the first DCI is later than the second DCI, the first indication of the first TCI state is used to update the first TCI state; and
when the time of reception of the second DCI is later than the first DCI, the second indication of the first TCI state is used to update the first TCI state.

18. The method of claim 15, wherein:
receiving, in a third DCI and a fourth DCI, a first indication of the second TCI state and a second indication of the second TCI state; and
identifying, based on a time of reception of the third and fourth DCIs, the first or second indication of the second TCI state to use to update the second TCI state after the beam application time.

19. The method of claim 18, wherein:
when the time of reception of the third DCI is later than the fourth DCI, the first indication of the second TCI state is used to update the second TCI state; and
when the time of reception of the fourth DCI is later than the third DCI, the second indication of the second TCI state is used to update the second TCI state.

20. The method of claim 15, wherein the first and second DCIs are received in control resource sets (CORESETs) associated with a same value of coresetPoolIndex.
